(19) United States
(12) Patent Application Publication
(10) Pub. No.: US 2025/0023078 A1
(43) Pub. Date: Jan. 16, 2025

(54) Advanced Fuel Cell Design, Apparatus And Fabrication

(71) Applicant: Richard K. Williams, Cupertino, CA (US)

(72) Inventor: Richard K. Williams, Cupertino, CA (US)

(21) Appl. No.: 18/773,948

(22) Filed: Jul. 16, 2024

Related U.S. Application Data
(63) Continuation-in-part of application No. 18/756,703, filed on Jun. 27, 2024.
(60) Provisional application No. 63/513,890, filed on Jul. 16, 2023.
(60) Provisional application No. 63/608,395, filed on Dec. 11, 2023.

(51) Int. Cl. H01M 8/1041; H01M 4/92; H01M 8/0234; H01M 8/0258; H01M 8/0267; H01M 8/04029; H01M 8/10; H01M 8/1004; H01M 8/1039; H01M 8/241

(52) U.S. Cl. CPC H01M 8/1041; H01M 4/92; H01M 8/0234; H01M 8/0258; H01M 8/0267; H01M 8/04029; H01M 8/1004; H01M 8/1039; H01M 8/241; H01M 2008/1095; H01M 2300/0082; H01M 2300/0088

(57) ABSTRACT

A advanced fuel cell (AFC) assembly comprises a variety of features improving its performance, reliability, durability, and manufacturability include an ion exchange membrane such as a proton exchange membrane comprising polymers of perfluorinated sulfonic acid or hydrocarbon compounds supported by an inert endoskeletal structure of greater mechanical strength preventing deformation damage from handling, temperature cycling, and ionomer swelling and contraction from humidity cycling. The endoskeleton may be attached to wider exoskeletal pillars used for singulating one membrane from another after fabrication and to a thicker handle used to transport the membrane during processing prior to separation. Other AFC features include a asymmetric catalyst coated membrane inhibiting fuel cross over, oxygen back streaming, and CO atmospheric poisoning; a graded heterogenous gas diffusion layer for enhanced charge and gas transport; and a self-aligned gasket-less assembly with integrated sealant preventing gas leakage.

### CROSS-REFERENCE TO RELATED APPLICATIONS

This application claims the priority of the following: U.S. Provisional Application No. 63/513,890, titled “Advanced Fuel Cell Design, Apparatus and Fabrication,” filed on Jul. 16, 2023, and U.S. Provisional Application No. 63/608,395, titled “Ion Exchange Membranes and Applications Thereof,” filed on Dec. 11, 2023.

This application is a continuation-in-part application of U.S. application Ser. No. 18/756,703, titled “Intelligent Buffered Fuel Cell with Low Impedance,” filed on Jun. 27, 2024.

Each of the foregoing applications is incorporated herein by reference in its entirety.

### SCOPE OF THE INVENTION

The invention relates to the construction and assembly of fuel cells comprising ion exchange membranes including those using hydrogen and methanol as fuel sources.

### BACKGROUND

The availability of clean reliable electrical energy is becoming increasingly important in modern technological society as it is plays a pivotal role in nearly every activity and industry today. Applications requiring electrical power include computing; communication, networking; and the Internet; transportation; telephony; wired and wireless networks; consumer electronics and entertainment; home appliances; medical devices; security systems; motor drive; satellites; defense; and emergency response. Industries, enterprises, and personal uses relying on electrical power are far ranging, including business, commerce, and banking; residential and commercial buildings; infrastructure; factories and heavy industry; farming and agriculture; biotech and medtech; semiconductors and electronics; avionics, aircraft, airlines, and space travel; boats, ships; trains and rail transport; automobiles and trucks; motorbikes, all terrain vehicles (ATVs) and scooters; hospitals, clinics, and healthcare; computer and server farms; and more. Even electrical power generation requires electricity to manage control functions.

Primary Power. The source of power this myriad of electrical applications can be categorized into two classes: primary power and secondary power. Primary power is a fundamental source of energy occurring in nature and converted into electricity generally using mechanical motion of turbine turning a generator. A generator converts rotary or in some cases linear motion into electric current in accordance with Faraday's law by juxtaposing a magnet and a coil. In operation, one of the two elements, either the coil or the magnet is constantly moving relative to the other element, thereby magnetically inducing electric current in the coil. The output of a generator, i.e. the current induced in the conductive coil, may be alternating current (AC) or direct current (DC). A variant of a generator, called an alternator, produces only AC.

The force producing kinetic movement of a generator rotor may come from a variety of sources including thermal energy used to boil a fluid to turn a turbine. Primary power thermal sources include natural heat (geothermal, concentrated sunlight); chemical reactions or burning of fossil fuels releasing heat including coal, natural gas, refined oil products, and biofuels; or nuclear reactions used to generate heat via fission of heavy atoms (or potentially fusion of hydrogen). All primary power sources suffer from some major limitation. In primary power generation the burning of fossil fuels, especially coal, is largely responsible for most air pollution and anthropogenic carbon dioxide releases. Among fossil fuels, natural gas represents the cleanest source of power.

Although nuclear power is free of greenhouse gasses, the disposal and storage of nuclear waste represents a significant environmental challenge and safety risk. Another major issue with present day liquid-cooled nuclear plants is their need to be located near large bodies of water such as rivers, lakes, and oceans. Unfortunately uncontrolled heating of the nuclear core, i.e. nuclear meltdown, can irrevocably contaminate water supplies causing radiation poisoning and cancer in residents, and poison livestock, fish, vegetables, and other food stuffs. Notorious nuclear disasters include the Three-Mile Island and Chernobyl Ukraine.

Another serious risk of nuclear power plants being located on the ocean is the risk of tsunami damage to the reactor facility itself. For example on Mar. 11, 2011 the Fukushima nuclear disaster in Tohoku Japan occurred as a result of 9.1 magnitude quake followed by 14 meter high tsunami. The tsunami damaged the emergency generators causing backup power loss to circulating coolant pumps resulting in the nuclear meltdown of three nuclear cores. The cascade of failures simultaneously killed two people from radiation, burned 16 persons from hydrogen explosions, and released 18,000 terabecquerel (TBq) of radioactive caesium-137 into the Pacific during the accident. Since this event, much of the world are now decommissioning nuclear fission power plants.

As a safer cleaner alternative source of energy, the kinetic motion of fluids (wind, falling water, ocean waves) may be converted into electricity using a turbine and generator. Falling water also referred to as hydroelectric power is however limited geographically to rivers and lakes, including artificial lakes creating by dams. Although the hydroelectric energy production is carbon free, the use of dams is opposed by many environmentalists for disrupting wildlife and destroying wildlife habitats. Recently modern wind farms located in windy offshore locations have come under increased scrutiny for causing whale beachings and bird deaths.

Geothermal power is also geographically limited, specifically to within the vicinity of volcanos and hot springs where magma penetrates the mantle into the earth's upper crust. Unfortunately volcanos are often associated with magmatic and tectonically active areas where earthquake risk and steam explosions must be considered as a safety hazard.

Solar energy, harvesting energy from sunlight, comes in two forms—thermal-solar power generation and direct photon conversion. In thermal-solar plants sunlight is focused by mirrors to a central boiler used to generate steam and drive turbines producing AC power. Despite its theoretical potential, commercial deployment of thermal-solar power production has proven to be technologically and economically unviable. Firstly, thermal-solar power generation requires large tracts of land where sunlight is plentiful and the sky is consistently free of clouds. As land is expensive, most thermal-solar power facilities must be located in deserts far from population centers. The long distance delivery of electrical power is however extremely problematic, especially using AC transmission.

Further complicating matters, diurnal temperature variations in dessert climates are extreme, ranging from below freezing in the night hours to over 55° C. (130° F.) by the afternoon. These large daily excursions in operating temperature have been found to damage mirrors, warp metal, and damage equipment resulting in unmanageably high repair and maintenance costs. As such several large projects solar-thermal projects have been abandoned. The alternative, centralized power generation via direct energy conversion of sunlight using photovoltaic (PV) cells for is similarly uneconomical, requiring vast swaths of land covered by expensive solar panels. Using cheaper land located far from metropolitan areas is even more problematic than solar-thermal farms as PV cells produce direct current, not AC power. High-voltage DC power transmission over large distances is currently too complex and expensive to be considered a viable technology for primary power.

A better alternative is to employ photovoltaic power generation, not as primary power for the electric grid, but locally as residential power generation for personal use. While the use of solar panels placed atop houses, apartments, and garages is becoming popular, it too faces serious technology and commercial challenges. Specifically, most residential solar owners use a solar inverter to convert DC into AC and to dump the power they generate back into the AC power grid receiving billing credits for “negative” power flow. This practice is intrinsically flawed and limited in its ability to scale. Firstly, like wind generation, solar power varies unpredictably with weather patterns and with cloud cover resulting in intermittent power unable to ensure a steady rate of power. Intermittent power can cause noise, power factor fluctuations, and destabilize the power grid impacting power quality for all users.

To offset the destabilizing impact of client-generated intermittent solar power, power utilities are forced to generate more AC power to mitigate transients and maintain a constant frequency for transmission. This action requires the utility burn more fossil fuels to counteract the intermittent power with generator power. Ironically, the more renewable energy is fed into the power grid, the more fossil fuel must be burned to compensate to create the grid working. As a result, many utilities no longer give credits to users for the power they generate. Instead, home owners and apartments are being asked to locally store the energy they generate.

The need for local power storage is part of even a broader topic—peak electrical demand management. A principal issue with primary power is the difficulty of synchronizing power generation with power consumption. Specifically when power is plentiful, energy consumption may not be sufficient to utilize the generated power, causing power to go wasted. Conversely in times of peak demand, e.g. in the early evening, renewable sources such as solar are not be available, forcing increased production using fossil fuels causing pollution and requiring higher current handling capacity of power transmission lines.

In such instances, it is preferable to deliver power to local sub-grids off peak hours and to store it locally. Stored energy is referred to as secondary power. Secondary power and local storage offers numerous benefits. Firstly it reduces the ratio of peak power to average power carried by transmission lines comprising the power grid. When users demand more power, they are able to draw it from local storage rather than drawing it from the power plant. Secondly, local power storage provides a degree of redundancy in case the main grid suffers a brownout or a power failure. Lastly local power storage acts as a buffer minimizing line voltage perturbations caused by non-sinusoidal power sources such as renewables. Secondary power may be stored in a variety of forms, not necessarily only using battery storage.

Secondary Power. The storage of power for subsequent use is referred to a secondary power. Once generated from primary sources, energy may be stored as electric charge or converted into a form of potential energy in gaseous, gravitational, or chemical form. For example, primary power may be used to pump water to a large container at a higher altitude storing energy gravitationally. When needed, the water is allowed to fall from its container using gravity to accelerate the fluid into a steady stream. The falling water is then used to turn a turbine and AC generator to produce electricity in a manner similar to hydroelectric power.

Similarly primary power can be stored hydrostatically as a pressurized air for subsequent use. In this case a pump powered by a primary power source is used to compress air to store in a container at an elevated pressure, typically several hundred times that of normal atmospheric pressure. When needed, the compressed air is released at a control flow rate turning a turbine and generator to make electricity for use. While both gravitational and pressurized gas can be used for local energy storage on a power grid, factory, building, or home, these forms of power storage are not portable. Less common energy retention and secondary power generation may employ temporarily stored energy comprising heat held in insulated containers or retained as momentum in large flywheels.

Another class of secondary power is chemical storage. In chemical storage, primary power can be used to separate chemicals into ions, reactive compounds, molecules, or elements. These components can be later converted into electrical power. The most common method of chemical energy storage is the use of an electrochemical cell known as a battery. In a battery reactive cations such as inorganic monovalent lithium ions are transported through the semipermeable separator propelled by an externally applied electric field. Delivered by a DC power supply called a charger, the applied electric field transfers power into the cell converting electrical energy into stored chemical energy. During charging, cations are transported across a semipermeable separator membrane accumulating on the anode electrode and increasing the cell voltage until the battery is fully charged. Once charged, the separator maintains the electrochemical potential between anode and cathode with minimal self-discharge leakage. The maximum stored charge and maximum cell voltage are limited. Exceeding this maximum voltage by overcharging may result in fire or explosion.

To recover power stored in the battery, an electrical load is connected across the cell's anode and cathode electrodes resulting in current flow in the battery, a process referred to as discharging. During discharge, electrons are removed from the anode flowing into the load. Concurrently, a corresponding number of cations must flow back across the separator to the cathode in order to maintain charge neutrality. This process discharges the battery lowering the electrochemical potential of the cell. In the case of lithium ion batteries, over-discharging of the cell may result in permanent cell damage subsequently leading to fire and possible explosion.

Another type of chemical storage is the process whereby electric power is used to form fuels or volatile chemical compounds to be used later for power generation. One such approach, called P2G or power-to-gas, employs electrolysis of water to produce hydrogen. The hydrogen may be used immediately to create electricity; stored in a pressurized canister for later use; or converted into another heavier fuel compounds such as syngas, methane, or liquid petroleum gas (LPG). These gasses may be stored, transported, and subsequently converted into electricity using conventional generators such as gas turbines.

Aside from electrolysis, hydrogen may also be produced from direct solar water splitting; thermochemical; and biological processes. Specifically during direct solar water splitting also known as photolytic conversion, hydrogen is produced from water using sunlight and specialized photoelectrochemical semiconductors. In direct photolytic conversion, absorbed light energy dissociates water molecules into hydrogen and oxygen. Alternatively, in photolytic biological systems, microorganisms such as cyanobacteria or green microalgae absorb sunlight as a driver to break down organic matter, releasing hydrogen. Thermochemical hydrogen production involves converting various fuel sources such as natural gas, biomass, or coal through a thermal process to release hydrogen from their molecular structure. Examples include natural gas reforming aka steam methane reforming, biomass gasification, biomass-derived liquid reforming, and solar thermochemical hydrogen. Biological hydrogen production includes microbial biomass conversion and photobiological conversion.

Beyond its use a fuel source for heating, hydrogen may be converted directly into electrical current using a hydrogen fuel cell with water as a byproduct of the chemical reaction. Although many different types of fuel cells are available for a wide range of applications, the most promising category of fuel cell is the proton-exchange-membrane or polymer-electrolyte-membrane fuel cell, with the acronym PEM FC. Well suited for portable and transportation applications, the PEM layer acts as an electrolyte to control proton transport after catalytically splitting hydrogen atoms into a hydrogen ion and an associated electron. A key requirement of the membrane is to allow proton conduction without allowing gas exchange of hydrogen and oxygen isolated in cathode and anode chambers.

Comparing the diversity of secondary power sources available today, the lithium ion battery and the PEM hydrogen fuel cell represent the best prospects for secondary power generation and energy storage, especially in transportation and portable applications. Each technology however suffers from a number of challenges including fire risk and safety considerations.

Lithium Ion Battery Technology. By far the most common form of energy storage involves the use of batteries. A battery is an electrochemical cell that once fabricated is able to absorb and retain energy through a process referred to as “charging” and to release the stored energy later to power an electrical load, a processes referred to as “discharging.” Despite their ubiquitous use, batteries suffer numerous limitations and intrinsic weaknesses, including the following:
After discharging, a battery must be recharged to a substantial charge state before reusing, a process which takes time during which an electrical vehicle cannot be driven, home battery backup power is lost, and electronics are inoperable or operate with diminished function.
Cycle life of a battery is reduced by repeated charge-discharge cycles where the total capacity at full charge diminishes over time. All batteries, even the popular Li-ion battery suffer limited cycle-life. Eventually the battery life becomes so limited the entire pack must be replaced, often at a price higher than the product using it.
Some batteries such as the lead-acid battery used in motor vehicles contain caustic chemicals or acids as an electrolyte representing a contact safety risk to users and first responders.
The manufacture of batteries includes hazardous, caustic, and flammable materials, especially chemistries involving group-I elements in the periodic table such as lithium. Factories have burned to the ground in Japan and in China from lithium fires.
Some batteries such as the Li-ion battery, contain highly volatile chemicals as electrolytes that if leaked from the cells or over-heated, may smolder, catch on fire, or in extreme circumstances explode. Reports of battery smoke and fire disabling vehicles such as aircraft, electric vehicles, notebook computers, and cell phones appear commonly in media publications. In extreme cases, battery fires may result in death or permanent burn injury.
Research on fire resistant cell construction using solid state lithium ion batteries, where the liquid electrolyte is replaced by a ceramic material continues. Although reported energy densities have improved, serious material and performance issues persist including high contact resistance between conductive electrodes and the ceramic electrolyte, and significant changes in battery characteristics when exposed to air and moisture.
To protect against accidental or intentional misuse of a battery, active protection electronics must be integrated into battery cells and into the battery pack system including protection electronics to prevent overcurrent, overvoltage, and over-heating and to maintain balanced cell voltages. Other protection mechanisms include a pressure release valve. In the event pressure builds up in the battery enclosure (metal can) containing the electrolyte from over heating, the battery vents the excess fumes to reduce the risk of explosion. Another protective feature is the use of a heterogeneous bi-layer separator that reduces or impedes current as a cell heats. This novel separator construction comprises pores which penetrate a separator comprising polymers or plastic layers having different coefficients of thermal expansion, i.e. dissimilar TCEs. While at room temperature, the pores align allowing the full degree of current to flow across the membrane, at elevated temperatures the pores misalign restricting ion flow thereby reducing heating.
Batteries are heavy relative to the amount of energy they store—performance measured by a parameter called gravimetric energy density, i.e. battery energy per weight. Cell weight is generally dominated by cobalt and nickel used in their construction of the battery cathode electrode followed by the graphite used in the anode in Li-ion batteries. The weight of the Li-ion battery pack in an electric vehicle can range from 450 kg to 900 kg (1,000 to 2,000 pounds) depending on vehicle's range. Although increasing a vehicle's battery capacity commensurately extends its per-charge driving range, the added weight unavoidably offsets the benefit of the additional storage.
The manufacture of lithium ion batteries involves a significant adverse environmental impact in all phases of production including mining and extraction, purifying and processing, along with recycling and disposal. Effects include ground, air, and water pollution along with habitat destruction. Ground and water pollution includes heavy metals and toxins leaching into waterways and aquifers. Air pollution includes gaseous byproducts of chemical refining as well as CO₂ from mining equipment and electric power generation needed by battery factories.
Production of lithium ion batteries has a significant carbon footprint. The term CO₂e describes all the carbon released during the entire Li-ion battery production process where the subscript “e” denotes the term effective or equivalent estimated to be 73 kg CO₂e/kWh. This upfront consumption of energy used to mine and process raw materials and manufacture an EV battery pack means that a new electric vehicle starts at a carbon disadvantage compared to gas powered internal combustion engine, then makes up the initial deficit with each year of use. See discussion to follow.
The mining and production of lithium batteries has been criticized for their inhumane and unethical supply chain management including forced labor, child labor, and other forms of economic conscription of impoverished peoples. The United Nations and Amnesty International are seeking to combat the problem by attempting to pressure reform of the entire supply chain starting in the mines of the Democratic Republic of the Congo; in the cobalt smelters in China; in the battery manufacturers in China, Japan, and South Korea; and by promoting consumer awareness for change in the global consumer electronic and EV markets, especially in the USA, EU, and UK. Although Li-ion battery pack costs have declined significantly since 2008, coupling surging demand with improved pay and working conditions for those in the battery trade is expected to reverse this trend leading to increased battery costs.
The raw materials used in lithium ion battery manufacture are concentrated in certain countries including China and Russia. As energy is considered a strategic component of national security by most countries, the supply chain for sourcing ores and salts used in lithium ion production now carries geopolitical considerations.

A key application of the lithium ion battery is in electric vehicles or EVs. To fully assess the environmental benefit of a battery EV we must consider the total green house gasses emitted during both manufacturing and use. Of the 73 kg CO₂e/kWh total carbon dioxide produced during battery manufacturing, roughly 40% or 28.5 kg CO₂/kWh occurs during mining, conversion and refining of the nickel-cobalt-manganese NCM powder. The second most energy-demanding activity, cell production, requires 14 kg CO₂/kWh or 20% to power drying and heating in the manufacturing process. The third largest impact on greenhouse gasses is aluminum refining. An intrinsically energy intensive process, aluminum production is responsible for 12.4 kg CO₂/kWh or 17%. Another 6.8% is used to fabricate associated pack electronics with an added 5% consumed in producing the battery's graphite anode. The high carbon footprint is largely tied to the fact that China, a major battery producer derives 60% of its electric power from coal. Given a 73 kg CO₂e/kWh dependence of released carbon during manufacturing, the net carbon footprint for a eV battery with a range of 40 kWh (e.g. Nissan Leaf) is 2920 kg, while a 100 kWh (e.g. Tesla) requires 7300 kg of CO₂.

Unlike internal combustion engines which burn gasoline and release CO₂ and other pollutants, greenhouse gasses from an EV come not from the vehicle itself but from the power production needed to charge the EV battery. As a reference, the US DoE reports conventional gasoline fueled engines emit 2.4 kg CO₂e for every 10 km travelled. In contrast, studies report EVs emit 1.0±0.5 kg of CO₂e, i.e. from 5-to-15 kg per every 10 km travelled, depending on how and where the electricity used to charge the EV battery is produced. This means the beneficial reduction in CO₂ emissions ranges from 0.9-to-1.9 kg for every 10 km driven with a nominal saving of 1.4 kg for typical electrical grids used for charging. For an average driving distance of 25,000 km (15,500 miles) per annum, a combustion engine releases 6,000 kg (6 metric tons) of CO₂ while an EV emits 2,500 kg or 2.5 metric tons.

This means an EV reduces carbon emissions by 3,500 kg (3.5 metric tons) per annum per driver with a net savings of 60%. Considering as described previously, an EV's initial carbon footprint is 4-to-7 metric tons larger than a gasoline engine at manufacture, and that EVs save 3.5 metric tons of CO2e per annum, it means the break even point where an EV becomes “greener” than a gasoline engine occurs between 1-to-2 years of use. After 5 years use, a gasoline engine has released 30 metric tons of carbon dioxide while an EV has emitted an average of (5.5+5.1)=10.5 metric tons including the 5.5 metric ton initial offset due to battery manufacturing pollution. As such, over the lifetime of the car, an EV reduces greenhouse emissions by two-thirds.

Unfortunately, the ecological damage of mining and high volume manufacturing of Li-ion batteries cannot be measured by CO₂ emissions alone. As such efforts continue to find viable alternatives to the ubiquitous Li-ion battery.

Li-Ion Battery Electrical Operation. The dynamic or time-dependent behavior of lithium ion cells involves the flow of electrons in a battery circuit and corresponding changes in the electrochemical and states within the cell corresponding to conduction. Normally, batteries alternate in three states of operation:
Charging: Conducting current in response to an external circuit comprising an electrical source power which increases the charge Q stored in the electrochemical cell, i.e. converting kinetic electrical energy into chemically stored potential energy.
Discharging: Conducting current in response to an external circuit comprising an electrical load which decreases the charge Q stored in the electrochemical cell, i.e. converting chemically stored potential energy into kinetic electrical energy.
Storage: The condition when a battery is electrically disconnected from any external electrical circuit whereby the charge Q stored in the electrochemical cell and the electrochemical potential therein does not change over time except for small changes in the internal electrochemical charge state within the battery itself (known as self-discharge).

In general, current in a battery varies as a function of time, i.e. I=f(t). Time variations in cell currents occur because most electrical networks to which a batteries are connected exhibit both transient and oscillatory properties, depending on operating mode of the system. These conditions arise when a battery is connected or disconnected to a power source (such as an AC-to-DC adapter), when an electrical device (like a cell phone) is turned on, or when the supply or demand of current in the battery naturally has time varying or reactive components. The same energy delivery requirements arise when driving an electrical load directly from a fuel cell. The internal resistance of conventional fuel cells available today, however, greatly limit their electrical performance.

An example of the transient behavior of current conduction in battery or fuel cell is shown in FIG. 1 where a battery pack 2 in circuit 1a containing one or more Li-ion cells 3 is connected in series with an electrical load represented by resistor 5 having a value R_{load} and capacitor 6 having capacitance C_{load}. For simplicities sake we will assume in this scenario the battery is already charged and capacitor 6 has no charge on it.

As shown in graph 1b, so long that switch 4 remains open, no current flows and I_{discharge}=0 as shown by line segment 10a. Once switch 4 is closed the current rapidly rises 10b from zero amperes to some momentary peak value 10c and then begins to decline 10d to a steady state value 38e. The excess current flowing (above the steady state value) is referred to as an inrush current.

Current inrush can result from reactive components such as capacitance or from time varying resistances (e.g. a light bulb filament).

In many cases the peak inrush current is limited by resistance intrinsic to the battery pack itself and within the lithium ion cell's internal construction. The final steady-state current is typically modelled in simplified form by Ohms law as I_{discharge}=V_{bat}/R_{load} even though resistor 5 may represent a complex circuit or system such as a cell phone, tablet, notebook computer, or even an entire automobile. Although inrush currents are generally short in duration and unable to cause damage to the battery, too high of a peak current could inadvertently trip protection circuitry in the battery pack interrupting normal startup operation of the system.

Another concern is how can battery protection electronics distinguish between transient inrush current and a dead short across the battery? While extended durations of excess battery currents may result from shorted component failures, other “virtual shorts” may include a motor with a stuck rotor, the flash-over current occurring during lighting of a gas discharge tube, or connecting a large array of discharged batteries in parallel with a charged battery pack (battery to battery charging).

FIG. 2A illustrates motor drive circuit 12a comprising battery pack or fuel cell stack 2 containing one-or-more series connected Li-ion cells with switch 4 and motor 12. Although switch 4 is shown as a simple idealized component in many instances it will comprise a low-resistance power metal-oxide-semiconductor field effect transistor, aka MOSFET. Since a motor is an electromechanical machine, circuit 11b represents the electrical equivalent model for a motor by equivalent circuit 12 comprising winding resistance 15 with resistance value R_{w}, winding inductance 13 with inductance value L_{w}, and back emf 14. Back emf, a phenomenological description of electromagnetic force represents an opposing voltage proportional to the motor rotational velocity ω, where V_{emf}=kₘ∫ and where kₘ is the motor constant.

In FIG. 2B representative current I_{M}(t) and voltage V_{emf}(t) waveforms shown in graph 11c are contrasted against motor rotational velocity Ω(t) in graph 11d. As shown before switch 4 is closed, motor current 25a is zero, motor rotational velocity 20a is zero, and back emf motor voltage 21b is zero. As soon as the circuit is completed and because the motor has not started turning, i.e. ω(t)=0, current 25b jumps to a value Iₚₑₐₖ=V_{bat}/R_{w}. This situation exists until the magnetic field exceeds the inertial force from the static coefficient of friction, aka stiction, until the instant 21 rotation commences at time tᵣ. Thereafter, the motor rotational velocity 20b rises to a steady state speed ω where the motor torque balances the mass loading the rotor. Correspondingly the motor voltage rises to a steady state voltage V_{emf} slightly below the battery voltage 22 with value V_{bat}, specifically where voltage difference 24 is given by the formula ΔV=V_{bat}−V_{emf}(t). This voltage difference in turn along with the winding resistance R_{w} determines the motor current 25d, specifically where I_{M}(t)=ΔV/R_{w}.

FIG. 3 contrasts battery charging to discharging. As depicted schematically, charging is achieved by connecting the positive terminal of power source 30 to the positive (cathode) terminal of Li-ion cell 3 allowing conventional current I_{charge} to flow clockwise from the power source into the cathode of the battery. By definition, electron conduction e⁻ in the circuit's conductors flow in opposite direction, i.e. counter-clockwise.

Conversely, discharging is achieved by connecting electrical load 31 (depicted as a resistor) across the positive (cathode) to the negative (anode) terminals of Li-ion cell 3 allowing conventional current I_{discharge} to flow counter-clockwise from the power source emanating from the cathode of the battery and dissipating power in electrical load 3. By definition, electron conduction e⁻ in the circuit's conductors flow in opposite direction, i.e. clockwise.

The charging and discharging processes can be better understood by considering the electrochemistry of a lithium ion cells. More precisely, the cells themselves follow the same basic electrochemistry of a coupled redox reaction comprising concurrent oxidation and reduction in opposite halves of the cell. As shown in FIG. 4, a lithium ion battery comprises two electrodes of differing composition called an anode 35 and cathode 36 sharing a common enclosure 33 and immersed in a conductive liquid or gel called an electrolyte 34. Anode 35 connects to the external circuitry through electrode anode 32a. Cathode 65 connects to the external circuitry through electrode cathode 32b.

To limit the reactions to electrochemical ion exchanges, and not to purely chemical processes, the two cell halves are separated by a porous membrane called a separator 37. The separator, often made of a polymer sheet, contains pores large enough to allow lithium ions 39 to flow from chamber to chamber during charging or discharging. The pores are however sufficiently small as to prevent molecular transport across the barrier (except in the event of a tear or melting on separator 37, a destructive and potentially dangerous failure mode).

During discharge as illustrated by resistor 31 externally connecting cathode 32b and anode 32a, current I_{discharge} flows from the cell and through the resistor, dissipating energy as heat in the resistor and generating heat in any parasitic resistive elements in the cell. The chemical reaction occurring during discharge is exothermic, producing additional heat not related to Joule heating in the metallic electrodes. The actual direction of current flow in battery often confuses many people. Following conventional electrical notation, during discharging positive charges flow internally with the electrochemical cell from the anode and flow externally from the cathode (labelled with a + sign) to the anode (labelled by a − sign) to form a single continuous loop of current.

While it is true that Li⁺ ions, ionized lithium atoms 39, comprise positively charged ions, the lithium ions never leave the battery, instead forming lithium oxide complexes 38 within cathode 36.

But since metallic electrodes and copper wires do not contain mobile positive charges, how can positive current flow in them? The simple answer is it doesn't.

Instead conduction in metals is limited to electron flow (denoted by e⁻) in equal amount but opposite in direction to the current flow convention. That means during discharging, current external to the battery flows from the battery's negative anode terminal toward the battery's positive cathode terminal in the form of electrons, not positive charge. But Kirchhoff's current law, a variation of charge conservation, states that the total current flowing into a node must always equal zero, expressed algebraically as

$${\sum }_{k = 1}^{n} {I}_{k} = 0$$

This means positive charging flowing into the cathode must equal positive charge flow out. But another way to interpret the meaning of positive charge flowing out is to consider the current as negative charge (aka electrons) flowing into the node. Charge conservation states that since charges are neither created or destroyed the total charges must balance to a net zero. The manifestation of the charge conservation principle become self evident by inspection of the electrochemical reaction at the cathode for a lithium ion battery given by

$${Li}_{1 - x} {CoO}_{2} + {x Li}^{+} + {e}^{-} \to {LiCoO}_{2}$$

where a lithium metallic cathode comprising Li₁₋ₓCoO₂ is converted to LiCoO₂ by absorbing both positive charged lithium ions xLi⁺ and an electron e⁻. During the reaction the lithium ions are supplied to the cathode by charge transport across the separator and through the electrolyte while the electron is donated from the wire carrying negative charges into the battery's cathode terminal.

Concurrently at the carbon-lithium anode CLiₓ electrons e⁻ are released into the wire and lithium ions xLi⁺ are released into the electrolyte, where C is the chemical symbol for elemental carbon:

$${CLi}_{x} \to C + {x Li}^{+} + {e}^{-}$$

thereby balancing the charges in the cell to a net zero change. Since the charges balance to zero, in doesn't matter that charge transport involves two different mechanisms—positive charge flow (lithium ions) inside the cells and electron flow outside the battery. Regardless the magnitude of current conduction in the loop (measured by coulombs per second, i.e. milli-amperes) is the same in the wire, the resistor, or the cell.

Therefore, the arbitrary adoption of positive charge flow as the standard definition of conventional current conduction offers the same mathematical precision and utility as a more detailed physics based mechanistic description but without the added complexity. Regardless, semiconductor physicists and battery chemists often casually intermix the current and electron flow terms without identifying the charge polarity or flow direction as it is self evident to those in the art.

In summary, during discharge a lithium battery converts stored energy into conduction current by converting CLiₓ into C at the anode and concurrently changing the metallic Li₁₋ₓCoO₂ into LiCoO₂ at the cathode. Since these compounds are in limited supply, the total charge Q available to power an electrical load by discharging the electrochemical cell is finite as given by the relation:

$$Q = {\int }_{o}^{t} Idt$$

While physicists measure charge in Coulombs (symbol Q), in battery powered electronics it is more useful to report a battery's capacity in milliamp-hours (mAh) or ratiometrically as C-rate where 1 mAh=3.6 coulombs. Care should be taken not to confuse the chemical symbol C meaning elemental carbon in chemical reactions with its use as the symbol C meaning coulombs, and also with its use as capacitance (where C is both a mathematical variable and a schematic element label).

Theoretically, charging a lithium ion cell should induce chemical reactions precisely the inverse to discharging, where during charging the anode must absorb electrons according to the reaction

$$C + {x Li}^{+} + {e}^{-} \to {CLi}_{x}$$

During charging electrons are supplied by power source 30 having its positive terminal connected to the battery's cathode (+ terminal) and its negative terminal connected to the battery's anode (− terminal). Concurrently during charging lithium ions flow inside the cell through the electrolyte and across the separator from the cathode 36 to the anode 35. The resulting reaction at the cathode during charging comprises

$${LiCoO}_{2} \to {Li}_{1 - x} {CoO}_{2} + {x Li}^{+} + {e}^{-}$$

The thermodynamics of charging in endothermic, i.e. electrochemically the cell absorbs heat from its surroundings becomes cooler in temperature. This cooling effect is however offset by Joule heating in the electrodes carrying the charging current. In general, for a healthy Li-ion cell charging occur at a cooler temperature than discharging. Since the charging equations mirror the discharging equations, meaning the products and reactants are swapped (i.e. the arrow direction is flipped), then charging and discharging of a lithium ion battery represent a reversible electrochemical reaction. Because however, the thermodynamics of these two operating modes differ, the charging and discharging reactions occur at different rates and at different temperatures.

In both charging and discharging the amount of current flowing varies with time depending on load or power source connected to Li-ion cell, the construction of the battery and its capacity, and the cell's age. A battery's age is not simply measured in calendar years, but by cycle-life, the number of times the cells are repeatedly charged and discharged.

If the electrochemical reactions described previously were truly reversible a battery's cycle life would be unlimited, at least until its metallic electrodes corroded. But because the reactions are not purely symmetric, small changes in a cell's stoichiometry occurring within each charge-discharge cycle results in small but irrevocable changes in electrochemistry, even if electrical operation is limited to the manufacturer's specified operating conditions. Conditions affecting battery cycle life include rate of charging, discharging currents including surge currents, temperature during charging, temperature during discharging, depth of discharge, storage conditions, and state-of-charge (SoC) during storage.

To depict and model the electrical behavior of the cell, it is common to used a schematic referred to as a lumped element circuit model. In a lumped element model, electrical behavior are combined into simple elements such as resistors, capacitors, and voltage sources even though the physical mechanisms are distributed throughout the cell or over distance. Phenomena like polarization my also be modelled as a counterposing electrical potential offsetting a fixed potential even though it is describing voltage variations of an electrochemical process.

Simplified electrical models for a Li-ion battery combine two time-invariant elements with two dynamically-changing components, namely two voltage sources and two resistive elements. Specifically the energy stored electrochemically can be represented as a constant independent voltage source with an open-circuit voltage V_{OCV}. A lumped element resistor, also time invariant, models the series resistance of the electrodes within the cell having a lumped resistance value R_{ohmic}.

The other two components are dynamic including cell polarization voltage source exhibiting time and frequency dependent voltage Vₚ(t) and dynamic cell polarization resistance with an aggregate distributed resistance R_{cells}(t). Together these two time and frequency sensitive elements appear as a dynamic impedance Z(t) shown for a lithium ion battery. The terminal voltage V_{bat} of the single Li-ion cell as a function of current is then given by the relation

$${V}_{bat} = {V}_{OCV} - {V}_{P} - I \cdot ( {R}_{cells} + {R}_{ohmic} )$$

where −V_{P}−|⋅(R_{cells}) represents a dynamic (i.e. time-dependent) voltage drop affected by frequency and I(t). The total non-reactive component of resistance Rbat is therefore the real component of impedance as given by R_{bat}=(R_{cells}+R_{ohmic}). All of these components both real and reactive depend strongly on the cell's state of charge (SoC) a description of the ratio of the current cell charge Q (above the minimum charge Qₘᵢₙ) divided by the cell's full capacity charge Q_{capacity} where

$$SoC = ( Q - {Q}_{min} ) / {Q}_{capacity}$$

$$where {Q}_{capacity} = {Q}_{max} - {Q}_{min} . For cases where {Q}_{min} ≪ {Q}_{max} then$$

$$SoC = ( Q - {Q}_{min} ) / {Q}_{capacity} \approx Q / {Q}_{max}$$

For example, a 2500 mAh capacity cell holding 1000 mAh of residual charge has a SoC of 40%. The open circuit voltage of lithium ion electrochemistry V_{OCV} varies from 3.2V to 4.1V depending on the cell's SoC and chemistry. While some Li-ion cells exhibit a peak SoC voltage of 4.1V or 4.2V other chemistries employing different cathode metals only reach 3.6V to 3.7V. The polarization voltage V_{P} 45 shown in the same graph on the rightmost y-axis remains relatively constant at 30 mV until SOC drops below 10%, then rises sharply to 160 mV indicating cell chemistry changes significantly when deeply discharged.

State of charge also impacts a Li-ion cell's ohmic resistance R_{ohmic}. For example the ohmic resistance during charging may remain a constant 3.5 mΩ until the cell's SoC falls below 40%. At this point the resistance rises linearly to 3.9 mΩ at 10% then jumps 41% to 5.5 mΩ. The effect of SoC on ohmic resistance during discharge is even more pronounced than during charging, with Rₒₕₘic exceeding 4.5 mΩ below 40% and doubling in resistance at 25%. This means the surge current capability is halved when a cell is discharged below a quarter of its rating.

A Li-ion cell's open circuit voltage V_{OCV}, also referred to as its cathode voltage, depends on the construction and composition of its electrolyte and electrodes. For example a LiFePO₄ based cell fully charged to 3.5V achieves gravimetric energy densities up to 140 mAh/g. In contrast LiNi_{0.8}Co_{0.2}O₂ based chemistries exhibit voltages of 3.7V but when charged to higher energy densities of 200 mA/g increases to 4.2V. Energy densities also depend on crystalline structure. LiCo₂ and NMC with (111) crystal orientation both exhibit voltages between 4.0V and 4.2V while LiMn₂O₄ exhibits highest voltage at 4.25V at energy densities of 120 mAh/g.

Charging above these voltages can lead to catastrophic cell damage, overheating, smoke and fire. But since the voltage at full charge varies by cell chemistry, there is no way to design protection circuitry to prevent dangerous overvoltage conditions on all cell types. For example, protection for LiCo₂ cell at 4.2V cannot prevent fire for LiFePO₄ whose maximum safe voltage is 3.5V. For these safety risks, Li-ion cells cannot be sold and used in loose form like NiCd, NiMH, and alkaline batteries. Instead, each Li-ion cell must be assembled into a “battery pack” containing the cell and its corresponding protection circuitry.

The protection circuitry is designed to avoid a variety of failure modes including overvoltage, undervoltage, overcurrent, over-temperature, etc. In this sense, the safe use of Li-ion cells, both during charging and discharging is neither simple nor obvious as it depends on cell chemistry, material selection, and cell construction.

Since batteries vary by size and storage capacity, when comparing charging and discharging properties of cells it is convenient to use stored charge rather than current. If we consider the charge contained within a battery as charge Q measured in coulombs denoted by the capital letter C and that Q=l·t where l measured as amperes is defined as 1 A≡1 C/sec then a coulomb may also be expressed in terms of ampere-hours simply by adjusting time t by the conversion factor that 1 hour=3600 secs. When expressing Q not a coulombs but in units of A-hr or mA-hr, then current can be designated by the term “C-rate” algebraically represented as

$$C - rate = {Q}_{capacity} / t$$

As such, the C-rate of a battery is the total charge capacity of the battery (measured in mAh) normalized by time (in hours). For example, at a C-rate of 1 C a battery having Q_{capacity}=1000 mAh battery will deliver 1000 mA for one hour. At a C-rate of 2 C the same battery can deliver 2000 mA for 0.5 hours. Similarly, at a C-rate of 0.5 C, a battery can deliver 500 mA for 2 hours, a C-rate of 0.2 C can deliver 200 mA for 5 hours, and a C-rate of 0.1 C can deliver 100 mA for 10 hours. Reformulating the prior C-rate equation

$${Q}_{capacity} = t \cdot C - rate$$

the hyperbolic relationship between C-rate and time becomes self-evident whereby discharge time is inversely proportional to C-rate with the constant of proportionality being the battery's charge storage capacity Q_{capacity}.

The advantage of describing battery capacity by C-rate is that it scales with current, making it convenient to determine how quickly a particular battery takes to charge or discharge as a ratio of current to its capacity. Since in physics charge is a conserved quantity, then C-rate can be considered a path independent state variable valid regardless of whether current is constant or time varying. This is important because Li-ion and many other battery chemistries must operate in a specified range of charge states designated as Qₘᵢₙ and Qₘₐₓ. Charging the cell above Qₘₐₓ or discharging it below Qₘᵢₙ can lead to cell damage and potentially cause overheating, fire, or explosion.

FIG. 5 summarizes the relationship between stored charge Q_{capacity}, state-of-charge (SoC), discharging time t, and battery current I_{bat} (expressed in terms of C-rate). As shown, a discharge C-rate of 1 C shown by curve 48a will discharge a battery from a maximum stored-charge level of (Qₘᵢₙ+Q_{capacity}) to a minimum level 49a of stored charge Qₘᵢₙ in a duration of 1 hour. The removal of the stored charge Q_{capacity} can involve any discharge waveform comprising time varying load currents I (t) whereby

$${Q}_{capacity} = {\int }_{0}^{t} I ( t ) dt$$

which can be expressed as an average current Iₐᵥₑ conducted over the discharge interval t where to fully discharge a battery

$${I}_{ave} = {Q}_{capacity} / t$$

Ideally, the equation is symmetric for both discharging and charging, where a charging current of 1 C shown by curve 47a increases the charge on the battery from Qₘᵢₙ at point 49a to Qₘₐₓ where Qₘₐₓ=(Qₘᵢₙ+Q_{capacity}), the maximum charge 49b after 1 hour. Alternatively, charging at a C-rate of 0.5 C shown by curve 47b requires 2 hours to increase the state of charge to 100%.

To avoid overcharging a cell, electronic protection must either monitor the charge charges in the cell, a process called coulomb counting, or precisely control the maximum and minimum cell voltages to stay within the safe operating area of SOA. Using voltage to define the safe operating area or SOA of a lithium ion battery is represented graphically in FIG. 6A. As shown, the safe operating voltage range 50f is bounded by line 50c representing the maximum safe voltage 56 and line 50a depicting the lowest safe voltage 53. Region 50b represents an over-discharged condition where a battery may already be permanently damaged reducing is capacity and possibly impeding normal charging.

Normal charging 52 commencing from point 53 may proceed up to point 56 without risk. Commencing charging in the over discharged state shown by curve 51 must be performed carefully to avoid battery malfunction, permanent damage, or worse. One such method is to use low charging currents (sometime called trickle charging) when operating in zone 50b. Whether damage actually occurs to the Li-ion battery depends on many variables leading to the battery's discharging including temperature, depth-of-discharge, the discharging current, and storage time.

Overvoltage conditions in a Li-ion battery are far less forgiving. Even slight overcharging a Li-ion battery above the voltage demarcated by line 50d in fire risk region 50e can lead to severe consequences including overheating during charging 57 and explosion 58 at only a slightly higher voltage. Although the numerical voltages displayed on the voltage axis are exemplary, the actual voltage varies by each lithium battery chemistry. The voltage difference between the top of the safe operating area 50c and the edge of fire risk condition 50d can be as little as 50 mV, so extreme care must be taken to avoid overcharging using voltage as a control parameter as depicted by curve 57.

Importantly, the process of Li-ion battery charging is not performed by simply applying a fixed voltage to the cell until the charging current decays but involves two different zones, constant current (CC) charging and constant voltage (CV) charging as represented in FIG. 6B by the charging curves I_{chrg(CC)} 59a and I_{chrg(CV)} 59b respectively. Moreover, charging currents may be controlled using continuous DC current or by employing pulse modulation and duty factor control to reduce heating. In general pulsed charging is capable of faster charge times than continuous charging. Other benefits of pulsed charging include extended battery cycle life.

Safe operating area is however, not only defined by voltage but also by current and temperature. Excessive charging or discharging currents can cause rapid heating leading to cell damage and fire risk. Protection circuitry is thereby required to prevent cell damage from operating outside the specified SOA for all four key parameters—overcharge voltage (V_{OC}) limit 50c, over-discharge voltage (V_{ODC}) limit 50a, along with over-current restrictions during charging and discharging, and an over-temperature protection (OTP) limit.

Although Li-ion operation is strictly interrupted in event of exceeding overcharge voltage (V_{OC}) limit 50c or dropping below over-discharge voltage (V_{ODC}) limit 50a, limitations in the safe operating range of current must be managed in a completely different way. A simple overcurrent detection circuit shutting off conduction above a defined level is not possible because of inrush current occurring when an electrical load is first connected to the battery as described previously in this disclosure.

If such a strict protective measure would be included the overcurrent protection would falsely trip from inrush every time the battery is connected to a load, rendering the battery totally useless. Instead Li-ion batteries are manufactured to accommodate much higher currents than the specified ratings of the product sold both during charging and during discharging. The manufacturing involves testing to ensure the fabricated cell is not defective and able to handle transient currents much higher than the cell's steady-state current rating.

For example during charging, a cell is rated to charge at a maximum charging current I_{chrg(max)} 60 at a specified C-rate of +1 C. In order to ensure safe and reliable charging within the specified range, during manufacturing the cell is tested for safety at a charge current I_{chrg(test)} 62 at a C-rate of 2.5 C, more than 2.5-times the cell's rating.

If the Li-ion cell is assembled into a battery pack prior to testing, then any overcurrent protection device must be chosen to trip at a level slightly exceeding the tested charge current I_{chrg(test)} 62 to avoid falsely triggering the protection mechanism during test charging. If, however, the cell is tested without any protection electronics, then the overcurrent protection device can be selected to trip at a level slightly below the tested charge current I_{chrg(test)} 62.

Note that the average charge current I_{chrg(CC)} 59a during constant-current mode charging is lower than specified current I_{chrg(max)} 60 which in turn is less than test current I_{chrg(test)} 62, where I_{chrg(CC)}<I_{chrg(max)}<I_{chrg(test)} is maintained. This guard band is deceptive as the constant-current vale I_{chrg(CC)} is an average value. If pulsed charging is used, the peak current for a 50% duty factor charging profile may be double the average current I_{chrg(CC)}, clearly beyond I_{chrg(max)} but still below I_{chrg(test)}.

The current guard band required for battery discharging is far more excessive than for charging. Unlike charging circuitry selected by a product system specifier, discharge current is determined by the electrical load which cannot be predicted, especially during load transients, inrush, and start-up conditions. Referring again to FIG. 6B, a cell rated to carry a maximum steady-state discharge current [−I_{load(max)}] 61 at a specified C-rate of-2 C is tested at a peak discharge current [−I_{load(test)}] 63 at a specified C-rate of −13.5 C, a current nearly seven-times the recommended maximum discharge current [−I_{load(max)}] 61.

If over-current protective circuitry for battery discharging is included in battery pack it is normally included primarily for short circuit protection, and not to limit short duration current spikes. As such, the overcurrent shutdown threshold [−I_{OCSD}] is selected to be even greater in magnitude than [−I_{load(test)}] 63. For load currents greater in magnitude than [−I_{load(test)}] but less than [−I_{OCSD}], battery packs typically rely on over-temperature protection (OTP) to prevent safety hazards rather than over-current detection circuitry.

As described, the charging and discharging currents are not listed in terms of amperes but specified as C-rate. The actual current values thereby scale in accordance with the capacity of the battery. For example the actual current for a 2 C discharge rate using a 3000 mAh battery is 6 A while a 2 C discharge rate using a 1000 mAh battery is only 2 A, one third the current. Similarly a 1 C charge rate charges for a 3000 mAh battery comprises a 3 A charge current while a 1000 mAh battery requires only 1 A.

Regardless of the battery capacity, the ratio of the rated discharge current to the rated charge current is two-to-one. The ratio of test current defining the SOA to the rated current varies significantly between charging and discharging conditions. While charging, the peak test current is only 2.5× the operating range, during discharging the ratio is 6.75. This asymmetry between charging and discharging is illustrated in the table below listing the SOA ratings for a differently rated Li-ion batteries.

| Cell capacity, | | | | |
|---|---|---|---|---|
| coulomb equivalency | 1000 mAh | | 3000 mAh | |
| Charge current | 700 | mA (0.7 C) | 2.1 | A (0.7 C) |
| I_{chrg(CC)}, typical | | | | |
| (average) | | | | |
| Charge current | 1 | A | 3 | A |
| I_{chrg(max)}, 1 C rated | | | | |
| Charge current | 2.5 | A | 7 | A |
| I_{chrg(test)}, 2.5 C rated | | | | |
| Discharge current | −2 | A | −6 | A |
| I_{load(max)}, 2 C rated | | | | |
| Discharge current | −13.5 | A | −40.5 | A |
| I_{load(test)}, 13.5 C rated | | | | |
| Cell resistance | 12 | mΩ | 4 | mΩ |
| Short circuit current, | 350 | A (350 C) | 1050 | A (350 C) |
| 0Ω, 4.2 V full charge | | | | |
| Overtemperature | 72−to−90° | C. | 72−to−90° | C. |
| shutdown | | | | |

One key property of the lithium ion battery is its ability to deliver high currents on demand to an electrical load. For a 3000 mAh battery, a 13.5 C test current is an impressive 40.5 amperes. Although this current is quite substantial it is no where near the peak current capability of a lithium ion cell. In this regard, the peak cell current defined as the short circuit current I_{sc} is given by the relation

$${I}_{sc} = \frac{{V}_{OC}}{{R}_{bat} + {R}_{short}} \leq \frac{4.2 V}{{R}_{ohmic}}$$

where V_{bat}=V_{oc}=4.2V, Rₛₕₒᵣₜ=0, and R_{bat}≈R_{ohmic}. For a standard 18650 cell, R_{ohmic}=4 mΩ in which case I_{sc}=1050 A, or a C-rate of 350 C. The ratio of the short circuit current to the discharge test current is given by I_{SC}/I_{load(test)}=350 C/17.5 C=20×. This large ratio enables short circuit protection to be set at an intermediate value without limiting the transient current performance of the battery. Protection for high discharge currents of extended duration instead rely on overtemperature protection in the range 72-to-90° C.

Despite its high energy density capability one concern with cylindrical Li-ion cells is internal heating, especially in the event of an operational fault or a battery pack malfunction. As illustrated in FIG. 6C, the temperature transient of a cylindrical cell during overheating shows the cell temperature immediately rise 64b above ambient temperature 64a when conduction commences then stabiliz3 64c during normal operation at a temperature well below the over-temperature shutdown detect limit T_{OTSD} 66.

Should excess heat generation from changing electrical conditions cause a further rise in cell temperature 64e, without properly functioning temperature protection the temperature can run away, rising uncontrollably until cell destruction or a fire 65 results. Because of its cylindrical construction heat in cell 67a concentrates in the center of the cell as shown by region 67b in radial temperature distribution 68 and centered lengthwise 69b at the peak of profile 69a. The cell centric concentration in heat causes the electrolyte to expends creating internal pressure which can cause the cell's metal can to burst in the center or explode. Another possibility is internal pressure causes the electrolyte to leak around chemical seal 67c and potentially combust in the presence of oxygen.

Because the fire risk is very real, the protection of lithium batteries is and continues to be a key concern in their widespread and ubiquitous use. Despite the numerous precautions detailed in this whitepaper, numerous inexplicable failures and fires persist. More effort is required to identify the root cause of such application failures and prevent further incidents.

The Challenge of Charging Li-ion Batteries. Because of its low series resistance and high load transient current capability during discharge, the lithium ion battery is capable of supporting a wide range of applications. Conversely, given its extreme sensitivity to overvoltage and to the risk of cell damage from over-discharging, care must be maintained to ensure operation within its safe operating area (SOA). Described previously, as a highly energetic electrochemical reaction, operating a Li-ion cell beyond its voltage-current-temperature SOA risks overheating, electrolyte leakage, smoke, ignition, fire, and possibly explosion.

To maintain operation strictly within its SOA, lithium ion battery packs employ a battery disconnect switch or “BDS” as a protective device separating the packs cells from electrical loads or power sources external to the pack, disconnecting them whenever a fault condition arises. While protection against excessive voltages, temperatures, and short circuits can be monitored using voltage references and comparators, the process of charging is more complex. During charging, high currents of extended duration can lead to elevated internal cell temperatures causing degradation of the battery separator, changes in electrolyte stoichiometry, electrode corrosion, and premature aging. Unfortunately lowering battery charging current results in excessively long charging times.

Rather than by supplying continuous conduction, in alternative approach pulse charging delivers short repeated bursts of high-currents to maximize the average charging rate while minimizing internal heating. So although pulse mode charging is able to control the average power transferred from a power source to the battery and thereby control heating, pulse mode operation does not limit the peak current in the battery during the conducting portion of the cycle.

Specifically, most step-down switch-mode battery chargers employ a Buck topology, one where the input to the charger Vᵢₙ is momentarily connected by a low-resistance conducting switch such as a power MOSFET to one terminal of an inductor. The other side of the inductor is connected to the converter's output, in this case the battery at a voltage V_{bat}. During each conducting interval the inductor instantaneously supports a voltage V_{L} equal to the differential voltage of its input and output, i.e. ΔV=(Vᵢₙ−V_{bat}). During inductor conduction, the current-voltage relationship is governed by the fundamental branch constraint V_{L}=L(dl/dt) where V_{L}=ΔV=(Vᵢₙ−V_{bat}).

Accordingly, the larger the voltage difference (Vᵢₙ−V_{bat}) across the inductor, the faster the current ramp dl/dt, the higher the peak current will be. Unfortunately, high current spikes, even of brief duration can still damage a lithium ion cell. This limitation is problematic when a Li-ion battery is deeply discharged, i.e. with a low state-of-charge SoC when current pulses are high, diminishing as the battery voltage rises.

The solution to this challenge is a dual-mode charger 73 such as shown in FIG. 7A comprising a linear-mode constant current charger 74, a switching charger 75, and a mode select mechanism depicted as a SPDT single-pole double-throw switch 76. In operation, whenever the voltage differential ΔV=(Vᵢₙ−V_{bat}) is large, i.e. in deep discharge, linear charger 74 delivers a constant current to the battery, denoted by the descriptor CI or sometimes CC. During CI charging, the battery reaches a specific target voltage at time t_{CV} the charger mode select circuit 73 switches from CI constant current mode to CV constant voltage mode and switching charger 75 becomes active. CV charger mode offers at least three advantages over CI mode. First, it charges the Li-ion cells faster than CI mode. Secondly switch mode operation is more energy efficient than linear mode. In linear node a voltage is sustained across the control device whilst current is conducted.

Thirdly and foremost, CV mode will not exceed the maximum safe voltage of the lithium ion battery pack 77. In CV mode, charging current drops to zero as the target voltage for V_{bat} is approached. In this manner CV mode has no risk of overcharging the cell or exceeding its overcharge voltage.

It should also be noted that lithium ion chargers, even dual-mode, assume a stiff voltage source as their input. In conventional chargers, if the input power source is unable to deliver the requisite power and current, charger operation will fail. This means lithium ion pack charging from a PV array, wind turbines, and from fuel cells are not trivial. Instead, most Li-ion packs are charged from the AC mains. Referring again to FIG. 7A charging involves rectification of sinusoidal AC mains 70 from AC to DC by full bridge 71. The resulting voltage is stepped down in voltage by switching converter 73 forming the input the input to dual mode charger 73. Switching converter 73 may comprise a Buck converter, a synchronous Buck converter, or a flyback converter with an appropriate winding ratio of a coupled inductor. The function of dual-mode charger 73 modifies the electrical power into a form beneficial for charging battery 77 comprising time varying waveforms V_{bat}(t) and I_{bat}(t) shown in FIG. 7B.

Specifically, during the discharge period when CI-CV charger 73 is not operating, battery current 80a is negative, i.e. where I_{bat}(t)<0. As such the battery voltage 81a declines. At time t_{CI} battery charging commences in the form of a constant current 80b via linear charger 74 whereby I_{bat}(t)>0 and the battery voltage 81b rises linearly. At time t_{CV}, the charger switches mode 76 into constant voltage pulse charging using a switching charger 75. As pulsed currents 80d commence the average battery current instantly rises 80c then declines 80z and the battery voltage 81z rises approaching its target voltage. As the voltage increases, the charger's duty factor having a value D=1−(V_{bat}(t)/V_{L}(t)) declines resulting in shorter current pulses 80e.

Like any battery, however, the Li-ion cell requires time to charge. This is particularly problematic in electric vehicle applications when a driver must interrupt travel to recharge. Battery charging is problematic for long journeys as it adds to travel time and driver fatigue. The availability of charging stations is another concern, especially in extremely cold weather where a car failure can be deadly. High global demand for high capacity lithium ion packs is another problem, facing supply chain challenges in scaling up Li-ion production, including unethical labor practices and the ecological impact of mining of cobalt, lithium, and other minerals needed in lithium ion battery pack assembly. Despite the foregoing issues, Li-ion battery represents the todays only viable technology for portable power in electronics and electric vehicles. The question persists what role if any can hydrogen fuel cells play in the future of power generation, distribution, and energy storage.

Given a practical limitation in the peak C-rate of Li-ion cells, the fastest way to charge a lithium ion cell is to disconnect all electrical loads during charging to expedite electrochemical process. In an EV, dedicated charging means a driver must discontinue ravel while recharging their car. If a public charge station can only deliver a charge rate of 0.5 C, it means recharging could take two-or-more hours turning a manageable four hour trip into arduous six hour ordeal.

The table of FIG. 8 compares a variety of battery pack topologies for varying applications ranging from 68 Wh to approximately 100 kWh, with weights ranging from 0.3 kg to 98400 kg and charging currents from 3 A to 375 A. As illustrated, charging times extend to from 2-to-7 hours unless a charging system is capable of hundreds of amperes. FIG. 9A illustrates battery pack charging time versus pack capacity for various chargers. For example a 70 W charger can charge a 70 Wh battery pack within one hour such a low power charger can not be used for charging high capacity battery packs of 1 kWh or more. Higher power chargers at 5 kW, 14 kW, 35 kW, and 98 kW represented by curves 82c, 82d, 82e, and 82f respectively are able to deliver a charge of 5 kWh, 14 kWh, 35 kWh, and 98 kWh in a one hour interval and double that in 2 hours.

The delivered power, given by the multiplicative product I_{bat}(vV_{bat}) where “v” is the number of series connected Li-ion cells, is represented by the hyperbolas 83a, 83b, 83c, 83d, 83e, and 83f in FIG. 9B corresponding to delivered power levels of 70 W, 1 kW, 5 kW, 14 kW, 35 kW, and 98 kW respectively. As shown, only high voltage battery packs where vV_{bat}≥200V are realistically able to deliver power of 5 kW or more.

Other Energy Storage Solutions. Other battery chemistries currently in development include lithium polymer, metal-hydrides like NiMH, sodium ion, zinc air, solid state lithium, iron air, and LFP lithium iron phosphate. Lead acid cells are generally considered too heavy and caustic for most applications. While some of these chemistries hold promise it is projected they will take years or even decades to perfect and even longer to scale for volume manufacturing. One potential alternative for storing energy is a room-temperature hydrogen fuel cell. The H₂fuel cell faces several unresolved challenges, especially how to improve the efficiency, reproducibility, and usability of the hydrogen fuel cell including reducing its electrical resistance and humidity dependence.

Hydrogen as a Fuel. Today the only realistic alternative to a lithium ion battery for portable energy and transportation is hydrogen fuel cell technology using hydrogen as a transportable source of power. Although a fuel cell may be considered as an energy generator rather than a form of energy storage, it does not represent a primary power source as it requires fuel, specifically hydrogen, to operate. This hydrogen must be extracted from another source, molecules containing hydrogen before a fuel cell can function. Common hydrogen sources include water, natural gas and methane, and fossil fuels. The hydrogen once produced is then converted into electricity by the fuel cell through an electrochemical process whose only byproduct is water, giving the appearance that a fuel cell is a pure pollution-free source of green electrical energy.

But are hydrogen fuel cells really a source of clean energy? As the adage goes—“the devil's in the details.” The key point is pure hydrogen does not naturally occur in nature (except in rare cases), but like many other sources of usable energy must first be extracted, i.e. refined. The process of hydrogen extraction however requires energy from a primary energy source, generally electricity generated from fossil fuels, natural gas, nuclear power, hydroelectric power, or from renewables such as solar energy and wind power. The pollution caused by a hydrogen fuel cell is therefore not the process of converting hydrogen into electric current, but the pollution and carbon gasses emitted during the production of its hydrogen fuel.

Accordingly, how “green” a hydrogen fuel cell depends on how polluting the power is to make its hydrogen production in the first place. Pollution emitted from hydrogen production is commonly referred to in accordance with the hydrogen color spectrum (even though it has nothing to do with light or color). Instead hydrogen color is an environmental metaphor for how polluting the production of hydrogen was, primarily ranked by the carbon emissions of the primary power source or source material used to extract the hydrogen. The table to follow describes various means to extract hydrogen and the metaphoric term used to describe the process.

As a metaphor, however, the hydrogen spectrum is neither scientific nor arranged monotonically by color (wavelength) of light. For example, green and yellow hydrogen refer to H₂ production from clean energy of renewable sources while brown and black hydrogen refer to processes involving the burning fossil fuels. Every other color is in between.

| Primary power | H₂ Spectrum | Hydrogen Generation |
|---|---|---|
| Wind power | Green: 100% | Large scale wind farm T2G2G |
| | renewable | (turbine-to-gen-to-grid) |
| | | Grid powers electrolysis |
| | | Wind farm T2G2G without power |
| | | transmission |
| | | Local grid powers electrolysis |
| | | in real time |
| | | Off-grid wind fan turbine-to- |
| | | generator |
| | | Gen powers electrolysis off- |
| | | grid in real time |
| | | Optional local storage for |
| | | delayed electrolysis |
| Solar-thermal | Green: 100% | Large scale solar farm and |
| | renewable | boiler for T2G2G |
| | | Grid powers electrolysis |
| Hydroelectric | Green: 100% | Hydroelectric T2G2G |
| | renewable | Grid powers electrolysis |
| Solar-PV | Green or | Photovoltaic arrays directly |
| | yellow: 100% | power electrolysis |
| | renewable | Requires DC/DC conversion & |
| | | batteries to regulate rate |
| | | Optional local high cap storage |
| | | for delayed electrolysis |
| | | Photovoltaic arrays with MPPT |
| | | (max power tracking) |
| | | DC/DC converter powers and |
| | | controls electrolysis rate |
| | | Optional local storage for |
| | | delayed electrolysis |
| Chlor-alkali | Yellow | Electrolysis of saturated sodium |
| | or white | chloride solution (brine) |
| | | Grid power for sodium hydroxide |
| | | & chlorine from salt |
| | | Capture free waste hydrogen |
| | | (unless it is reburned) |
| Natural | White | Naturally occurring, geological |
| hydrogen | | hydrogen found in underground |
| | | deposits, may occur in fracking |
| | | projects |
| Nuclear-electric | Pink | Nuclear heat exchanger for T2G2G |
| | | Grid powers electrolysis |
| Thermo-nuclear | Purple (violet) | Nuclear heat exchanger for T2G2G |
| Nuclear-electric | | powers electrolysis |
| | | Nuclear heat exchanger for chemo- |
| | | thermal electrolysis |
| Thermo-nuclear | Red | Nuclear heat exchanger for chemo- |
| | | thermal electrolysis |
| Natural gas | Blue | Steam methane reforming (SMR): |
| | | steam + NG + catalyst |
| | | Produces H₂ with CO and CO₂ |
| | | byproducts |
| | | Uses carbon capture, storage, |
| | | utilization (CCSU) |
| | | Combines SMR with integrated fuel |
| | | oxidation system |
| | | Improved carbon recapture |
| | Gray | Steam methane reforming (SMR): |
| | | steam + NG + catalyst |
| | | Produces H₂ with CO and CO₂ |
| | | byproducts |
| Methane | Turquoise | Methane pyrolysis with solid |
| | | carbon byproduct |
| | | Thermal, plasma (Kvaerner), or |
| | | catalytic decomposition |
| Igneous coal | Brown | Coal gasification for H₂ with |
| | | CO and CO₂ byproducts |
| | | Benefits from carbon capture, |
| | | storage, utilization (CCSU) |
| Bituminous coal | Black | Coal gasification for H₂ with |
| | | CO and CO₂ byproducts |
| | | Benefits from carbon capture, |
| | | storage, utilization (CCSU) |

Note in the table, the term T2G2G is an acronym for turbine-to-generator-to-grid where a turning turbine powers a generator delivering electricity into the power grid. The force used to drive the turbine may be derived from renewable energy or by consuming a fuel. Renewable sources for T2G2G electric power may include wind power, hydroelectric or geothermal sources, and solar power (aka yellow hydrogen). T2G2G assumes the power grid is capable of absorbing generated energy. Aside from supplying electric into the grid via T2G2G, other turbine-to-generator electric power methods may be employed to directly power electrolysis either contemporaneously or stored locally as electric charge in batteries for later hydrogen conversion, i.e. delayed electrolysis.

In photovoltaic (PV) direct conversion of sunlight, generated electricity may power electrolysis in real time or be temporarily stored in batteries and regulated by a DC/DC converter to maintain a more steady hydrogen generation rate. More elaborate PV systems may include MPPT, an acronym for maximum power point tracking where the solar panel track the suns movement to maximize power generation. Some papers refer to solar PV hydrogen as yellow hydrogen.

Nuclear power also provides numerous means to produce hydrogen. Although nuclear reactors produce radioactive nuclear isotopes as dangerous waste pollutants, nuclear fission does not produce carbon dioxide. So considering atmospheric pollution nuclear power is clean despite representing a radiative contamination risk to soil and groundwater. Moreover nuclear power is not truly renewable as it consumes nuclear fuel and produces waste. As such, nuclear generated electric power for water electrolysis is referred to as pink hydrogen. Purple or violet hydrogen combines pink hydrogen from nuclear-electric powered electrolysis with additional hydrogen generated thermally via a chemo-thermal electrolysis process. Red hydrogen uses high-temperature catalytic splitting of water with nuclear thermal power as its heat source.

Other colors of hydrogen production, such as blue, gray, and turquoise, using processes involving natural gas and methane processing are considered cleaner than coal and oil but are not really considered green-tech. For example, blue and gray hydrogen refer to steam methane reforming (SMR) or auto-thermal reforming (ATR) of gasses combined with or without carbon recapture. Turquoise hydrogen involves thermal splitting of methane via methane pyrolysis producing waste carbon in solid form, producing carbon products but not air pollution.

Black and brown hydrogen involves coal gasification. The environmental cleanliness of coal gasification varies dramatically based on the type of coal used, how its is chemically pretreated, the temperature of the chemical processing, pollutant gas reclaim methods, carbon sequestering, and more. As no single standard coal gasification process exists or is even possible, the carbon footprint of coal gas varies widely.

An even more complex question involves producing hydrogen as a secondary byproduct of regular chemical production, manufacturing performed whether the hydrogen is captured or just wasted. In this sense, even though the process may produce CO₂, the act of capturing the hydrogen doesn't produce any additional carbon dioxide. An example of this type involves the conversion of salts into important inorganic chemicals sodium hydroxide & chlorine. As part of chlor-alkali industry, chemical refining comprises electrolysis of saturated sodium chloride solution (brine) where hydrogen is a byproduct. The hydrogen can be captured and burned to generate heat needed in the process improving the overall energy efficiency of the manufacturing process. Otherwise the hydrogen can either be captured or released into the atmosphere. Since the hydrogen capture did not result in any additional CO₂ generation, the hydrogen is referred to as white hydrogen. Some papers more broadly refer to free hydrogen as yellow hydrogen as they don't increase CO₂.

Other hydrogen generation methods involve waste recycling, converting biomass into methane and then into hydrogen. When mixed with gasifying coal, this process is called co-gasification. These processes capture hydrogen from waste gasses generated from methane naturally occurring in the decay of organic compounds and biomass. Efficiency and energy yield is enhanced by mixing, i.e. integrating, fuel sources. Such integrated technologies may combine coal-sawdust, coal-sewage sludge, coal-meat, and coal-bone meal into a source of hydrogen. The coal-meat and coal-bone meal mixtures reported exhibit the best results for hydrogen production. The carbon footprint varies widely depending on the mix of hydrogen sources and the reactions used.

In summary, innumerable means exist to convert primary energy into hydrogen fuel. The forgoing example include green renewable resources such solar and wind; polluting energy sources such as coal and biomass; and intermediate sources such as nuclear and natural gas.

A separate matter is the challenge of transporting hydrogen. This topic depends on the relative locations of the hydrogen production and where it is converted into electricity. For example, hydrogen-to-electric-power conversion can occur close by the end user or nearby the hydrogen production source. If the conversion occurs near the electricity client, then the hydrogen fuel must be transported from its source to its targeted user community. Alternatively, if the H₂ to electric power conversion occurs near the hydrogen production facility, then the electric power must be transmitted over a grid or transmission line system to the user. Both distribution methods, hydrogen transportation and electric power transmission, face both efficiency and safety challenges.

Hydrogen distribution requires installed infrastructure to transport pure hydrogen as compressed gas or hydrogen compounds. Hydrogen distribution in vehicle transportation is even more complex as gas stations must be retrofitted to manage hydrogen fuel sales. The details of hydrogen transport are beyond the scope of this invention disclosure.

Conversely electric power transmission means the hydrogen is converted locally but the resulting electrical power must be transmitted over great distances. Although DC transmission offers such capability, most power transmission occurs over AC power grids unaccustomed to non-sinusoidal variable power sources. Transmitting AC power or long distances can lead to instabilities in the power grid destroying transformers, causing fires, and even damaging client devices connected to the grid.

Regardless of the myriad of challenges of hydrogen production and distribution, the opportunity of hydrogen powered homes, factories, and vehicles is compelling. The key component in any of these implementation is the means to convert hydrogen into electric power—a device called a fuel cell.

Fuel Cell Operation. Unlike a battery which delivers energy stored previously during electrical charging, a fuel cell converts hydrogen fuel into electrical energy in real time creating electrical energy and simultaneously delivering it to an electrical load. As such, a fuel cell does not require charging, but instead needs processed fuel, generally hydrogen, to operate.

An example of a fuel cell 70 is shown in FIG. 10, where fuel in the form of hydrogen 75 is separated by a chemical catalyst 78 such as platinum into positive ions and negatively charged electrons, i.e. hydrogen ions 77a (aka protons) and electrons 76a. The anode redox reaction is

$${H}_{2} \to 2 {H}^{+} + 2 {e}^{-}$$

During fuel cell operation, hydrogen ions 77a in the anode travel across an electrolytic membrane 79 to become hydrogen ions in the cathode 77b. There they combine with electron 76b and a reducing agent 80 such as diatomic oxygen 70 to produce water 81. The cathode redox reaction is given by the half reaction

$$2 {H}^{+} + 2 {e}^{-} + 1 / 2 {O}_{2} \to {H}_{2} O$$

Because anodic generated electrons 76a cannot traverse electrolyte barrier 79, they must take an external path around the cell from anode 73 though load resistance 71 to cathode 74 resulting in usable electric current. In this manner the hydrogen fuel cell converts hydrogen and air (or oxygen) into electricity and water.

This type of fuel cell is referred to as a PEM FC, an acronym for proton exchange membrane or polymer electrolyte membrane. The source of hydrogen, supplied contemporaneously to the cell during operation, depends on the operating temperature range of the fuel cell. Charge transport through the PEM electrolyte occurs via ionized hydrogen cations, i.e. protons. Using a thin film solid electrolyte, PEM FCs do not risk leakage of caustic chemical, acids, or fires of flammable fluids like other older fuel cell technologies used by the space program.

Present-day PEM FCs commonly referred to as low-temperature or LT-PEM FCs employ a solid polymer membrane comprising a sulfonated poly tetrafluoroethylene (PTFE) based fluoropolymer-copolymer, chemical formula C₇HF₁₃O₅SC₂F₄. First branded Nafion by Dupont, tradenames of fluoropolymer-copolymer related compounds useful as proton exchange membranes include Aciplex, Flemion, Dowew, and fumapem F. Morphologically fluoropolymer-copolymer these materials comprise a nanometer-sized network of hydrophilic domains allowing movement of water and cations across the membrane in one direction but inhibiting the flow of 2π electrons and anions in the opposite direction. As such, the ionomeric membrane favors transport of positively-charged hydrogen ions over negatively charged electrons, exemplifying a charge exclusion mechanism known as permselectivity. Phenomenologically, ionomers mimic subunit V of cytochrome-c oxidase (CCO-V), a mitochondrial transmembrane protein commonly known as ATP synthase responsible for creating and storing biochemical energy as adenosine triphosphate (ATP). Emulating the regulatory function of the electron transport chain in cell biology, synthetic ionomers comprise a blend of both electrically neutral repeating units and ionized units (typically carboxylic acids) covalently bonded to the polymer backbone.

By limiting ionized subgroups to 15 mole percent, the membrane splits positive and negative charges while managing current flow, in essence performing the same function as a semiconductor diode. Variations of the membrane are use in the separator of lithium ion batteries. That said, numerous deficiencies exist in present day proton exchange membranes, especially involving a strong temperature and humidity dependence and the inability to function at freezing temperatures.

The term “low temperature” in the acronym LT PEM FCs is a misnomer as it refers to operating temperatures lower than most other fuel cell varieties. Specifically Nafion based PEM FCs typically operate in the 60° C.-to-80° C. range, significantly above normal ambient temperatures on earth. A variant of PEM fuel cells called a high temperature of HT PEM FC employs lead-doped Nafion and a modification of the platinum catalyst to platinum-ruthenium. With this modification, the operating temperature range increases to the range of 110° C.-to-180° C. Both LT and HT variants of Nafion PEM FCs are not useful at room temperatures of 25° C.-to-50° C. and are completely non-functional in freezing conditions at T≤0° C. As such, Nafion based PEM FCs are unsuitable for consumer use or in transportation applications.

Another variation of the PEM FC, the direct methanol fuel cell replaces gaseous hydrogen with methane as the fuel. The change beneficially reduces the operating temperature to the 30° C.-to-60° C. range. The anodic reaction changes to CH₃OH+H₂O [symbol] CO₂+6H⁺+6e⁻ and the cathode [symbol] reaction is modified to 1.5O₂+6H⁺+6e⁻ [symbol] ³H₂O. Unfortunately the direct methanol fuel cells emits carbon dioxide. In automotive applications this means that cars remain CO₂ polluters where carbon sequester methods are not useful. As such direct methane PEM FCs are unsuitable for consumer use or in transportation applications.

Although hydrogen PEM FC represents the most promising type of fuel cell, other fuel cells with different chemistries exist. FIG. 11 illustrates four exemplary non-PEM fuel cell types—the alkali fuel cell aka AFC, MCFC, PAFC, and SOFC.

Alkali fuel (AFC) cells operate on compressed hydrogen and oxygen with potassium hydroxide (KOH) as an electrolyte with H₂O as a byproduct. Ionic transport within the electrolyte involves negatively-charged hydroxyl (—OH) anions. Using a fluidic electrolyte means AFCs risk leakage. Moreover the cells require high temperature operation, between 150° C.-to-200° C. Therefore AFCs are not considered suitable or safe for consumer use or in transportation applications.

Molten carbonate fuel cells or MCFC comprise high-temperature compounds of sodium or magnesium carbonate salts such as Na₂CO₃ as their electrolyte. Charge transport comprises carbon trioxide (CO₃²⁻) anions. The fuel cell consumes H₂, O₂ and beneficially CO₂ and release water but is sensitive to carbon monoxide (CO) poisoning. Aside from consuming CO₂, another benefit in MCFC use inexpensive nickel rather than platinum as a catalyst. Its high operating temperature, roughly 650° C., renders MCFC unsuitable for consumer use or in transportation applications.

True to their namesake, phosphoric acid fuel cells or PAFCs use phosphoric acid, chemical notation H₃PO₄, as their electrolyte. Like PEM fuel cells, charge transport in a PAFC involves H⁺ cations. In operation the cell consumes hydrogen and oxygen and produces water. Unfortunately the presence of liquid phosphoric acid heated to 200° C. makes PAFC dangerous for use except for industrial applications. As such PAFCs are not considered safe for consumer use or transportation applications.

Solid oxide fuel cells or SOFCs utilize a metal infused ceramic compound such as oxides of zirconium or calcium (yes, calcium is a metal) as an electrolyte including YSZ, ScSZ, and GDC. Fed by hydrogen and oxygen and producing water, charge transport involves divalent oxygen O²⁻ anions for charge transport. Although the solid electrolyte cannot leak, the ceramic can crack from impact or repeated temperature cycling to its nominal operating condition of 1000° C. These excessive operating temps limit high temperature limits applications of SOFC units to large scale industrial applications, and unsuitable for consumer use or transportation applications.

In conclusion, as summarized in the table below, a variety of fuel cells exist, none of which are suitable to meet the consumer and transportation market requirements. The only low temperature fuel cell technology produces CO₂ as a waste gas. Of these technologies, the proton exchange membrane or PEM fuel cells have the best chance to being readapted for lower temperature operation especially for room and at freezing temperatures commonly encountered at high altitudes and in polar regions.

| | Electro- | Ion | | | |
|---|---|---|---|---|---|
| FC Name | lyte | Transport | Fuel | Effluent | Temp ° C. |
| Methane | PEM | H⁺ | CH₃OH, | CO₂, | 30-60 |
| PEM | | | H₂O | H₂O | |
| LT PEM | PEM | H⁺ | H₂, O₂ | H₂O | 60-80 |
| HT PEM | PEM | H⁺ | H₂, O₂ | H₂O | 110-180 |
| Alkali | KOH | —OH | H₂, O₂ | H₂O | 150-200 |
| AFC | | | | | |
| PAFC | H₃PO₄ | H⁺ | H₂, O₂ | H₂O | 180-200 |
| MCFC | Na₂CO₃ | CO₃²⁻ | H₂, O₂, CO₂ | H₂O | 650 |
| SOFC | YSZ, | O²⁻ | H₂, O₂ | H₂O | 1000 |
| | ScSZ, | | | | |
| | GDC | | | | |

Among the foregoing options PEM fuel cells continue to present the best opportunity for improvement and commercial adoption. Advantages of the PEM FC include its us of a thin solid electrolyte, ease of assembly, and no concern for leaking caustic chemicals or acid. FIG. 12 illustrates a schematic of s single membrane PEM fuel cell absent the cell housing. As shown, an expanded view of cell construction illustrates two gas diffusion layers 90 and 94 where anode diffusion layer 90 includes a hydrogen fuel inlet and a second port, an outlet for recycling unused hydrogen.

Conversely, the cathode gas diffusion layer 94 has an oxygen inlet and a water outlet. Since fuel cell operation produces water, water removal is critical to maintain operation without flooding the cell electrolyte. Sandwiched between the gas diffuser layers are the anode catalyst 91, cathode catalyst 93, and the intervening proton exchange membrane (PEM) layer 92. PEM layer 92 comprises the permselective polymer of ionomer-impregnated PTFE film having thickness typically 100 microns thick.

Anode catalyst layer 91 includes platinum to dissociate hydrogen into protons (cations) and electrons bound within a carbon matrix. Because the oxygen reduction reaction (ORR) on the cathode side of the PEM more significantly affect the reaction rate and impedance of the fuel cell, Pt loading in the anode catalyst can be reduced without affecting electrical performance. While this strategy may appear to represent an opportunity for cost savings, low Pt anodes are at substantially greater risk for severe contamination from the chemical impurities present in the fuel. Contaminants such as carbon oxide, hydrogen sulfide or ammonia can react with platinum particles creating strong, nearly irreversible chemical bonds, consequently decreasing the electrochemical surface area and irrevocably damaging the cell. As such, very low anode catalyst loading is ill advised. New developments include tantalum-doped titanium dioxide (TiO₂) or alternatively combining TiO₂ with SiO₂ using vinyltrimethoxysilane (VTMS) as a binder.

On the cathode side, catalyst layer 93 accelerates the oxygen reduction reaction (ORR) combining electrons, protons, and oxygen to produce water. The stoichiometry and structure of the cathode catalyst layer continues to evolve. Present day designs comprise carbon infused with platinum. To reduce costs, new efforts attempt to develop alloys of PtNi, PtCo, Pt—Gd, Pt—Y, Pd, and Pd, Au. Other approaches include nanoparticles, nanostructures, nanosheets, and carbide cores.

Another important element in a PEM FC is the bipolar plates used to conduct current out of the fuel cell assembly and to form channels to carry coolants if needed. The properties of these metallic bipolar plates include
Good electrical conductivity (<10 Ω-cm)
Affordable cost (no rare materials, high volume capable)
RoHS compliant
Superior thermal conductivity (>20 W/cm²)
Low hydrogen permeability
High chemical and corrosion resistance
Mechanical stability against compression
Reliable during temperature cycling
Low weight per volume
Recyclable, inexpensive metal reclaim

PEM FC Electrical Characteristics. The electrical properties of a proton exchange membrane fuel cell depend on its design, materials, manufacturing, and fuel. Assessing the utility of various constructions of PEM fuel cells, however requires a common basis of comparison. Like the previous discussion regarding lithium ion batteries, a relevant comparison of electrical performance can be made using a lumped-element equivalent circuit model.

FIG. 13A illustrates one basic model for a fuel cell comprising an open circuit voltage 100 of magnitude V_{chem}, a DC resistance 104 of magnitude R_{ohmic}, and dynamic elements 103 comprising FC polarization voltage 101 of variable magnitude Vₚₒₗ and membrane resistance 102 of variable magnitude R_{memb}. The fuel cell terminal voltage V_{FC} is then given by the equation

$${V}_{FC} = {V}_{chem} - {V}_{pol} - I \cdot ( {Z}_{memb} + {R}_{ohmic} ) \approx {V}_{eff} - I \cdot ( {R}_{memb} )$$

where the dynamic impedance Z(t) is given by

$$Z ( t ) = \frac{{V}_{pol}}{I} + {Z}_{memb}$$

and where real components V_{eff}≈V_{chem}−Vₚₒₗ and R_{memb}≈Re {Z_{memb}}>>R_{ohmic}. This equivalent simplified model is depicted in FIG. 13B where the effective FC voltage 100 and DC membrane resistance 102 are both a function of temperature T, relative humidity of the anode RHA, relative humidity of the cathode RHC, and current density I/A.

To accommodate these interdependences a modified phenomenological model of a PEM fuel cell is depicted in FIG. 14A highlighting the role of humidity (water vapor) and water transport in the cell. Adapted from FIG. 10, the diagram includes the various roles of water in fuel cell operation. Identified elements include enclosure or encasement 120, PEM membrane 122 with anode catalyst layer 124a and cathode catalyst layer 124c. The catalyst layers are bounded by electrically conductive gas diffusion layers 123a and 123c on the anode and cathode side of the PEM membrane respectively.

The core of the fuel cell is the energy conversion element assembly commonly referred to as the membrane electrode assembly or MEA. The precise definition of the fuel cell core depends on how many layers are included. When referring to the PEM layer and its two catalyst layers, the sandwich may be referred to as a MEA3 in reference to its three constituent layers. The most common definition of a membrane electrode assembly is MEA5, meaning the MEA3 core plus its two enclosing gas diffusion layers. The term MEA7 refers to the structure comprising MEA5 plus two sealant rings inserted to prevent gaseous leaks between the gas diffusion layers and the conductive bipolar plates carrying gasses. MEA7 is considered a term-of-art not commonly referred to in the literature.

The role of water in PEM FC operation is critical. If the water content in the fuel cell is too low, reactivity drops, electrical impedance is increased, and delivered power is significantly reduced. To prevent the fuel cell from “drying out” water vapor must be mixed into hydrogen fed to the fuel cells. Specifically gasses supplied to anode chamber 121a comprising incoming hydrogen 75 must be humidified by water vapor 81a. The humified hydrogen 128a is then split in anode catalyst layer producing electrons and protons intermixed with H₂O molecules. Unused gasses 129a effused from anode gas channel 121a include both hydrogen and water vapor.

This mix can be resupplied, i.e. recirculated, to supply the inlet gasses 128a to the anode with no additional consumption of energy. Concurrently water vapor transported 127a through the anodic gas diffusion layer 129a reaching the anode catalyst layer 124a supports ion transport and fuel cell energy production. Unused excess water diffuses in the reverse direction 127a back across the diffuser layer returning to anode gas chamber 121a in an unused state.

The role of water in cathodic reactions is equally critical. In this example, humified air 128c is supplied to the fuel cell cathode gas channel 121c as a blend of air and/or oxygen 80 mixed with water vapor 81c, i.e. gaseous H₂O. Combining O₂ 60 with gaseous water 81c in the cathode gas channel 121c, the cathode mixture regulates the oxygen reduction reaction (ORR) in the cathode by traversing 127c the cathode diffusion layer 123 to the catalyst layer 124c thereby regulating proton cation reduction into water. In equilibrium, since the process generates additional water in the catalyst layer the excess water flows 127c across the diffusion layer in the reverse direction, increasing the humidity in cathode gas channel 121c which is regulated to the proper level by effluent removal 129c.

Since both water transport 127a in the anode and 127c in the cathode maintain equilibrium, the role of water is crucial in determining the fuel cell current and impedance. Too little water will dry out the cell, making start difficult. Too much water can adversely affect PEM FC performance. For example, excess humidity in the anode can reduce proton transport across the membrane, a phenomena referred to as electroosmotic drag shown by arrow 125. Excess humidity in the cathode can cause back diffusion of water 126 lowering cell efficiency and comingling anodic and cathodic water. In normal operation, water in the cathode should be separate from water vapor in the anode.

As such, even though the efficiency of a PEM FC is often described in reference to the relative humidity of the ambient, in more details the anode and cathode relative humidity are not the same and should be specified separately. For technical clarification, the term relative humidity or RH describes the percentage water vapor, i.e. the water vapor partial pressure, in a gas is defined by the ratio of the ambient gas temperature divided by the gas dew point temperature—the temperature where water comes out of solution changing from its gas phase into liquid.

For convenience sake it is common practice to specify the RH for a fuel cell as a single value for both anode and cathode with the understanding that better results may be obtained by optimizing the two RH values separately. Note also that the schematic shown in FIG. 14A represents the cross section where gas channels are present on both the anode and cathode side of the cell and where the bipolar plate electrodes are not visible. For further clarity FIG. 14B illustrates the addition of bipolar conductive plates to the cell carrying both electricity and gasses.

As depicted, anode gas channel 121a carrying humidified hydrogen 75 is formed within anode bipolar plate 119a. Some cross sections where anode bipolar plate 119a directly contacts the anode gas diffusion layer 123a do not include the gas channel. Instead gas carried by gas channel 121a spreads in all directions 117a throughout anode gas diffusion layer 123a to uniformly reach the anode catalyst layer 124a. Various anode gas channel geometries not shown including grids and spirals have been investigated to provide maximum uniformity to the MEA3. In addition to housing the gas channel, anode bipolar plate 119a conducts electric current from the MEA5 via anode gas diffusion layer 123a. As such both anode gas diffusion layer 123a and anode bipolar plate 119a must feature lower electrical resistance.

Similarly, cathode gas channel 121c carrying humidified oxygen 80 is formed within cathode bipolar plate 119c. Some cross sections where cathode bipolar plate 119c directly contacts the cathode gas diffusion layer 123c do not include the gas channel. Instead gas carried by gas channel 121c spreads in all directions 117c throughout cathode gas diffusion layer 123c to uniformly reach the cathode catalyst layer 124c. Various cathode gas channel geometries not shown including grids and spirals have been investigated to provide maximum uniformity to the MEA3. In addition to housing the gas channel, cathode bipolar plate 119c conducts electric current from the MEA5 via cathode gas diffusion layer 123c.

As such both cathode gas diffusion layer 123c and cathode bipolar plate 119c must feature lower electrical resistance. Note also that depending in the location of the cross section, various combinations of bipolar plates and gas channels may or may not be present in an illustration. For example the cross section shown in FIG. 14A depicts the cut line 118 of FIG. 14B.

As described the electrical characteristics of a PEM fuel cell primarily depend on the relative humidity RH of the anode and cathode, the cell temperature, and on current density. Low gas flow from inadequate supply pressure, localized heating (hot spots), and carbon monoxide (CO) poisoning of the catalyst may also impact operation.

The following sets of curves exemplify the electrical properties of prototype PEM fuel cells published in the literature, all of which suffer from serious performance and reliability challenges. They are included herein to provide mechanistic insight into FC operation. FIG. 15 illustrates the effective terminal voltage V_{FC} of a PTFC based fuel cell at 70° C. as a function of current density I/A for relative humidity ranging from 100% to 0%. Each curve exhibits a characteristic response comprising an electrochemical potential voltage 149 at near zero current of value V_{chem} which drops to a lower effective voltage 147 of magnitude V_{eff} with only a slight electrical current load. The difference is the no load polarization voltage 148 given by the relation Vₚₒₗ=V_{chem}−V_{eff}.

Aside from the initial voltage drop Vₚₒₗ at low current, each response curve above 27% relative humidity has a characteristic shape with increasing current comprising a quasi-constant voltage plateau followed higher current knee, beyond which a precipitous cell voltage drop-off occurs. The values of V_{chem}, Vₚₒₗ, V_{eff}, and V_{FC} (I/A) vary by fuel cell design and chemistry. For the illustrated example using a PTFC membrane, V_{chem}=1V and V_{eff}=0.83. At a current density of 400 mA/cm², the effective terminal voltage V_{FC} monotonically decreases with humidity, specifically 0.65V, 0.58V, 0.40V, and 0.35V respectively for different values of relative humidity, namely RH=100% for curve 140, 60% for curve 141, 35% for curve 142, and 27% for curve 143. Although higher values of relative humidity are able to maintain greater cell voltages at low current densities, the corresponding knee current at V_{FC}=0.2V occurs at monotonically lower current densities, e.g. at densities of 1.3, 1.25, 1.0, and 0.75 A/cm² for RH values of 27%, 35%, 60% and 100% respectively.

Below 20% humidity, the behavior of the fuel cell differs considerably from higher humidity operation. For example, at RH=20% curve 144 exhibits voltage collapse at any current over 0.1 A/cm² with no voltage plateau present. As indicated by curve 145, at 0% relative humidity the fuel cell is incapable of delivering any current whatsoever. Both of the curves represent a condition when inadequate water is present to support the fuel cell's minimum sustainable chemical reaction.

An important observation is that although the effective voltage V_{eff} 147 does not vary significantly with temperature and humidity, the fuel cell is incapable of generating and sourcing significant current at that voltage. For voltages below V_{eff}, the voltage-current characteristic spreads into a family of diverging curves each representing the relative humidity of the fuel cell ambient. The greater the current density the more divergent the electrical properties are. As such, it is difficult to maintain a useful load current and maintain a reasonable cell voltage.

FIG. 16 illustrates the same PEM fuel cell operating at 90° C. showing fuel cell voltage V_{FC} versus current density varies parametrically by relative humidity comprising curves 150, 151, 152, 153, 154, and 155 at RH values of 100%, 60%, 35%, 27%, 20%, and 0% respectively. Despite the fact that the cell voltage V_{chem} 156 and V_{eff} 157 remain nearly unchanged from operation at 70° C., the shape of the voltage-current conduction curves with humidity change substantially. Specifically unlike its lower temperature behavior, at elevated temps (except for 100% humidity curve 150) cell voltage V_{FC} by current density is purely monotonic in both voltage and current with no voltage plateau or knee.

FIG. 17 replots the 70° C. fuel cell voltage against relative humidity varied parametrically by current density with curves 158, 159, and 160 for current densities 0.2, 0.6, and 0.76 A/cm² respectively. Although at low current densities such as 0.2 A/cm² the usable fuel cell voltage increases proportionally with RH, at high current densities the sustained voltage peaks at around RH=55% then declines, likely due to water logging effects such as electroosmotic drag and back diffusion described previously. With the exemplary PEM FC, if the maximum current density is limited, then the usable range of humidity depends on the minimum rated cell voltage.

As shown in the below table if the delivered current is 600 mA/cm² maximum, then to operate at RH≥45% only 0.5V per cell can be ensured. If the maximum guaranteed current is reduced to 200 mA/cm² then 45% humidity can deliver 0.55V. If the minimum guaranteed voltage is lowered to 0.5V, then the fuel cell can work down to 36%. Unfortunately, limiting cell voltages and current to function across a wider range of humidity is not a good tradeoff.

| Current Density. T = 70° | Minimum V_{FC} | Usable RH Range |
|---|---|---|
| 600 mA/cm² | 0.60 V | 100% |
| | 0.55 V | 57% to 100% |
| | 0.50 V | 46% to 100% |
| 200 mA/cm² | 0.60 V | 57% to 100% |
| | 0.55 V | 46% to 100% |
| | 0.50 V | 36% to 100% |

Another major concern is the high internal resistance of fuel cells. Unfortunately, the series resistance of a PEM FC is also highly sensitive to humidity. FIG. 18 illustrates the specific resistance of a PEM fuel cell for various relative humidity levels including curves 165-to-169 corresponding to RH values of 100%, 60%, 35%, 27% in the range of 100-to-800 mΩ-cm². Curve 169 shows resistance at 20% relative humidity is even higher, occurring n the range of 1200-to-1700 mf-cm² and limited to current densities below 300 mA/cm².

Specific resistance is the internal resistance of the PEM cell normalized by area. While current density I/A is rated by the current I divided by area A with units either as A/cm² or mA/cm², specific resistance is a measure of the resistance times the area having units of mf-cm². The best technologies offer the lowest [R_{FC} A] multiplicative product, allowing to trade off cost and performance. To calculate the resistance of a fuel cell of active area A, the resistance R_{FC} is given by

$$R = \frac{[ {R}_{FC} A ]}{A}$$

where [R_{FC} A] is the technology dependent specific resistance of the fuel cell. Unlike the lithium ion battery whose resistance is dominated by the ohmic resistance of its conductive electrodes, fuel cell conduction is dominated by the real component of the membrane impedance, i.e. Re {Z_{memb}}.

As shown, specific resistance is inversely proportional to relative humidity, where 100% RH curve 165 is less than one-third the resistance of the 27% curve 168. As discussed, the membrane resistance is really an electrical representation of the electrochemical process occurring within the MEA. This explains why the specific resistance of the fuel cell decreases with increasing current, mechanistically explained by a more complete electrochemical reaction is occurring and because more water is produced at higher currents. In fact, inflection in the resistance curves above 0.3 A/cm² occurs because of enhanced water production.

The biggest problem of the hydrogen fuel cell is its intrinsically high membrane resistance. For a 1 cm² area, the fuel cell resistance RFC ranges from 300 mΩ to 900 mΩ. For the same area lithium ion battery the resistance is between 4 mΩ and 12 mΩ depending on the cell design. As such the fuel cell resistance is between 10× to 75× higher than a comparable area Li-ion battery. The high resistance technologically prohibitive for delivering current spikes, rendering conventional PEM fuel cells unusable in most real world applications.

Unfortunately, the resistance disadvantage can be much worse than 75 times. This is because of the low almost unusable voltage of a single fuel cell. As described previously, even though today's fuel cells exhibit a maximum chemical potential of 1V, as described previously even low levels of current demand drop the cell voltage substantially. To cover even a modest range in relative humidity the cells can only be counted to deliver between 0.6V-to-0.5V depending on the humidity. Referencing this voltage to the ubiquitous 3.7V Li-ion cell, and equivalent voltage stack of fuel cells requires 5-to-8 stacked membranes with resistances as high as 8·900 mΩ=7200 mΩ, i.e. 7.2Ω. Compared to the same area lithium ion battery at equivalent voltages, it means the series resistance of conventional PEM fuel cells compared to a nominal 18650 Li-ion battery is (7.2Ω/4 mΩ) 18=1800× higher.

The effect of series resistance is shown in FIG. 19 where a series stack of “n” fuel cells 170a to 170z arranged in a single string (m=1). The lumped element equivalent circuit of a voltage source 172 with the magnitude nV_{FC} and resistor 171 with an aggregate resistance of nR_{FC}. The voltage V_{FC} is the nominal voltage of a single fuel cell able to operate over the required range of humidity and temperatures, and R_{FC} is its resistance, e.g. 0.50V and 800 mΩ. Table 173 describes the equivalent resistance nR_{FC}, the total voltage nV_{FC}, and the total energy nQ_{FC} for a ns1p fuel cell array where the parallel strings m=1 and the number of series cells n varies from 1-to-8.

Compared to a lithium ion battery with a nominal voltage of 3.75V, a stack of fuel cells able to operate down to RH=36% and deliver 200 mA/cm², requires n≥(3.75V/0.5V)=8 cells. The 8s1p array therefore exhibits a maximum voltage V_{FC}=8·0.5V 4V and a series resistance of R_{FC}=8·800 mΩ=6.4Ω. Unlike a lithium battery, the peak output current of the 8s1p (i.e. n=8, m=1) fuel cell array cannot be calculated by the equation

$${I}_{sc} = \frac{{nV}_{FC}}{n ( {R}_{memb} + {R}_{short} )} = \frac{{nV}_{FC}}{{nR}_{FC}} = \frac{8 ( 0.5 ) V}{8 \cdot ( 800 m Ω )} = 625 mA$$

because the fuel cell voltage V_{FC} is a function of current. In accordance with FIG. 17, a current of mA for 1 cm² device can only maintain a cell voltage of 0.42V, not 0.50V. In such a case, the stack voltage drops from 4.0V to 3.3V. Commensurately, the peak current drops from the calculated value of 625 mA to an adjusted value of 525 mA. Without short circuit protection a lithium ion battery having the same active area can deliver between 300 A to 940 A, roughly 2000× the transient current of a n=8 fuel cell stack.

An alternative configuration which lowers fuel cell module electrical resistance is to parallel fuel cells instead of connecting them in series. This 1smp array configuration is shown in FIG. 20 for “m” parallel cells 180a-180z of FCs, each comprising a single cell (n=1). The equivalent circuit has an aggregate resistance 181 of R_{FC}/m. Unfortunately as shown in table 183, the fuel cell voltage 182 is only V_{FC} in the range of 0.5V to 0.6V regardless of how many cells are paralleled.

Although fuel cells cannot compete in electrical performance, the total energy delivered by a fuel cell is unlimited because it consumes fuel rather than storing charge. That said, in all practical applications the total volume of gas available is always limited. As described in the table each fuel cell contributes energy in the form of total charge Q_{FC} to the array. Like voltage, energy supply is additive when a n=8 fuel cell array delivers 8 times the energy of a single cell despite the series connection. Calculating how much charge Q_{FC}each cell contributes to the total depends on how the charge is accounted for.

The total power contribution of each cell is based on two factors—the total hydrogen available and the total surface area of the MEA, i.e. the aggregate membrane area. Although the surface area of the PEM determines maximum steady state current delivery as well as transient current performance, over time all fuel will be consumed. Therefore, the true value of QFC is based on the amount of hydrogen it can consume without renewing its supply. In this sense, renewing a FC's hydrogen supply is the equivalent of recharging a battery. Assuming the maximum hydrogen supply is a fixed number per delivery and not continuous hydrogen generation, then the hydrogen supply must be divided by the total number of fuel cells it powers.

Given that the total number of hydrogen molecules is n_{H2} and that every H₂ molecule comprises two hydrogen atoms, then the number of charges produced from one hydrogen molecule is equal to Q_{H2}=2N_{H2} where the number of hydrogen molecules n_{H2}, a quantity depending on the volume, pressure, and temperature of the container that holds it.

Assuming this total charge Q_{H2} is divided across m·n fuel cells where Q_{H2}=2n_{H2} then according to the law of charge conservation

$${Q}_{H 2} = 2 {n}_{H 2} = {mnQ}_{FC}$$

meaning the total charge is assume to be shared evenly among all fuel cells. Rearranging the terms produces the charge per fuel cell Q_{FC} as a 2/m·n fraction of the total hydrogen molecules.

$${Q}_{FC} = {Q}_{H 2} / mn = ( 2 {n}_{H 2} ) / mn$$

When m=1 this ratio becomes Q_{FC}=Q_{H2}/n as shown in FIG. 19. Although it may seem like an apples-to-oranges comparison, an optimistic assessment of fuel cell capacity is to compares the stored charge in a lithium ion battery to the stored charge in the same volume of hydrogen gas. The same energy division is exhibited in parallel cells as shown in FIG. 20 where a total charge Q_{H2}=mnQ_{FC}=mQ_{FC}. As such, when n=1 then Q_{FC}=Q_{H2}/m.

Volumetric Energy. When considering the energy stored in hydrogen, the container is important in determining how much hydrogen can be safely contained. Factor include the size, shape, the materials, and any reinforcement. FIG. 21 compares a variety of containers used as cans for lithium ion batteries. Although the cons are not designed for gas containment perse, Li-ion batteries may operate above atmospheric pressure depending on operating conditions. To avoid explosive venting, some Li-ion batteries include pressure relief valves.

As shown, an AA battery size canister 184a also known as a 14650 battery has a length of 5 mm and an outer diameter of 0.7 cm holding a volume of 17.5 ml (or cm³). The industry standard battery container, the so called 18650 canister 184b, has a length of 6.5 cm, an outer diameter of 1.8 cm, and an enclosed volume of 16.5 ml. The slightly larger 21700 canister 184d commonly used 26 in EVs has a length of 7.0 cm, an outer diameter of 2.1 cm, and an enclosed volume of 24.2 ml. Both the 18650 and 21700 batteries include a pressure relief valve that releases gasses at 24 bars, i.e. twenty four times atmospheric pressure. As an alternative form factor, the thicker walled miniature gas canister 184c used by Coravin for delivering compressed argon gas for wine dispensing has dimensions of 6.3 cm in length and an outer diameter of 2.2 cm plus a narrow 2.8 cm long nose for high pressure connections with a total volume of 20.7 ml. Because of its thicker walls, the mini-canister supports a pressure of 179 bars, 7.5× greater than the Li-ion canisters. Despite holding 15% less volume than the 21700 can, the higher pressure allows more hydrogen to be compressed into a lesser volume, specifically 6.4 times more hydrogen and 12.8 times more coulombic charge. Using these ratings, it become possible to compare the energy storage potential of hydrogen in a direct comparison to lithium-ion batteries.

Although smaller form factors have potential application in portable devices and are useful in comparing volumetric performance of fuel cells and Li-ion batteries, larger form factors are needed in electric vehicle applications, such as container 185a shown in FIG. 22A and canister 185b shown in FIG. 22B. A discussion of large volume hydrogen containment is not a topic of this invention and will not be discussed further here.

A key motivation is normalizing hydrogen energy storage to Li-ion battery canister form factors allowing a direct comparison of energy densities. FIG. 23 is a graph of charge capacity Q_{T}versus canister volume, varied parametrically by canister pressure at 10 bars (line 191a), 20 bars (line 191b), 30 bars (line 191c), 50 bars (line 191d), and 100 bars (line 191e). As a volumetric reference, the graph includes the volume of the 14500 (AA) battery 190a, the 18650 canister 190b, the Coravin high pressure canister 190c, and the 21700 can 190d.

In order to calculate the charge present in a container of gas, it is first necessary to calculate the number of moles of gas it contains. Using the ideal gas equation PV_{g}=NR_{g}T where N is the number of moles, P is the pressure in pascals, V_{g} is gas volume (given 1 ml=1 cm³=10⁻⁶ m³), R_{g} is the ideal gas constant (8.314 J·K⁻¹·mol⁻¹), and T is the gas temperature (300° K), then for an exemplary pressure of 10 bars=1 MPa=10⁶ Pa, the number of moles is given by

$$N = \frac{{pV}_{g}}{{R}_{g} T} = \frac{( 1 {0}^{6} Pa ) ( 1 {0}^{- 6} {cm}^{3} )}{( 8.3 \; 14 J \cdot {K}^{- 1} \cdot {mol}^{- 1} ) ( 300 ° K )} = 4 \times {10}^{- 4} mol$$

The molar concentration is converted into H₂ molecules using Avogadro's number N_{A} where N_{A}=6.022×10²³ mol⁻¹, where

$${N}_{H 2} = {NN}_{A} = ( 6.022 \times 1 {0}^{23} {mol}^{- 1} ) ( 4 \times {10}^{- 4} mol ) = 24 \times {10}^{19} {H}_{2} molecules$$

As a diatomic molecule having monovalent ionic charge where z=(2 electrons/H₂), the total charge Q_{H2} in coulombs per ml is given by Q_{H2}=z_{H2}N_{H2}

$${Q}_{H 2} = ( 2 elec / {H}_{2} ) ( 24 \times {10}^{19} {H}_{2} ) ( 1.6 \times {10}^{- 19} coulombs / elec ) = 76.8 coulombs$$

Converting coulombs to mA-hr

$${Q}_{H 2} = 76.8 C = 76.8 A sec \frac{1000 mA}{A} \frac{hr}{60 \cdot 60 sec} = 76.8 A sec ( \frac{0.2 \; 78 mA hr}{A sec} ) = 21.35 mA hr$$

meaning at T=300° K and 10 bars of pressure, every milliliter of hydrogen contains 77 coulombs or 21.4 mAhr of electric charge, presuming the hydrogen is fully converted into electricity. As the ideal gas equation describes, the molar concentration of a gas and therefore the equivalent charge and cell capacity Q_{H2} increases linearly with pressure and volume.

| | | Q_{H2} for | Q_{H2} for | Q_{H2} for | Q_{H2} for |
|---|---|---|---|---|---|
| Pressure | Q_{H2}/V | 7.5 ml | 16 ml | 21 ml | 24 ml |
| (bars) | (mA-hr ml⁻¹) | (mA-hr) | (mA-hr) | (mA-hr) | (mA-hr) |
| 10 H₂ | 21.3 | 161 | 342 | 448 | 512 |
| 20 H₂ | 42.7 | 322 | 683 | 897 | 1025 |
| 30 H₂ | 64.1 | 483 | 1025 | 1345 | 1537 |
| 40 H₂ | 85.4 | 644 | 1366 | 1793 | 2050 |
| 50 H₂ | 106.8 | 805 | 1708 | 2242 | 2562 |
| Li-ion | 150-200 | 850 | 3000 | — | 4800 |
| 100 H₂ | 213.5 | 1610 | 3416 | 4484 | 5124 |
| 177 H₂ | 377.6 | 2847 | 6042 | 7930 | 9063 |

As shown, any increase in pressure results in an corresponding increase the volumetric energy density, measured in units of mAh per milliliter. At a pressure of 100 bars, the energy density of stored hydrogen exceeds that of lithium-ion. Direct comparisons of stored charge can be made for specific volumes.

For example an AA-sized lithium battery, also referred to as a 14500 cell, when fully charged can deliver 850 mAh while the same volume of hydrogen at 100 bars while contains 1610 mAh. An industry standard 18650 lithium battery when fully charged, delivers around 3000 mAh while the same volume of hydrogen at 100 bars delivers 3400 mAh. A 21700 form factor stores 4800 mAh of energy in lithium-ions but over 5100 mAh of charge in H₂ at 100 bars.

FIG. 23 is a graph of stored capacity Q_{H2} plotted against hydrogen storage volume in ml (or cm³) ranging from 7.5 to 50 ml with equivalent charge up to 8 A-hr. Each curve represents a different pressure include line 191a at 10 bars, 191b at 20 bars, 191c at 40 bars, 191d at 60 bars, and 191e at 100 bars. Also included are lines 191f at 177 bars and 191g at 200 bars. The two high pressure curves are depicted as dashed lines it is difficult to contain gas at such gas pressures in small form factors.

For direct volumetric comparison the graph also identifies specific sized containers, namely volume 190a for the 14500 canister 184a also referred to as AA size in battery vernacular, volume 190b for 18650 canister 184b, volume 190c for the canister 184c also known as a Coravin capsule, and volume 190d for the 21700 canister 184d. Except for canister 184c, all the metal can sizes shown are limited to a maximum of 2.4 bars. Because of its heavier construction, canister 184c is capable of supporting at least 177 bars of compressed argon, and is shown as evidence that high pressure gas can stored in small form factor containers without leakage.

Specifically, calculated values of stored charge Q_{H2} in canister 184c include approximately 1 A-hr at 20 bars shown by marker 193b, 2.9 A-hr at 60 bars shown by marker 193b, 2.9 A-hr at 60 bars shown by marker 193b, 4.6 A-hr at 100 bars shown by marker 193e, and nearly 8 A-hr at 177 bars the commercial rating for canister 184c as represented by marker 193f. For comparison, the volumetric energy for lithium-ion cells is depicted by AA-sized 14500 form factors of volume 190a illustrated by markers 192a, 18650 sized form factors of volume 190b illustrated by markers 192b, and 21700 sized form factors of volume 190d illustrated by markers 192e.

General observations of this analysis reveals that line 191b representing 20 bars of pressure transects markers 192a meaning hydrogen at 20 bars pressure contains similar charge to AA sized lithium ion batteries at comparable sizes. Similarly, line 191d representing 100 bars of pressure transects both markers 192b and 192e meaning hydrogen at 100 bars pressure contains similar charge to 18650 and 21700 sized lithium ion batteries at comparable sizes.

Benefitting from the higher pressure capability of canister 184c, hydrogen at 20 bars shown by marker 193a contains comparable charge to 14500 AA sized Li-ion batteries 192a and double the charge at 40 bars shown by marker 193c. Hydrogen at 60 bars shown by marker 193d contains comparable charge to 18650 Li-ion batteries 192b and 70% greater charge at 100 bars shown by marker 193e. Moreover, hydrogen at 100 bars shown by marker 193e contains comparable charge to larger volume 21700 Li-ion batteries 192e. At nearly 8 A-hr depicted by marker 193f, taking full advantage of the pressure capability of canister 184c, 177-bar hydrogen holds roughly 10× the charge of 14500 AA-sized Li-ion batteries 192a, 2.7X the charge of the 18650 Li-ion batteries 192b, and 1.6× the charge of 21700 Li-ion batteries 192e. This analysis concludes that on a volumetric basis hydrogen is capable of between 1× to 10× the energy density of the lithium ion battery even in small form containers.

FIG. 24 is a log-log graph of capacity Q_{H2} measured in A-hr against pressure p ranging from 10 to 1000 bars. Canister volume varied parametrically include the small form factor low pressure canisters shown by dashed lines 195a, 195b, 195c, and 195e corresponding to the 14500 AA-sized canister 184a, a 10 ml volume in an unspecified container, the 18650 canister 184b, and the 21700 canister 184d respectively. As such, the maximum pressure for these form factors is shown limited to 30 bars. In contrast, the Coravin type capsule shown by line 195d, 20 bar marker 193b, 60 bar marker 193d, and 177 bar marker 193f operates at much higher pressures than thin metal canisters can support.

For larger form factors capacity-pressure lines include line 195f at 40 ml; line 195g at 100 ml; line 195h at 300 ml; line 195i at 1 L; line 195j at 3 L; line 195k at 10 L; line 195l at 30 L; line 195m at 100 L; and line 195n at 300 L. Also included on the graph is the equivalent energy of a 60 L tank of gasoline containing 34 kW-hr of energy. Converted into kA-hr assuming V_{FC}=0.8V and It=Pt/V_{FC}then the equivalent electrical energy in 60 L of gasoline is 43 kA-hr or if converted into electrical energy 700 A-hr per liter. This comparison is not a direct comparison of the energy content of gasoline to hydrogen. Volumetrically, methane and gasoline contain three time the energy of hydrogen. But converting hydrogen into electric current in a fuel cell is a direct process conserving charge, electron for electron, where at higher hydrogen pressures, there is more charge available per volume. Alternatively converting gasoline into electrical power involves burning the fuel to produce heat, then converting the heat into electrical energy using a turbine and generator. This process has an overall energy efficiency of only 34%, as such even though gasoline holds 3× the power of hydrogen, it converts energy into electrical power at ⅓^{rd} the efficiency. This means as long as the hydrogen pressure exceeds 300 bar, a fuel cell EV has the potential to match or even outperform a hybrid electric vehicle but without the carbon footprint of a combustion engine.

Minimum Gas Flow Rate. In order to prevent fuel delivery from affecting electrical generation, a minimal flow rate must be maintained The required flow to prevent reaction rate limited current generation can be calculated Faraday's law of electrolysis

$$Q = It = ( zN ) F$$

which states in an electrochemical reaction the charge Q is equal to the number of electrons expressed in moles (zN) times Faraday's constant. Faraday's constant is defined as the charge of an π electron q times Avogadro's number N_{A} or

$$F = {qN}_{A} = ( 1.6023 \times 1 {0}^{- 19} coulombs / electron ) ( 6 \times {10}^{23} electrons ) = 96 , 485 coulombs / mole$$

Rearranging Faraday's equation for the number of moles N yields

$$N = \frac{Q}{zF} = \frac{It}{zF}$$

Given the aforementioned ideal gas equation also solved for N

$$N = \frac{{PV}_{g}}{{R}_{g} T}$$

equating the two yields the relation

$$\frac{{V}_{g}}{It} = \frac{{R}_{g} T}{zFP}$$

where given the flow rate FR≡(V_{g}/t) having units of cm³/sec, or more commonly as mL/min the equation may be rewritten as

$$\frac{FR}{I} = \frac{1}{z} [ \frac{{R}_{g} T}{FP} ] [ \frac{60 s}{min} ]$$

Evaluated for STP, i.e. standard temperature and pressure of 173° K or 0° C. and P=1 bar or one atmosphere becomes

$$\frac{FR}{I} = [ \frac{0.013945}{z} ] \frac{L}{min \cdot A}$$

where the ratio [0.013945/z] is defined as the GSC gas stoichiometry constant which varies by molecular species. As a diatomic unipolar molecule hydrogen z=2 mole-e⁻/mole H₂while for oxygen z=4 mole e⁻/mole O₂. As such, at 1 A of current the STP GSC for hydrogen is 6.97 mL/min while for oxygen is 3.49 mL/min. If airs is used instead of pure oxygen, the 20.95% concentration of oxygen requires a five times higher flow rate or 16.6 mL/min. At a higher temperature of 25° C. and 50° C., the required flow rates are increased by 14% and 29% respectively. As summary of the gas parameters are included in the table below:

| FC | | | | | | |
|---|---|---|---|---|---|---|
| Chamber | Pressure | Temperature | | Anode | Cathode | |
| Gas | X | X | | Hydrogen H₂ | Oxygen O₂ | Air |
| Purity | X | X | | 100% | 100% | 20.95% |
| 1A GSC | 1 bar | 0° | C. | 6.97 | 3.49 | 16.66 |
| at STP | | | | mL/min | mL/min | mL/min |
| 1A GSC | 1 bar | 25° | C. | 7.95 | 3.98 | 18.99 |
| at 25° C. | | | | mL/min | mL/min | mL/min |
| 1A GSC | 1bar | 50° | C. | 8.99 | 4.50 | 21.49 |
| at 50° C. | | | | mL/min | mL/min | mL/min |

While the above rates represent the minimum flow rate per ampere per cell they do not take into account mass transport across wider PEM membranes. So although the minimum flow rate is the product of the GSC times the number of discrete cells (mn), in reality some guard band is required to account for diffusion and catalysis. Semantically, this guard band is called stoichiometric ratio SR, at minimum having values of 1.1-to-1.5 for H₂, and 2-or-more for O₂. Since unused gas is recycled, there is no penalty for running a higher flow rate. An SR rate of 2 to 4 may be used.

The equation for calculating the flow rate cells comprising an m-by-n array of cells each conducting current I_{FC} is given by the equation

$$FR = ( mn ) {I}_{FC} ( GSC ) ( SR )$$

where FR is flow rate is measured in mL/cm²; n is the number of series cells in a stack; m is the number of parallel stacks, and I_{FC} is the fuel cell current for a given area; and the GSC gas stoichiometry constant.

Limitations in Scaling Fuel Cell Power. From the foregoing we can conclude that fuel cells hold great promise as a source of clean electrical power but suffer a number of intrinsic deficiencies preventing their practical use and widespread adoption. The biggest challenges limiting the utility of a PEM fuel cell is not the energy density of hydrogen but its electrical and electrochemical characteristics, specifically
The fuel cell voltage is too low. As described, the best case maximum fuel cell voltage is 0.8V per cell. When considering humidity and temperature variations, a more realistic voltage is 0.5V-to-0.6V per cell. This voltage is 13%-to-16% of a 3.75V lithium-ion battery, the industry standard for electric vehicles.
The fuel cell resistance is too high. Considering temperature and humidity variations the nominal resistance for a best in class PEM fuel cell today is approximately 10 per cm² of fuel cell. Compared to the 4 mΩ resistance of a standard lithium ion battery, the resistance is hundreds of times too high to support high current load transients and start up current demands.
The PEM fuel cell characteristics are highly dependent on humidity and temperature. At cold temperatures or dry conditions the PEM FC ceases to operate and has no means to jump start itself into operation.
The manufacturing, material science, and reliability of PEM fuel cells is either unknown or substandard. Effects like CO poisoning and corrosion can irrevocably damage fuel cell operation. Temperature cycling reliability studies are unavailable. Moreover, the existing PEM FC designs are actually engineering prototypes and therefore cannot be used to project reliability and yield issues scaled to production levels.

Among these issues, the first two bullet points in combination essentially render the real world application of hydrogen fuel cells useless. This problem is exemplified by FIG. 25 describing options to optimize FC electrical performance based on a fixed amount of available fuel cell area, i.e. the PEM surface area. Specifically if we consider the best possible use of five FCs each 1 cm² in area, two options emerge—either to parallel the cells or place them in series. Starting with one cell of 1 cm² having a resistance of 1Ω or a figure-of-merit in specific-resistance of 10 cm² shown at point 198, then the remaining four cells can either placed in series with the first cell into a series array as shown by curve 196, or placed in parallel into a parallel array shown by curve 197.

Both solutions are problematic. In the case of a series array the stacked cell voltage for 5 FCs is five time higher than one cell, e.g. 2.5V instead of 0.5V, but the series 196 resistance is also five times higher than its single cell resistance 198 increasing from 10 to 50. In essence the current handling ability remains unchanged, going from 0.5V/10=0.5 A for a singe cell to 2.5V/50=0.5 A for five series cells. Connecting five cells in parallel decreases the equivalent resistance 197 to one-fifth its original value 198, and thereby increasing the current capability 5-times, going from 0.5V/1 Ω=0.5 A for a single cell to 0.5V/0.2Ω=2.5 A for five parallel cells. Unfortunately, the cell voltage remains an unusable 0.5V. So the choice is either to raise the voltage and lose current through higher resistance of a series array, or to improve the current and reduce the resistance but retain too low a cell voltage to be useful. In engineering, such a tradeoff is referred to as a lose-lose scenario.

The only real solution to this quandary is to increase the total number of cells by a series-parallel array comprising parallel strings or “stacks” of series connected cells as represented in FIG. 26. As such the array comprises m parallel stacks each of n series connected cells. For example stack “a” comprises n-connected series cells 200aa through 200za; stack “b” comprises n-connected series cells 200ab through 200zb; . . . , stack “y” comprise n-connected series cells 200ay through 200zy; and stack “z” comprises n-connected series cells 200az through 200zz, where the array contains m-parallel connected stacks. Note that to a first order approximation, paralleling cells is the identical to increasing the active area of the PEM membrane. Specifically connecting five 1 cm² cells in parallel is electrically identical to making a single FC with a PEM area of 5 cm². As such the depiction of parallel sells as discrete components is illustrative.

So with m parallel stacks of n series connected FCs the same nomenclature nsmp used for batteries may be adopted to describe the array. For example a {n=2, m=3} array or 2s3p comprises three stacks of fuel cells, each with 2 series connected PEM membranes. A {n=8, m=7} array or 8s7p comprises seven stacks of fuel cells, each with 8 series connected PEM membranes. The equivalent lumped element model for such an array comprises a voltage source 202 having a net voltage nV_{FC} and series resistance 201 having a equivalent resistance R_{FC}=(nR_{FC})/m where increases m reduces the net resistance and where increasing n increases the total resistance.

The total charge delivered by the array is the sum of all the fuel cells Q_{H2}=mnQ_{FC}. Considering however that the total available charge is the hydrogen reservoir containing a fixed Q_{H2} amount of ampere-hours, the a more meaningful version of the same equation is Q_{FC}=Q_{T}/mn, meaning the total energy is divided evenly amongst the constituent fuel cells.

FIG. 27 includes table 203 summarizing the series combination of fuel cells up to n=8. If the minimum voltage of each fuel cell is 0.5V then 8V_{FC}=4V, a voltage similar to a lithium ion battery. If however each fuel cell has a minimum voltage of 0.6 then 7V_{FC}=4.2V and 6V_{FC}=3.6V not precisely equal to a single Li-ion cell in voltage. The relative relationship between m and n indices is shown in FIG. 28 which compares specific resistance R_{FC} A in Ωcm² on the ordinate axis to the value n on the abscissa varied parametrically where m=1 for line 212, m=2 for line 213, m=3 for line 214, m=4 for line 215, and m=6 for line 216, where increasing m lowers the next resistance. Not that whenever m=n as shown by line 217, the net resistance is identical to the single cell resistance 210, in the example shown 1 Ωcm². For example line 214 intersects line 217 when m=n=3. Therefore it can be concluded in order to maintain a cell resistance no greater than single cell, cell array design must follow the rule m≥n. So to minimize resistance while matching the voltage of a lithium ion battery, applicable arrays include a 8s8p, 7s7p, or 7s8p array to minimize the impact of series resistance when stacking cells for higher voltages.

Even with a large array of cells the net fuel cell resistance is around 10, a value far too high to be useful for powering motors or to supplant lithium ion packs. So despite the ability for hydrogen fuel cells to compete with lithium ion batteries on an energy density basis, the high cell resistance complicated by ambient sensitive voltage and current is prohibitive for the application of fuel cells in real applications like consumer electronics, computing, electric vehicles, and uninterrupted power.

Problematic Applications for Fuel Cells. For fuel cells to compete with the lithium ion battery it must perform adequately in real world applications including motor drive, communication, and computing. FIG. 29 illustrates two such applications, namely brushed DC motor drive and brushless DC motor drive. As shown, in brushed DC motor drive a DC power source, in this case fuel cell array 300 delivers current I_{L}(t) to an electrical load, in this case brushed motor 301. In a brushed DC permanent magnet motor, the rotating magnetic field is creating by redirecting current into various coils via electrodes on the rotor using conductor brushes. Neglecting the power transistor used to turn the motor on and off, in this application the fuel cell array voltage V_{FCa} is applied directly to the motor 301, whereby V_{FCa}(t)=V_{L}. Alternatively, in brushless motor drive commutation is performed electronically by motor drive circuit 302 inserted between the fuel cell array 300 and motor 301. In brushless motors, the motor includes 3, 6, or more phases, only one phase of which is shown in the schematic. In such cases, the total current supplied by the fuel cell I_{FCa} (t) is the aggregated sum of the load current into each phase.

In practice, the motor drive control module 302 as shown in FIG. 30 generally includes a voltage regulator 304 with an input filter capacitor 303 producing a low voltage regulated output V_{IV} used to power a microcontroller μC 305 and the multiphase power stage, i.e. motor driver 306. Since power is consumed by these three components, then necessarily I_{FCa}(t)>I_{L}(t). In the example shown, the low voltage regulator 304 output provides power to motor driver 306 and thereby motor 301, then the voltage is limited to low voltage, typically between 3V-to-24V with 5V being commonplace.

When higher motor torque is required, for example in an electric vehicle, a high voltage in preferable to low voltage motors because of lower currents and less heat loss to winding resistance in motor 301. In such instances motor drive module 302 includes both high voltage and low voltage components as shown in FIG. 31. As shown voltage input V_{FCa} from fuel cell array 300 filtered by capacitor 303 powers two DC/DC converters, generally comprising switching regulators including low voltage regulator 304 and high voltage regulator 307. Low voltage regulator 304 generally comprises a step down type regulator producing an output voltage V_{Iv} lower than its input voltage V_{FCa} used to power microcontroller μC 305. The microcontroller in turn generates drive signals to control motor driver 306 connected to motor 301 in one or more phases.

As a step down circuit, low voltage regulator 307 may comprise a linear regulator or a switching regulator comprising a Buck converter or synchronous Buck converter topology. The design of high voltage regulator circuit topology depends on the relative voltage of fuel cell 300 and the desired operating voltage of motor 301. If the fuel cell array has a lower voltage than the motor being driven, i.e. V_{FCa}<V_{L} then high voltage DC/DC converter 307 likely comprises a boost converter topology. Conversely, if the fuel cell array has a higher voltage than the motor being driven, i.e. where V_{FCa}>V_{L} then DC/DC converter 307 likely comprises a synchronous Buck topology or may be eliminated altogether directly connecting motor driver 306 to the fuel cell.

While these topologies appear to be good application prospects for fuel cells, in reality none of them work. The issue is the fuel cell has too have of an impedance to drive a motor directly, especially during startup where a high surge current is needed to overcome inertia called stiction.

The motor startup problem is exemplified in the electrical waveforms FIG. 32 including the load current waveform I_{L}(t), the pulse width modulator duty factor D(t) used in the high voltage DC/DC regulator 307 (in this example as a boost converter), the regulator output Vₕᵥ used to power the motor driver, and the motor rotational velocity ω (t). Aside from small voltage drops across conducting power MOSFET transistors, when the motor is turned on regulator output Vₕᵥ and the motor voltage waveform V_{L}(t) are essentially identical. The graph is divided phenomenologically into four intervals of time described as (a) off, (b) stiction, (c) FC limits current, and (d) FC voltage collapses. Although the example described uses the high voltage terminology the waveforms are generally applicable for both high voltage and low voltage motor drive applications.

In the off interval before time 310b, the motor is off and load current I_{L}(t) 311a is essentially zero except for small currents used to periodically monitor for faults such as open circuits, disconnections, etc. During this interval motor rotational speed 314a is zero, the high voltage supply voltage 313a is constant and unloaded, and the switching regulator is operating in light load mode with narrow pulses 312a. At t_{b} identified the time 310b, the motor drive is activated causing the motor current I_{L}(t) to rise rapidly 311b. Sensing a small drop in its Vₕᵥ output voltage 313b, the pulse width modulator's duty factor immediately reacts to compensate, increasing 312b to transfer more energy to the load. Because the rotor has not started turning 314b, held in place by inertia referred to as the static coefficient of friction, aka stiction, then ω(t)=0, there is no back emf to counter the drive voltage and the current demand on the fuel cells is at its greatest level. At time t_{c} shown by time line 310c, the rotor starts turning 314c.

Because of its poor current delivery capability and high resistance, fuel cell 300 is unable to fully supply the requisite current whereby the duty factor 312c immediately jumps to the maximum amount typically D=95% (but not 100% because they need to keep switching to maintain stable operation). Despite this rapid adjustment and longer switch on time, the regulator cannot maintain voltage and the output voltage Vhv (t) continues to sag 313c causing a corresponding drop in current 311c delivered to the motor. The motor rotation velocity 314c then stalls, unable to achieve a minimal ω (t) to overcome the dynamic coefficient of friction. With zero velocity, the back emf of the motor drops to zero 314c causing a last desperate attempt to jump start the motor through a temporary rise in motor current I_{L}(t) 311c just prior to time 310d labelled time t_{d}.

Failing this attempt the fuel cell or the motor begin to overheat resulting in a steady and decline in supply voltage Vₕᵥ(t) 313d and motor current I_{L}(t) 311d during the final interval following time 310d. This condition is generally irrevocable as the converter and fuel cell are doing everything possible to start the motor with the PWM duty factor 3212d maintained at its maximum, and the back emf remaining at zero because the rotor velocity 314 is stuck at zero. As such an unaided fuel cell cannot support motor drive.

Even if by some miracle the motor could start, for example by pushing the car or rolling it down a hill so that at time 310b, the rotor velocity ω (t_{b})>0 at turn on, unlike a conventional gasoline engine or an EV with regenerative braking any electricity has no where to go because conventional PEM fuel cells cannot operate reversibly by splitting water into hydrogen and oxygen the way electrolysis does. This means, EV driving range is further reduced as inertial energy routinely recovered during regenerative braking in al commercial battery powered electric motor driven vehicles will instead be lost as heat, not recovered.

Aside from electric vehicles for transportation including cars, trucks, vans, and recreational vehicles, motors are abundantly present in homes, factories, mass transit systems, airplane terminals, and construction. For example, motor powered homes appliances include refrigerators, washing machines, dryers, heating-ventilation-air-conditioning (HVAC) systems, room and exhaust fans, water pumps for pools and sump pumps, and more. Battery backup for home power will therefore be subject to all the same troubles as defined above except that the DC/DC converter is replaced by a DC-to-AC inverter, which functions must the same way as a boost converter except producing sinusoidal output power. As in home power backup, another big market is a power wall—a home storage device used for capturing energy produced from a photovoltaic array such as batteries. But a fuel cell cannot store electrical energy. Restaurants, schools, and hospitals have similar requirements for driving motors and for capturing and storing solar energy from photovoltaic arrays. Again, today's best in class fuel cells are incapable of supporting these use cases.

Another class of electrical load involves communication devices. Communication devices include WiFi routers, cable boxes, cell towers, along with mobile devices, emergency services, walkie talkies, cell phones, repeaters, emergency mobile towers, and more. More than virtually other use of power, communication systems require backup power during power outages and disasters when electricity is unavailable but when need is greatest. Examples of extended power outages include the Fukushima-Tohoku earthquake and tsunami disaster, the Katrina hurricane, the 2022. Texas deep freeze and power grid failure, the 2011 southwest blackout accident, California wildfire power failures attributed to PG&E such as the Dixie fire, and more. In many cases, the power grid remains inoperable for weeks. The value of hydrogen backup power in such scenarios cannot be overstated.

An example shown in FIG. 33 comprises a fuel cell array 300 powering an RF module 330. In one simplified yet exemplary schematic representation 330a, the RF module includes two dominant electrical loads comprising RF transceiver 331 and radio frequency power amplifier 334 and antenna 334a. Oftentimes these components are directly connected to the a voltage source in able to suppliant extremely fast current transients of over 1000 A/μs. Unfortunately unable to react to rapid electrical transients and suffering high series resistance, hydrogen fuel cells are poorly suited for such applications.

The load transient problem which can occur in servers and computers too, is especially problematic in communication as devices remain in a quiescent state doing essentially nothing the suddenly wake up without warning demanding full current. Rapid current demand occurs concurrently in both RF power amplifier 334 and in the digital or mixed signal RF integrated circuit used to realize transceiver 331, the combination of the two further exacerbating the current transient and the challenge of delivering power on demand without warning.

FIG. 34 illustrates typically waveforms of an RF communication module in three intervals (a) sleep, (b) sniff, and (d) active modes. In the sleep interval prior to time t_{b} shown by time event 335b, switching voltage regulation within the transceiver IC and RF PA operate in light load with narrow pulses 337a, load current demand IL(t) 336a is very low, e.g. leakage current, and supply voltage V_{L}(t) 338g remains constant. At time t_{b} the transceiver wakes up to sniff for RF signals called pings used to update the local network router what devices are connected.

The sniff creates a short spike of current 336b and a temporary dip in voltage V_{L}(t) 338b causing a momentary increasing in duty factor 337b where the voltage recovers 338c as the current returns to its quiescent level 336c, after which the pulse widths return to their light load mode 337c. At time t_{d} shown by event line 335d, the module commences active communication whereby the current 336d instantly jumps to the full load condition I_{L}(t)=I_{xcvr}(t)+I_{rf} (t). Immediately the load voltage drops 338d, in part because the current increase is to fast and too great to be supplied by filter capacitors.

Sensing the voltage drop, the internal regulators within the transceiver and RF PA ICs jump to their maximum D value 337d allowing for some small voltage recovery 338e. Because of the slow response and high resistance, the greater duty factor cannot compensate for the performance degradation of the fuel cell and final voltage V_{L}(t) shown by 338f is below the minimum voltage specification 339 of the RF module, i.e. where V_{L}(t)<Vₘᵢₙ. Such a condition constitutes a system failure of the RF module.

Another class of application for fuel cell backup power is computing. As shown in FIG. 35, fuel cell array powering notebook 350 include implementation 350a comprising a lithium ion battery pack 351 with input current I_{bat}(t). The battery pack in turn powers computer system 352 with load current I_{L}(t). While it may appear than the fuel cell array is in parallel with the battery where V_{FCa}=V_{bat}, this is in fact not the case. Instead as illustrated is FIG. 36, the lithium ion battery pack is actually a complex circuit comprising battery array 357, CI-CV charger 356 with input filter capacitor 355a, cell balancer 358, battery disconnect switch BDS 359 with an output filter capacitor 355b.

The functions of these components are quite complex. CI-CV charger 356 charges the cell array with a constant current (CC) mode until the cell array reaches a specified voltage, then the charger transitions to a constant voltage (CV) mode allowing the maximum possible charging current. The function of cell balancer 358 is to make sure every cell connected in series maintains precisely the same voltage. The function of the battery disconnect switch BDS 359 is to disconnect the battery array from the electrical load in the event of a shorted load, over current, battery overvoltage, or over temperature conditions.

The specifications of any power source used to supply energy to a lithium ion battery pack are determined by the input requirements of the pack itself. In particular, it is assumed that this power source represents a “stiff” voltage source. A stiff voltage source is a power supply whose voltage does not significantly sag or drop as a function of the load current it supplies. In other words a stiff voltage source can modelled as an ideal voltage source in series with negligible series resistance. An example of a stiff voltage source is an AC/DC wall adapter whose power rating matches or exceeds the power specification of the load it is powering. Most lithium ion battery packs such as those used in a notebook computer or a power tool strictly specify their input voltage range and power requirements.

Referring again to the schematic of FIG. 36, the compatibility of using a fuel cell as a source of power to charge an array of lithium ion cells involves meeting several criteria. These include:
The minimum output voltage of fuel cell 300 must exceed the fully-charged voltage of the Li-ion cell array 357 for battery pack 351, in this case a 4s4p topology, plus some added voltage headroom required by CI-CV charger 356, typically 1-to-2 volts.
The minimum output voltage of fuel cell 300 must be maintained at full current in accordance with the minimum specified input current for battery pack 351.
The minimum output voltage of fuel cell 300 must be maintained over the full range of environmental conditions including cold temperatures and low relative humidity levels.
The lowest power output capability of the fuel cell must exceed the maximum power input requirement for battery pack 351 plus any power concurrently delivered to the battery's electrical load in the amount P_{L}=V_{bat}I_{bat}.
The transient output current capability of fuel cell 300 must meet the peak current demand of CI-CV charger 356 operating in pulse mode.

In the dual-mode CI-CV charging shown in the waveforms of FIG. 37, operation involves three phases, namely (i) discharge, (ii) constant current charging, and (iii) PWM constant voltage charging. A fourth phase, top-off charging is not shown, as it does not involve any significant current conduction. During the discharge phase, the battery pack supplies power to an electrical load without replenishing the charge in Li-ion cell array 357. As such the charging current 392 is zero, i.e. I_{chg}=0 in which case the battery voltage will decline as it powers the battery's load. Alternatively the CI-CV charger can regulate a constant voltage V_{bat} on the battery by delivering its current entirely to the electrical load in the amount P_{FC}=P_{L}=V_{bat}I_{bat}. In this case there is no change in the voltage V_{bat} of the Li-ion array, in which case the net current charging the cells is also zero and I_{chg}=0.

In the second phase, constant current charging, CI-CV charger 356 outputs a constant current to Li-ion array 357. To prevent an electrical load from interfering with the CI-mode charging, the battery disconnect switch 359 is often be turned off. Absent any load current, since Q=It=CV then constant current charging results in a linear increase of battery charge overtime. Assuming the battery capacitance is constant, this means that constant current charging produces a corresponding linear increase in battery voltage. Since the magnitude of current I_{chg} during CI-mode charging is low compared to the maximum current capability of a fuel cell then I_{chg}<I_{DC((max)}.

The challenge for a fuel cell to charge a lithium ion battery pack becomes more problematic in the constant voltage CV-mode. Although linear methods for constant voltage charging exist, the most common method for CV charging today employs PWM pulsed charging. At the onset of pulsed mode charging, current control jumps from a constant value controlled by linear feedback is switch mode, where a power MOSFET is turned-on fully acting a low resistance switch.

The rapid rise in average current 392c at transition time t_{CV} is proportional to the voltage differential between the target voltage V_{OC} and the battery voltage V_{bat} (t)=V_{CV} at the time of the transition. Concurrently the pulse width duty factor increases to maximum widening pulses 392d in order to expedite charging. Provided the power source to CI-CV charger 356 is sufficiently stiff, the cells will charge with each pulse, the voltage will rise and the pulse widths will become narrower 392e. As a result the average charging current 392z flowing into Li-ion cell array 357 will decline exponentially as the battery voltage approaches its target value. Although this waveform typifies pulsed charging from an AC adapter able to supply high currents, the current capability of a fuel cell is limited by a high series impedance and by a counterposing polarization voltage that effectively decrease V_{FCa} at high current densities.

The net effect of these two phenomena is that the fuel cell cannot deliver the required current instead producing a lower current pulse 394d resulting in an initial charging current 394c substantially lower than the current 392c. Because the current is limited by the fuel cells source, the on-time of successive pulses such as 394e remains higher in duty factor than 392e when pulse current is not limited. As such the charging curve 394z is significantly slower than the desired charging profile of curve 392z. In essence, charger operation malfunctions because of an inadequate or incompatible power source.

Unfortunately, this problem arises because a fuel cell does not behave as stiff voltage source. This problem is further exacerbated by variability with manufacturing, humidity, and temperature. As discussed previously in FIG. 13A, the voltage of a fuel cell depends on current, humidity, and temperature having an equivalent circuit comprising an open circuit voltage 100, a fixed ohmic resistance 104, and two dynamic impedance components—polarization voltage 101 and membrane resistance 102, both of which depend on fuel cell current.

Theses parameters severely limit the performance and utility of conventional PEM fuel cells. FIG. 38 illustrates the terminal voltage of a 4s fuel cell as a function of current density comprising present construction. The characteristic I-V curve includes an immediate drop in voltage from the open circuit value 395 followed by polarization voltage losses 396. In region 397 the behavior is quasi-ohmic as determined by the fuel cell membrane resistance. In region 398, fuel cell performance begins to suffer charge transport limitations of the PEM electrolyte leading to a collapse in sustainable voltage 399 at high current densities.

Conventional Fuel Cell Processing. Despite its simple appearance, fabrication processes for PEM fuel cells vary widely, as their electrical performance. One key element in PEM performance is fabrication of the catalyst coated membrane (CCM) also referred to the three-layer membrane electrode assembly or MEA3. The CLL comprise two catalyst layers sandwiching the PEM membrane. The proton exchange membrane or PEM membrane comprises a ion exchange membrane or ionomer typically constructed of a sulfonated polytetrafluoroethylene (PTFE) matrix based fluoropolymer-copolymer able to conduct positive charges, i.e. protons and hydrogen ions but unable to transport electrons through the membrane. In essence the PEM membrane performs the same function as a diode vacuum tube rectifier transporting only one polarity charge carrier. A more detailed explanation of this conduction mechanism will be provided in the regular utility patent filing to follow.

The second most important elements of a PEM fuel cell is the function of the anion and cathode catalyst layers or CLs. The three layers are present on opposing sides of the PEM membrane to promote electrochemical activity. On the anode side, catalytic activity in the anode electrode catalyst layer or AECL involves separating electrons from neutral hydrogen atoms, generally from H₂ hydrogen molecules resulting in 2 electrons and 2 protons. A proton is the essentially a protium or deuterium hydrogen ion, i.e. H⁺ comprising one proton or zero or one neutron. In chemical vernacular, the process of an atom giving up an electron in a chemical reaction is referred to as oxidation even though oxygen is not involved in the process.

On the cathode side, the cathode electrode catalyst layer or CECL captures incoming protons transported across the PEM layer and combines them with incoming electrons and oxygen. The absorption of free electrons, a chemical process referred to a reduction, is not favorable unless a reducing agent, typically oxygen is introduced in the material to make the recombination process energetically favorable. When O₂ molecules perform this function, the chemical reduction process produces H₂O as a byproduct. As such, the oxidation-reduction electrochemical process also referred to as a “redox” reaction produces no carbon or polluting byproducts, ands is hence as “green” as the hydrogen on which it relies.

The function of the catalyst is to promote the probability of the reaction thermodynamically. Catalytic chemical processes not only increase the likelihood (yield) of a redox reaction but improve the reaction rate, meaning more electricity is generated at a faster rate, i.e. at a higher current One principle property of a catalyst is its ability to recover from a reaction recovering the original catalyst material in the same quantity and concentration restoring it in unreacted form. Noble metal such as platinum and its relatives are best suited for performing this function. Because it is expensive, attempts continue, albeit with limited success, to either eliminate or reduce the platinum concentration (aka platinum loading of the film) in PEM catalyst layers. Mixing the platinum with other materials can reduce the platinum loading but must not interfere with gas transport, electron conduction, or chemical reactivity. Materials may include carbon, titanium dioxide, and platinum compounds.

Deposition of these blends in precise concentration ratios is not trivial especially using liquid or vapor phase processes, one common version of which involves ultrasonic spray painting, a type of printing. As shown in FIG. 39, the preparation 400 of a Pt spray paint is complex, involving controlled wetting with a carbon-platinum powder 401 with a water pipet process 402 followed by gentle mixing via shaking 403. Improperly performed, the constituent material will clump producing an inhomogeneous solution. Next isopropyl alcohol (IPA) is carefully added. To prevent combustion, the IPA is added by pipet to slow the mixing rate and limit the exothermic reaction energy release. To improve wetting of the PEM membrane's hydrophobic surface, ionomer 405 is added to the paint followed by more IPA via pipetting 406. All of these processes are extremely sensitive to the mixing rate and to temperature, making the ink formulation a source of high variability in reproducibly fabricating PEM CCM membranes.

After the ink is mixed, it is introduced into a high sheer mixer 407 then into the head nozzle 407 of an ultrasonic spray painter where it combines with argon gas to spray a 250 μm spot in the Nafion film or PEM membrane 408. Because however the spot size is a small fraction of the surface area A_{FC} of the fuel cell PEM membrane 408, the spray must be rastered across the surface using a computerized numerical control (CNC) table 408 following a complex raster pattern 409 for painting across the surface in an attempt to increase thickness and uniformity. Eight-to-ten printer head passes may be required to reach the target thickness with a platinum loading of 0.33 mg Pt/cm². The process is slow, expensive, low in throughput and highly variable in the resulting PEM layer.

This process is described only on the anode side but must be repeated on the cathode surface of the membrane. FIG. 40 illustrates the complexity of the fabrication sequence starting with the proton exchange membrane 408. The PEM sheet is cut into squares 410. The individual PEM squares are attached 411 to an acrylic mask then aligned to the spray paint apparatus 412. The platinum ink mix 400 is then loaded into the ultrasonic spray CNC and printing of the anode CL commences. The print head then traverses a prescribed anode raster pattern A1-to-A8 for spraying include steps 413a, 413b, 413c, 413d, 413e, 413f, 413g and 413h followed by heat drying 414.

At the completion of the anode catalyst deposition AECL, the PEM is inverted 415 then a cathode mask K is attached 416 to the PEM. At this step the PEM backing is removed 417, the mask is then aligned 418 to the spray apparatus after which the platinum ink mix 400 is then loaded into the ultrasonic spray CNC and printing of the cathode CL commences. The print head then traverses a prescribed cathode raster pattern K1-to-K8 for spraying include steps 419a, 419b, 419c, 419d, 419e, 419f, 419g and 419h followed by heat drying 420. The CCM PEM is then removed from the cathode mask 421 then sandwiched by PTFE film 422, hot pressed 423 to complete binding of the painted layers, then removed from the PTFE sandwich to complete fabrication of the CCM ME3 assembly.

The PEM layer 436 shown in FIG. 41 is then aligned to the GDL gas diffusion layers 435a and 435c, gaskets 434a and 434c, bipolar plates 433a and 433c, collectors 432a and 432c, insulation plates 431a and 431c, and end plates 430a and 430c. These highly manual steps are illustrated in FIG. 42 involving the vacuum plate in step 450a, PEM membrane 408 in step 450b, acrylic mask 451 in step 450c, attaching PEM module 452 to acrylic mask 451 in step 450d, then inverting the structure in step 450e, and completing the module 455 in step 450f.

Summary of Existing Fuel Cell Limitations. For the foregoing reasons, present day fuel cells are incapable of directly powering most electrical loads including motors, digital and RF circuitry, and lithium ion batteries or their charge circuits. Electrical deficiencies of hydrogen fuel cells and especially PEM fuel cells include
High internal cell resistance of approximately 1200 mΩcm² limiting transient current and steady-state DC current capability
Low cell voltages under some operating conditions, as low as 0.2V per cell
Poor competitive performance against lithium ion batteries with resistances at 4V of up to 8Ω, as much as 2000 times greater
Cell voltages that decline with increased current conduction because of electrochemical effects (other than resistive voltage losses).
Inability to behave as a stiff voltage source having an operation region where the cell voltage remains relatively constant, i.e. flat, over a meaningful range of operating currents.
High dependence on humidity and temperature, electrical characteristics suffer the inability to operate at relative humidity levels below 35%, to operate at temperatures below freezing, or combinations thereof.
Unknown electrical behavior driving high frequency loads with fuel cell AC impedance may affect system performance
Inability to absorb or store energy from a generator, photovoltaic array, or any transient power source such as regenerative braking.
Inability to communicate fuel cell status to a system.
Inability to communicate with fuel storage to assess remaining energy capacity.
Inability to stack cells to high voltages without commensurate increases in resistance and a net reduction in transient current handling capability.
In ability to safely isolate fuel cells from high voltages present when stacking cells.
Extremely large PEM membrane areas are required to offset the adverse impact of stacking resistance.

What is needed is an significant improvement and fundamental redesign to fuel cells to improve their electrical performance and functionality to be competitive with lithium-ion battery packs including the means to drive the full spectrum of electrical loads.

Many of the foregoing problems are result of an energy, voltage, or impedance mismatch between the fuel cell and the electrical load it is intended to drive. Other improvements required include the ability to compensate for environmental effects of humidity, temperature, and power cycling, to communicate with the electrical system or load relying on the FC module's power, and the ability to absorb and retain recycled and environmentally harvested energy—a function fuel cells are incapable of performing today. Another important feature of the invention is high voltage isolation.

The solution to overcoming limitations in transient current capability and ameliorating impedance mismatch problems of fuel cells driving real world electrical loads are addressed in a related application entitled “Intelligent Buffered Fuel Cell with Low Impedance”. Otherwise improvements in the fundamental construction and fuel cell design are described herein.

### SUMMARY OF THE INVENTION

A family of advanced fuel cell designs and fabrication methods are described herein to improve the electrical performance, manufacturability, and reliability of all types of ion exchange fuel cells including PEM proton exchange membrane based fuel cells using hydrogen or glucose as fuel. Many of the methods and apparatus described herein however, are not limited to a specific chemistry or membrane type, but more broadly applicable to the entire spectrum of fuel cell technologies including solid AEM anion exchange membranes.

In contrast to PEM membranes, AEM membranes transport the OH⁻ radical rather than H⁺ as the primary ionic charge conduction species. As such AEM are advantageous because of their use of non-precious metal catalysts such as cobalt, nickel, or silver instead of expansive Pt-based catalysts. While the majority of the disclosure refers to PEM membranes specific for H⁺ or cation conduction it will be understand to those skilled in the art that many of the disclosed methods and apparatus are equally applicable to the construction and use of solid AEM anion exchange membranes.

One class of inventions described herein focuses on improving the mechanical strength and durability of an ionomer polymeric ion exchange membrane while simultaneously enabling the electrically active portion of the membrane to be thinned to enhance charge transport and reduce electrical resistance. In conventional ion exchange membranes, thicker films exhibit improved mechanical strength at the expense of suffering poorer ion transport, lower conversion efficiencies, greater electrical resistance, increased polarization losses, and higher dependencies on environmental conditions of humidity and temperature. Although electrically beneficial, thinning an ionomeric ion exchange membrane can result in poor film polymerization during fabrication resulting in degraded film integrity, increased membrane damage during manufacturing and handling, planarity problems caused by sagging of the thin polymer, lower manufacturing yields, and high production costs.

In one embodiment of this invention an ionomeric cation membrane is heterogenous in construction comprising a pattern of support pillars providing added mechanical strength to the membrane either by being locally thicker or stronger than the electrically active portions of the film. In one embodiment the pillars comprise PTFE aka polytetrafluoroethylene, a synthetic fluoropolymer of tetrafluoroethylene optionally mixed with a filler for enhanced pillar strength comprising carbon fiber, graphite, graphene, carbon nanotubes, diamond dust particles, or high temperature fibrous materials or polymers. In another embodiment, the pillars may comprise PCTFE aka polychlorotrifluoroethylene, FEP aka fluorinated ethylene propylene, HDPE aka high-density polyethylene or other plastic compounds such as PMMA polymethyl methacrylate, and polyimide.

In a related embodiment, the pillars may comprise a different thickness, stoichiometry, and optical absorption spectrum than the rest of the membrane assembly, able to preferentially absorb energy from a corresponding wavelength laser for ablation and cutting. For example if the pillar is composed primarily of PTFE, a 10.6 μm CO₂ or 248 nm KrF laser may be used in singulation. Regardless of the wavelength employed in laser singulation, the laser's pulse duration should be limited ideally less than 100 ns to avoid heating or damage to the adjacent active membrane surfaces.

In one embodiment the strengthened pillars form a ring around a active PEM membrane, circumnavigating the active area forming an exoskeleton surrounding the electrically active PEM membrane. In another embodiment the pillars form an endoskeleton further subdividing the active PEM membrane into smaller electrically conductive island and where the endoskeletal pillars merge into the exoskeletal support at the cell's periphery. In a related embodiment the width of the exoskeleton pillars are wider than that of the endoskeleton in order to facilitate separating, i.e. singulating, a sheet containing multiple fuel cells into individual fuel cells with a saw, punch or laser. As such, the full width of the endoskeletal pillars is contained within the final fuel cell assembly while the final width exoskeleton pillars due to singulation process is narrowed in an amount corresponding to the laser beam width or mechanical saw kerf. In another embodiment, the mechanically strengthened pillars may comprise insulating or high resistivity material because they need not carry current.

In contrast active ion exchange regions circumscribed by the skeletal pillars are conductive, carrying current preferentially based on polarity. In this sense the conductive ion exchange membrane or ionomer is similar to a semiconducting diode exhibiting charge specific conduction, e.g. preferentially conducting positively-charged cation molecules and suppressing electron flow in a PEM, or conversely conducting negatively charged anion molecules and suppressing proton conduction in an AEM. As disclosed the active area of a ion exchange membrane is 10 μm to 100 μm in total thickness comprising a uniform bulk film or a constituting an inactive polymeric substrate matrix coated with an ionomeric thin film involved in charge transport and hopping conduction. As such the electrical conduction properties of the ion exchange membrane may involve two different mechanisms, either bulk conduction of surface conduction.

In bulk conduction PEM based fuel cells, the conducting film may comprise an uniform ionomer bulk membrane such as PFSA perfluorinated sulfonic acid with either SSC short side chains or LSC long side chains of vinyl ethers. Material sources include dispersions, powder, and pellets. Film formation may occur in a contained chamber such as a mold tool. The microstructure of PFSA can be modified by physical, chemical, and physicochemical action used in polymer formation including treatment at different temperatures, humidity, mechanical loading, ultrasonic excitation, and doping. Aside from the sulfonate group —SO₃⁻ other hydrophilic radical able to attach to a hydrophobic fluorocarbon backbone include carboxylate —COO⁻ and the meta-phosphonate ligand —PO₂⁻.

The membrane may also be non-uniform, comprising a porous polymeric substrate such as PTFE coated with an thin ionomeric layer, typically less than 100 nm in thickness serving as the ion exchange medium. Examples include PTFA-coated PTFE or composite membranes using a hydrophilized porous substrates such as PTFE treated by a hydrophilic solution of gallic acid with 3-trimethoxysilylpropyl and diethylenetriamine. Other hydrocarbon ionomers are mainly sulfonated aromatic thermostable polymers, such as poly(ether-ketone), poly(ether-sulfone), poly(p-phenylene), and polybenzimidazole. Film formation from dispersions, powder, and pellets may occur in a contained chamber such as a mold tool and subsequently involve immersing, spraying, or coating the substrate in a PFSA solution or hydrophilic treatment.

The PEM membrane can also be modified to convert glucose into electrical energy. In one embodiment the membrane is used in an abiotic glucose fuel cell or AGFC where abiotic catalysts such as metals, metal oxides, metal sulfides and carbon-based nanomaterials catalyze glucose oxidation. At the anode, in an acidic environment or near neutral pH glucose catalysis produces a set of two hydrogen ions (protons) and two electrons, along with gluconic acid as a reaction byproduct. Like a hydrogen PEM fuel cell the protons traverse the ion exchange membrane where at the cathode they combine with oxygen to form water in the cathode chamber.

In an alternative embodiment KOH is introduced into the anode together with glucose whereby the KOH dissociates into K⁺ and OH⁻ making the pH of the anode reaction alkali. Unlike the acidic glucose reaction, at high pH levels the protons created by oxidation of glucose are immediately neutralized by the hydroxyl radicals producing water and leaving two ionized potassium cations 2K⁺. The cations and water then diffuse across the membrane where the water is reduced by oxygen back into OH⁻ which recombines with the ionized potassium K⁺ to produce potassium hydroxide as am effluent thereby maintaining charge neutrality.

In either case, Pt is the most widely reported abiotic catalyst for glucose but suffers limitations of catalyst poisoning of reaction byproducts. Non-platinum metals such as Au, Ag, Ni, PD, Co, Mn, alloys, metallic oxides, carbon-based materials and their composites may also be used as catalysts in both hydrogen and glucose fuel cells

An alterative to a PEM proton exchange membrane is the anion exchange membrane or AEM. Whereas PEM and other cation exchange membranes conduct current across the membrane using positively charged ions called cations, the AEM uses negatively charged ionized molecules such as hydroxyl radicals for transmembrane conduction. In a AEM anion exchange membrane based fuel cells, a solid semiporous membrane may comprise a polymer backbone and positively-charged cationic groups allowing for the passage of negatively charged ions through the membrane using the charge sensitive mechanism of hopping conduction. Connected by covalent bonds forming various atomic structures including block polymers, graft polymers, clustered polymers, comb shaped polymers, and quaternary structures containing ammonium cations, the AEM selectively enables anion conduction while suppressing proton conduction. Such membranes may comprise aliphatic or aromatic polymers such as poly(sulfone)s, poly(arylene-ether)s, poly(phenylene)s, poly(styrene)s, polypropylene, poly(phenylene-oxide)s, poly(olefin)s, poly(arylene piperidinium), and poly(biphenyl alkylene)s] with different cationic groups such as quaternary ammonium, guanidinium, imidazolium, pyridinium, tertiary sulfonium, spirocyclic quaternary ammonium, phosphonium, phosphatranium, phosphazenium, metal-cation, benzimidazolium, and pyrrolidinium.

AEM anion exchange membranes may also be used in glucose fuel cells. Membranes such as PVA polyvinyl alcohol and polysulfone (PS) may be used to transport OH⁻ anions generated by catalyst induced reduction of H₂O in the cathode. Upon entering the fuel cell anode the hydroxyl radical oxidizes the C₆H₁₂O₆ glucose molecule producing divalent carbonate CO₃²⁻ along with water and conduction electrons.

The state-of-the-art in forming AEM membranes is not at this time competitive to PEM membranes and Nafion films, in part because of the poor mobility of OH-anions in comparison to cation conduction, in part because the hydrophilic-hydrophobic microphase separation structure enabling cation conduction along a molecular surface of a PFSA-PTFE matrix is more mature than those involving anion transport. As anion film preparation is expected to technologically “catch up” with PEM membrane fabrication over the next decade, the embodiments made in accordance with this invention anticipate the use of either cation or and anion conducting films. Since many of the inventive features described herein do not rely on a specific membrane chemistry, the techniques as disclosed are agnostic to type of membrane employed in the fabricated fuel cell.

The chemistry of formation for PFSA polymers, PTFE substrate ionomers used in PEM membranes and of aliphatic or aromatic polymers in AEM membranes is considered in greater detail in related provisional application “Ion Exchange Membranes and Applications Thereof,” the specifics of which will not be explored further here.

In an exemplary process made in accordance with this invention a mold chamber is subdivided into and filled with a material such as PTFE, carbon, and other strengtheners, then molded or processed into a hardened exoskeletal and endoskeletal material. Thereafter the mold chase is removed leaving the skeletal structure in place. The chamber is then filled with a thin layer of PTFE powder or solution needed to form structural lattice for the active ion membrane. The thin film material is then molded in the chamber with the previously fabricated skeletal pillars forming a continuous seamless heterogenous membrane. Because the second molding occurs in contact or containing the first mold, the process is referred to herein as an over-mold. After over-molding, the PTFE heterogenous membrane is treated with PFSA or other suitable hydrophilic solution to electrically activate the thin proton exchange membrane. Alternatively the PFSA can be formed as a bulk ionomer without any scaffolding, substrate, or support except for the skeletal waffle.

Thereafter the fabricated sheet of PEM membranes can be coated with a catalyst layer on each side forming a completed MEA3 three-layer membrane assembly also referred to as CCM catalyst coated membrane. In one embodiment, the catalyst coating on the cathode side of the PEM membrane may be less hydrophilic and more hydrophobic than the catalyst coating on the anode surface of the membrane. In another CCM embodiment, the catalyst is formed using a sputter deposition of a carbon film with platinum or other rare earth metal embedded in the matrix. In another embodiment the sputtering machine performs non-reactive ion etching of the PEM membrane to remove surface defects and contaminants prior to commencing film deposition.

In another embodiment, the stoichiometry of the deposited catalyst layer on the two sides of the PEM are not the same, for example where the cathode side catalyst layer may comprise more porous lower film density with reduced platinum catalyst concentration replaced in part by metal oxides such as TiO₂. In another embodiment the stoichiometry of the deposited catalyst layer may be uniform, or stepped from one formulation to a second, or gradually varied as a continuum in varying compositional blends.

In another embodiment a sheet of multiple PEM membrane unit cells is singulated by saw, laser, or punch after the CCM fabrication is completed where the cut lines corresponding the exoskeleton of wider pillars separating each PEM unit cell.

In another aspect of forming am ion exchange fuel cell a gas diffusion layer or GDL comprises a carbon paper sequentially coated by a print head or deposition nozzle to create two or more deposited layers atop the carbon paper having different porosities. In one embodiment two or more print heads concurrently deposit varying porosity carbon film onto the carbon paper as either the paper moves by the heads or the heads move along the length of the paper. In one embodiment the print heads spray carbon ink of varying composition comprising fine, medium, and course blends of carbon comprising short, medium, and long carbon fiber solute mixed in a solvent at varying concentrations.

In another embodiment a single print head deposits a time varying composition of carbon ink of varying granularity by either switching among differing solution reservoirs or blending their contents dynamically during deposition. In yet another embodiment of the gas diffusion layer the various carbon layer exhibit a monotonic increase in pore size from the denser carbon paper bottom surface to the more porous top surface either in discrete layers or varying as a continuum in pore size across the deposited layers. In yet another version the carbon paper may be coated on one side with a thin carbon-platinum or carbon-metallic coating before or after deposition of the GDL printing or deposition.

In another set of embodiments detailing the assembly of the CCM and GDL, the carbon paper edge of a first GDL is attached to the CCM on the anode side while the carbon paper edge of a second GDL is attached to the CCM on the anode side completing a five-layer membrane assembly of MEA5. In one version of this process flow, a handle comprising a polymer, plate, or silicon wafer is temporarily bonded or glued to the CCM prior to attaching a first GDL to the CCM, and detached prior to attaching a second GDL to the other side of the CCM.

In accordance with this invention, a gasket or sealant may be included in the MEA5 assembly enclosing the periphery of the unit cell to reduce gas leakage at the CCM-to-GDL interface. The seal may by formed or inserted between the CCM and the GDL on either the anode side, the cathode side, or both. The sealant material may comprise a polymer such as silicone, polyimide, various rubbers, PTFE, or a nonporous material, preferably compressible without fracturing. Once assembled the MEA5 assembly is compressed under pressure until the GDL and the CCM come in direct electrical contact. The compression may include heat as well as ultrasonic excitation to improve bonding and reduce contact resistance between the GDK and the catalyst layers.

Formation of the GDL seal ring may involve a separate gasket ring inserted between the CCM and GDL during assembly, or alternatively may involve deposition of the sealant material onto the CCM or printing of the sealant onto the GDL. In an alternate fabrication sequence offering reduced compressive stress, the catalyst layer is selectively removed in the regions where the sealant ring is to be formed. In one process flow, the catalyst layer on either side of the CCM is masked and etched selectively removing the catalyst layer at the cell's periphery. Thereafter sealant comprising a polymer such as silicone, polyimide, PTFE or other non-porous material is deposited to fill the void formed by the catalyst layer removal. During CL etching mechanical support may be provided by a handle or a previously attached GDL.

Since ideally the sealant ring should be coplanar with the remaining catalyst layer or only slightly thicker and since selective precision thickness depositions are not viable in manufacturing, several process options are disclosed. In one case a localized deposition is performed using a movable print head able to locate and deposit sealant in a defined pattern. The film is then etched back to be substantially coplanar with the unetched CL layer. In a second method, a thin seed layer is deposited which has a greater affinity for the exposed polymeric PEM material than for the carbon-metallic CL layer. Excess material can be removed from atop the CL area using a short chemical dip leaving the seed material only in the exposed windows. The sealant layer is then selectively grown only atop the localized seed layers. In yet another embodiment a thick sealant is uniformly deposited across the patterned CL membrane and then etched-back using an anisotropic planarizing etchback. In an anisotropic etch, etching occurs perpendicular to the etch surface so that thicker layers in the defined sealant windows are not removed while planar surface are cleared.

In yet another embodiment the photoresist used to etch the CL layer remains in place and is hard-baked at a higher temperature to strengthen it. The sealant material is then deposited to a thickness filling all the holes overflowing onto the planar surface, a 3D volumetric effect. After filling the photoresist and everything atop it is removed, i.e. lifted off, leaving tall vertical columns of sealant that can be removed using an isotropic etch leaving only the sealant laterally protected by the CL in place.

In another embodiment the geometry of the fuel cell is rectangular with an aspect ratio of the unit fuel cell greater than 2:1 but preferable 3:1 or 5:1 whereby the sealant ring not only circumscribes the fuel cell but may transect the unit cell to provide added mechanical support especially if the sealant is semi-rigid using polyimide, PTFE, or other plastics. The patter of the intra-PEM sealant rings may or may not match the endoskeletal structure of the disclosed heterogenous membrane construction.

In another embodiment the carbon paper side of the GDL may be coated with a material comprising carbon-platinum, carbon-metallics, or any material identical to the catalyst layer deposited onto the PEM membrane. In this process the catalyst layer deposited onto the GDL and the catalyst layer deposited onto the PEM are assembled contacting one another eliminating any contact potential or temperature coefficient mismatch between them as they are similar or identical in construction. The resulting composite catalyst layer may comprise direct CL-to-CL bonding or may include an etched sealant ring at the periphery. All combinations of anode and cathode side fabrication of a composite catalyst layer and sealant ring are possible including cathode with or without sealant ring, anode with or without sealant ring, cathode with or without composite catalyst layer, and anode with or without with or without composite catalyst layer.

Advanced fuel cells made in accordance with this invention includes bipolar plates for carrying gas and conducting electric current. Given the various combinations of inventive PEM membranes, catalyst coated membranes, and gas diffusion layers as disclosed, the addition of the bipolar plates to form a seven-layer membrane assembly or MEA7, collectively comprise numerous inventive permutations and combinations, regardless of the bipolar plate design. In yet another embodiment, the MEA7 assembly includes non-porous coating on the outside of the assembly preventing gas diffusion and leakage from the cell sidewall. MEA7 designs as disclosed comprise a substantially rectangular shape for ensuring one-dimensional gas flow, a gas intake manifold for distributing fuel along the length of the fuel cell, gas channels crossing the narrow portion of the rectangular shaped cell thereby minimizing 2D and 3D effects, and an exhaust manifold for collecting effluent along the length of the rectangular cell.

Coolant channels as designed flow within the bipolar plates lengthwise to ensure uniform temperature along the length of the module. The coolant channels are transverse to the fuel channels to ensure every channel behaves isothermally identically.

In yet another embodiment the bipolar plates comprise an extended edge longer than the plate itself by which the MEA5 cells are contained. This feature provides self alignment to a stack of fuel cells with no concern of malfunction or gas leakage from misaligned MEA3 and MEA5 cells. In another embodiment the self aligning plates are tripolar, providing fuel for an adjacent anode, exhaust for an adjacent cathode, and coolant for both. In one embodiment of the self-aligned fuel cell the outer channel is wider accommodating sealant to prevent gas leakage between the GDL and BPP or TPP. In one embodiment the sealant is applied to the outer edge of the GDL. In another case it is deposited into the edge channel of the plate.

In another embodiment the bipolar and tripolar plates carry coolant into a heat exchanger able to heat or cool the fuel cell as required. In another embodiment the fuel channel and effluent channel may carry hydrogen, oxygen, air or and water vapor as required.

In another embodiment the MEA7 fuel cell assembles are stacked into a series circuit where some fuel cell may be disabled or shunted while others remain active including the ability to cut the fuel supply from dormant or bypassed cells.

### BRIEF DESCRIPTION OF THE DRAWINGS

FIG. 1. Schematic and waveform of battery driving a resistive or capacitive load.

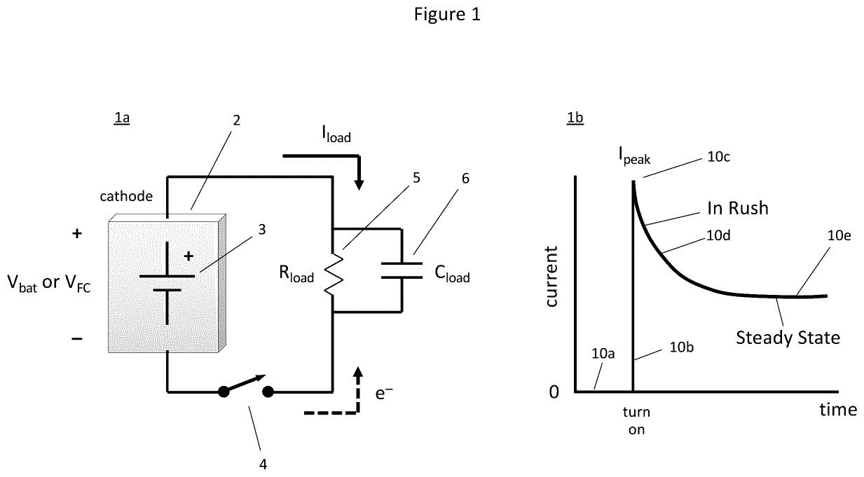

FIG. 2A. Schematic and equivalent circuit of a battery driving a motor.

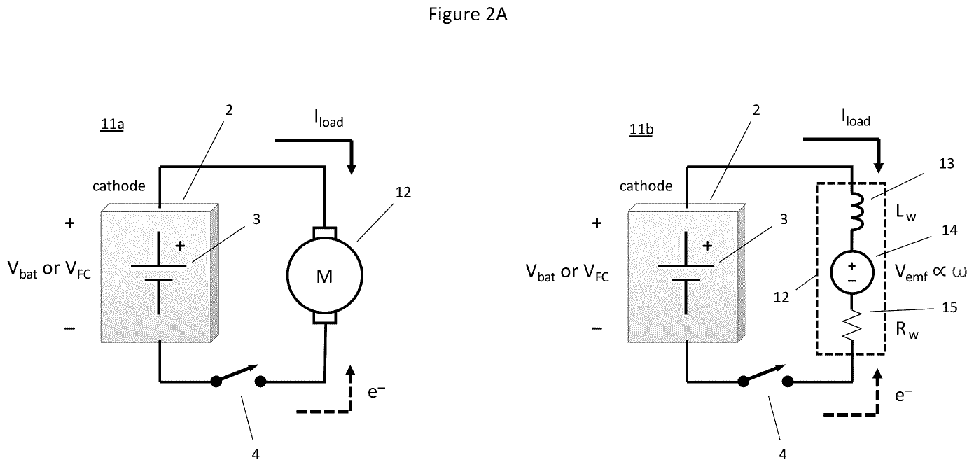

FIG. 2B. Example waveforms of a battery driving a motor.

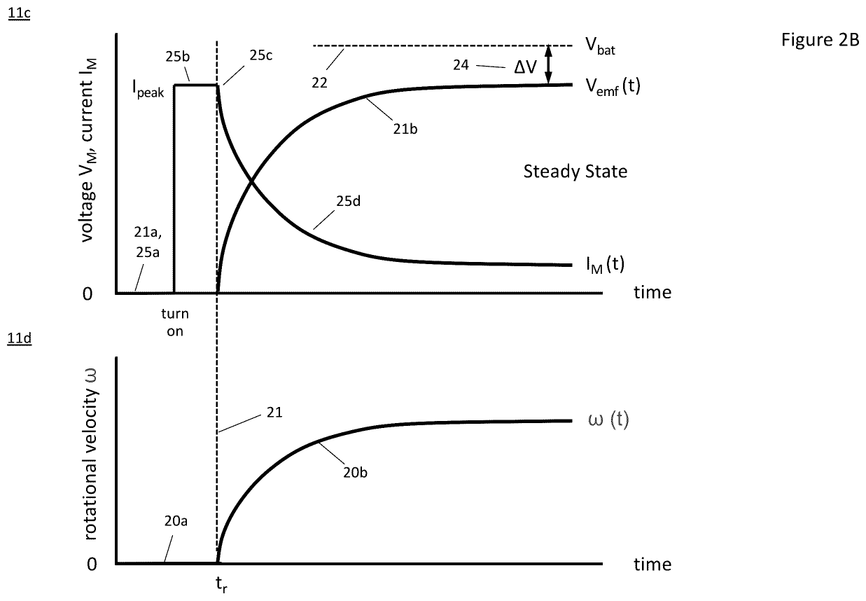

FIG. 3. Schematics of two operating modes for a battery comprising charging and discharging.

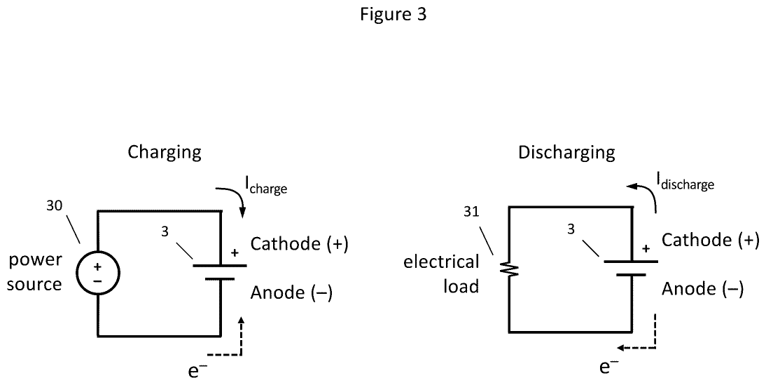

FIG. 4. Electrochemistry of a lithium ion battery during charging and discharging.

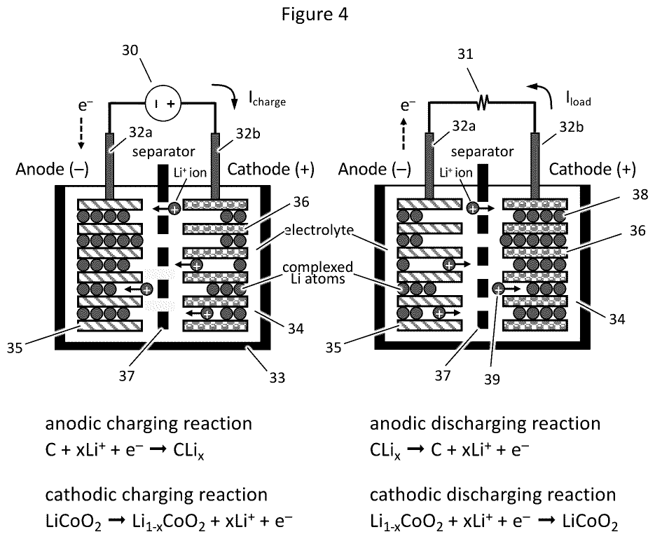

FIG. 5. Exemplary charge storage characteristics of a battery in terms or C-rate during discharging and charging.

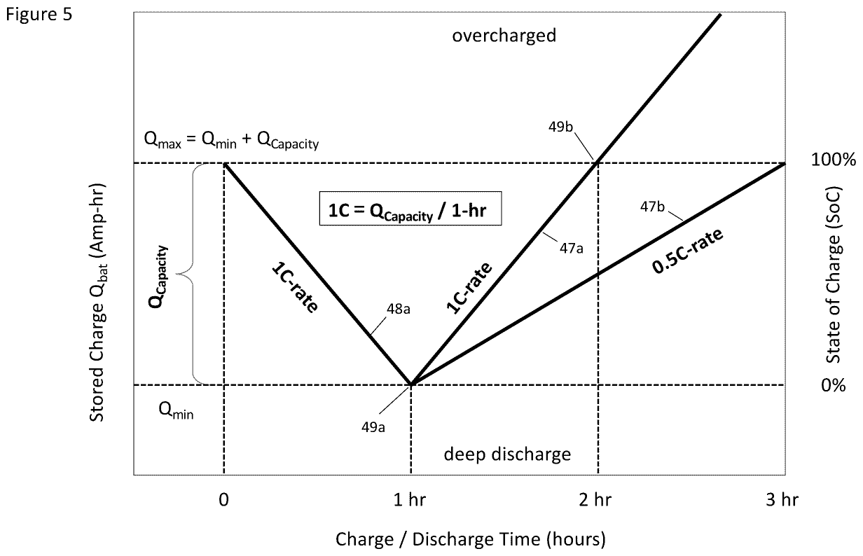

FIG. 6A. Limitations in voltage range of Li-ion battery including fire risk from overcharging and cell damage from over-discharging.

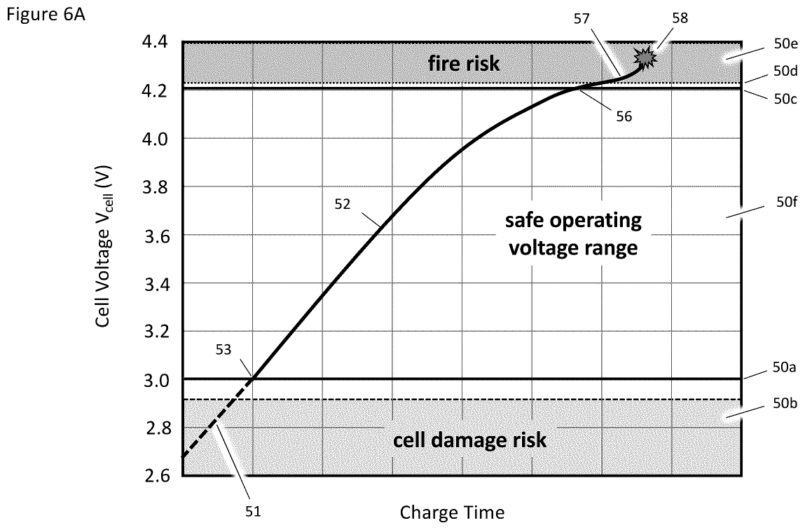

FIG. 6B. Definitions of current-voltage SOA safe-operating-area for a Li-ion battery.

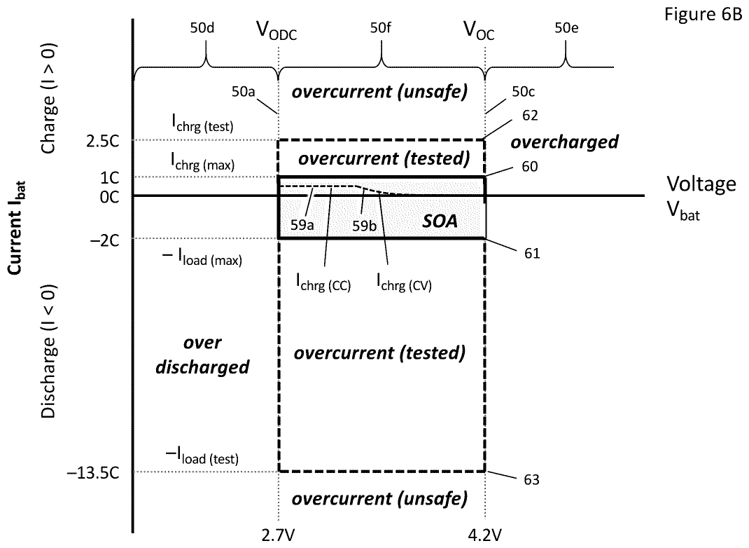

FIG. 6C. Thermal profile of a Li-ion battery during heating and overheating.

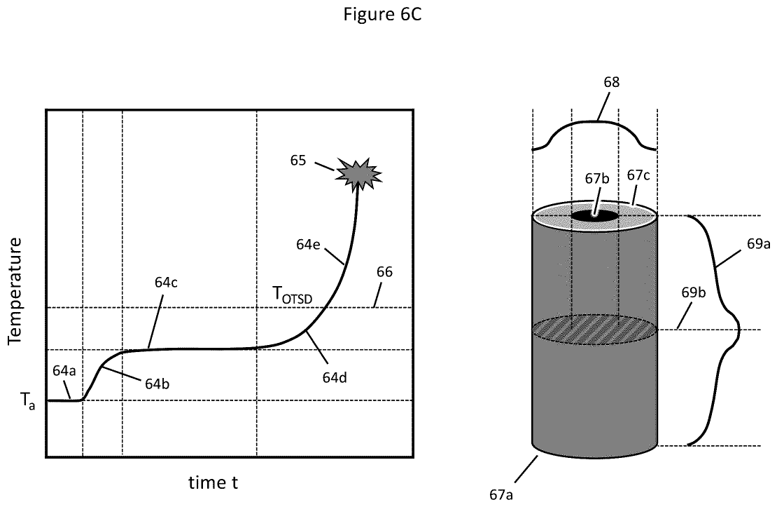

FIG. 7A. Schematic illustrating an offline power source charging a lithium ion array from rectified AC mains through a high-voltage switching regulator stage followed by a dual-mode constant-current constant-voltage charger circuit.

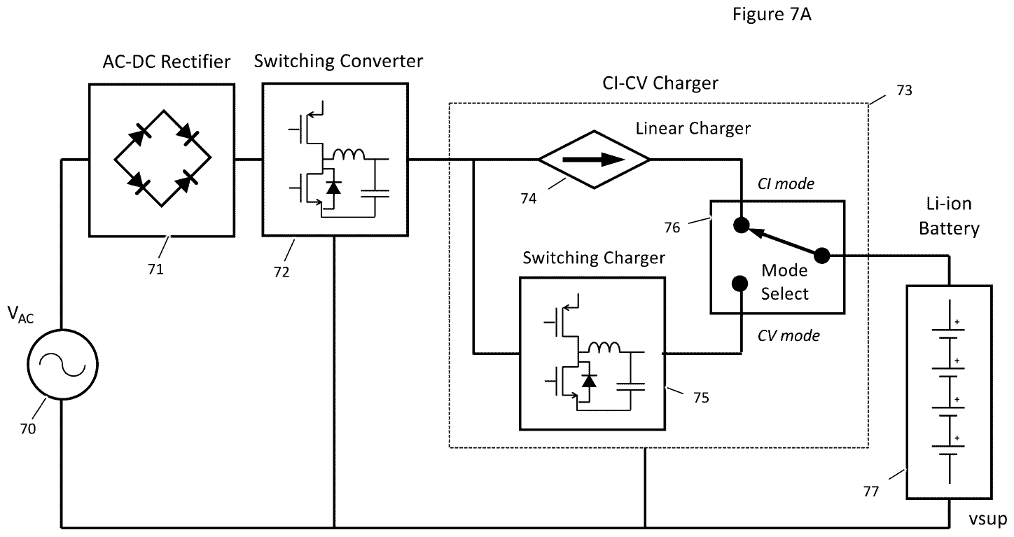

FIG. 7B. Waveforms illustrating operation of dual-mode constant-current constant-voltage charging of a lithium ion battery array of cells.

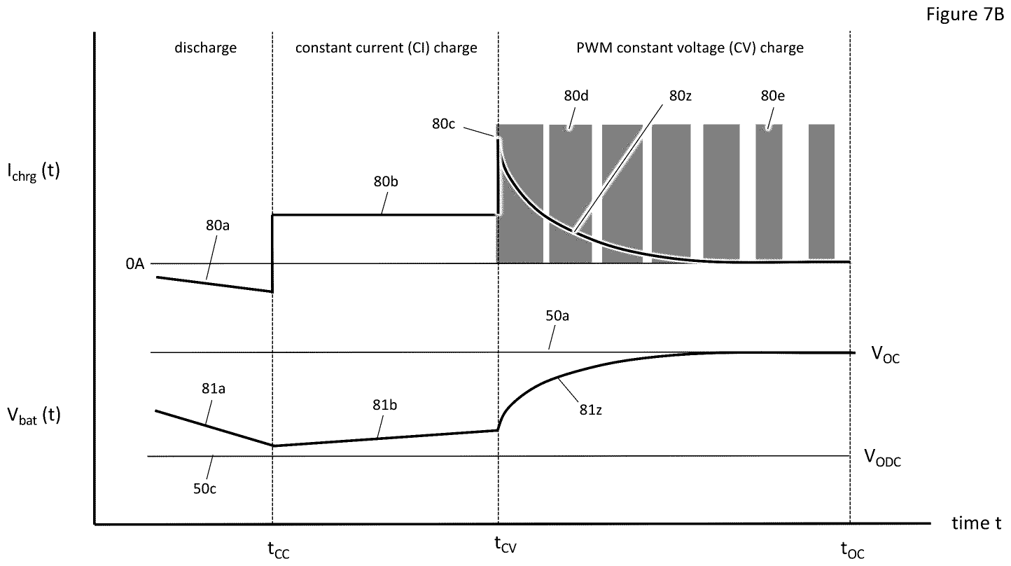

FIG. 8. Table summarizing various lithium-ion battery topologies by exemplary applications including weight, stored charge, charging requirements, and corresponding charging times.

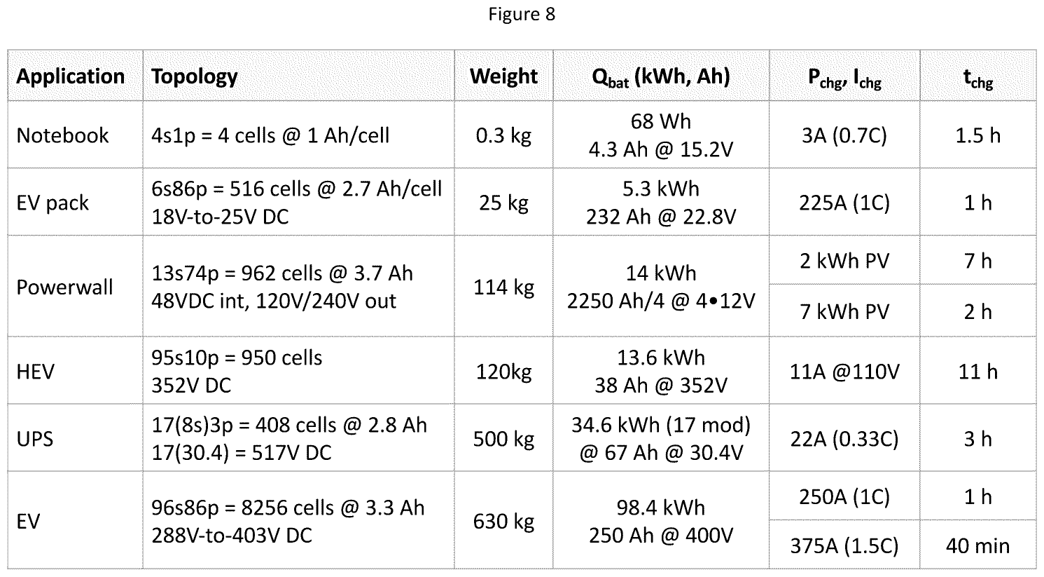

FIG. 9A. Graph depicting Li-ion pack charging times versus battery pack capacity in kWh on the bottom x-axis and in units of Ah on the second x-axis as a function of charger power delivered to the pack.

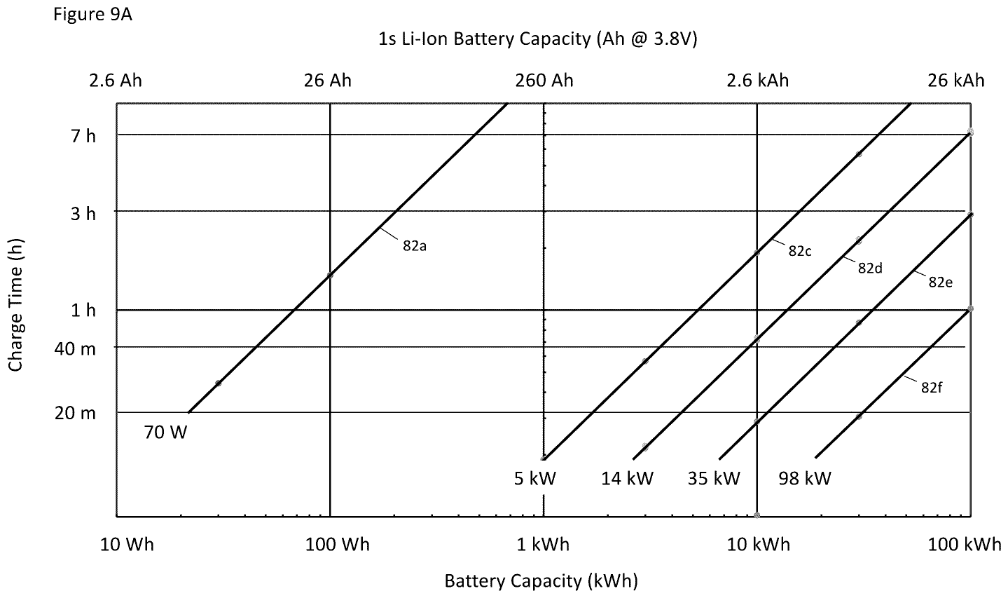

FIG. 9B. Graph depicting Li-ion charging current versus battery series string voltage as a function of charger power delivered to the pack.

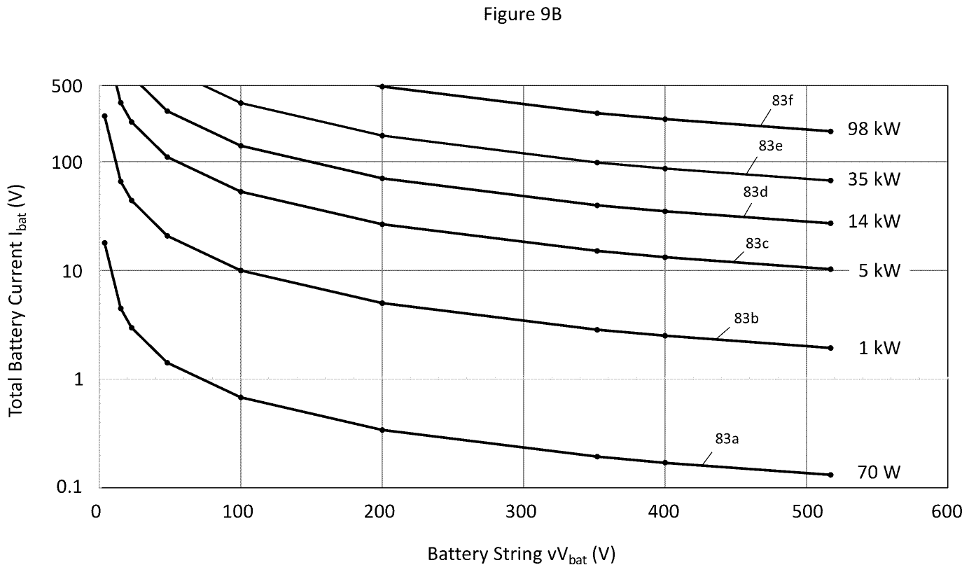

FIG. 10. Mechanistic schematic of hydrogen fuel cell electrochemistry.

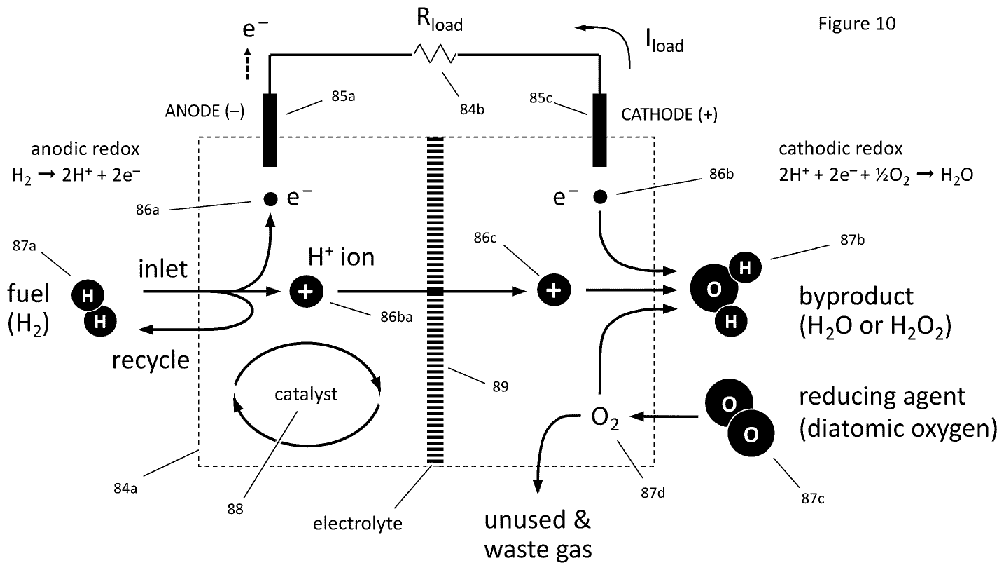

FIG. 11. Charge transport models for alkali, MCFC, PAFC, and SOFC fuel cells showing ion conduction in electrolyte.

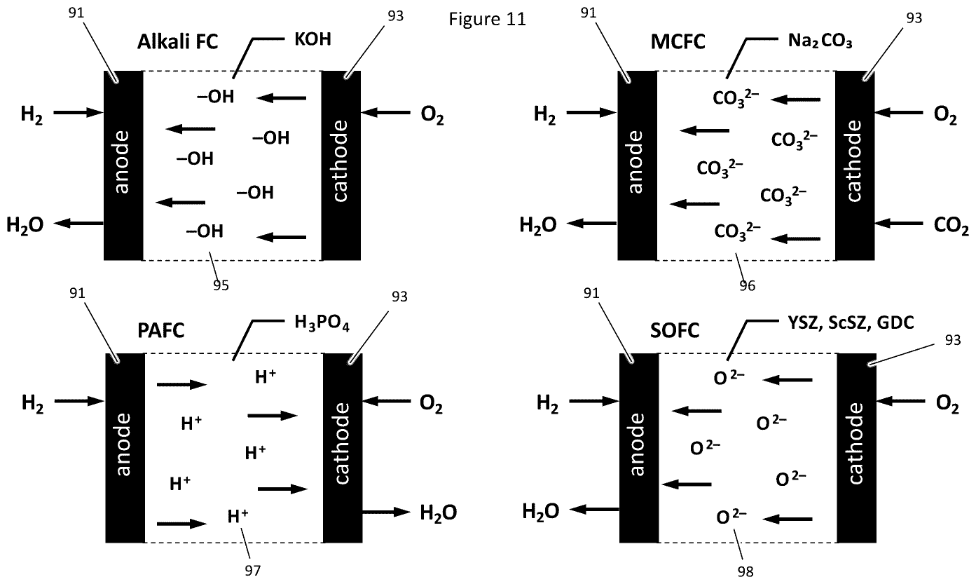

FIG. 12. Diagram of fuel cell components comprising a membrane electrode assembly (MEA).

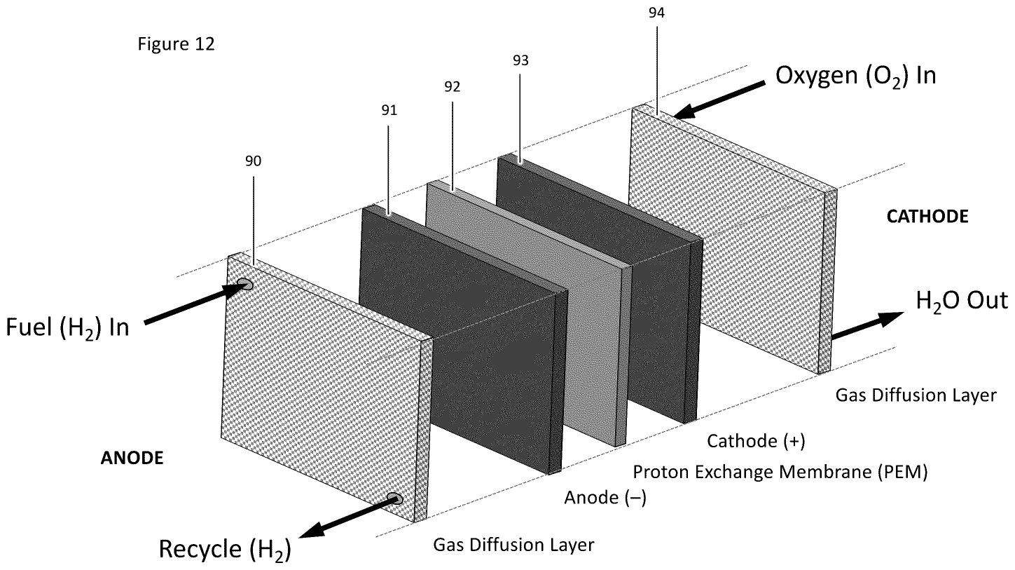

FIG. 13A. Lumped element schematic representation of a fuel cell.

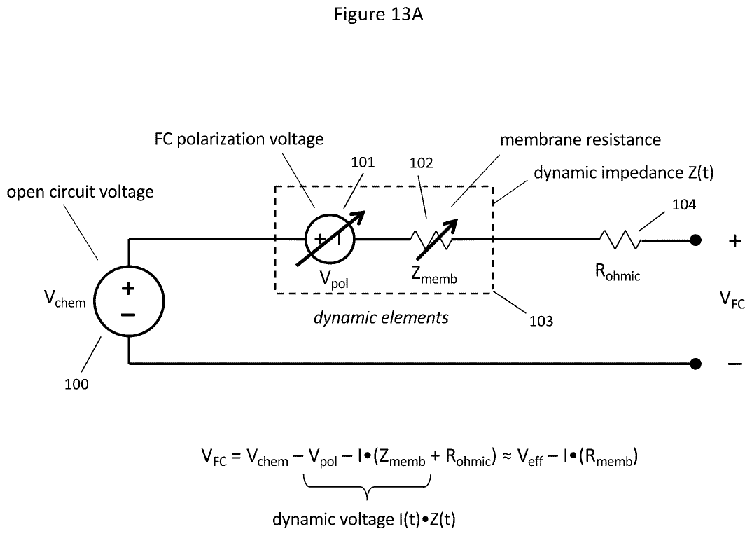

FIG. 13B. Simplified lumped element schematic representation of a fuel cell.

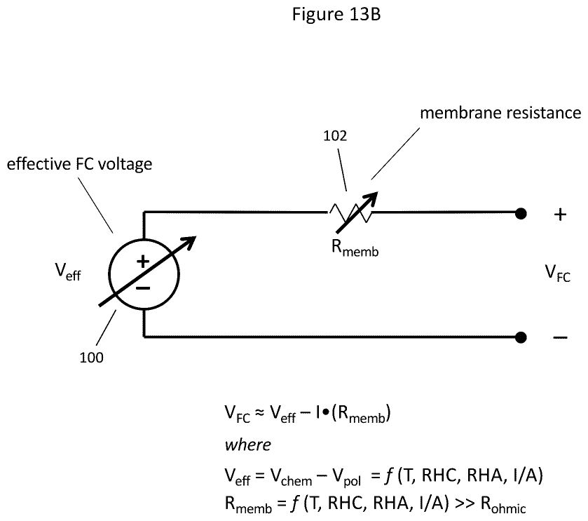

FIG. 14A. Schematic of operation of fuel cell membrane electrode assembly depicting mechanisms involving water.

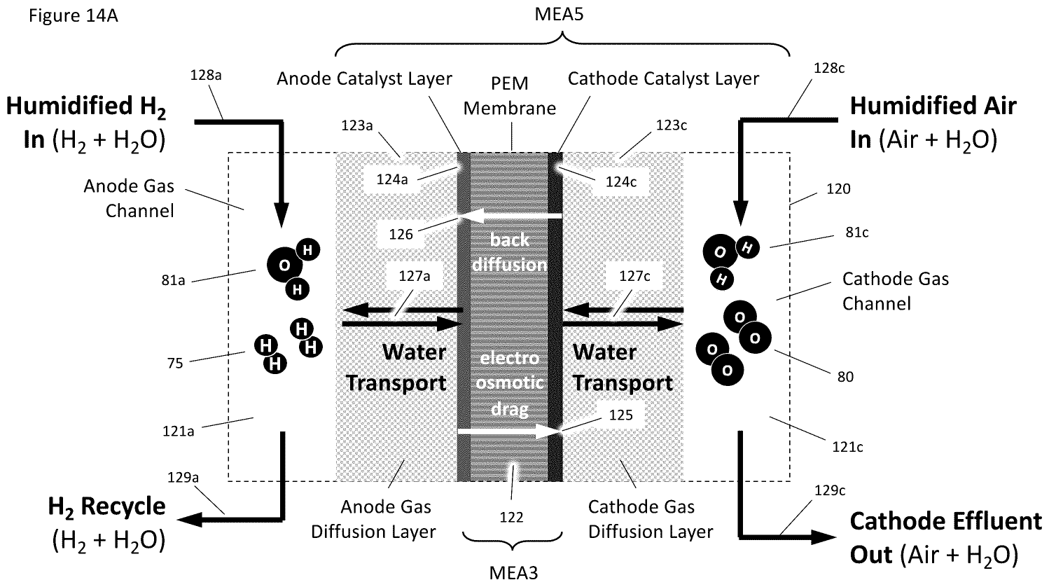

FIG. 14B. Schematic representation of function of gas diffusion layer (GDL) in a PEM fuel cell.

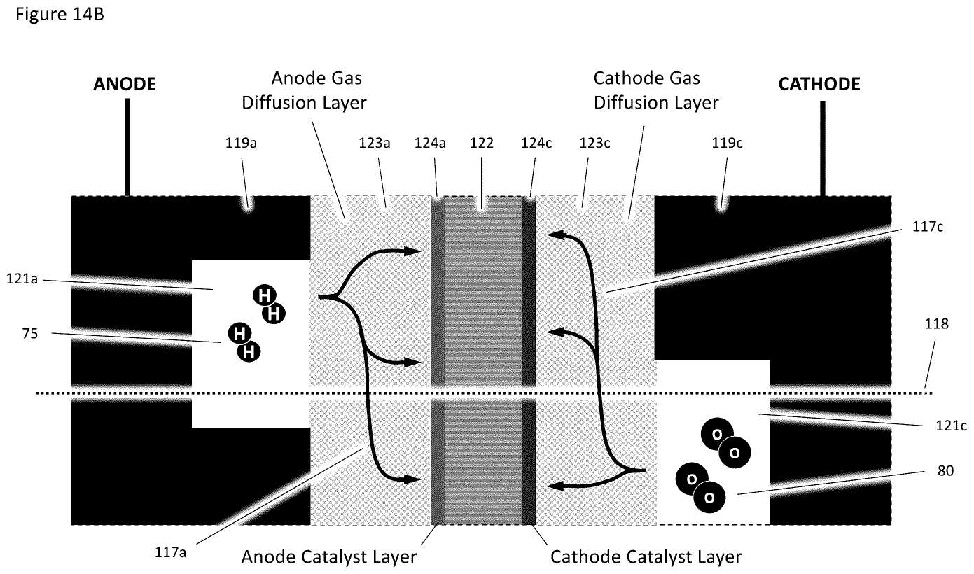

FIG. 15. Exemplary curves of conventional PEM hydrogen fuel cell voltage V_{FC} at 70° C. as a function of current density I/A for various levels of relative humidity RH.

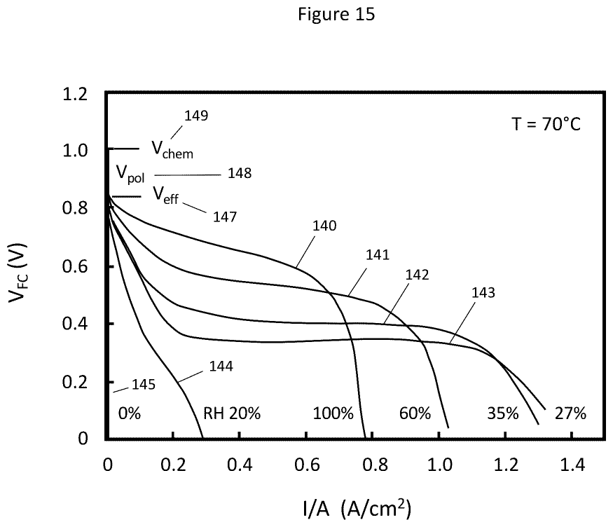

FIG. 16. Exemplary curves of conventional PEM hydrogen fuel cell voltage V_{FC} at 90° C. as a function of current density I/A for various levels of relative humidity RH.

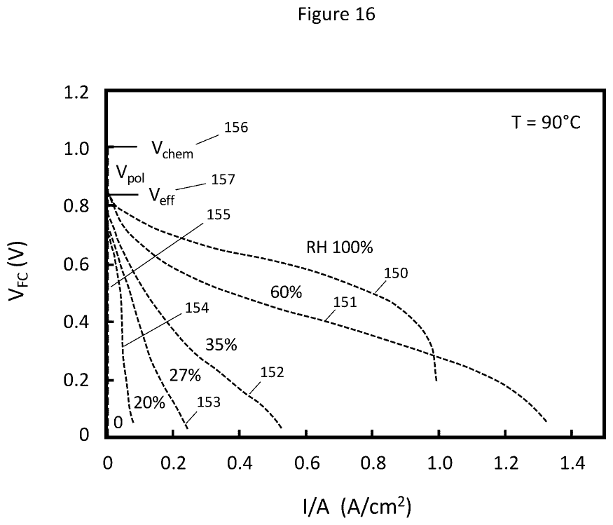

FIG. 17. Exemplary curves of conventional PEM hydrogen fuel cell voltage V_{FC} at 70° C. as a function of relative humidity RH for various levels of current density I/A.

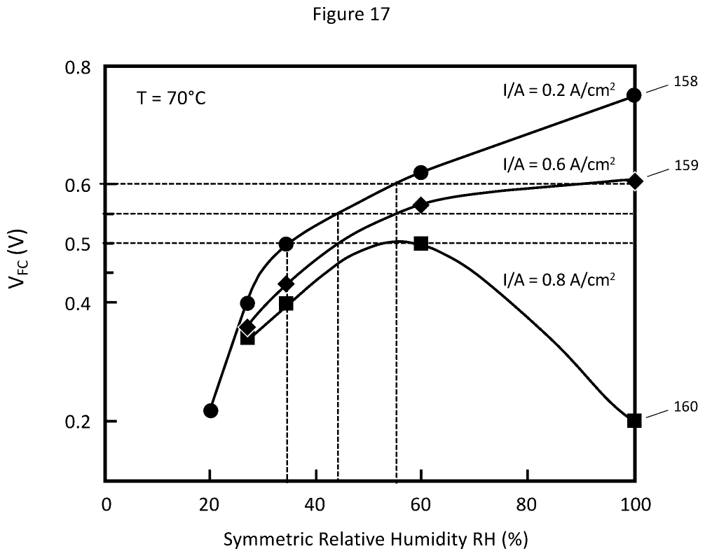

FIG. 18. Exemplary curves of conventional PEM hydrogen fuel cell specific resistance R_{FC} A at 70° C. as a function of current density I/A for various levels of relative humidity RH.

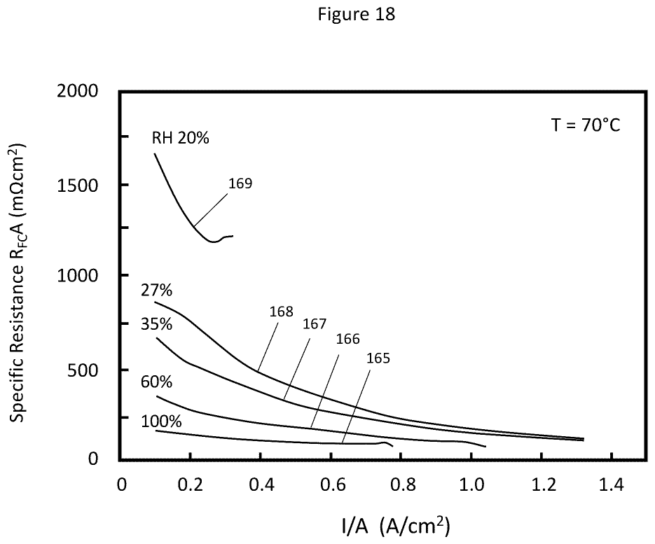

FIG. 19. Schematic of lumped element model for array of “n” series connected fuel cells including voltage, resistance, and total generated charge.

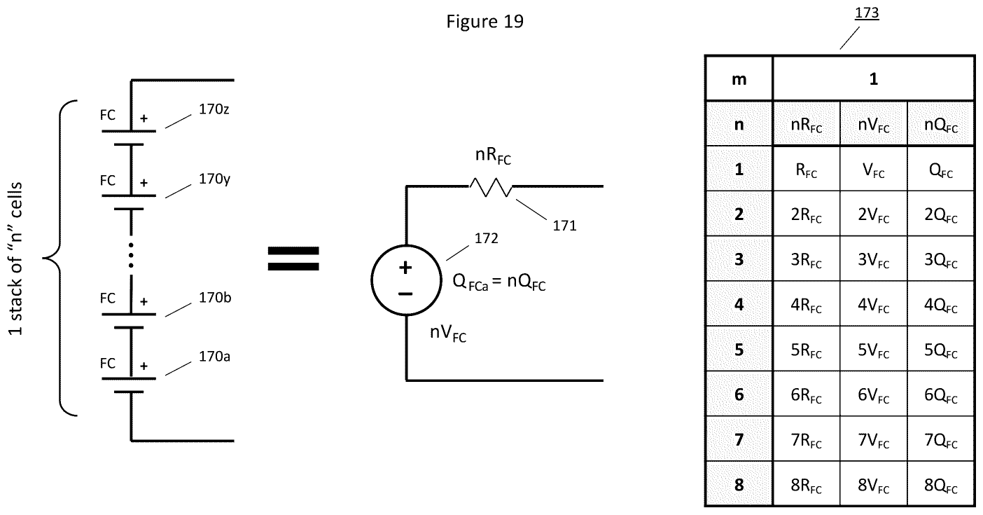

FIG. 20. Schematic of lumped element model for array of “m” parallel connected fuel cells including voltage, resistance, and total generated charge.

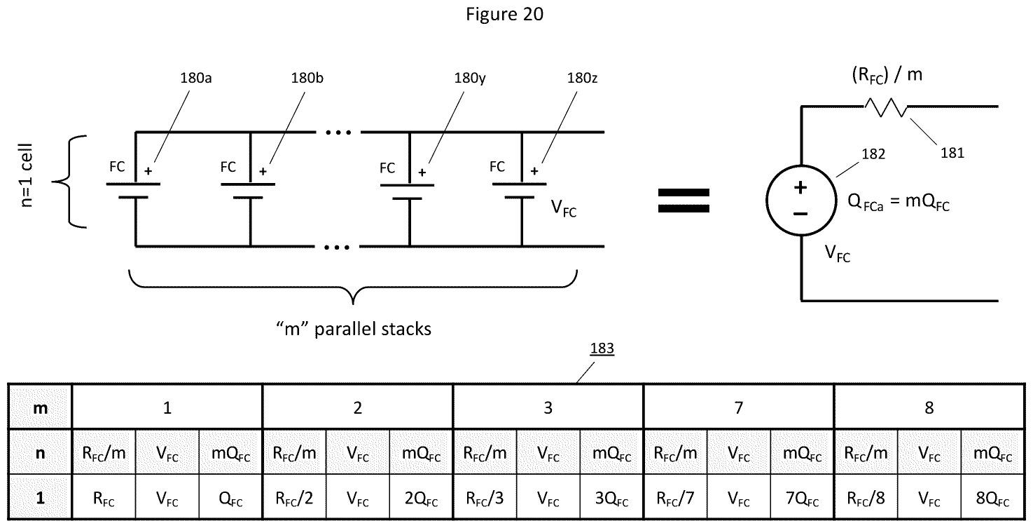

FIG. 21. Dimensions of various small form factor canisters illustrating container volume and pressure limitations.

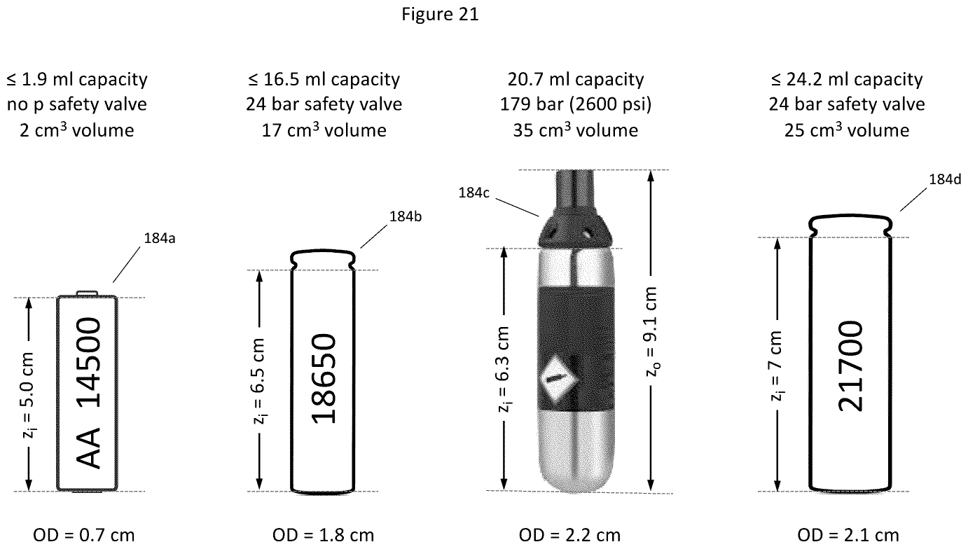

FIG. 22A. Example of high pressure hydrogen gas canister including construction, PRD pressure release device, and valve.

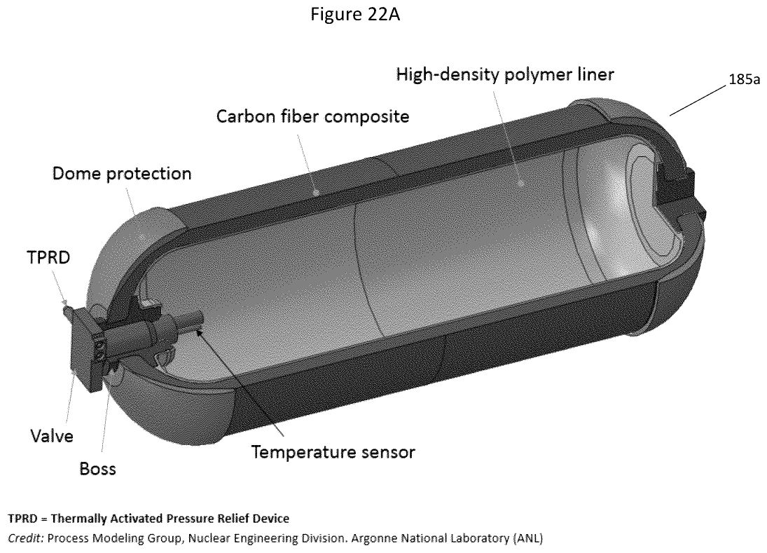

FIG. 22B. Alternate example of high pressure hydrogen gas canister including construction and related hardware.

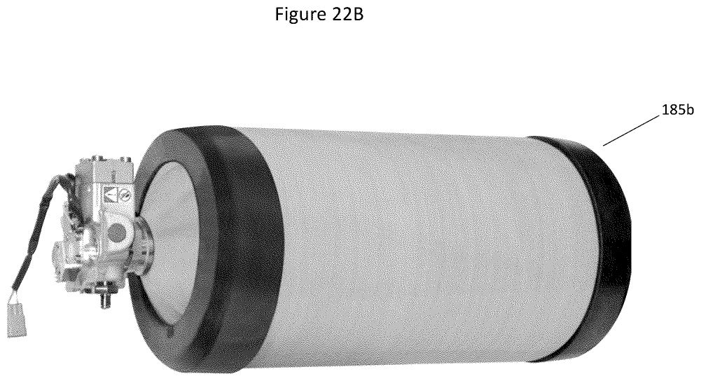

FIG. 23. Linear graph of gas canister volume showing calculated value of electric charge Q_{T}equivalency for hydrogen at various pressures measured in bars.

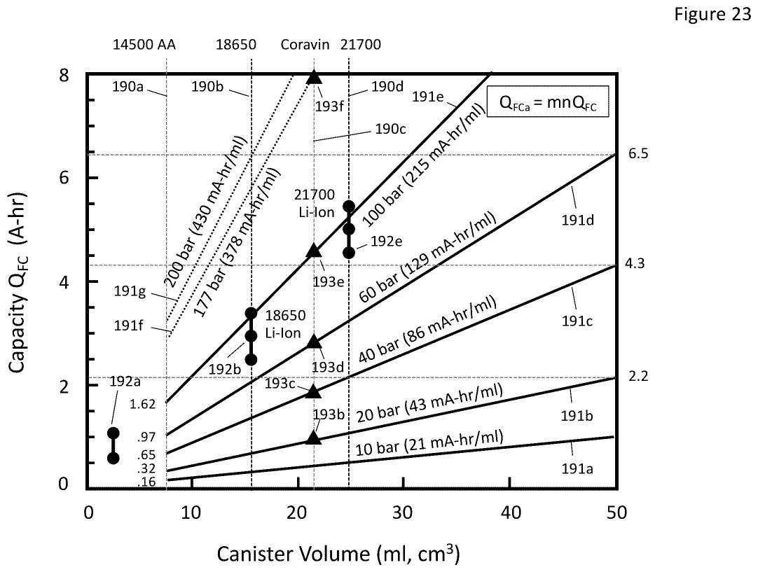

FIG. 24. Log-log graph of gas canister volume showing calculated value of stored energy in kWh and electric charge Q_{T} in Ah for hydrogen at various pressures measured in bars with gasoline as reference.

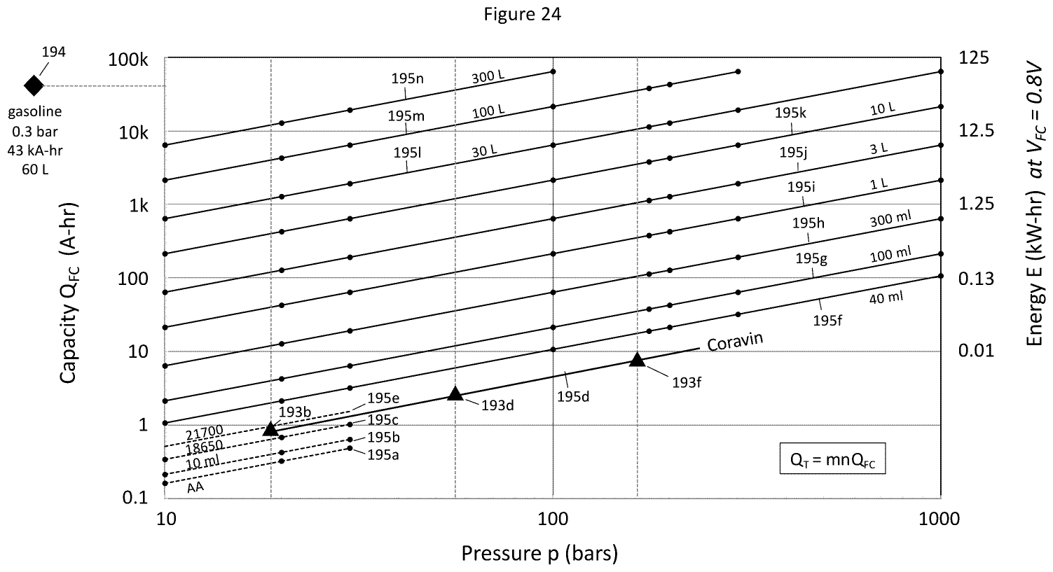

FIG. 25. Specific resistance of exemplary hydrogen fuel cells as a function of number of fuel cells contrasting parallel and series configurations.

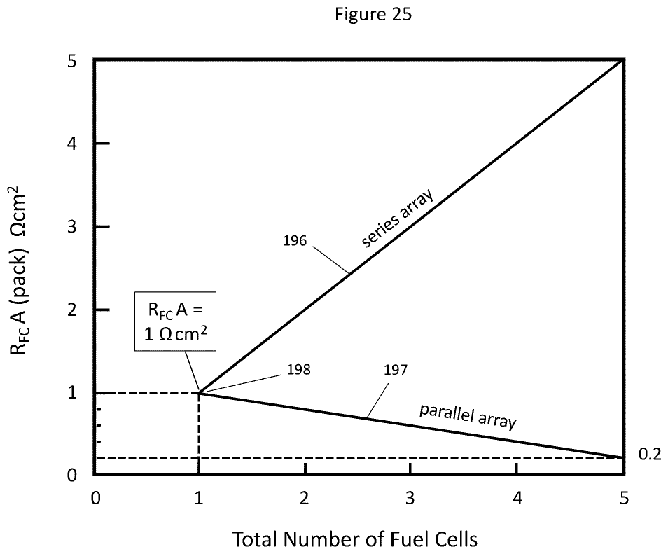

FIG. 26. Schematic of lumped element model for array of “m by n” series-parallel array of fuel cells including voltage, resistance, and total generated charge.

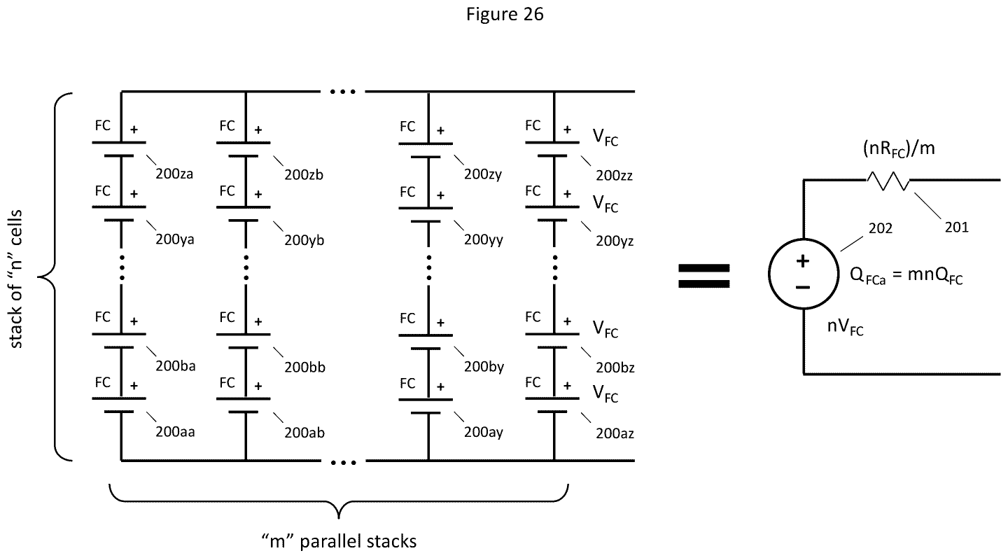

FIG. 27. Summary table of various arrays of “m by n” series-parallel fuel cell arrays parametrically describing voltage, resistance, and total generated charge.

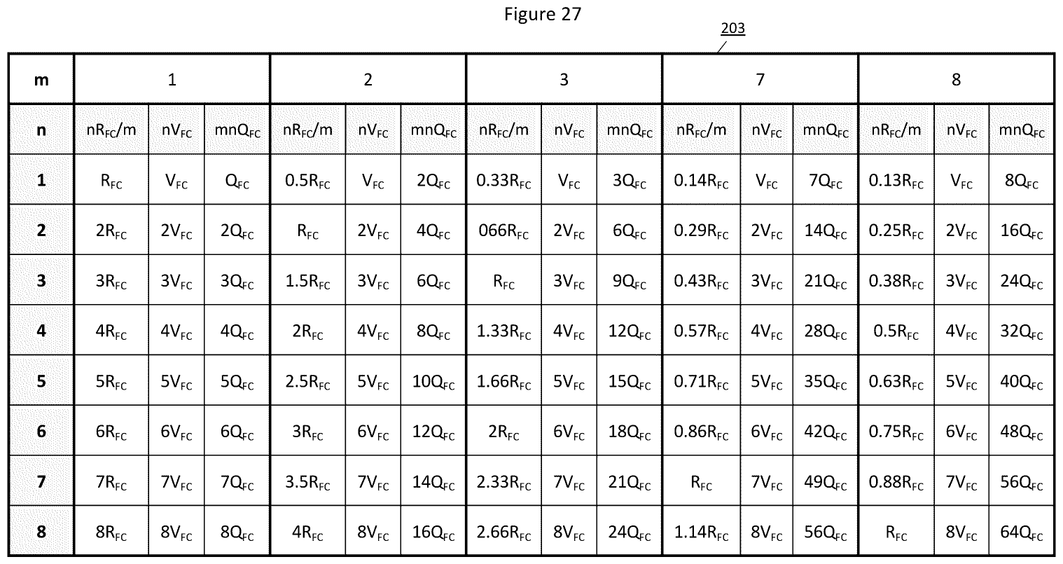

FIG. 28. Graph of specific resistance of hydrogen fuel cells as a function of number of fuel cells of number of “n” series connected cell varied parametrically for various “m” parallel combinations.

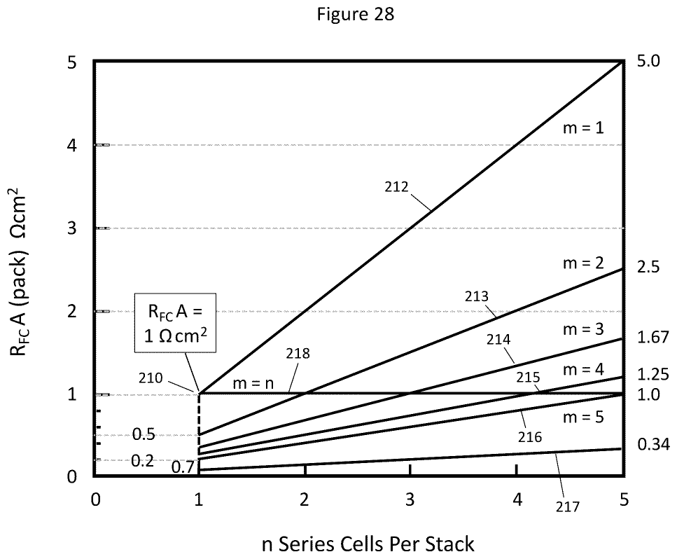

FIG. 29. Schematic of fuel cell array driving brushed and brushless motors.

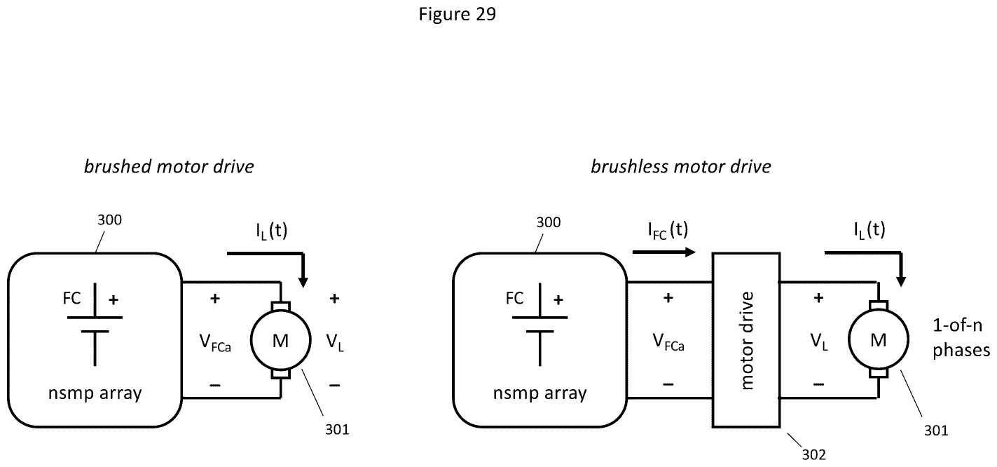

FIG. 30. Schematic of fuel cell array driving low voltage motor via motor drive module.

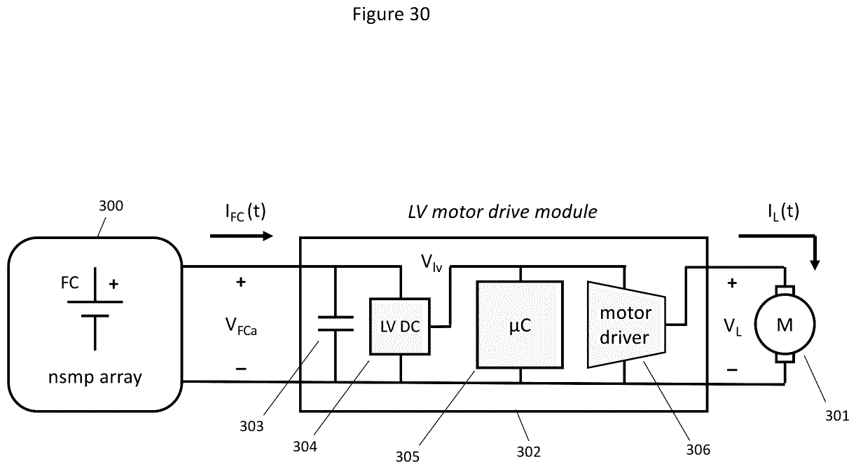

FIG. 31. Schematic of fuel cell array driving high voltage motor via motor drive module.

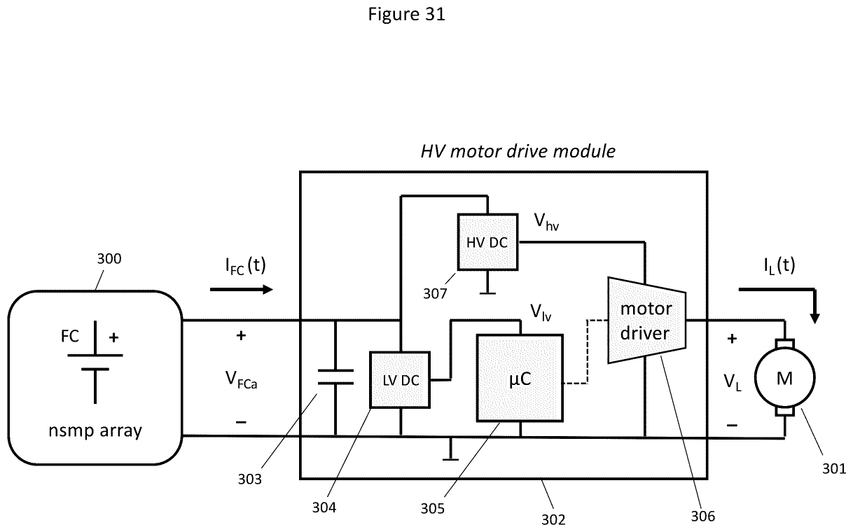

FIG. 32. Voltage and current waveforms depicting problematic motor startup for motor drive powered by high resistance fuel cell.

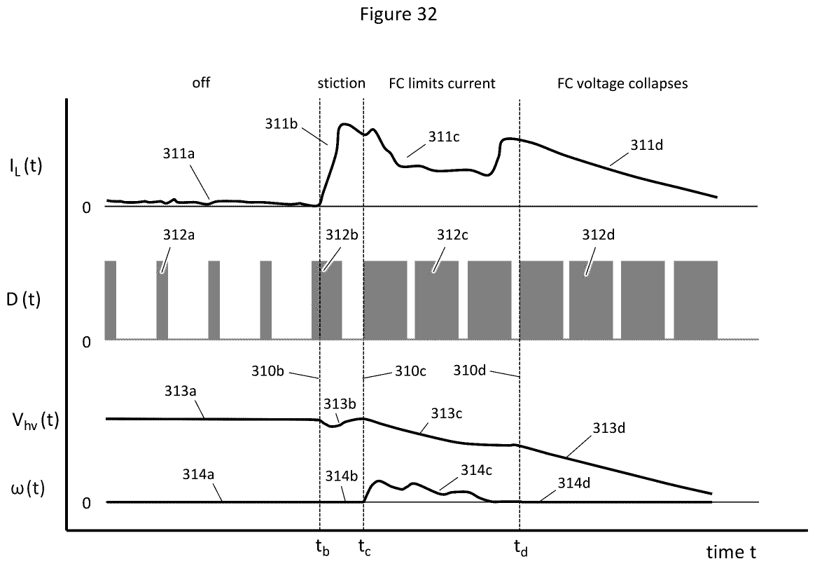

FIG. 33. Schematic of fuel cell array in radio frequency communications including an exemplary equivalent circuit of RF module.

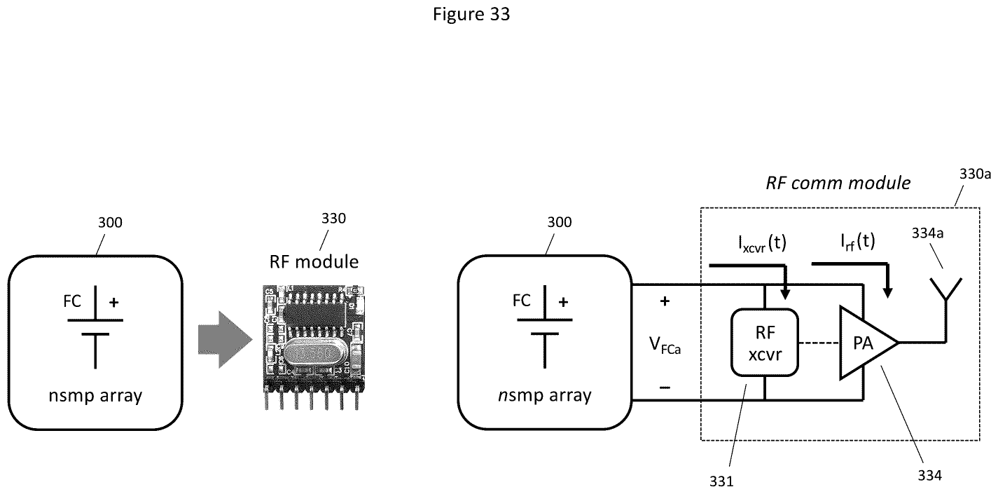

FIG. 34. Voltage and current waveforms depicting problematic operation of RF module powered by high resistance fuel cell leading to system failure.

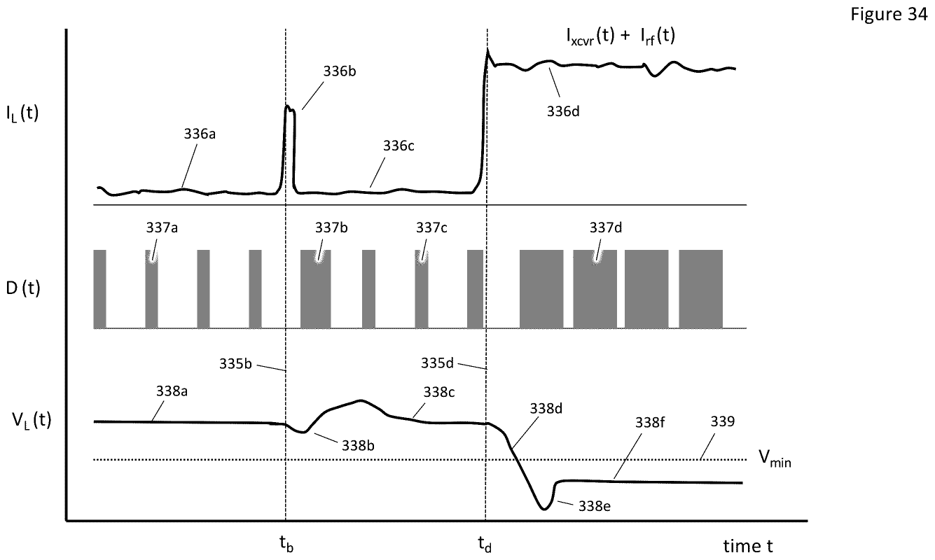

FIG. 35. Schematic of fuel cell array driving notebook computer and equivalent circuit including lithium battery pack.

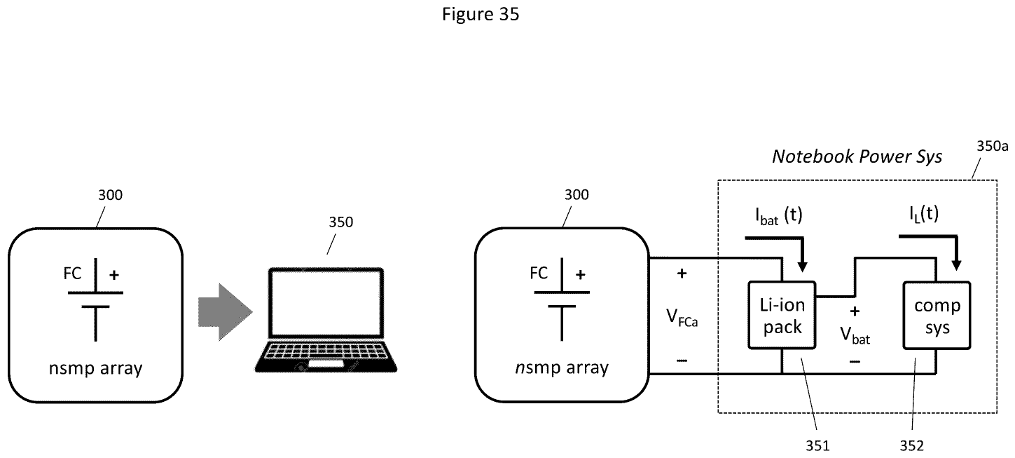

FIG. 36. Detailed schematic of fuel cell array driving lithium battery pack comprising a series-parallel array of lithium ion cells including protection electronics and charger circuit.

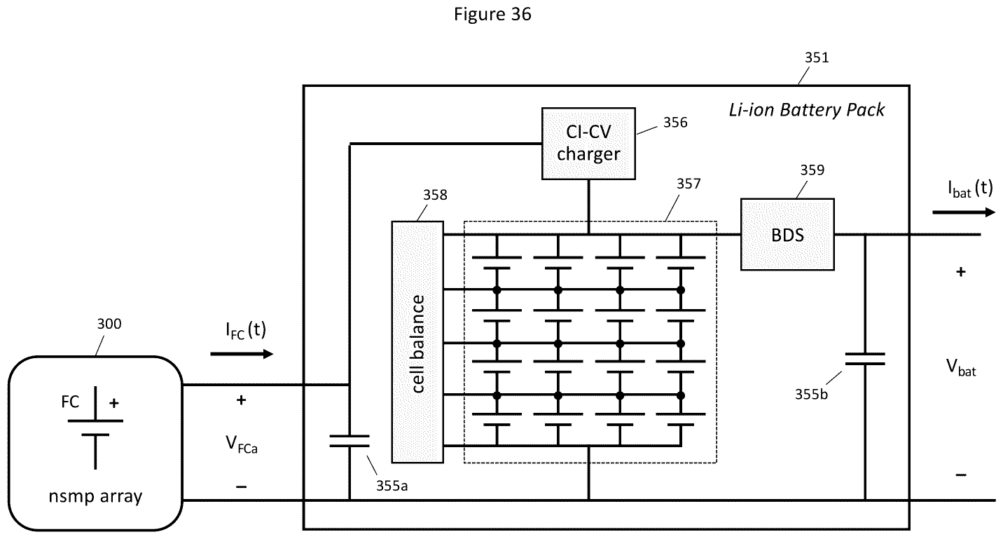

FIG. 37. Schematic representations of single fuel cell unable to charge a lithium ion battery pack either directly or via boost converter.

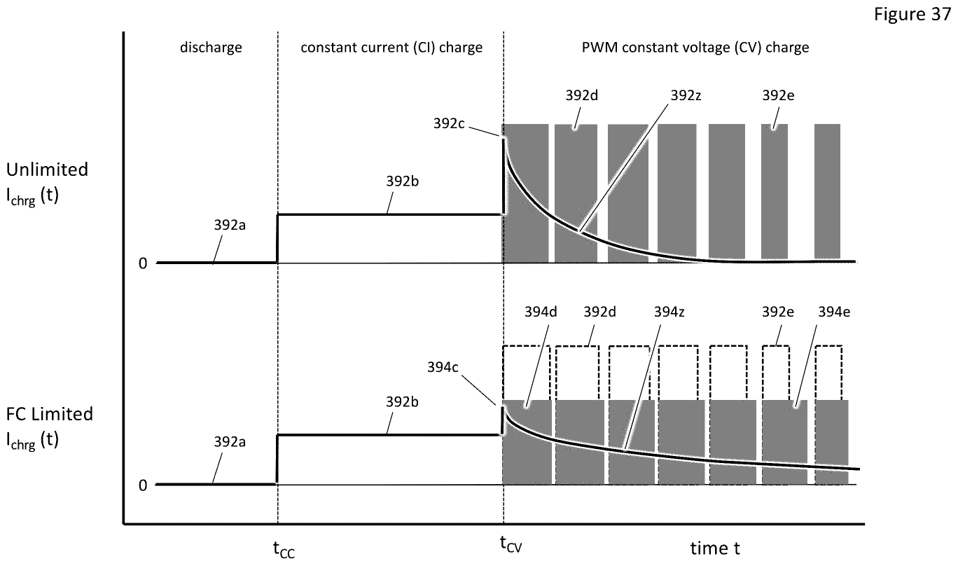

FIG. 38. Fuel cell voltage vs current density for a stack of four fuel cells.

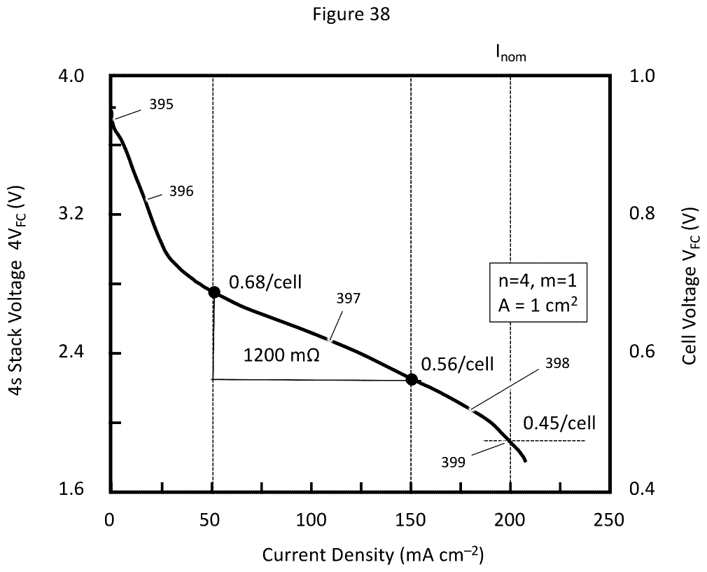

FIG. 39. Formulation and spray painting of carbon platinum ink on PEM fuel cell.

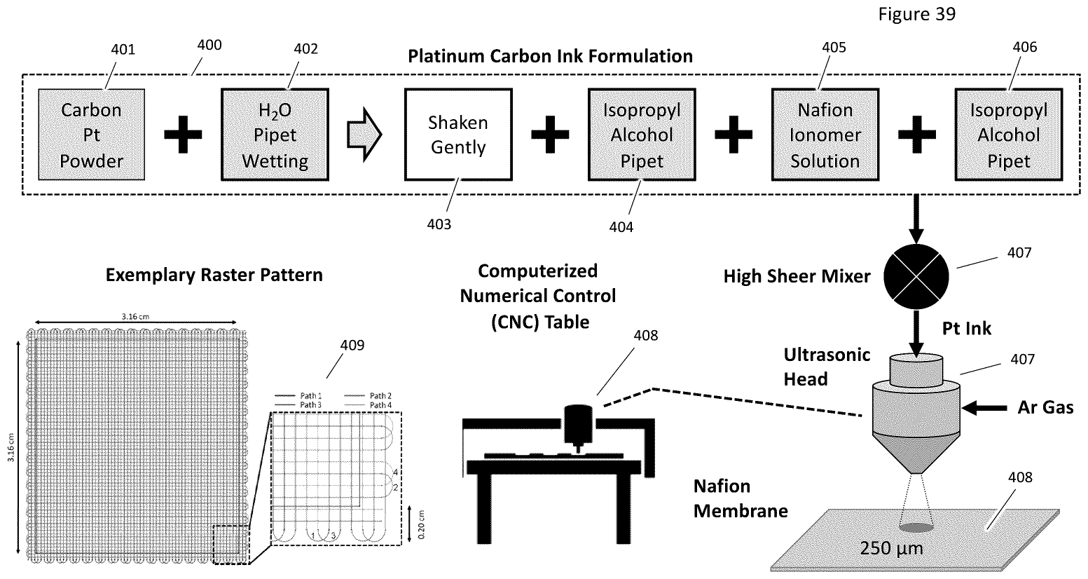

FIG. 40. Exemplary steps of platinum printed PEM fuel cell fabrication.

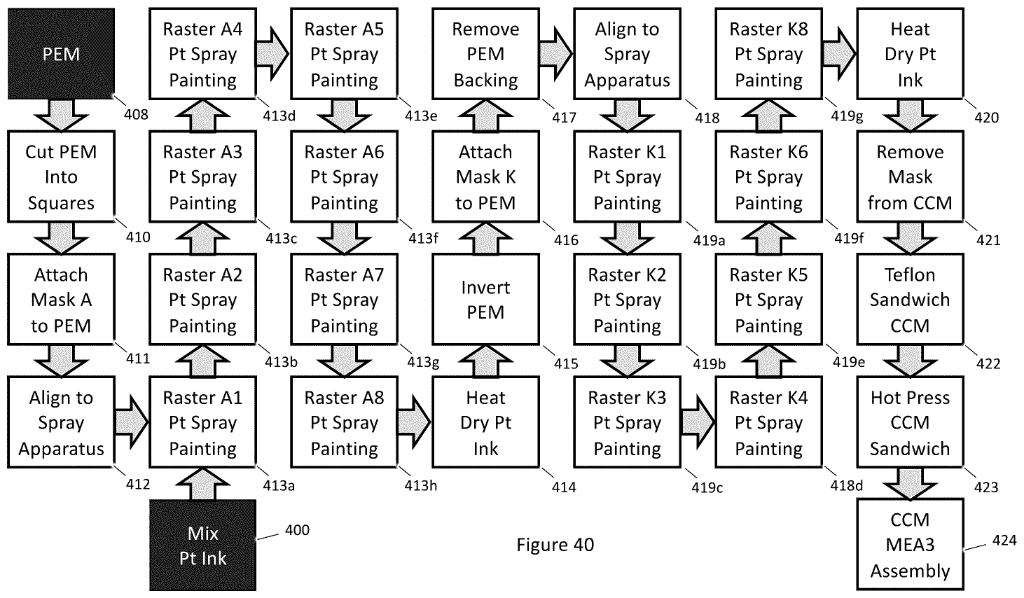

FIG. 41. Assembly of PEMFC module.

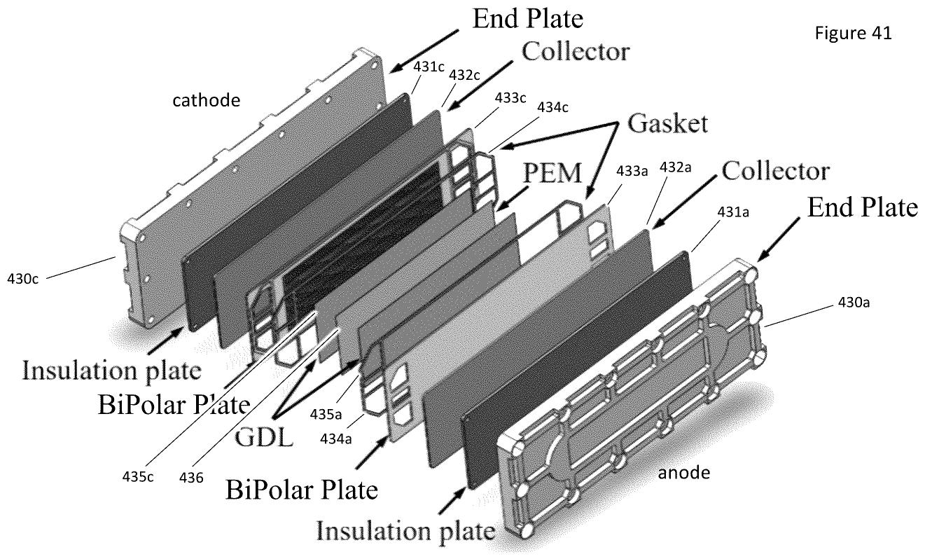

FIG. 42. Apparatus for laboratory fabrication of PEM fuel cell.

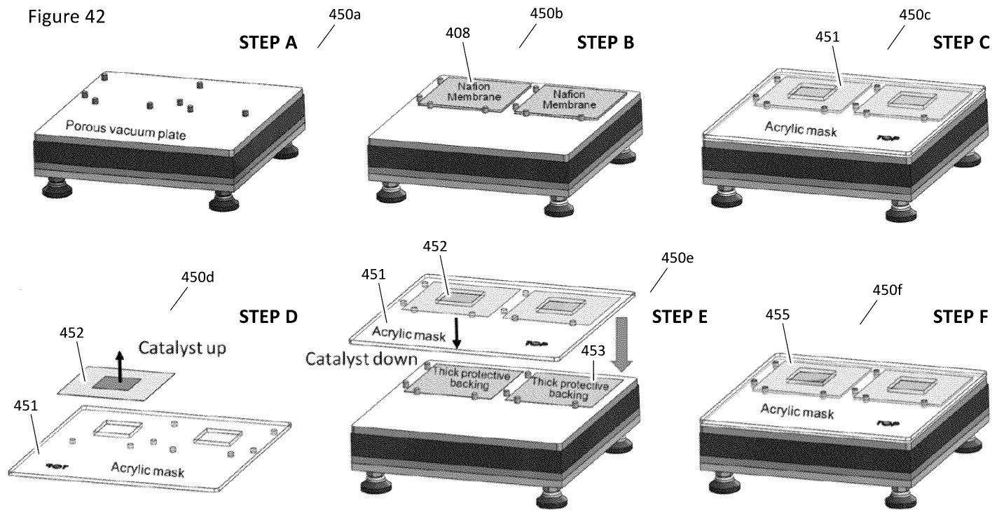

FIG. 43. Membrane resistance versus PEM ionomer thickness.

FIG. 44A. Cross section of heterogenous PEM where ionomer thickness exceeds PTFE pillars.

FIG. 44B. Cross section of heterogenous PEM where ionomer thickness does not exceed PTFE pillars

FIG. 45. Exemplary process flow for fabricating heterogeneous PEM sheet.

FIG. 46. Process flow for molding PTFE skeleton.

FIG. 47. Process flow for molding PTFE skeleton reinforced PEM.

FIG. 48. Cross section of PEM sheet showing thick backside support and thin top protection.

FIG. 49. Plan view of PTFE skeleton and multi-PEM membrane including exoskeletal and endoskeletal support and PEM unit cell definition.

FIG. 50. Examples of various catalyst layer deposition processes.

FIG. 51A. Process for in situ cleaning of membrane using sputter etching prior to sputter deposition of catalyst layer.

FIG. 51B. Process for CCM fabrication using plasma sputter deposition of catalyst layers.

FIG. 52. Process flow for fabrication of catalyst layer (CL) on PEM using two target sputter deposition.

FIG. 53. Process flow for anode electrode catalyst layer (AECL) deposition.

FIG. 54. Three compositions of anode electrode catalyst layer (AECL).

FIG. 55. Process flow for CCM fabrication involving attachment of handle wafer before inverting MEA.

FIG. 56. Process steps for cathode electrode catalyst layer (KECL) deposition in for CCM fabrication.

FIG. 57. Fabricated catalyst coated membrane (CCM).

FIG. 58A. Fabrication of a multizone GDL using multi-head printing or painting.

FIG. 58B. Fabrication of a multizone GDL using single-head printing or painting from mixed or sequenced starting material.

FIG. 59A. Cross section of MEA7 illustrating CCM, GDL and bipolar plate

FIG. 59B. Exemplary cross section of a multizone GDL.

FIG. 60. Process flow for fabricating MEA5 assembly.

FIG. 61A. Process steps attaching cathode GDL to MEA3 assembly.

FIG. 61B. Process steps for attaching anode GDL to MEA3 assembly.

FIG. 62. Cross section of completed MEA5 assembly.

FIG. 63. Alternate process flow for fabricating MEA5 assembly with gaskets.

FIG. 64A. Process steps for attaching cathode GDL and gasket to PEM3 assembly.

FIG. 64B. Process steps for attaching anode GDL and gasket to PEM3 assembly.

FIG. 65. Cross section of completed MEA5 assembly with gasket.

FIG. 66. Alternate process flow for fabricating MEA5 assembly with sealant and composite AECL.

FIG. 67. Process steps for patterned etching of catalyst layer.

FIG. 68A. Process steps for application of sealant to PEM module by printing.

FIG. 68B. Process steps for application of sealant to PEM module by selective growth.

FIG. 68C. Process steps for application of sealant to PEM module by deposition and etchback.

FIG. 68D. Process steps for application of sealant to PEM module by liftoff.

FIG. 69. Top and side views of sealed MEA with reinforced PEM membrane.

FIG. 70. Comparison of square, rectangular, and reinforced PEM membranes.

FIG. 71. Process steps for attaching cathode GDL with sealed reinforced PEM3 assembly.

FIG. 72. Process steps for attaching of CL coated anode GDL to PEM3 assembly.

FIG. 73. Cross section showing MEA5 comprising a sealed cathode and composite AECL.

FIG. 74. Process steps showing thermal annealing of composite AECL.

FIG. 75A. PEM fuel cell cross sectional view of MEA5 assemblies comprising no seal and double sealed structures.

FIG. 75B. Alternative PEM fuel cell cross sectional view of MEA5 assemblies comprising double composite CL and sealed composite CLs.

FIG. 75C. Alternative PEM fuel cell cross sectional view of MEA5 assemblies comprising double-composite CL single seal, and double-composite CL double seal structure.

FIG. 76. Process flow for fabricating MEA7 assembly.

FIG. 77. Diagram showing assembly of MEA7 comprising MEA5 and BPP sandwich.

FIG. 78. Cross sections of variations of MEA7 assembly with and without edge cap.

FIG. 79. Top and side views of gas flow channels and gas manifold in BPP.

FIG. 80. Top and side views coolant channels and coolant manifold in BPP.

FIG. 81. Diagram showing final fuel cell assembly process.

FIG. 82. Cross sectional view of final fuel cell module assembled without gaskets.

FIG. 83. Cross sectional view of final fuel cell module assembled with dual sealant.

FIG. 84. Cross sectional view of final fuel cell module assembled with sealant and composite CL.

FIG. 85. Cross sectional view of final fuel cell module assembled with double composite CL with single and double sealant

FIG. 86. Diagram showing assembly of self-aligned fuel cell using sealant on BPP fabrication process.

FIG. 87. Cross sectional view of final self-aligned fuel cell module fabricated using sealant on BPP process.

FIG. 88. Diagram showing assembly of self-aligned fuel cell using sealant on PEM fabrication process.

FIG. 89. Cross sectional view of final self-aligned fuel cell module fabricated using sealant on PEM fabrication process.

FIG. 90. Cross sectional view of alternative self-aligned fuel cell module using post assembly sealant.

FIG. 91. Schematic cross section of a 1s PEM fuel cell identifying membrane electrode assemblies MEA3, MEA5, and MEA7.

FIG. 92. Cross sectional comparison of bipolar plate (BPP) and tripolar plates (TPP).

FIG. 93. Assembly of 2s PEM identifying membrane electrode assemblies MEA3, MEA5, and MEA7 along with TPP interconnection.

FIG. 94. Schematic cross section of a 2s PEM fuel cell identifying membrane electrode assemblies MEA3, MEA5, and MEA7 along with TPP interconnection, conductors, and end caps.

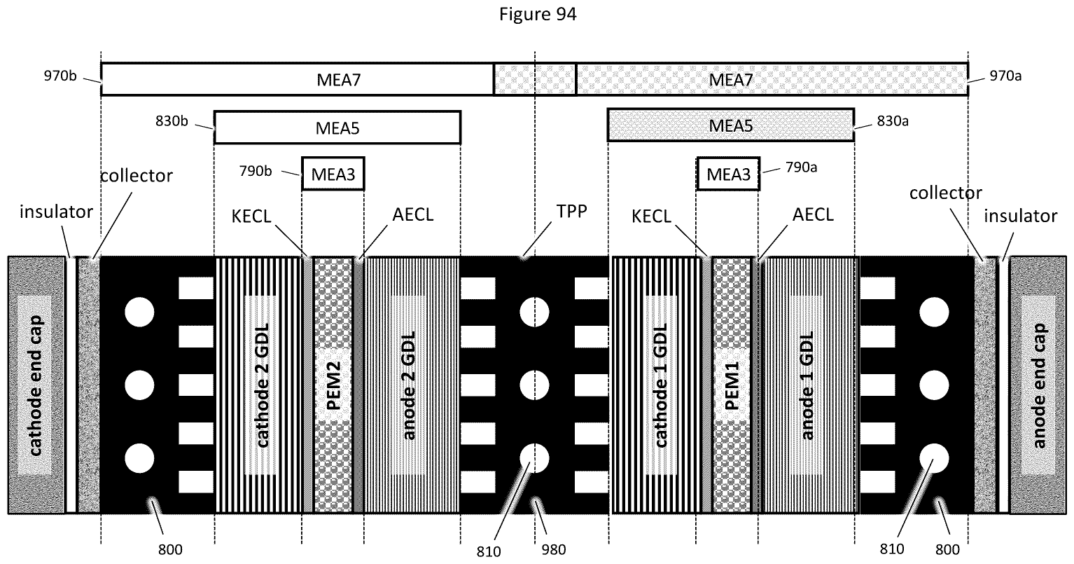

FIG. 95. Schematic representation of fluid flow through tripolar plate (TPP).

FIG. 96. Various schematic representations of a (6s+2s) split fuel cell stack.

FIG. 97. Schematic cross section of a 6s PEM fuel cell identifying ME5 membrane electrode assemblies, collectors, and single chamber enclosure.

FIG. 98. Various schematic representations of a two chamber split (6s+2s) split fuel cell stack including 2s bypass switch and fuel shut off microvalve to chamber 2.

### DESCRIPTION OF THE INVENTION

Modern day fuel cells exhibit a variety of design flaws leading to poor and highly variable electrical performance. The design defects and process deficiencies are present in nearly element of the PEM module including effects of:
The PEM membrane construction and geometry.
The catalyst layer formulation and deposition method including interfacial preparation.
The gas diffusion layer (GDL) construction and fabrication.
Contact between the GDL and the CCM including the role of gaskets.
Contact between the GDL and the BPP including the role of gaskets.
Nonuniform gas flow in the BPP across the fuel cell.
Ability of BPP to regulate fuel cell temperature.
Reliance on alignment keys to ensure components align and fit together.
Sensitivity of the MEA7 assembly to compressive force including electrical and mechanical properties and potential damage therefrom.
Limitations in gas an fluid transport with the MEA7 module.
Intrinsically limited provisions for statistical process control of design parameters and fabrication of fuel cells. i.e. intrinsically poor Cₚₖ capability.

To remedy the numerous deficiencies as discussed, the advanced fuel cell disclosed herein comprises numerous innovations which may be applied individually or in combination. In general these improvements reduce series resistance and lower polarization voltage of the PEM fuel cell, thereby reducing the impact and dependence of cell voltage on current, i.e. making the fuel cell a more ideal voltage source. Other benefits include improved durability and temperature cycling, lower temperature and humidity dependence, and improved manufacturing consistency (higher Cₚₖ). Elements contributing to these beneficial improvements include the following mechanisms:
Reduced thickness reducing ohmic conduction losses without impacting mechanical and chemical film stability.
Reduced interfacial resistance between fuel cell elements including the contact resistance between the catalyst layer and the PEM ionomer; between the CCM and the gas diffusion layer (GDL), and betwixt the GDL and the bipolar.
Increased contact area reducing contact resistance between fuel cell elements.
Eliminating abrupt material transitions using graded materials thereby eliminating mechanical stress from differential temperature coefficients of expansion (TCE) and lowering contact potentials between dissimilar materials.
Reduced leakage of gasses through the sides of fuel cell.
Improve fuel delivery across the PEM membrane to maximize conversion efficiency and increase power output.
Ability to stack fuel cells with separate or shared gas supplies and the ability to cut off gas from selected cells.

The improvements disclosed herein, arranged by fuel cell components comprise the following elements:
The PEM membrane.
The catalyst layers, together with the PEM membrane (CCM or MEA3).
The gas diffusion layer (GDL).
The combined structure of the CCM and the GDL (MEA5).
The bipolar plates (BPP) and tripolar plates (TPP).
The combined structure of the MEA5 and the BPP/TPP (MEA7).
All interfacial surfaces therein.
Current collectors.
Enclosing encasement.

A detailed description of these elements follows.

Ion Exchange Membrane: An ion exchange membrane is an electrochemical membrane that carrying current preferentially based on polarity. In this sense the conductive ion exchange membrane or ionomer is similar to a semiconducting diode exhibiting charge specific conduction, e.g. preferentially conducting positively-charged cation molecules and suppressing electron flow in a PEM, or conversely conducting negatively charged anion molecules and suppressing proton conduction in an AEM. As disclosed the active area of a ion exchange membrane is 10 μm to 100 μm 16 in total thickness comprising a uniform bulk film or a constituting an inactive polymeric substrate matrix coated with an ionomeric thin film involved in charge transport and hopping conduction. As such the electrical conduction properties of the ion exchange membrane may involve two different mechanisms, either bulk conduction of surface conduction.

A PEM membrane generally comprises a plastic-like substrate akin to Teflon modified into a charge transport ionomer by integration with a charge specific ion exchange medium such as a SO₃H (sulfonic acid) group. As described in the literature, the hydrophilic nature of the ionic groups in the ionomer attract water molecules which dissociate the protons from the sulfonic acid group. Once dissociated, protons “hop” from one acid site to another through mechanisms facilitated by hydrogen bonding of water molecules. The interconnected network of hydrophilic domains allow movement of water and cations, but the membranes do not conduct electrons and minimally conduct anions due to permselectivity (charge-based exclusion). As such, the PEM membrane electrically functions as a rectifier, a diode, able to separate negative and positive charge transport. Such materials, e.g. called Nafion commercially, are included in a variety of diverse applications and devices including lithium ion batteries and fuel cells.

The backbone of these molecules, the tetrafluoroethylene based fluoropolymer-copolymer PTFE is hydrophobic and “slippery” creating an anti-stick surface. When sulfonated, PTFE exhibits unique electrical and electrochemical properties including being highly conductive to protons and cations but inhibiting electron and anion conduction. Sulfonated PTFE is an example of an ionomer, a polymer composed of repeat units of both electrically neutral repeating units and ionized units attached to a polymer backbone as pendant groups. Typically less than 15% of the molecule is ionized. Electrical and chemical activity of these functional groups operate independently from the backbone chain or the polymer as a whole. In organic chemistry vernacular, functional side groups determining a molecule's distinctive properties are referred to as “moieties”, in the case bestowing a proclivity for conducting only positively charged ions.

Comprising perfluorovinyl ether groups terminated with sulfonate groups attached to a tetrafluoroethylene backbone, the PTFE based ionomer can be synthesized by co-polymerizing a derivative of a perfluoro, specifically “alkyl vinyl ether”, and tetrafluoroethylene aka TFE together with sulfonyl acid fluoride. PTFE fabrication commences with the formation of chloroform, a process reacting methane with hydrogen chloride and chlorine in either the vapor or liquid phase given by the reaction:

$${CH}_{4} + 3 {Cl}_{2} \to {CHCl}_{3} + 3 HCl$$

and followed by its conversion into chlorodifluoromethane by reacting the CHCL₃ chloroform with anhydrous hydrogen fluoride in a gas phase reaction whereby

$${CHCl}_{3} + 2 HF \to {CHClF}_{2} + 2 HCl$$

The third step involves converting the chlorodifluoromethane into tetrafluoroethylene (TFE), a highly volatile and explosive monomer comprising the gaseous precursor to the chemically stable PTFE. Using the gas phase reaction

$${CHClF}_{2} \to {C}_{2} {F}_{4} + 2 HCl$$

produces C₂F₄ or sometimes depicted as (CF₂)═(CF₂) aka tetrafluoroethylene which because of its reactive properties cannot be stored or transported, but instead must be immediately polymerized onsite for safety reasons. Using a process referred to as radical polymerization, the reactive TFE is combined with water and various initiators like disuccinic acid peroxide or ammonium persulfate to form PTFE. Other methods reported include decomposition of TFE by electric arc or by emulsion polymerization using peroxide initiators e.g. H₂O₂ (hydrogen peroxide) and ferrous sulphate.

Because of its ionized pedant moieties, the ionomer exhibits good electrical conductivity up to 0.2 S/cm depending on its fabrication and process thermal history where thinner layers are more conductive. Because of its hopping conduction mechanism, the material's conductivity strongly depends on both humidity and temperature. Aside from its electrical behavior, such ionomers also exhibit properties of high temperature stability up to 80° C., resistance to chemical attack, high permeability to both water and to gasses. Nafion films can be purchased in premade membrane sheet forms or molded from liquid dispersions or powders. The application of Nafion or other ionomers as a proton exchange membrane in a fuel cell requires both good electrical conductivity and mechanical rigidity. Overcoming the mechanical fragility of a thin ion exchange membrane represents a debilitating limitation on existing membrane fuel cells, a limitation addressed in greater degree in the subsequent section entitled “Membrane Strength.” Assuming for the moment the mechanical frailty problem can be overcome without limiting the membrane to thick PTFE firms as a substrate, then a wide variety of membrane options become feasible including bulk conduction PFSA layers with ultra-thin PTFE or without ant PTFE scaffolding in the active areas.

Accordingly, the membrane may be non-uniform, comprising a porous polymeric substrate such as PTFE coated with an thin ionomeric layer, typically less than 100 nm in thickness serving as the ion exchange medium. In one implementation a PTFA-coated PTFE or composite membranes uses a hydrophilized porous substrates such as PTFE treated by a hydrophilic solution of gallic acid with 3-trimethoxysilylpropyl and diethylenetriamine. Other hydrocarbon ionomers include sulfonated aromatic thermostable polymers, such as poly(ether-ketone), poly(ether-sulfone), poly(p-phenylene), and polybenzimidazole. Film formation from dispersions, powder, and pellets may occur in a contained chamber such as a mold tool and subsequently involve immersing, spraying, or coating the substrate in a PFSA solution or hydrophilic treatment.

In bulk conduction PEM based fuel cells fabricated in accordance with this invention, the conducting film may comprise an uniform ionomer bulk membrane such as PFSA perfluorinated sulfonic acid with either SSC short side chains or LSC long side chains of vinyl ethers. Material sources include dispersions, powder, and pellets. Film formation may occur in a contained chamber such as a mold tool. The microstructure of PFSA can be modified by physical, chemical, and physicochemical action used in polymer formation including treatment at different temperatures, humidity, mechanical loading, ultrasonic excitation, and doping. Aside from the sulfonate group —SO₃⁻ other hydrophilic radical able to attach to a hydrophobic fluorocarbon backbone include carboxylate —COO⁻ and the meta-phosphonate ligand —PO₂⁻.

The PEM membrane can also be modified to convert glucose into electrical energy. In one embodiment the membrane is used in an abiotic glucose fuel cell or AGFC where abiotic catalysts such as metals, metal oxides, metal sulfides and carbon-based nanomaterials catalyze glucose oxidation. At the anode, in an acidic environment or near neutral pH glucose catalysis produces a set of two hydrogen ions (protons) and two electrons, along with gluconic acid as a reaction byproduct. Like a hydrogen PEM fuel cell the protons traverse the ion exchange membrane where at the cathode they combine with oxygen to form water in the cathode chamber.

In an alternative embodiment KOH is introduced into the anode together with glucose whereby the KOH dissociates into K⁺ and OH⁻ making the pH of the anode reaction alkali. Unlike the acidic glucose reaction, at high pH levels the protons created by oxidation of glucose are immediately neutralized by the hydroxyl radicals producing water and leaving two ionized potassium cations 2K⁺. The cations and water then diffuse across the membrane where the water is reduced by oxygen back into OH⁻ which recombines with the ionized potassium K⁺ to produce potassium hydroxide as am effluent thereby maintaining charge neutrality.

In either case, Pt is the most widely reported abiotic catalyst for glucose but suffers limitations of catalyst poisoning of reaction byproducts. Non-platinum metals such as Au, Ag, Ni, PD, Co, Mn, alloys, metallic oxides, carbon-based materials and their composites may also be used as catalysts in both hydrogen and glucose fuel cells

An alterative to a PEM proton exchange membrane is the anion exchange membrane or AEM. Whereas PEM and other cation exchange membranes conduct current across the membrane using positively charged ions called cations, the AEM uses negatively charged ionized molecules such as hydroxyl radicals for transmembrane conduction. In a AEM anion exchange membrane based fuel cells, a solid semiporous membrane may comprise a polymer backbone and positively-charged cationic groups allowing for the passage of negatively charged ions through the membrane using the charge sensitive mechanism of hopping conduction. Connected by covalent bonds forming various atomic structures including block polymers, graft polymers, clustered polymers, comb shaped polymers, and quaternary structures containing ammonium cations, the AEM selectively enables anion conduction while suppressing proton conduction. Such membranes may comprise aliphatic or aromatic polymers such as poly(sulfone)s, poly(arylene-ether)s, poly(phenylene)s, poly(styrene)s, polypropylene, poly(phenylene-oxide)s, poly(olefin)s, poly(arylene piperidinium), and poly(biphenyl alkylene)s] with different cationic groups such as quaternary ammonium, guanidinium, imidazolium, pyridinium, tertiary sulfonium, spirocyclic quaternary ammonium, phosphonium, phosphatranium, phosphazenium, metal-cation, benzimidazolium, and pyrrolidinium.

AEM anion exchange membranes may also be used in glucose fuel cells. Membranes such as PVA polyvinyl alcohol and polysulfone (PS) may be used to transport OH⁻ anions generated by catalyst induced reduction of H₂O in the cathode. Upon entering the fuel cell anode the hydroxyl radical oxidizes the C₆H₁₂O₆ glucose molecule producing divalent carbonate CO₃²⁻ along with water and conduction electrons.

The state-of-the-art in forming AEM membranes is not at this time competitive to PEM membranes and Nafion films, in part because of the poor mobility of OH-anions in comparison to cation conduction, in part because the hydrophilic-hydrophobic microphase separation structure enabling cation conduction along a molecular surface of a PFSA-PTFE matrix is more mature than those involving anion transport. As anion film preparation is expected to technologically “catch up” with PEM membrane fabrication over the next decade, the embodiments made in accordance with this invention anticipate the use of either cation or and anion conducting films. Since many of the inventive features described herein do not rely on a specific membrane chemistry, the techniques as disclosed are agnostic to type of membrane employed in the fabricated fuel cell.

The chemistry of formation for PFSA polymers, PTFE substrate ionomers used in PEM membranes and of aliphatic or aromatic polymers in AEM membranes is considered in greater detail a related provisional application “Ion Exchange Membranes and Applications Thereof,” the specifics of which will not be analyzed further here.

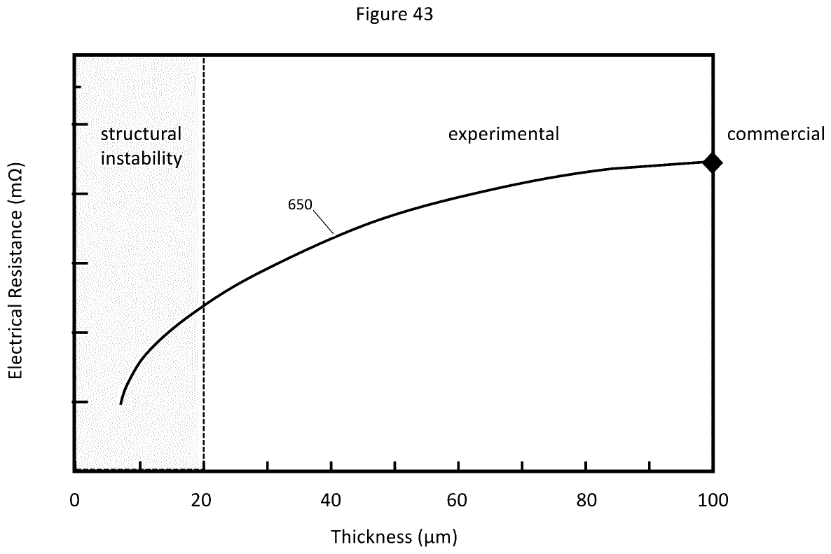

Membrane Strength. As depicted in FIG. 43, fabrication of Nafion films exhibits a substantial improvement in conductivity 650 below the commercially standard 100 μm thickness but suffers various forms of instability below 20 μm. To overcome the limitation of membrane instability, a heterogeneous ionomer is disclosed combining regions offering enhanced mechanical support along with the thinnest possible membrane for reducing resistance.

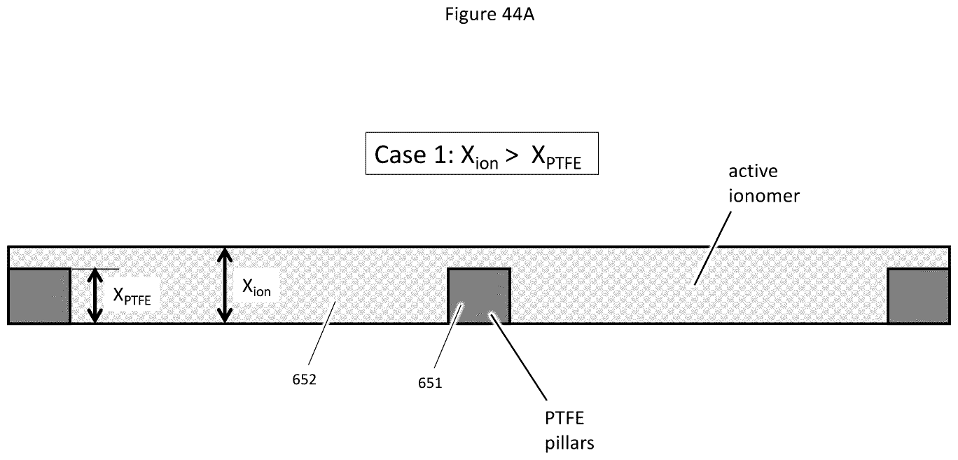

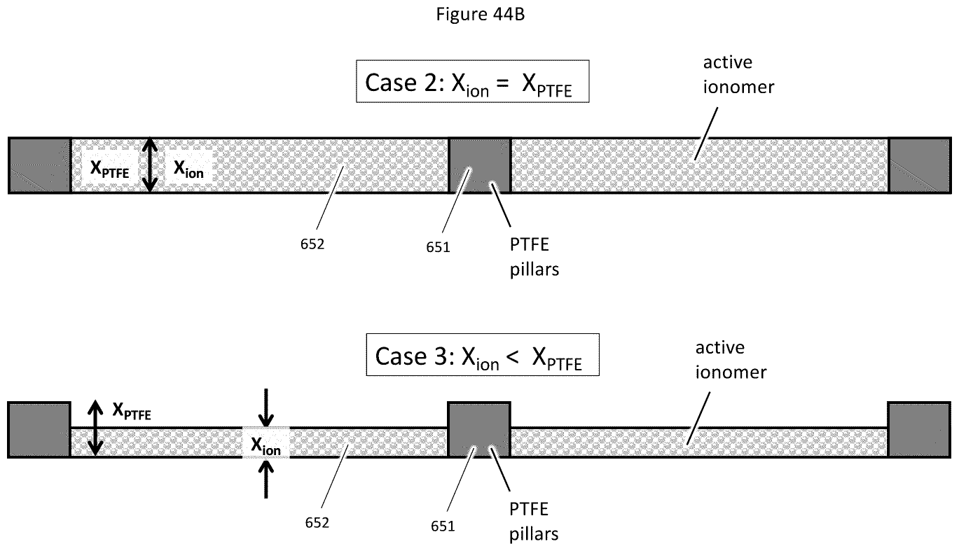

Examples of the heterogenous PEM include the over-mold process shown in FIG. 44A. In an over-mold labelled as Case 1, a skeletal backbone 650 comprising pre-molded reinforced pillars of PTFE and other structural support material such as carbon fiber or carbon nanotubes is molded within a chamber with an ionomer 652 such as Nafion where the thickness of the resulting ionomer Xᵢₒₙ is thicker than X_{PTFE} the height of the PTFE pillar, i.e. mathematically as Xᵢₒₙ>X_{PTFE}. Because the second mold compound covers and encases the first the resulting PEM is referred to as an over-molding process. In case 2 shown in FIG. 44B, a process of coplanar molding results in a uniform thickness PEM where the height of both the pillars 651 and the ionomer 652 are precisely equal, or Xᵢₒₙ=X_{PTFE}. In Case 3, when Xᵢₒₙ<X_{PTFE} the ionomer 652 is thinned to a thickness below the pillar height 651. While this process produces the thinnest layers the resulting thickness is not as uniform as it is not physically constrained by the mold during molding, unless a second mold chaise is inserted between the pillars. Either way, the result is a nonplanar membrane, which renders MEA assembly more challenging.

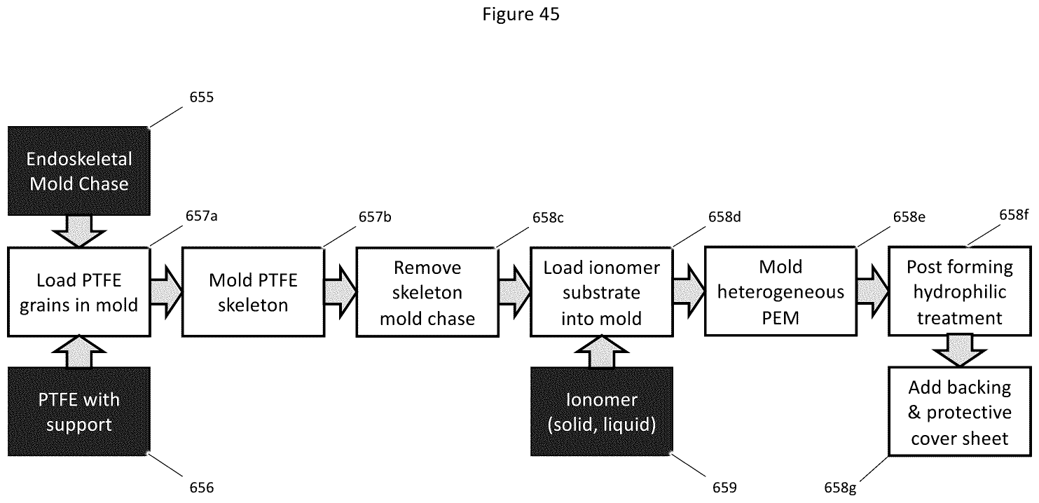

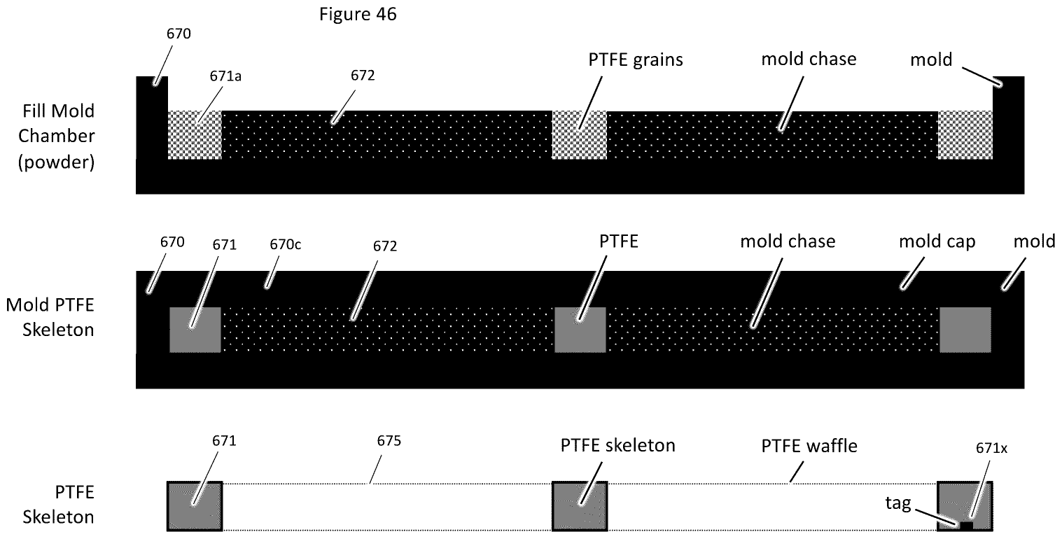

The process for fabricating a PTFE reinforced heterogeneous PEM is illustrated in the flowchart of FIG. 45 where a mold cavity is loaded with a mold chase 635 reducing the cavity volume and defining the PTFE support skeleton, and with PTFE powder. To reinforce the pillar strength, the PTFE powder 636 may be mixed with any high temperature fiber material or with carbon compounds including graphite, carbon nanotubes, or diamond powder, a waste product of industrial diamond production. The first step 637a in the process “load PTFE grains in mold” is shown in uppermost cross section of FIG. 46 illustrating mold chamber 670, mold chase 671, and composite PTFE grains 671a.

The second step 637b of the process “mold PTFE skeleton” is illustrated in the middle cross section on the same figure illustrating mold chamber 671 and mold chase 672 sealed by mold cap 670c acting as a lid to constrain the PTFE powder where under pressure or elevated temperatures melts or agglomerates into a sold TPFE forming PTFE skeleton 671.

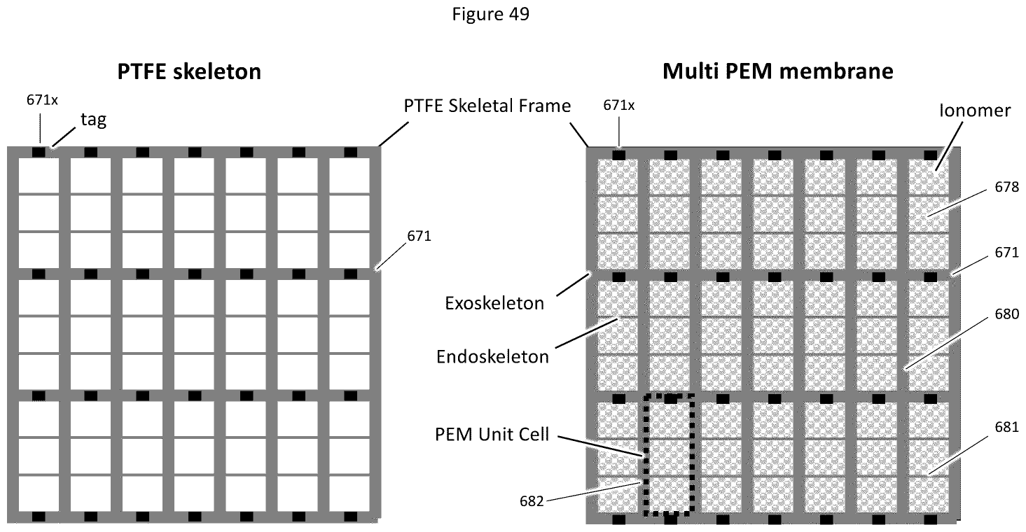

In step 658c removing skeleton 671 from the mold results in the third cross section labelled as a PTFE waffle 675 because of its waffle like pattern as depicted in the left side plan view labelled skeletal frame of PTFE skeleton 671 in FIG. 49. During this step, one side of the skeleton may be tagged by a laser mark 671x or some other identifier. The tag is needed for symmetric catalyst coated membranes where the cathode and anode catalyst layers must be distinguishable during fabrication to ensure the membranes are later inserted into the assembly in their proper orientation. The tag may comprise and indentation, or may include a light activated fluorescent compound. It may be located along either the exoskeletal pillars of on a connecting frame used during handling.

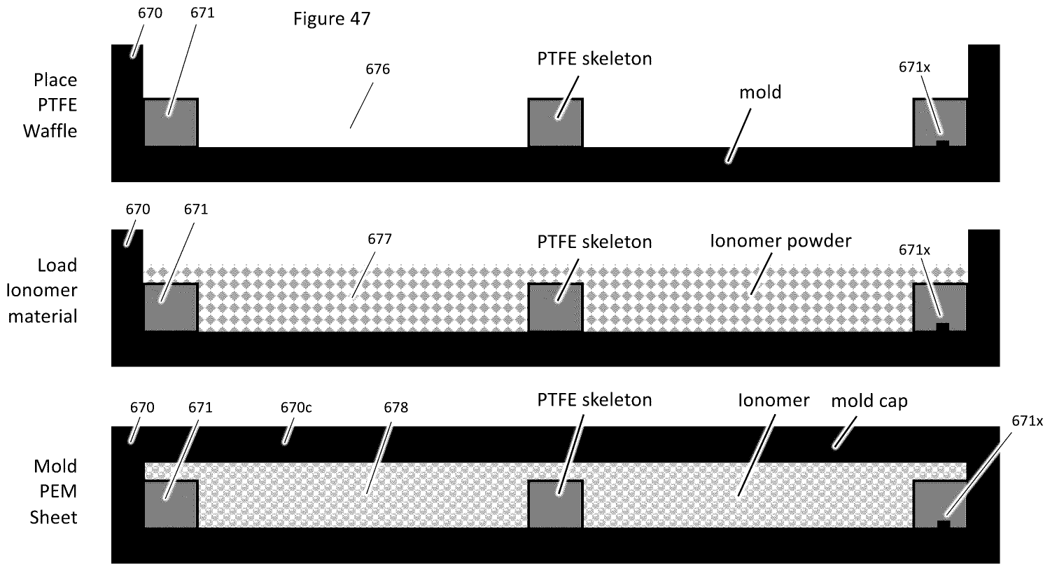

Returning to the process flow of FIG. 45, the next step 658d “load ionomer into mold” involves placing the waffle shaped endoskeleton 671 structure into mold 670 as shown in the top cross section of FIG. 47, then filling empty portions 676 of the mold 670 with the ionomer material 677 either in liquid or powder form 659 as depicted in the middle drawing. In step 658e “mold heterogenous PEM” the material is heating, typically using RF heating, and simultaneously compressed to create the heterogenous PEM membrane as shown in the lower drawing of FIG. 47 illustrated by mold chamber 670 with mod cap 670c containing PTFE endoskeleton 671 and polymerized ionomer 678. In step 638f, the resulting film is treated to maximize electrical conduction and selectivity using a hydrophilic solution.

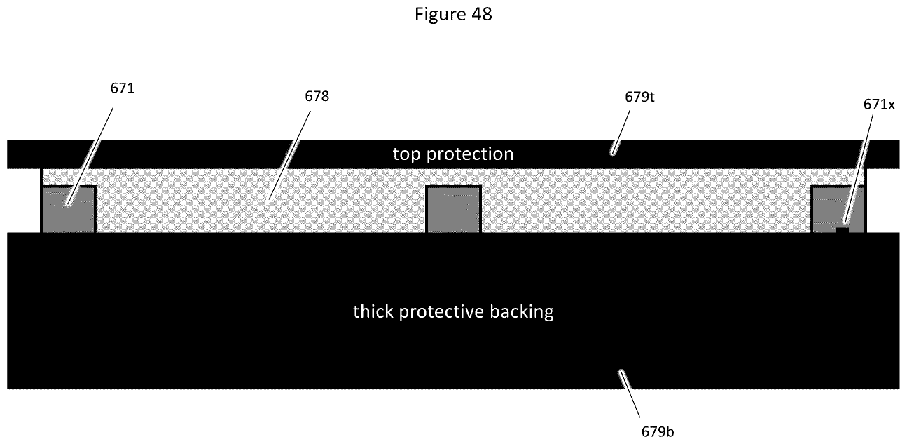

The last step 658g in the flow chart of FIG. 45, entitled “Add backing & protective cover sheet,” is illustrated in FIG. 48 whereby thick protective backing 669b is adhesively attached to the back of the fabricated heterogenous membrane comprising polymerized ionomer 678 and PTFE endoskeleton 671. The top portion of the membrane is then scratch protected by a thin layer of top protection 679t.

The results of this process is a sheet comprising a thin ionomer 678 supported by reinforced PTFE pillars arranged in a grid pattern as shown in the right side drawing of FIG. 49 entitled “Multi PEM Membrane”. The skeletal grid 671 comprises two widths of PTFE pillars—thick stripes labelled as PEM exoskeleton 680, and thinner stripes labelled as the PEM endoskeleton 681. The exoskeletal 680 stripes define the borders of separate PEM membranes which later in the fabrication process are cut to separate, i.e. “singulate”, the PEM membranes into individual pieces. A PEM unit cell 682 is therefore defined by the edges and intersections of an exoskeletal 680 matrix comprising thin ionomer 678 internally supported by endoskeleton 681.

Using this method, the fabrication of one PEM membrane sheet produces a large number of PEM membranes. For example, depending on its aspect ratio a sheet of 40 cm² fuel cells may produce 1,700 PEM units yet still fit within a 300 cm diameter circle, sizes compatible with state of the art manufacturing devices.

Using this methodology and PEM design, PEM manufacturing can be considered as a batch process and not limited to the low throughput of conventional assembly based manufacturing. Irrespective of type of polymer used for the ionomer, the disclosed manufacturing process reduces manufacturing costs via batch processing, improves strength of the PEM membrane, and reduces handling induced damage. Critically the formation of skeletal support for a PEM or AEM membrane enable ultra-thin layers to be handled without damage, finally rendering the manufacturing of ion exchange membrane a viable option for mass production.

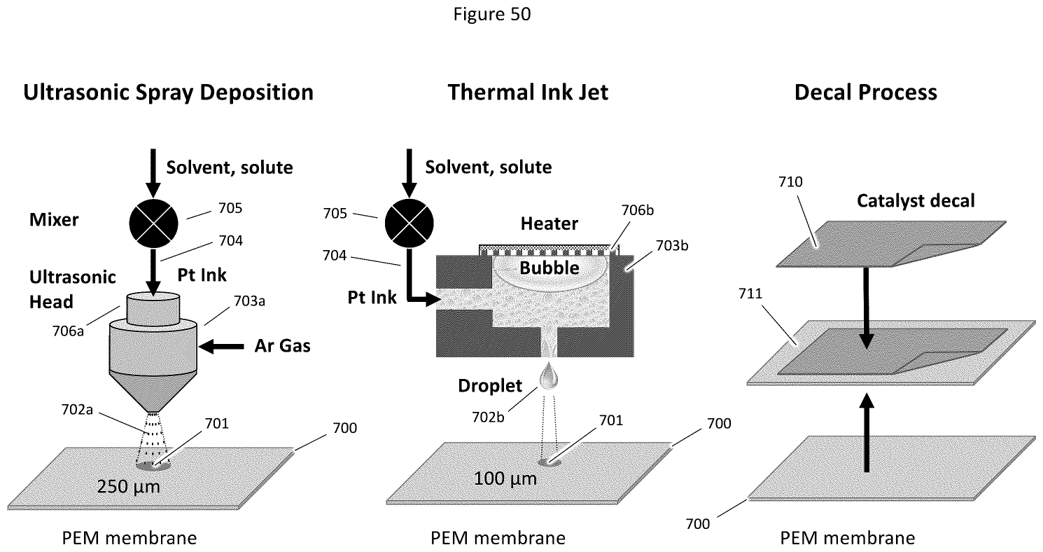

Catalyst Layer (CL) Formation. The formation of the catalyst layer on the PEM membrane is a critical component of a fuel cell yet conventional fabrication methods summarized in FIG. 50 such as printing, painting, brushing, and decal adhesion suffer innumerable deficiencies causing uncontrollable variability in PEM electrical performance. One form of printing shown in the left-side schematic involves ultrasonic spray deposition where a Pt laden catalyst solute is combined with a solvent in mixer 705, then the Pt ink transported 704 into reservoir 706a within ultrasonic head 703a. In operation the Pt ink is combined with argon gas to create ultrasonic spray 702a depositing catalyst 701 onto PEM membrane 700. Challenges with platinum ink ultrasonic printing include poor uniformity, changing concentrations, controlling viscosity if the ink, ensuring the solute and solvent remain well mixed, long print times, and low manufacturing throughput. Especially problematic, with a small spot size of only 250 μm in diameter covering the entirety of PEM membrane 700 is a slow and arduous process.

Another Pt ink print method involves thermal printing as shown in the center schematic representation of FIG. 50. As shown, Pt laden catalyst solute is combined with a solvent in mixer 705 then the Pt ink is transported 704 into thermal head 703b, where heater 706b creates a bubble within the printhead chamber pushing droplet 702b onto PEM membrane 700. Because of surface tension droplets 702b are small covering an area 701 smaller of only 100 μm in diameter, even less than ultrasonic painting. Worse yet, because the paint Pt concentration in solution is a function of temperature, heating to propel the ink onto the membrane surface affects the solution concentration causing added variability in the stoichiometry of the printed film. A significant challenge in CL formation using printing is inconsistent stoichiometry if the deposited layer. Because most such methods start with a solute suspension in a solvent, small changes in temperature, mixing, and flow rate can produce dramatic changes in film composition.

A third method to form a catalyst layer on a PEM membrane involves a decal process, manually attaching a prefabricated sheet of catalyst material called a decal 710 onto PEM membrane 700 to form attached catalyst region 711 held in place by coulombic forces into annealed in place. As a manual operation the decal process, while convenient for research labs, in not manufacturing worthy or reproducible.

In all the cases shown whether by printing or decal transfer a huge source of PEM variability is interfacial impurities and the present of interfacial charges. While the semiconductor industry fought over a decade to eliminate the effects surface adsorbed impurities and Q_{SS}, surface state charge, the fuel cell industry is largely ignorant of such influences, pretending they do not exist. Liquid cleaning in solvents and deionized water produce do not removing surface debris or ensure an interface free of surface state charge.

Finally, because the catalyst layer forms a bridge between the electrically active ionomer membrane and the carbon rich gas diffusion layer, no one material can satisfy the optimum requirements for minimizing contact potential while maximizing catalytic activity. Implications of this restriction is that the CL layer should either comprise a graded composition or a bilayer sandwich structure. Printing cannot even produce such a graded material. A CL bilayer by contrast would involve ceasing platinum ink printing mid-process the changing ink composition and restating the process not only adding time and lowering throughput but creating another interfacial layer to contend with.

Given the foregoing requirements, application of the CL is best performed using a precision deposition method repurposed from the semiconductor industry. While chemical vapor deposition (CVD) is theoretically possible, the complex blend of components in the catalyst layer each with different evaporation temperatures means controlling the individual vapor pressures to manage the deposition stoichiometry is challenging at best, if not impossible to regulate.

Instead of printing or decal methods, as disclosed herein the most appropriate process for CL catalyst layer formation is to employ sputtering to deposit the CL onto the PEM membrane with precise stoichiometry and superior uniformity. Unlike chemical vapor deposition which in involves a heterogenous gas phase reaction, sputtering is purely a mass transfer process using the momentum of large ions to knock atoms of materials to be deposited. Because deposition does not rely on heating or evaporation, there is no change in the relative composition of a deposited film due to gas phase partial pressure of the reaction products. Instead, statistics ensures the composition of the deposited film is precisely matched to the source from whence it came.

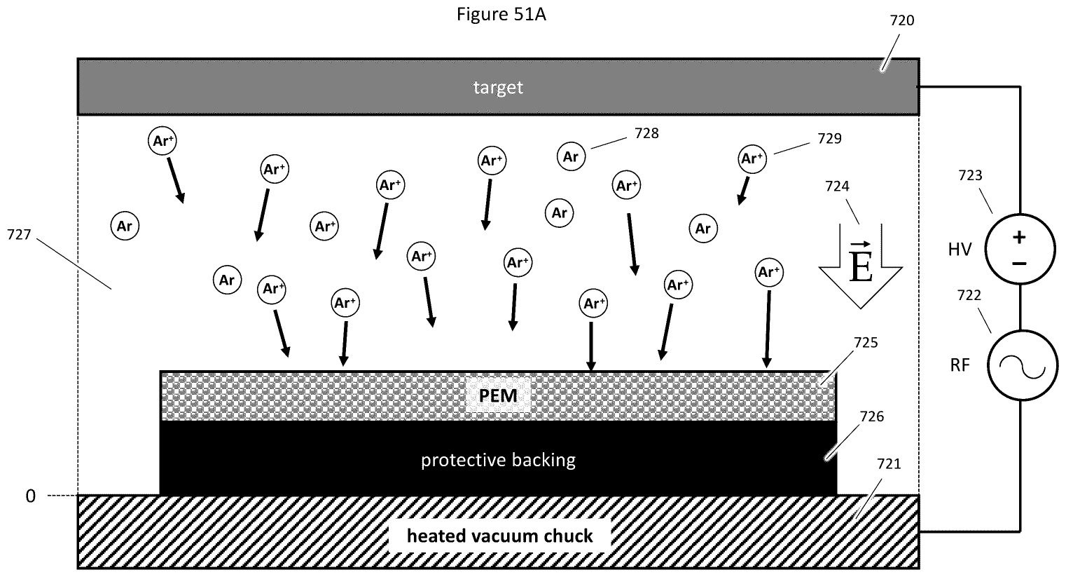

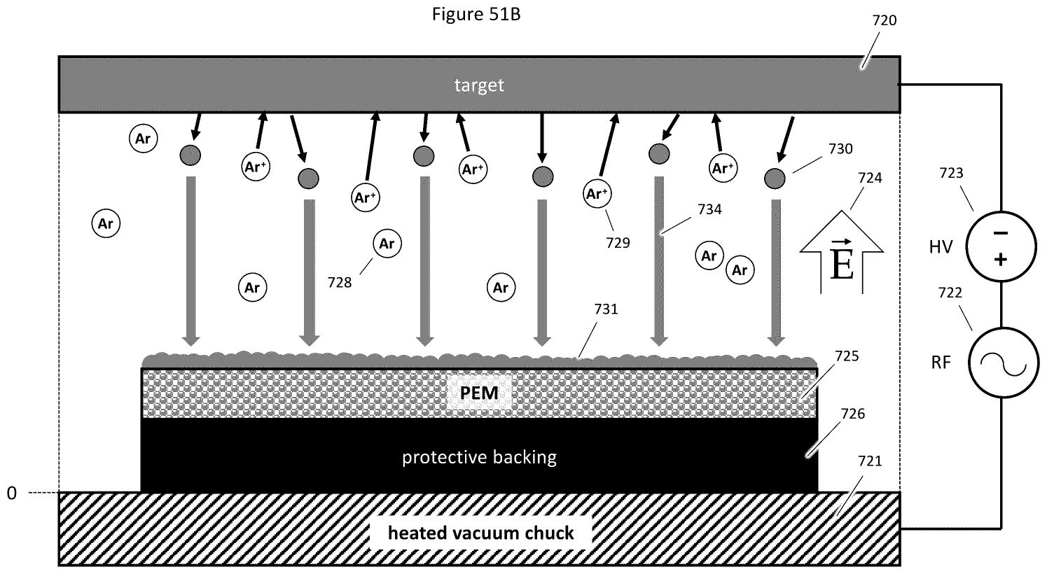

In this particular case, the sputtered layer is the catalyst coating layer comprising a blend of platinum, carbon, TiO₂ and other materials onto the PEM membrane material dislodged from a prefabricated “target” material. As depicted in FIG. 51A and FIG. 51B, the process of sputtering involves creating a gas plasma of ionized argon 729 in a chamber with an RF power source 722 and then accelerating the positively charged argon ions by a DC electric field 724 powered by a high voltage power supply 723. The disclosed process involves two sequential phases performed in situ in the same reactor without interruption.

Prior to commencing deposition the PEM surface should be cleaned removing surface contaminants. To perform surface cleaning in the sputtering chamber the DC electric field polarity is reversed. As shown in FIG. 51A, RF source 722 ionizes the argon atoms 728 into positively charged argon ions 728. Mounted atop heated vacuum chuck 721 is PEM membrane 725 with protective backing 726 or optionally using a silicon wafer as a carrier for the PEM membrane. By biasing the substrate holding the PEM target to a negative potential, the positive charged argon ions accelerate toward the wafer chuck 721 bombarding the PEM layer 725 with argon ions. The mass transfer removes contaminants without chemically reacting with or otherwise degrading the ionomer layer of its surface.

Starting deposition of the catalyst layer immediately after in situ cleaning and without removing the wafer from the chamber, the interface between PEM and CL materials is pristine, eliminating oils, contaminants, inclusions, and other defects. The benefit of this pre-deposition treatment is substantial reducing interfacial resistance, minimizing surface state charge, and eliminating any contact potential between dissimilar materials.

After in situ sputter cleaning, the polarity of high-voltage DC supply 723 is reversed flipping the direction of electric field 724 by 180° in which case argon ions 729 accelerate into target 720 dislodging target atoms 730. As shown in FIG. 51B the accelerated argon ions collide with target 720 transferring their momentum breaking the atoms from the target surface, raining down on the deposition layer. Through gravitational force and atomic ricochets, the target's atoms rain down onto PEM layer 725 forming deposited catalyst layer 731 in the precise predefined blend of the elements and molecules of target 720. Although sputtering may employ a single target of uniform composition, it is also possible to grade the deposited CL layer either by using a target with a graded stoichiometry or to employ co-sputtering from two targets of differing composition.

In co-sputtering, the two target materials can be deposited in sequence or concurrently while adjusting the deposited blend in a controlled gradation. Gradual grading of CL component concentrations also reduces polarization and contact potential related losses. Likewise graded concentrations reduces mechanical stresses and diminishes temperature coefficient of expansion induced stress cracks and wear-out mechanisms during cycling.

The deposited film may include catalysts such as platinum, ruthenium, or palladium, along with carbon, and other materials such as boron nitride which impede the diffusion of carbon monoxide (CO) into the membrane. Alternatively, titanium dioxide may be included in the cathode catalyst layer to further enhance oxygen reduction reaction (ORR) rate and reduce ORR limitations on conduction. Ruthenium may also used to reduce methanol crossover in DMFCs.

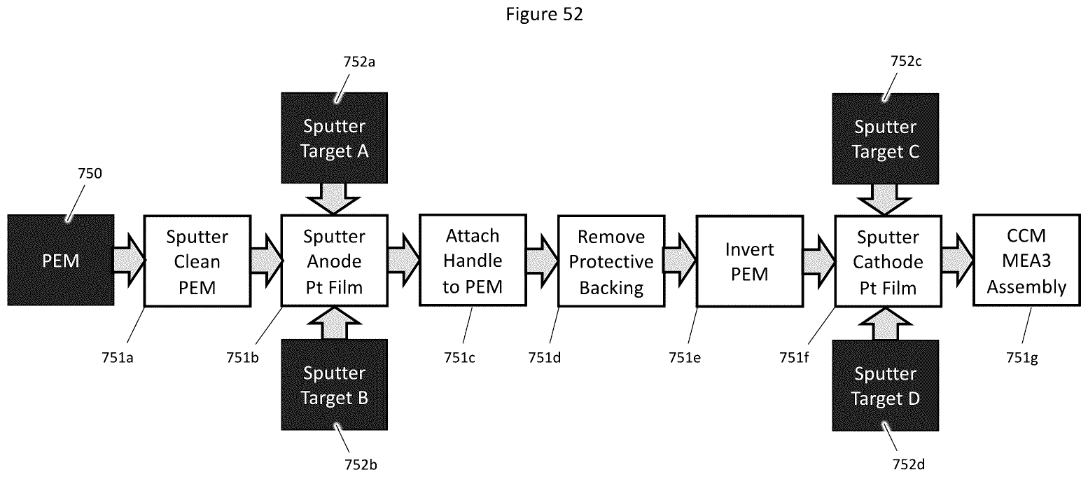

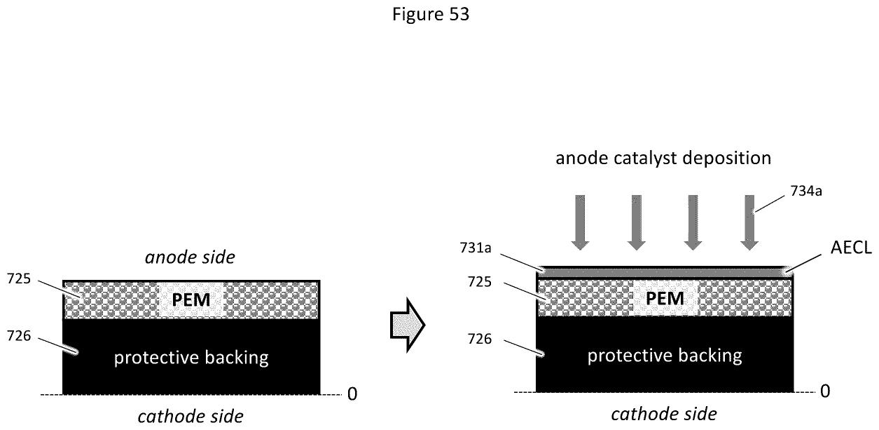

In an exemplary process made in accordance with this invention, FIG. 52 illustrates a flow chart depicting the sequence of steps to fabricate a CCM cathode coated membrane, also referred to as a MEA3 three-layer membrane electrode assembly. Starting with MPE starting material step 750 shown in the left side cross section of FIG. 53, PEM membrane 725 is placed on wafer chuck cathode side and protective backing 726 pointed down and its PEM membrane anode side exposed, pointed up into the sputter chamber with it protective layer removed. In step 751a, the anode side of the PEM membrane is cleaned of surface contaminants using sputter etching followed anode sputter deposition step 751b. In this step shown in the right side cross section of the aforementioned FIG. 53, anode catalyst material is sputtered 735a onto the anode side of PEM 725 forming the anode electrode catalyst layer labelled by its acronym AECL 731a. The layer may be formed by sputtering a composite catalyst material from a single sputter A-target 752a or by co-sputtering material from A-target 752a and B-target 752b of dissimilar composition.

Using sputter deposition from one or two targets to form the catalyst layer atop a PEM membrane, process control facilitates a myriad of films. By adjusting the catalyst layer deposition conditions, the CL layer's composition, grain size, gas diffusivity, interfacial charge, and contact potential can be modulated impacting various electrical parameters including cell voltage, polarization voltage, DC membrane resistance, AC impedance, transient response, as well as fuel cell efficiency, humidity dependence, temperature dependence, and gas pressure response.

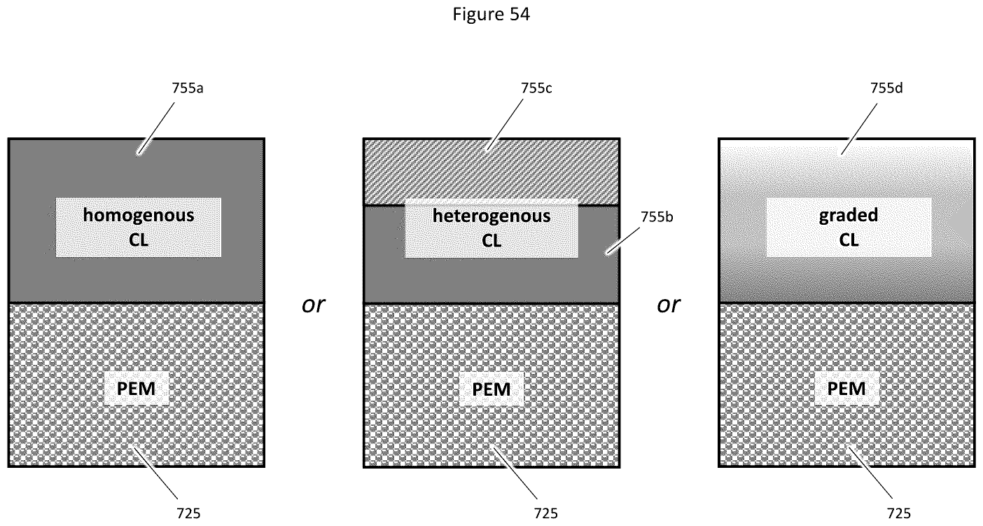

The CL deposition may occur sequentially or concurrently at different rates based on the DC accelerating bias in the sputter device. In one embodiment the first layer deposited from A-target 752a comprises a platinum rich compound mixed with the ionomer and a low percentage of carbon followed by deposition from B-target 752b. For example, B-target 752b may comprise a low molar weight of platinum mixed with a higher molar fraction of carbon. Transition from the A-target to the B-target may occur abruptly or transition gradually over a period of minutes during which both targets are concurrently sputtered producing a transition comprising a mix of platinum, ionomer, and carbon. Exemplary films deposited as the ACEL anode electrode catalyst layer atop PEM membrane 725 are shown FIG. 54 include a homogenous CL 755a, a heterogenous CL 753c, and a graded CL 753d.

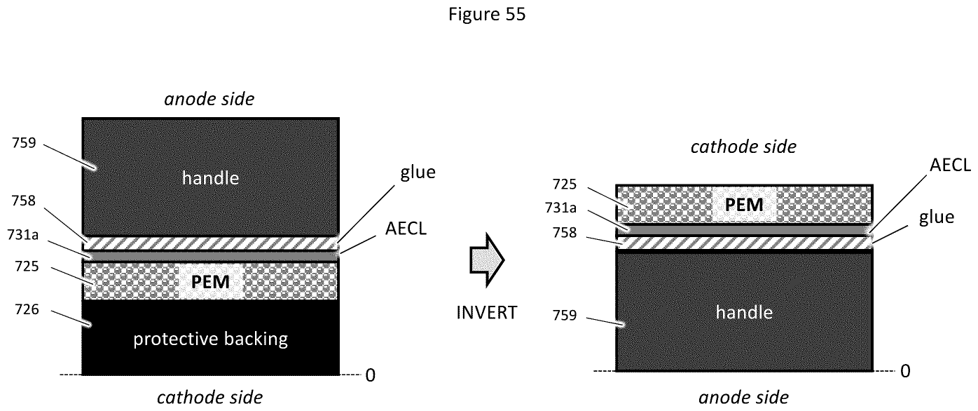

The next step 751c in the flow chart of FIG. 52 involves attaching handle 759 comprising a thick polymer film, silicon wafer or other rigid material to provide mechanical support to the sandwich comprising AECL 751a and PEM membrane 725 for subsequent processing. The layer may be attached using adhesive 758 as shown in the left side cross section of FIG. 55 followed by step 751d where protective backing 726 is subsequently removed. In step 751e, the entire structure is then inverted as shown in the right side cross section of FIG. 55, thereby exposed the unprotected cathode side of PEM 725 to the sputter chamber.

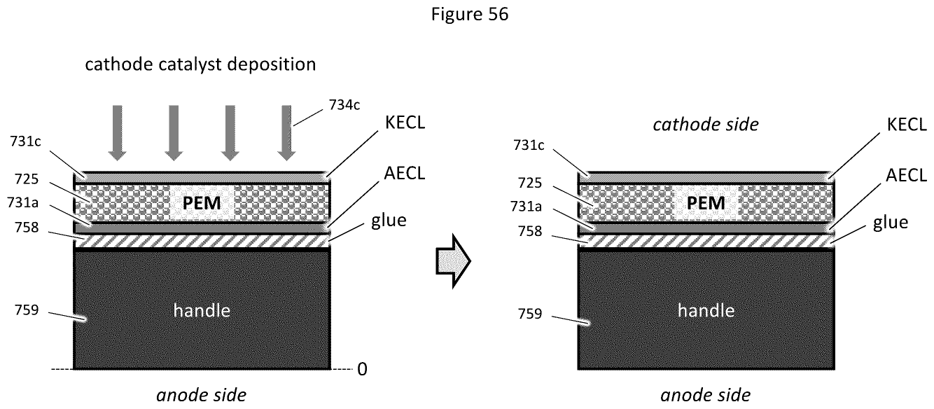

Once inverted in step 751f, sputter deposition of a cathode catalyst layer shown in the right cross section of FIG. 56 is performed comprising a combination of one or two sputter targets C-target 752c and D-target 752d. The cathode catalyst deposition 734c illustrated in FIG. 56 forms cathode electrode catalyst layer or KECL 731c which may be uniform, heterogenous, or graded in its constituent composition. Note in electronics vernacular dating back to vacuum tube era, the term cathode is generally abbreviated by the letter K (not the already overused letter C).

Returning to the flow chart of FIG. 52, cathode sputter deposition 751f involves sputtering sequentially from C-target 752c and D-target 752d. Comparing anode and cathode formation, while C-target 752c may comprise the same platinum loading and composition of A-target 752a, the stoichiometry of D-target 752d may differ altogether become the electrochemistry of reduction reaction occurring in the cathode chamber is uniquely distinct from the oxidative process of the anode. For example D-target 752a may comprise a low platinum loaded carbon film mixed with a metal oxide such as TiO₂. The gas porosity requirements of the cathode film also differ from the anode. For example, on the anode side the gas diffusant is hydrogen while on the cathode side the gasses are much larger, for example O₂ and H₂O vapor.

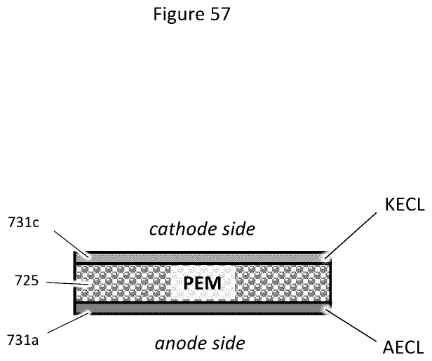

The right side cross section of FIG. 56 illustrates the cross section of the CCM sandwich immediately after KECL deposition. In the subsequent step 751g, adhesive 758 is dissolved removing handle 759. Once removed from handle The resulting PEM sandwich CCM as shown in the cross section FIG. 57 comprises PEM membrane 725 coated with a cathode electrode catalyst layer or KECL 731c and anode electrode catalyst layer or AECL 731a. The structure called a catalyst coated membrane or CCM forms the 3-layer core of the fuel cell also referred to as a membrane electrode assembly or MEA3.

Gas Diffusion Layer (GDL) Fabrication. To transport hydrogen and oxygen to the membrane catalyst interface and to remove oxygen and heat, two gas diffusion layers sandwich the MEA3. In addition to facilitating fluid and transport and heat conduction, the GDLs are responsible for conducting electric current. One material well suited for combing a porous structure with electrical conductivity is carbon in the form of graphite. Other candidates include carbon nanotubes and various composite materials. The problem with any material used to form the GDL, there is an intrinsic tradeoff between atoms carrying current and the pores carrying gasses. Increasing the pore size improves gas flow but increases electrical resistance.

Conversely smaller pores increase GDL surface contact area lowering contacting and simultaneously increase volume of electrical conducting atoms in the GDL matrix thereby reducing series resistance through the layer. Unfortunately smaller pores reduce gas transport limiting the hydrogen fuel supply arriving at the PEM interface and adversely impact the cathode's GDL from removing generated water from the cell. Present day fuel cells use uniform pore size GDLs selected to balance these two limiting effects. The result is high electrical resistance, a propensity for water logging and PEM membrane swelling, low cell voltages, and increased sensitivity of fuel cell performance to atmospheric humidity. Although experimental methods to produce a GDL with two sizes of pores exhibit improved performance, formation of a GDL by manually spraying or painting layers onto carbon paper are neither reproducible or manufacturable, as pore size depends on deposition rate, processing temperature, and stoichiometric solute concentration.

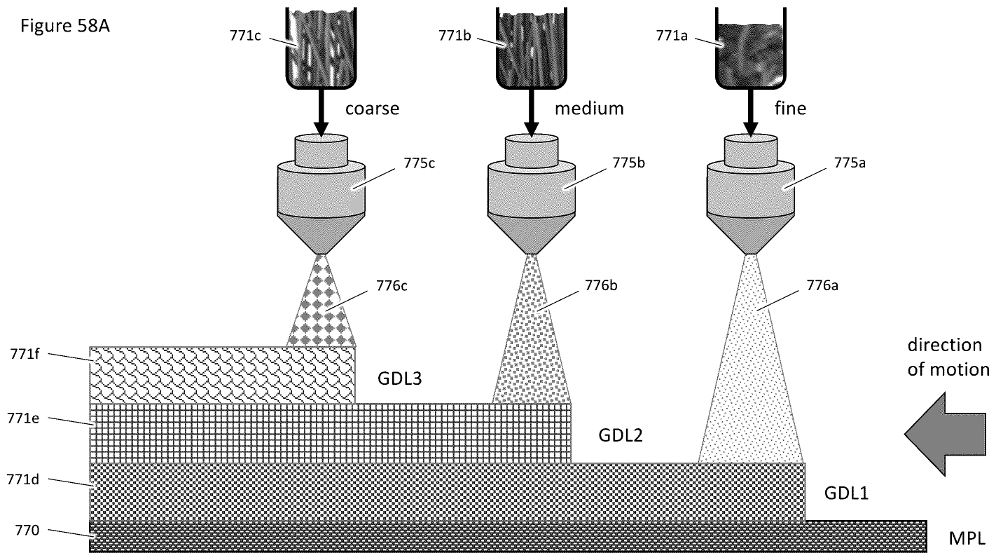

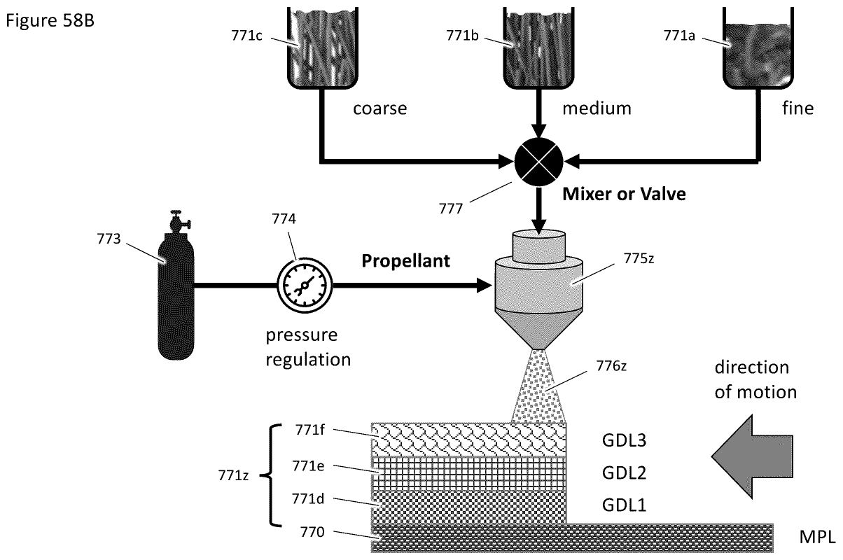

As disclosed herein, one method able to precisely control film thickness, stoichiometry and porosity of a multilayer carbon film involves the sequential deposition using a multi-head printer depicted schematically in FIG. 58A. During processing three sources of carbon 771a, 771b, and 771c with different degrees of granularity, namely fine, medium, and coarse respectively are deposited through print heads 775a, 775b, and 775c onto MPL carbon paper 770. The term MPL is referred to as a “micro-porous layer” indicating the size of the pores in the paper are smaller than one micron, typically 0.5-to-1.0 μm in diameter. In 2D printing the print head must scan back and forth as the carbon MPL paper is fed through the printer in the same manner an inkjet printerworks. Alternatively, the print head may comprise a continuous bar or a number of smaller print heads able to uniformly print the entire width of the paper in one pass eliminating the need for scanning the a single print head back and forth across the paper width.

In the case of linear motion of the carbon paper showed in FIG. 58A, the uncoated PMP carbon paper 770 is first coated by spray 776a with the material 771a to produce a deposited layer 771d comprising the least porous layer GDL1. As the paper advances areas already coated by GDL1 are next coated by spray 776b with the material 771b to produce a deposited layer 771e comprising the layer GDL2 of medium porosity. As the paper further advances, areas already coated by GDL2 are next coated by spray 776c with material 771c to producing deposited layer 771f comprising the porous layer GDL3.

Since the carbon paper advances at a steady pace producing each deposited layer to a specific thickness must account for the change in viscosity for the formulations 775a, 775b, and 775c each with different viscosities and carbon filler sizes. The deposition rate can be adjusted by varying the fluid pressure and flow rate. Another variable to be considered is the distance between the print head nozzle and the paper. As more layers are deposited not only does the GDL thickness increase but the gap between the print head and the paper decreases meaning the spot width from spray 776c is smaller than 776a. To maintain a uniform thickness the pressure and flow rate driving the printer head 775c must be greater than head 775b which must be higher than the pressure driving 776a in order to produce similar thickness assuming comparable viscosities. In this manner carbon growth can be adjusted dynamically producing a pore size increasing from layer GD1 to GDL2 to GDL3. Although the multiple head implementation can produce step changes in porosity the method cannot produce a smooth continuous gradation in pore size.

To produce a continuum in pore size requires blending, i.e. mixing 777 different carbon sources and spray them through a common spray nozzle. This sequential blended carbon coating method is shown in FIG. 58B where one print head 775z deposits some blend 776z of fine, medium, and coarse carbon coatings onto MPL carbon paper 770. In this process the print head remains above stationary position along the carbon paper until the full thickness of the GDL 771s is deposited. The layer may comprise discrete boundaries of compositions 771d, 771e, and 771f or may be continuously graded with no clear boundaries except between the deposited layer 771z and the MPL carbon paper 770. Precise deposition rates relies in pressure control 774 of propellant 773.

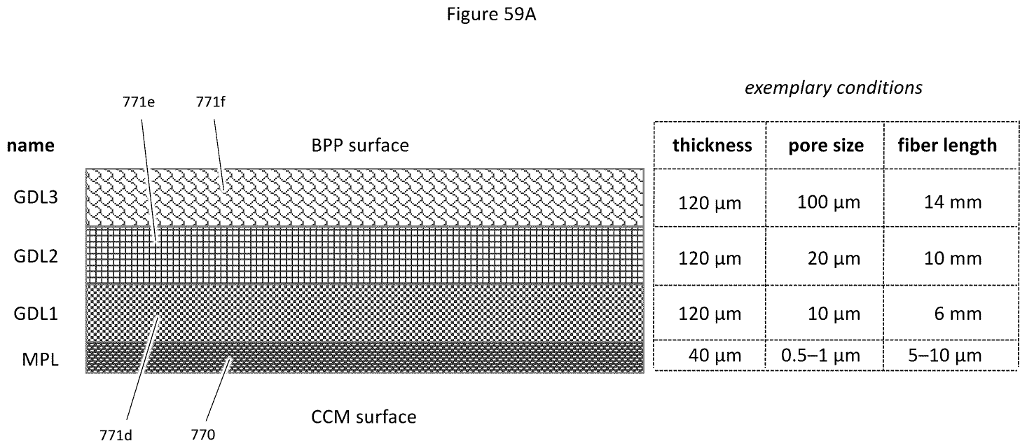

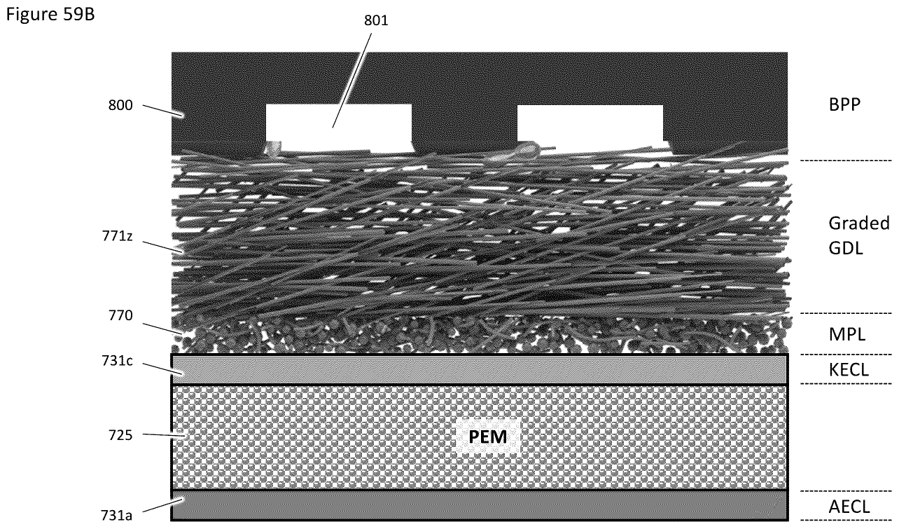

As depicted in schematic cross section of FIG. 59A, the size of the pores are graded from micron sizes at the GDL-to-CCM interface to macropores located at the top of the GDL adjacent to the bipolar layer and gas channels. The submicron pore size of the micropore layer 770 or MPL at the CCM interface maximizes contact area. Atop the MPL is a graded gas diffusion layer of varying pore sizes, For example the carbon paper may comprise a micropore layer 40 μm thick with pore sizes of 0.5 μm to 1.0 am. The surface area available for ohmic contact to the CCM is approximately 50%. Formed atop the MPL is the GDL1 of 120 am thickness containing 10 am pores followed by GDL2 comprising a 120 μm thick layer of 20 μm pores, covered by GDL3 comprising a 120 am layer with 100 μm sized pores. Alternatively the pore size gradation can be more gradual as represented by graded GDL layer 771z. The actual pore dimensions may vary depending on the process but in general represent a monotonic increase from MPL base 770 abutting the CCM core to the top of the composite GDL layers 771z adjacent to bipolar plate 800 and gas channel 801.

The resulting gradient in gas concentrations from varying the film pore size improves gas transport by introducing diffusion assisted transport offsetting some of the impact of the micropore interface. A four zone graded GDL structure although not continuous to be vastly superior to the uniform of uniform GDL atop the MPL demonstrated thus far. Five zone, six zone, or continuously graded pores are expected to further enhance fuel cell function and durability. Pore size can varied by charging the growth conditions and by changing the length of carbon fibers used in the film growth. For example the micropore layer is composed of fibers 5-to-10 μms in size while the three GDL layers range from 6 mm up to 14 mm. During deposition, the average length can be adjusted by controlling the blend of mix of the carbon fibers in a continuous process. For example 6 mm fibers are transitioned to 10 mm fibers by decreasing the flow rate of the shorter fiber and gradually increasing the longer fiber to replace it.

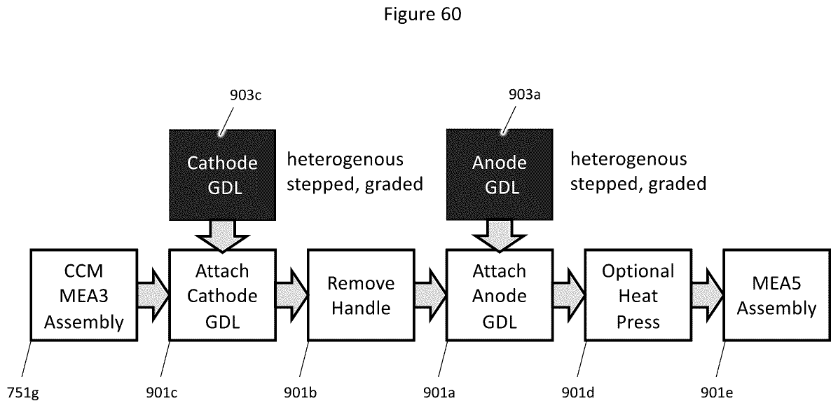

One the GDL is formed the film, a type of carbon paper, is then attached to the catalyst layer of the MEA3 core of the fuel cell. This process represents an assembly based process for attaching the GDL to the CCM as represented in the block diagram flow chart of FIG. 60. Step 751g represents the completed CCM or MEA3 assembly to subsequently sandwich between the cathode and anode GDL layers. The specific sequence, whether connecting the CCM to the anode side or cathode side GDL is not critical nor is the exemplary sequence intended to be limiting. Although the same GDL can be used for both anode and cathode sides of the CCM, in general the gases on the cathode side namely O₂ and H₂O are atomically larger than the H₂ gas feeding than anode. As such in one embodiment the pore sizes of the cathode size GDL are larger than that on the anode.

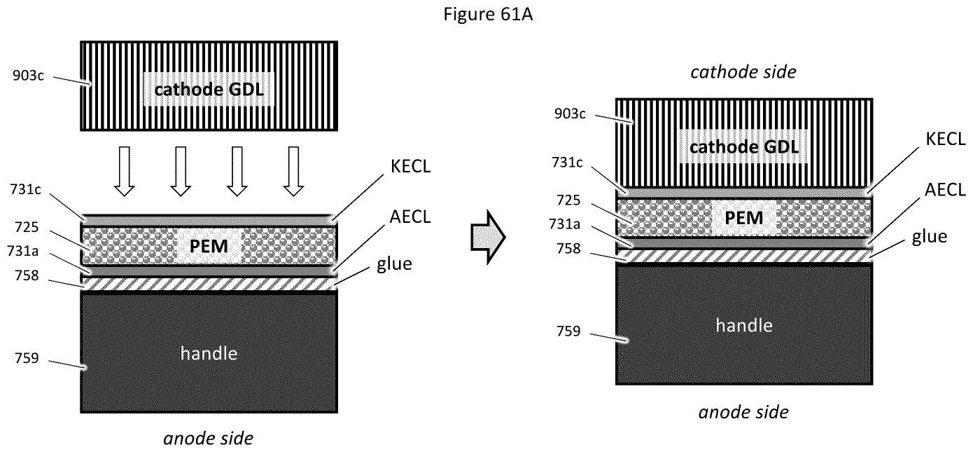

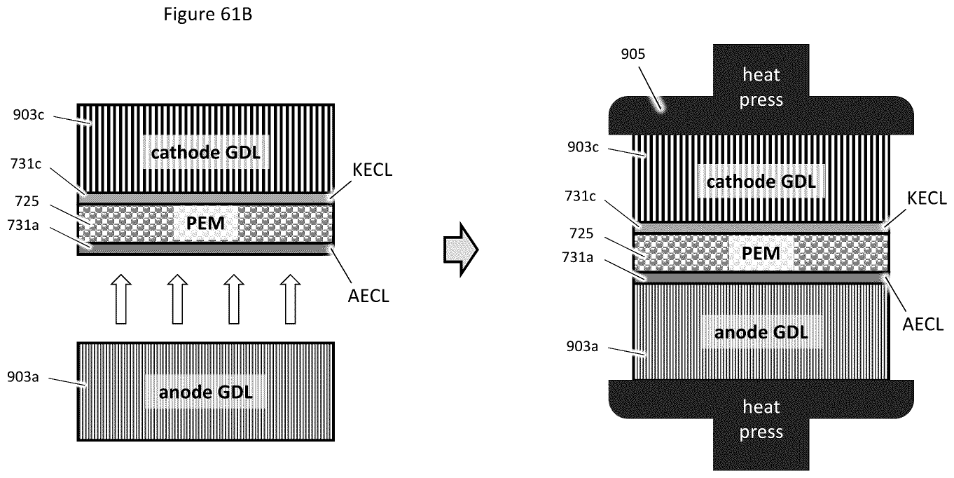

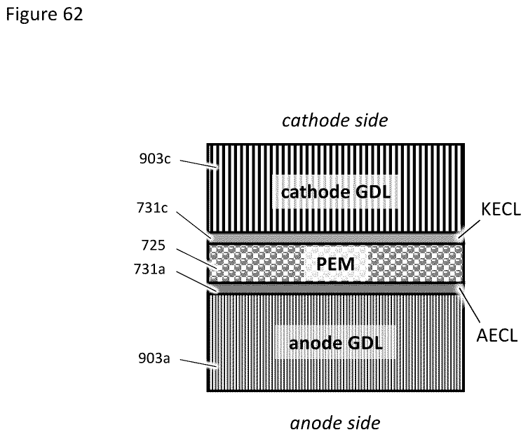

In one exemplary fabrication sequence shown by the process flow in FIG. 60, the cathode GDL component 903c is first attached in step 901c to the CCM component 751g. This process step is shown in the cross sections of FIG. 61A where cathode GDL 903c is attached to exposed surface of KECL 751c which is part of the CCM sandwich structure comprising KECL 751c, PEM membrane 725, and AECL 731a. For support during handling, the anode electrode catalyst layer 731a is attached to handle 759 by a temporary adhesive 758. Thereafter in step 901b the handle is removed and in step 901a the anode GDL 903a is attached to the opposite side of the CCM, followed by bonding 901d with a heat press to complete fabrication of MEA5 assembly 901e. This process is illustrated in FIG. 61B where once the handle is removed, anode GDL 903a is attached to the newly exposed bottom surface of AECL 731a where cathode GDL 903c provides added mechanical support to the CCM sandwich comprising KECL 731c, PEM 725, and AECL 731c. The right-side cross section illustrates pressure bonding using heated press 905 resulting in a completed MEA5 module shown in FIG. 62.

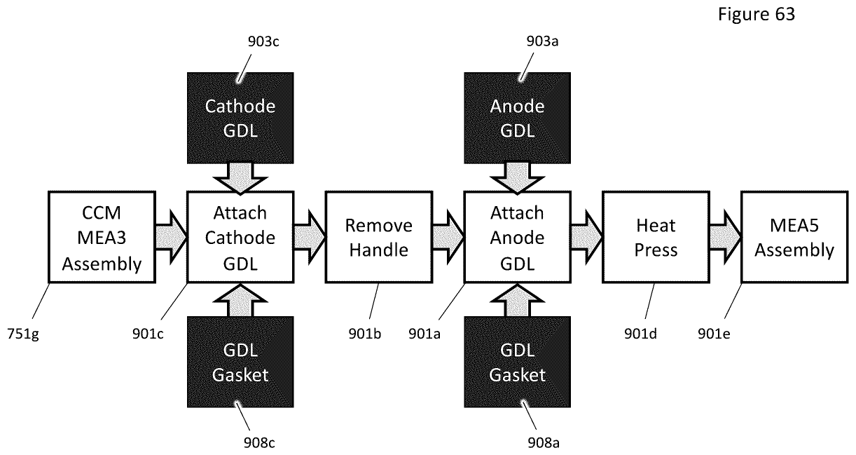

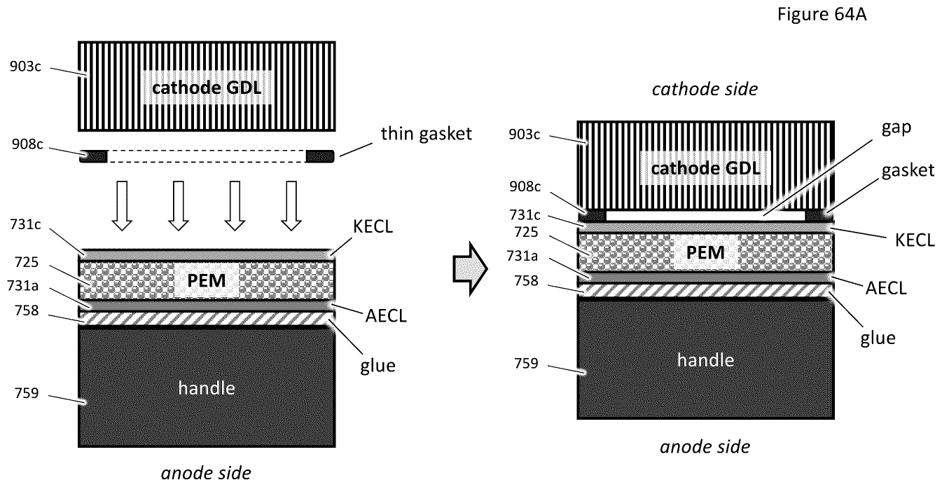

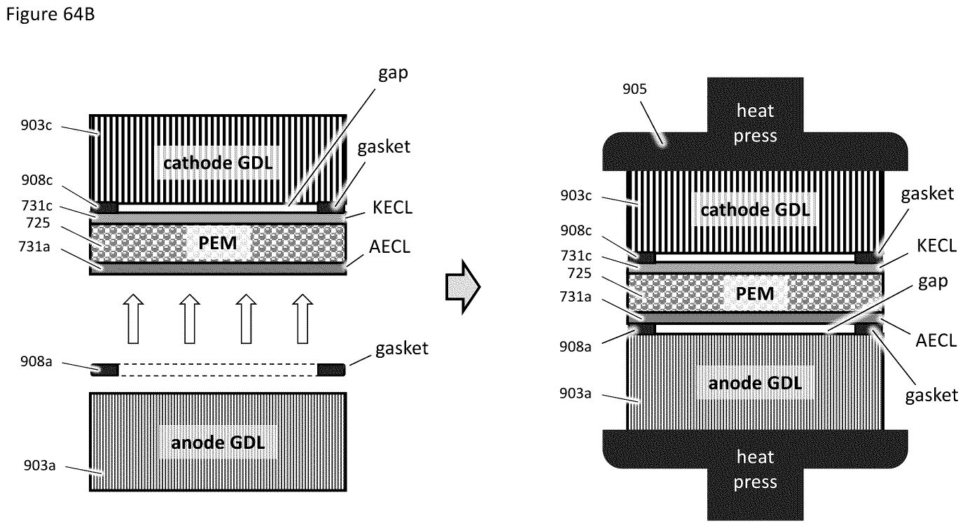

An alternate embodiment shown in FIG. 63 includes the addition of gaskets inserted between the CCM and the GDL to suppress gas leakage out the sides of the module. Specifically in the step “attach cathode GDL” 901c is modified to include GDL gasket component 908c. Similarly in step 901a the process “attach anode GDL” is modified to include GDL gasket component 908a. As shown in FIG. 64A, a “thin gasket” 908c is inserted between KECL 731c and cathode GDL 903c. In one embodiment gasket 908c, constructed of PTFE or silicone, must be very thin and compressible otherwise it will reduce the contact area between the CL layer and the conductive surfaces of the GDL increasing contact resistance. In FIG. 64B, a second gasket 908a is inserted between anode GDL 903a and AECL 731a followed by pressure heating to squeeze the GDL in contact with the CCM.

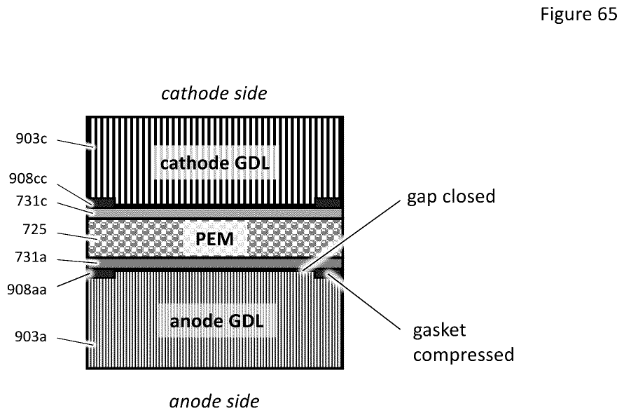

The process is sensitive as excessive force can damage the PEM. The resulting structure shown in FIG. 65 highlights the fact that in order to achieve good surface contact between the GDL and catalyst layers the gasket must be squeezed thin, thereby compressing the porous carbon in the GDL. As such anode gasket 908aa one compressed forcibly occupies part of the volume previously occupied by anode GDL 903a. Similarly cathode gasket 908cc one compressed forcibly occupies a portion of the volume previously occupied by cathode GDL 903c.

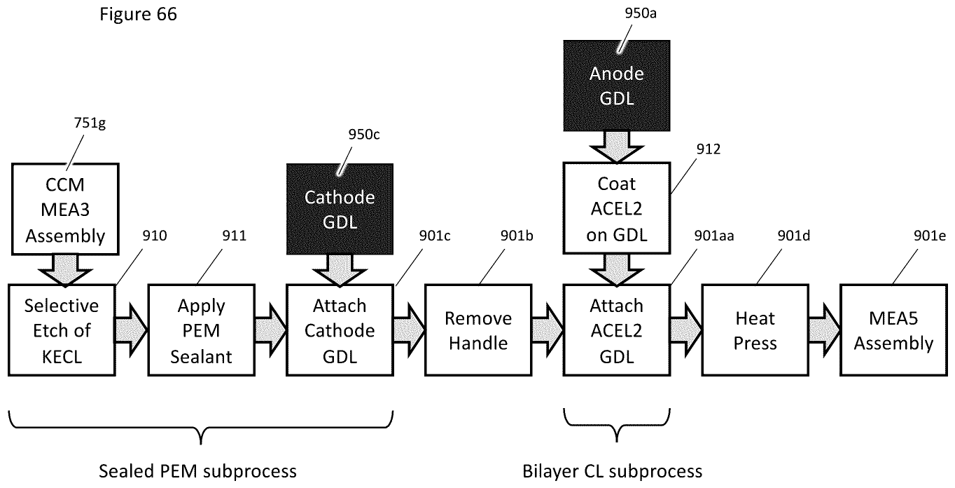

An alternative process disclosed herein and shown in the flow chart of FIG. 66 comprises two methods made in accordance with this invention, namely (i) a countersunk sealant process, and (ii) a bilayer CL contact process. The countersunk sealing process produces a sealant ring which functions like a gasket circumscribing the edge of the PEM CCM but without adding another component into the assembly process. The bilayer CL contact process minimizes cracking risks between the GDL and the CL layer of the MEA3 and thereby leakage therefrom by coating the GDL with the same CL material as used on the CCM. These two process steps may be applied independently or used in combination. They may be applied to either the anode or cathode sides of the CCM, or both. For brevity's sake in the example shown by the flow chart of FIG. 66, the PEM sealant process is applied to the cathode side of the PEM. The composite or bilayer CL process is used on the anode side. These examples are selected arbitrarily.

The countersunk sealing process produces a sealant ring which functions like a gasket circumscribing the edge of the PEM CCM but without adding another component into the assembly process. This process avoids the poor contact and damage risk of the aforementioned gasket process by replacing the catalyst layer selectively and replacing it with a sealant such as silicone, PTFE, or polyimide. The sealant material may comprise an organic like silicone or polyamide, a polymer like PTFE, a glue like epoxy, or a hard metal often referred to as a barrier metal impervious to gas transport such as titanium, tungsten, nickel or molybdenum.

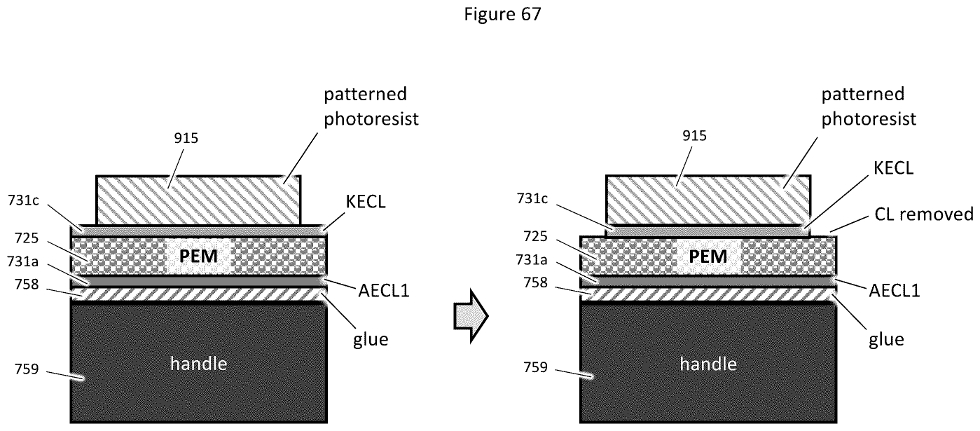

As shown the process commences with a selective etch step 910 of KECL 731c of CCM assembly 751g. As depicted in FIG. 67, the self sealing KECL process starts by coating the cathode side of the CCM with photoresist 915, soft baking it to stiffen it, then patterning the photoresist through an optical photomask and removing portions of the photoresist in the developing process much like developing photographic film. After developing the photoresist, the resist is hard baked using a higher temperature process to harden it against etching. Once hardened the metal catalyst layer 731c is etched away in the exposed portions preferably using a plasma etcher. After selectively removing the catalyst layer several methods may be used to apply the edge sealant. In some embodiments the photoresist is first removed before applying edge sealant. In other versions the photoresist remains in place and is later used to “lift off” deposited sealant in all regions except the sealant ring locations.

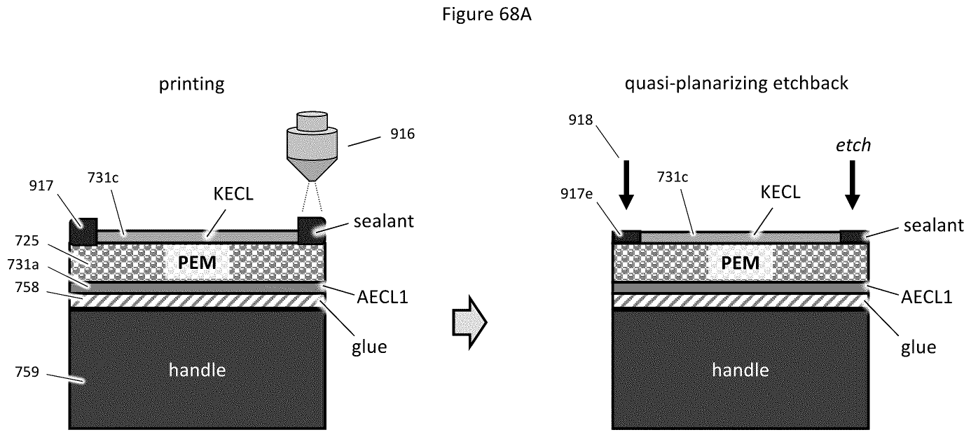

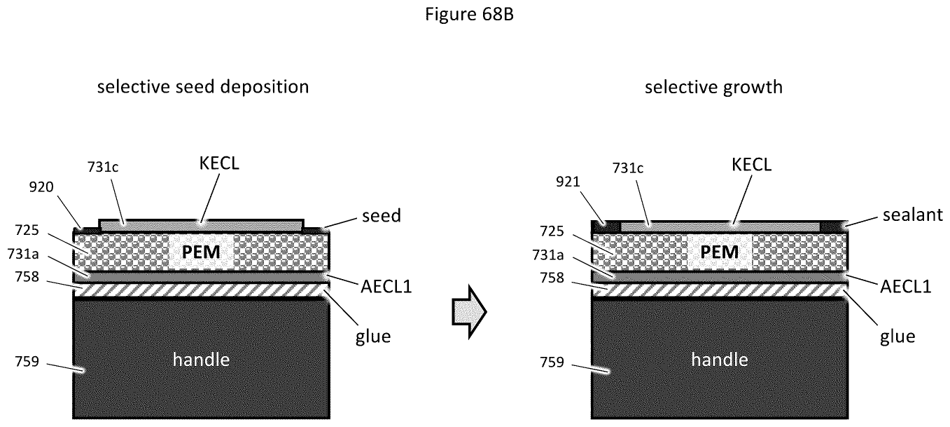

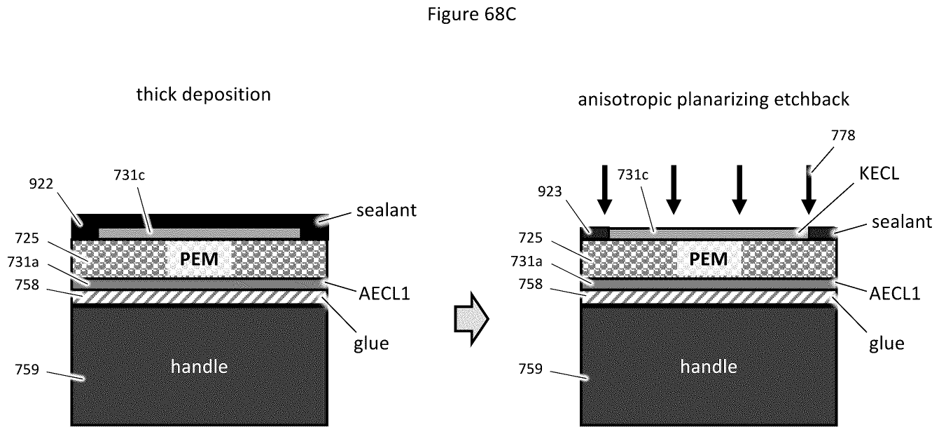

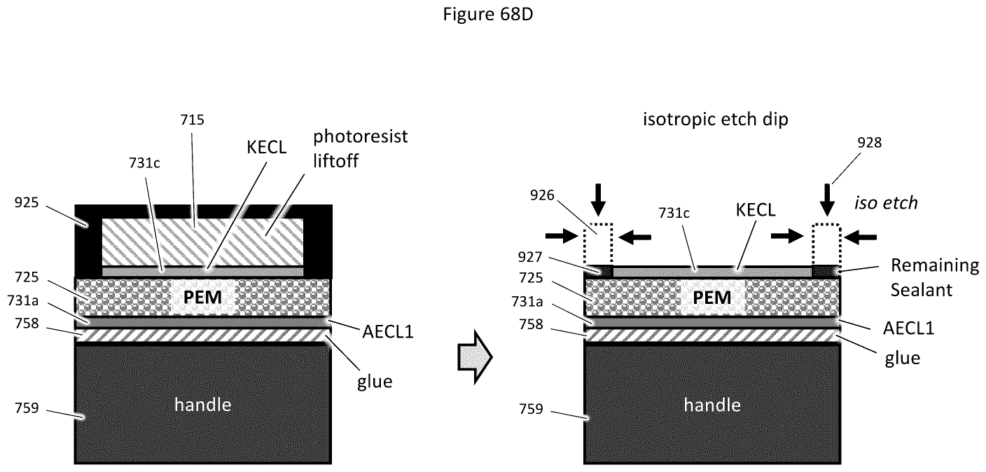

In one embodiment shown in FIG. 68A—the selective deposition process, photoresist 915 is first removed and the sealant material 917 is deposited only on the etched areas of KECL 731c using a printing or painting process 916. The deposited film may be “etched back” using any chemical or plasma so long that the etchant is selective and does not attack the exposed KECL layer. The resulting structure is essentially coplanar, where the post etchback height of the sealant 917e is the same as KECL 731c.

In another embodiment shown in FIG. 68B, photoresist 915 is first removed and a thin promoter layer 920 is deposited and then etched back. Because the indented areas fill in three dimensions the etchback removes the promoter layer over the flat areas of the KECL but not in the 3D windows where the KECL was previously removed. Alternatively photoresist 915 can remain in place during deposition of promoter layer 920 then lifted off by removing the photoresist. Regardless of the method used the resulting structure show in the left side cross section only leaves an promoter layer 920 as exposed seed material in defined windows. A sealant material or barrier metal 921 in then grown using an electroless plating process growing only in locations where the promoter seed is present. The thickness of sealant material or barrier metal 921 is gown to a final thickness coplanar with KECL 731c.

In another embodiment referred to as an “etchback process”, after removing photoresist 915 a thicker sealant material 922 is deposited uniformly across the entire PEM structure as shown in FIG. 68C. Because of 3D growth the indented areas fill and overflows the thickness of the film in the etched holes is greater than on flat surfaces provided that the hole is not too wide. During a planarizing etchback 778 the sealant is removed parallel to the surface until the remaining sealant 923 is coplanar with the top of the KECL layer 730c.

In yet another embodiment referred to as a “lift-off” process shown in FIG. 68D, the sealant material 925 is thickly deposited prior to stripping the photoresist 715. The deposited film normally breaks along the sidewall of the steep photoresist vertical edge. During removal of the photoresist any material on top of it washes away leaving only thin pillars 925 atop areas wherever the KECL was previously removed. An isotropic etch 928 etches these thin pillars from all sides removing them and leaving only sealant 927 in the KECL etch windows coplanar with the top of the catalyst layer KECL 731c.

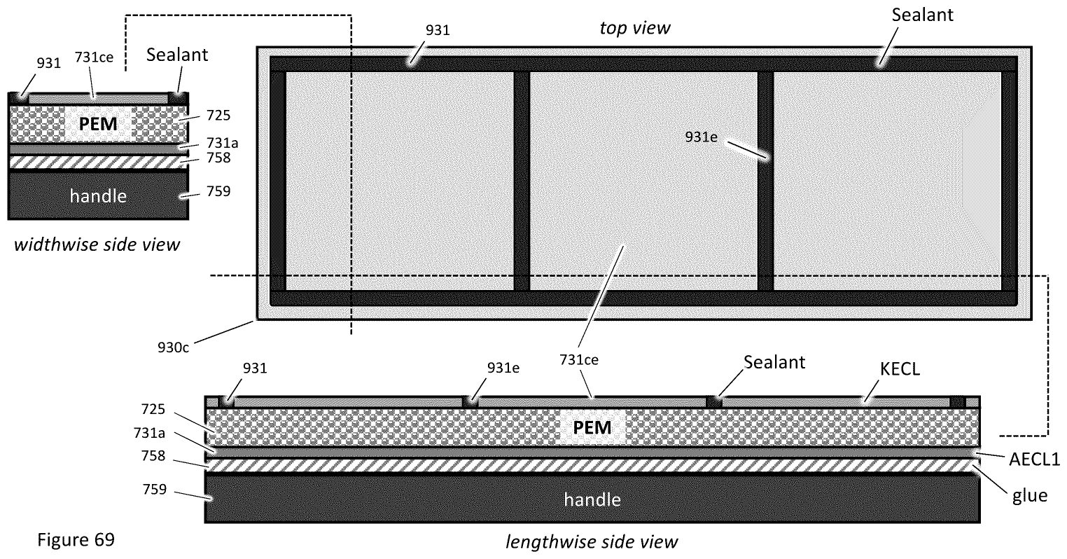

The location of the sealant is also not limited to the edge of the PEM but may cross the fuel cell to provide added mechanical rigidity as shown in the top view and in length-wise and width-wise side views of FIG. 69. As shown, sealant 931 circumscribes the PEM membrane 780c but may also includes endoskeletal cross bars 931e, subdividing the KECL into separate islands 731ce. The sealant process can be performed on a single PEM layer but is most cost efficient to be performed on a PEM sheet prior to singulation.

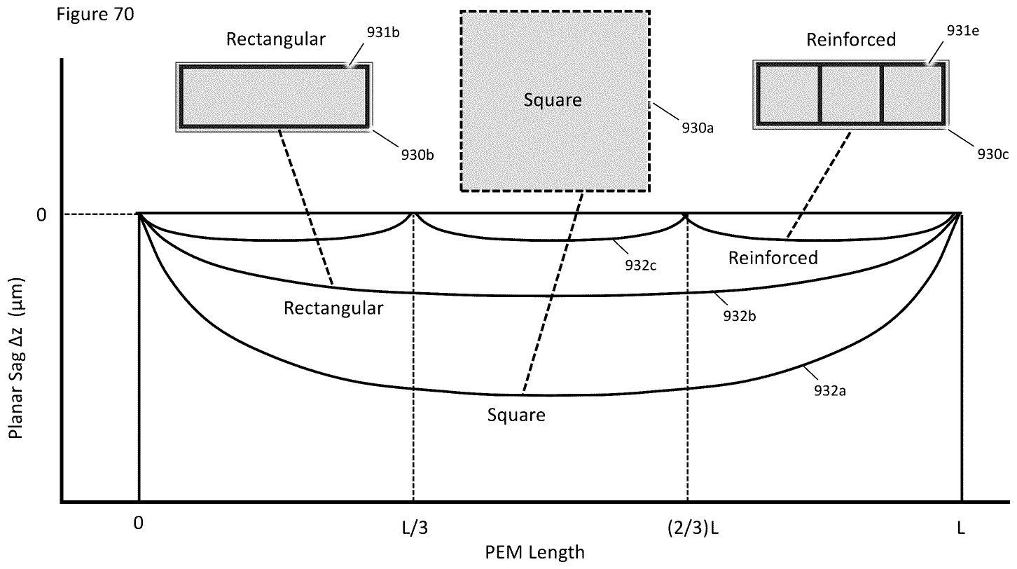

Because this process can be performed on a multi-PEM sheet, the step can be used to prevent sagging of the PEM membrane during handling. This benefit is shown in FIG. 70 where the planar sag Δz is compared for a square with no support against a rectangle with support from a circumscribing sealant, and against the same aspect ratio rectangle with both peripheral and interior support. As illustrated an unsupported square 930a of length and width L exhibits the greatest degree of sag 932a. Providing internal reinforcement reduces membrane sag during manufacturing. For example, a rectangular geometry 930b circumscribed by sealant 931b shows reduced sag 932b compared to an unreinforced square geometry. Subdividing the same aspect ration rectangle 930c further into thirds by internal support 931e spaced part at a distance L/3 further limits sag 932c thereby improving handling during manufacturing. Although the countersunk sealant process as disclosed Improves manufacturability, the primary purpose is to reduce lateral gas leakage.

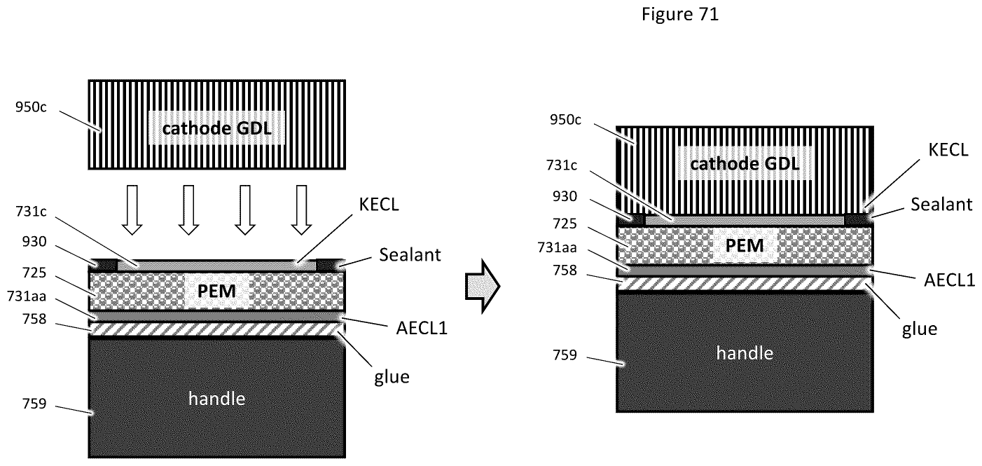

Following sealant step 911 in the flow chart of FIG. 66, cathode GDL 950c is attached to KECL 731c in step 901c. Illustrated in the cross sections of FIG. 71 the process involves attaching cathode GDL layer 950c to the CCM comprising KECL 731c and countersunk sealant 930 as shown, irrespective of which countersunk sealant process was used in forming seal ring 931. During the attachment operation, handle 759 remains glued to the anode side of the exemplary CCM. Once cathode GDL 950c is attached providing additional mechanical support, the handle is then removed in step 901b.

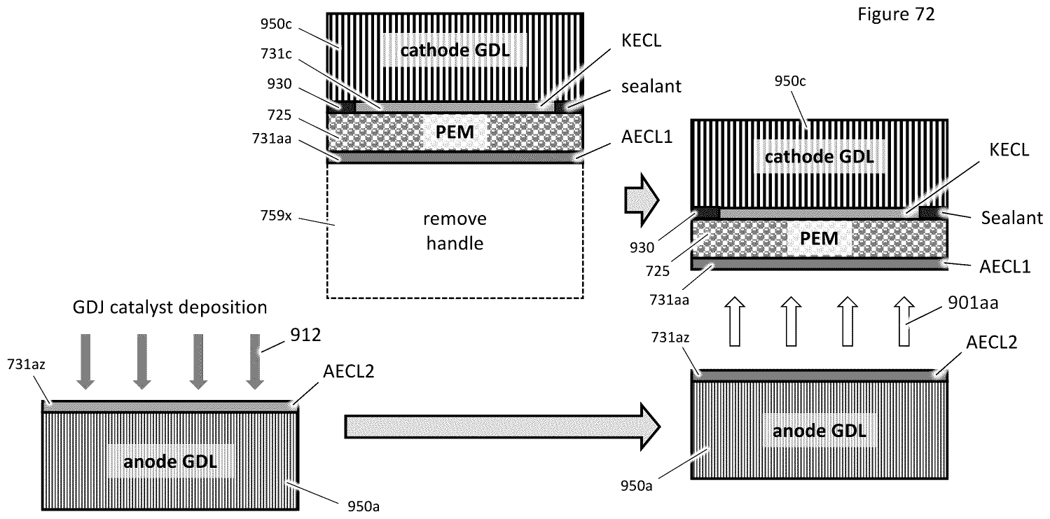

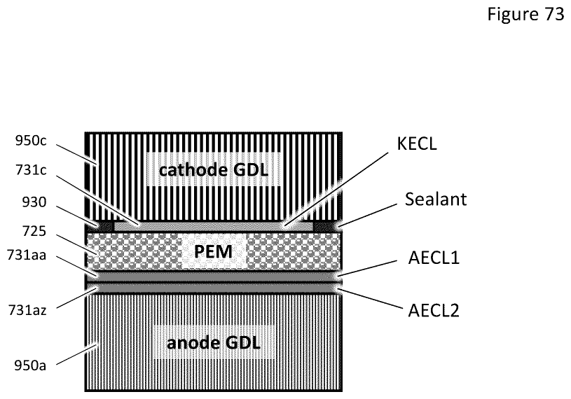

In the next phase in the exemplary process flow, a bilayer CL subprocess comprising step 912 coating anode gas diffusion layer 950a with an AECL2 catalyst material 731az as shown in FIG. 72. Subsequently, in step 901aa the ACEL2 layer 731az is attached to the exposed ACEL surface 731aa resulting in the cross sectional structure shown in FIG. 73. As shown immediately upon assembly, this bilayer or composite AECL comprises two layers AEC1 731aa deposited onto the PEM membrane, and AEC2 731az deposited onto the anode GDL. In one embodiment this layer referred to as AECL2 has less platinum and ionomer than the AECL1 attached to the PEM membrane. For example the AECL2 layer may comprise only material sputtered from Target D while the AECL1 layer is graded with platinum rich material from target C followed by increased content from Target D.

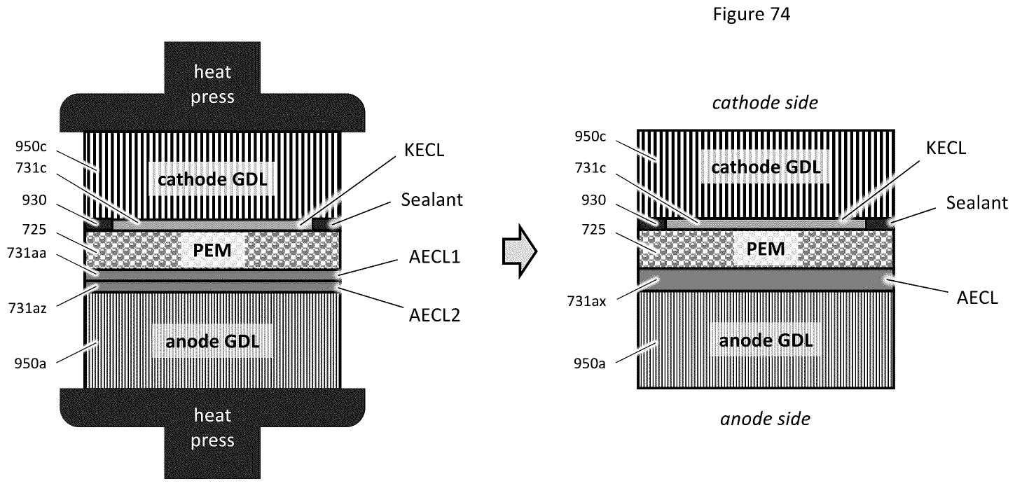

In FIG. 74, a heat press squeezes the sandwich causing the two AECL layers 731aa and 731az to merge into one continuous AECL layer 731ax with no internal interfaces contributing to membrane resistance, contact potential, or polarization voltage. Since the two materials are similar stoichiometrically the contact is more ideal than an interface between than a CCM to GDL contact minimizing contact resistance and polarization voltage.

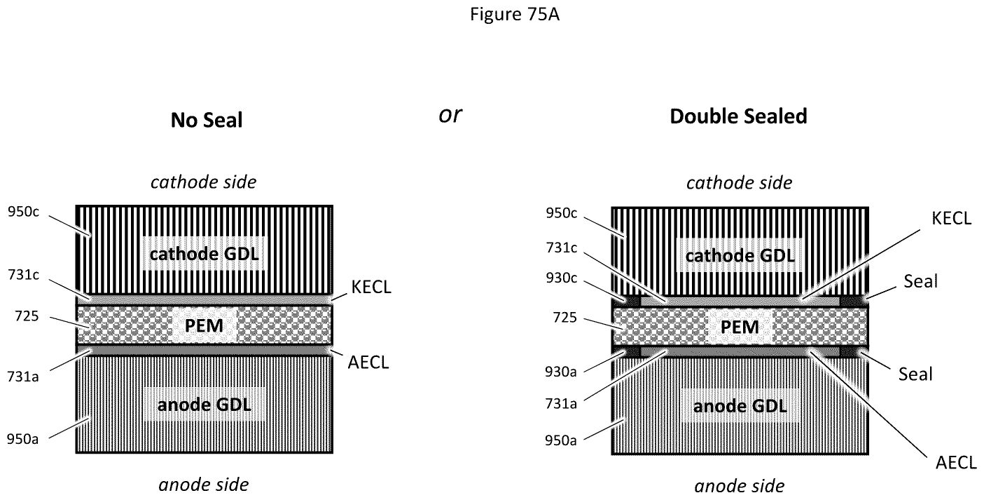

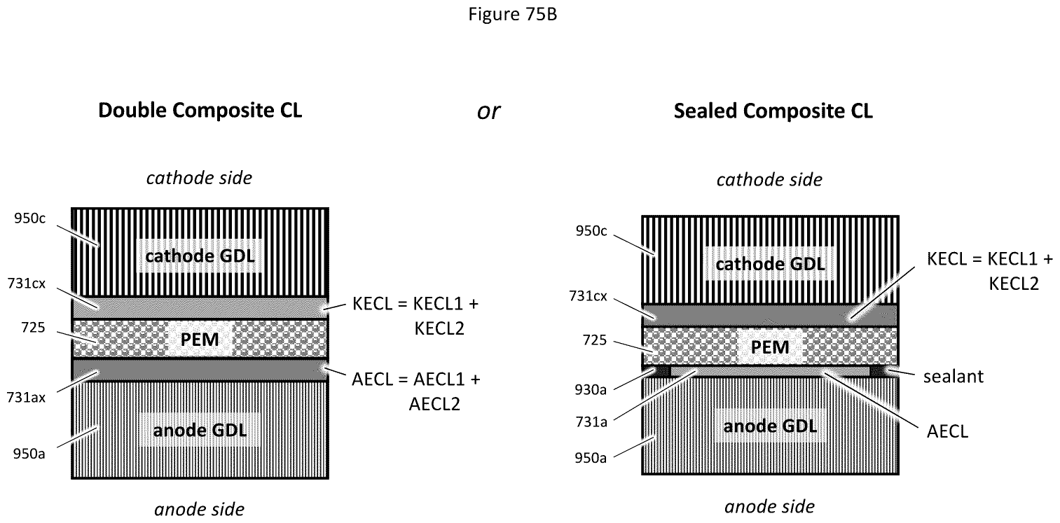

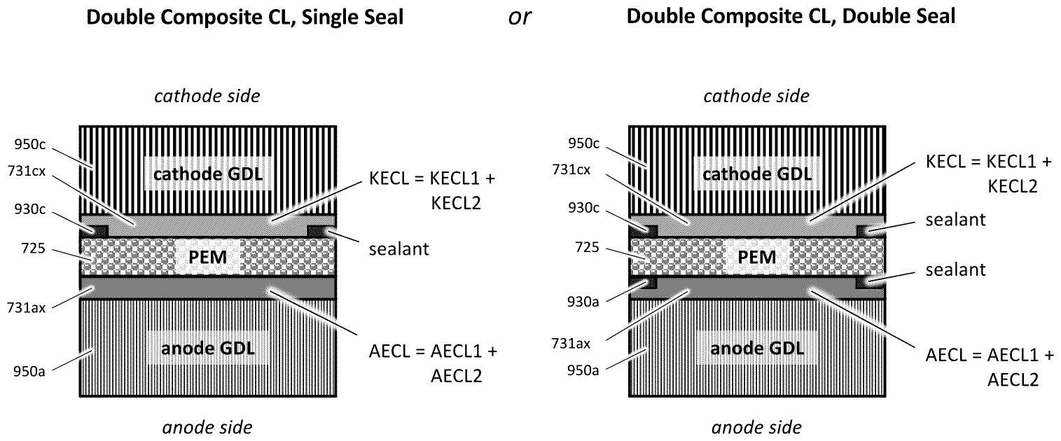

Given the foregoing process flows for the sealed PEM and composite CL, a variety of structural combinations are possible when fabricating a MEA5 sandwiches. The left side cross section of FIG. 75A illustrates a MEA5 with no sealant comprising PEM 725, AECL 731a, KECL 731c, and anode and cathode GDLs 950a and 950b contrasted against a double sealed structure, i.e. a fuel cell sealed on both anode and cathode electrodes by sealant 930a and 930c.

The left side cross section in FIG. 75B illustrates double composite MEA5 including a bilayer composite catalyst layer 731ax on the anode and another bilayer composite catalyst layer 731cx on the cathode. The composite catalyst layers on the anode and cathode electrodes may not be the same in thickness or in composition. The right side figure shows the combination of a sealed anode with sealant 730a and bilayer composite catalyst layer 731cx on the cathode, the inverse construction of the MEA5 shown previously in FIG. 74.

FIG. 75C illustrates double composite catalyst layers 731ax and 731cx on both anode and cathode respectively where the cathode is also sealed by sealant 930c. The sealant only extends for the height of KECL1 and is covered by KECL2. The other cross section in the same figure shows the combination of a fully symmetric double structure on both anode and cathode comprising both a double sided seal 930a and 930c along with double-sided composite catalyst layers 731ax and 731cx.

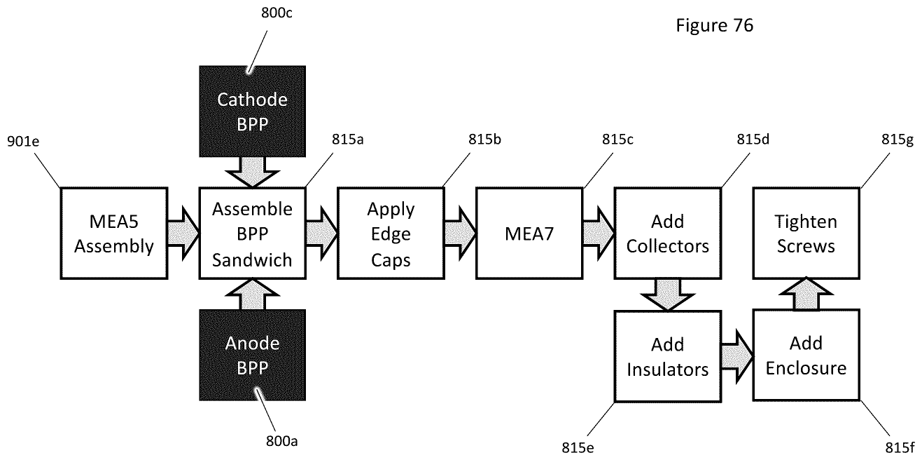

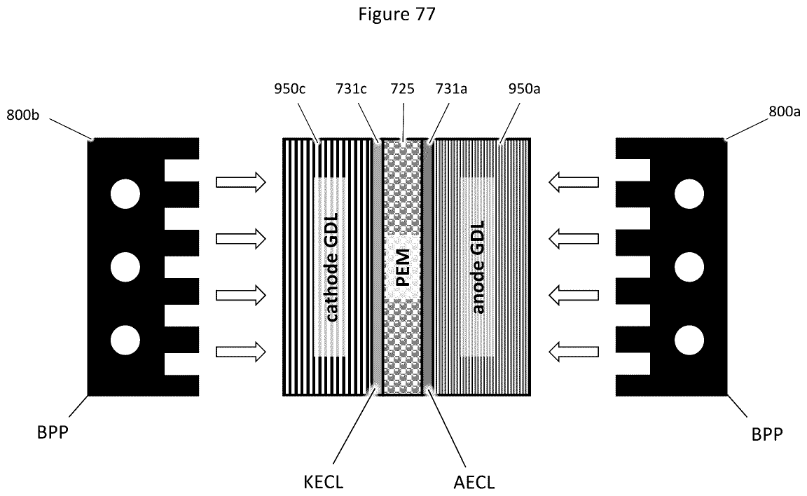

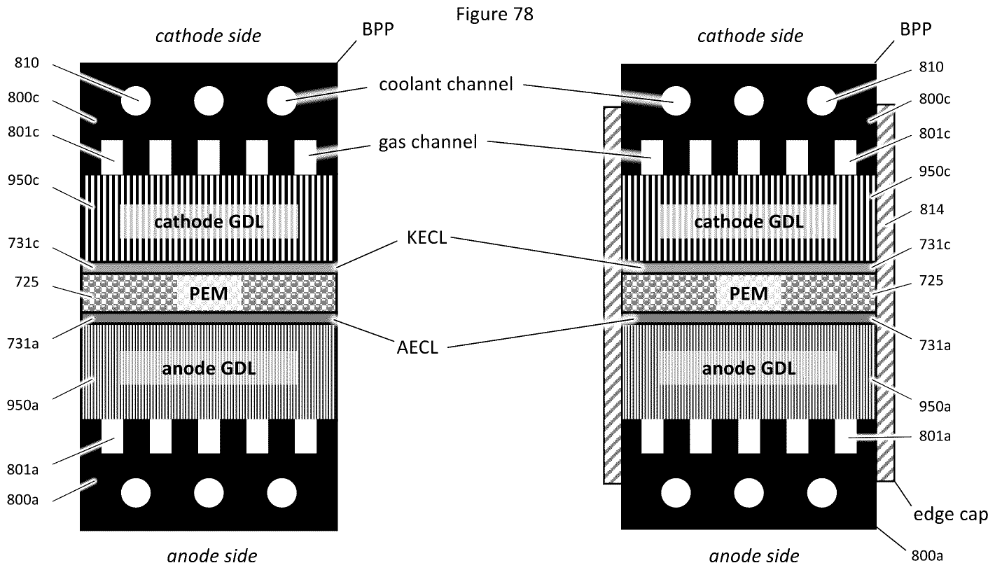

MEA7 Assembly. Fabrication of a seven-layer membrane electrode assembly or MEA7 comprises the MEA5 sandwiched by bipolar plates referred to a BPP. One manufacturing flow is shown in FIG. 76 starting with MEA5 assembly 901e followed by step 815a attaching cathode BPP 800c and anode BPP 800a the process of which is represented in the cross section of FIG. 77. Optionally a side plate 814 to prevent gas leakage may be attached or glued onto the structure to complete the MEA7 module 815c. FIG. 78 illustrates the resulting MEA7 structure comprising PEM membrane 725, anode and cathode catalyst layers 731a and 731c, anode and cathode GDL gas diffusion layers 950a and 950c, anode and cathode BPP bipolar plates 800a and 800c, anode H₂ and cathode O₂ gas channels 800a and 800c, and coolant channel 810. The right side illustration also includes side gas cap 814. To complete a PEM fuel cell comprising a single n=1 membrane, electrical collectors are attached in step 815 followed by an insulating layer 815e. The entire structure is then assembled into an enclosure 815f which is compressed by tightening machine screws 815g.

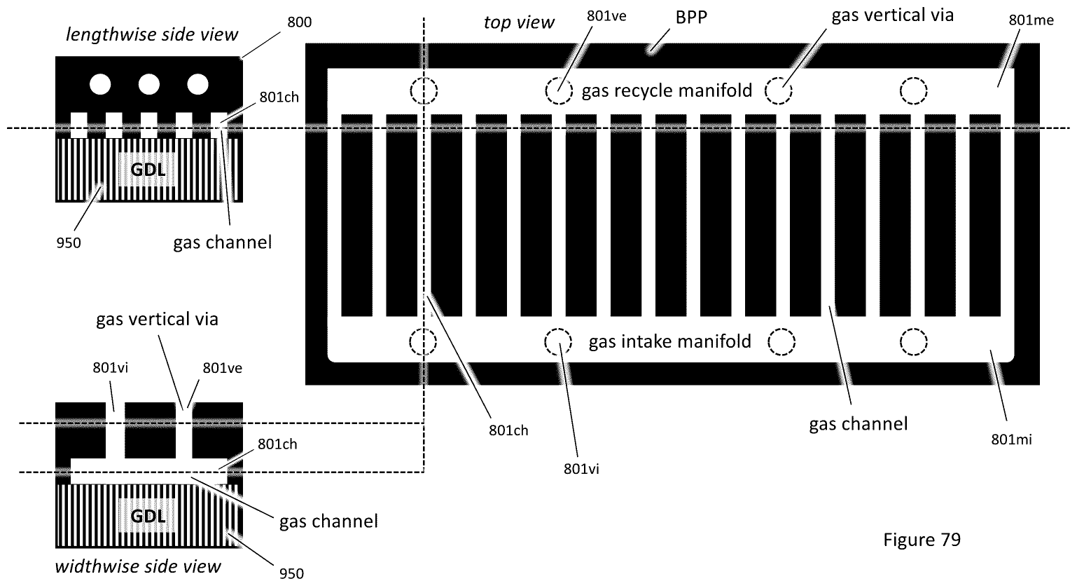

By adopting a rectangular shape, gas can be evenly distributed along the length membrane as shown in FIG. 79. The gas is distributed using a chamber referred to as a gas intake manifold 801mi, traverses the narrow width of the membrane through a gas channel 801ch and is collected in the gas recycle manifold 801me. Gas enters and exits the manifolds vertically through gas vertical vias 801vi and 801ve as represented by dotted line circles. The gas channels may employ any geometry including serpentine patterns stripes of varying widths and combinations thereof. The top view shown corresponds to the cross section cut line through the plane of gas channels.

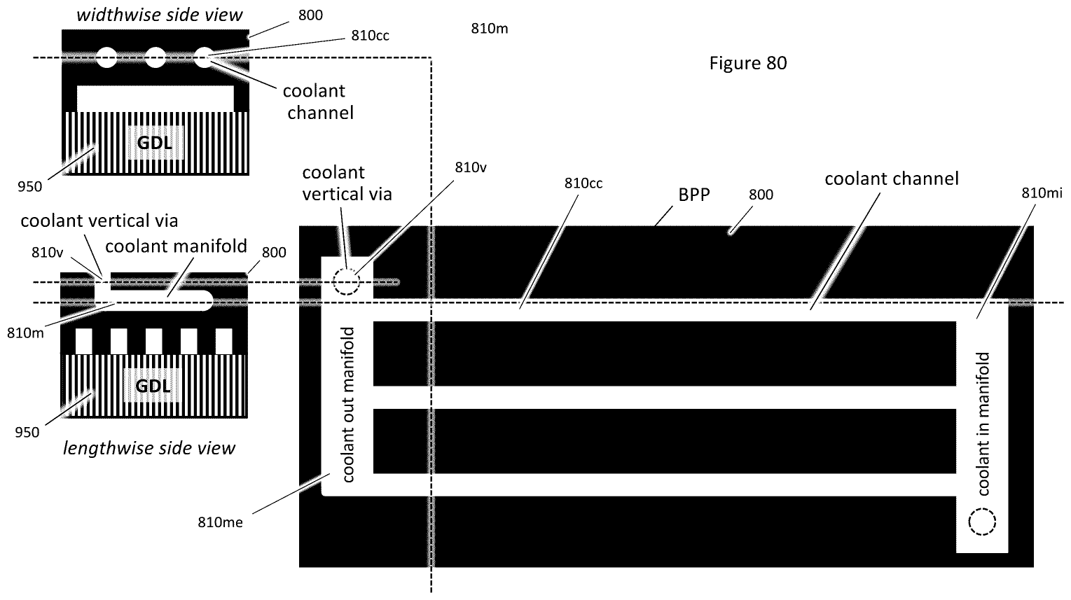

FIG. 80 shows the plan view of the BPP in the plane of a cutline through the coolant channels. The fluid conducted in the channels 810cc may be forced air or cooling fluid. Flow occurs vertically through a coolant vertical via 810v into a coolant in manifold 810m, traveling through the lengthwise coolant channel to be collected in the coolant out manifold exiting vertically through another coolant vertical via. The BPP bipolar plate 810 is not identified as either anode or cathode since cooling operation is generally the same in both electrodes.

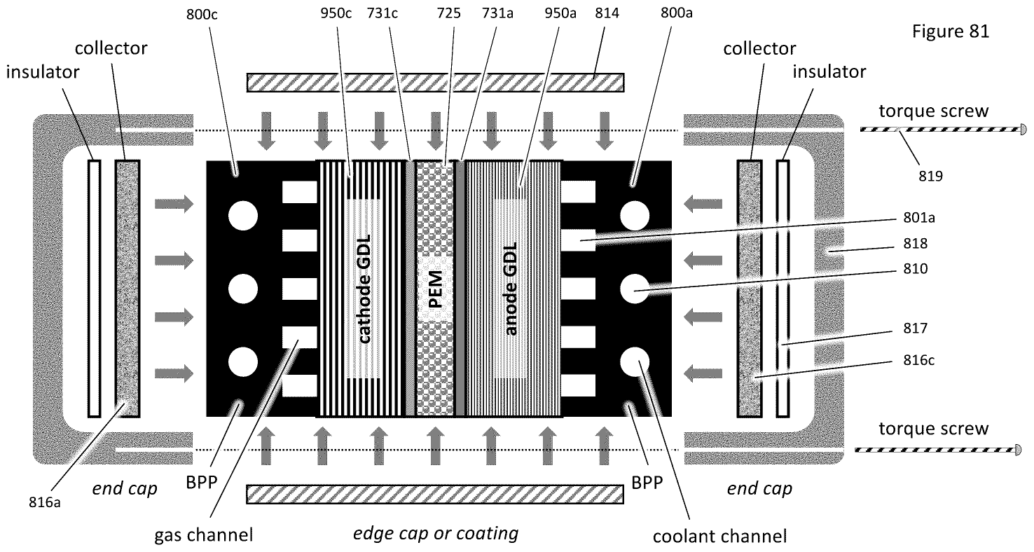

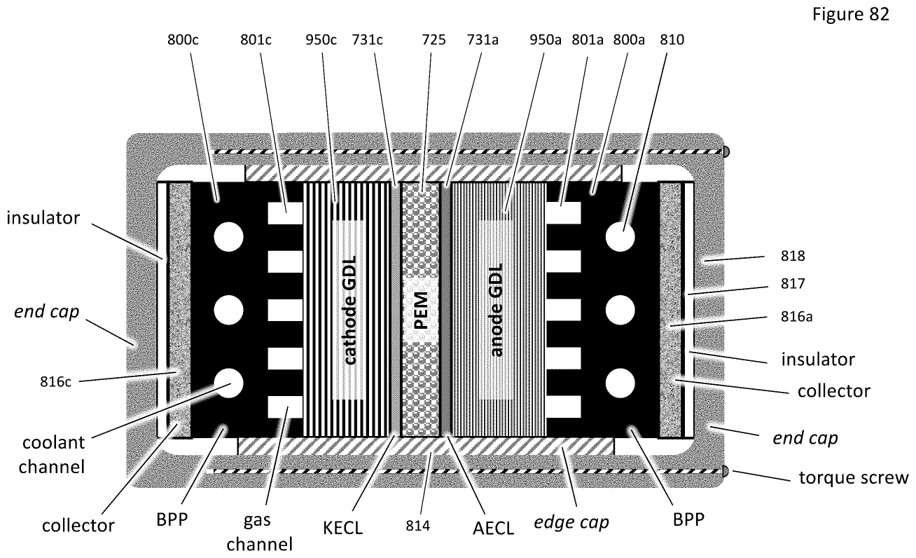

The complete assembly is shown in the top view of FIG. 81 including a MEA7 with an optional edge cap 814, conductive metal plates as collectors 816a and 816c separated from the enclosure 818 by insulator sheets 817. The enclosure is then aligned and tightened by torque screws 819. The final assembly is shown in FIG. 82.

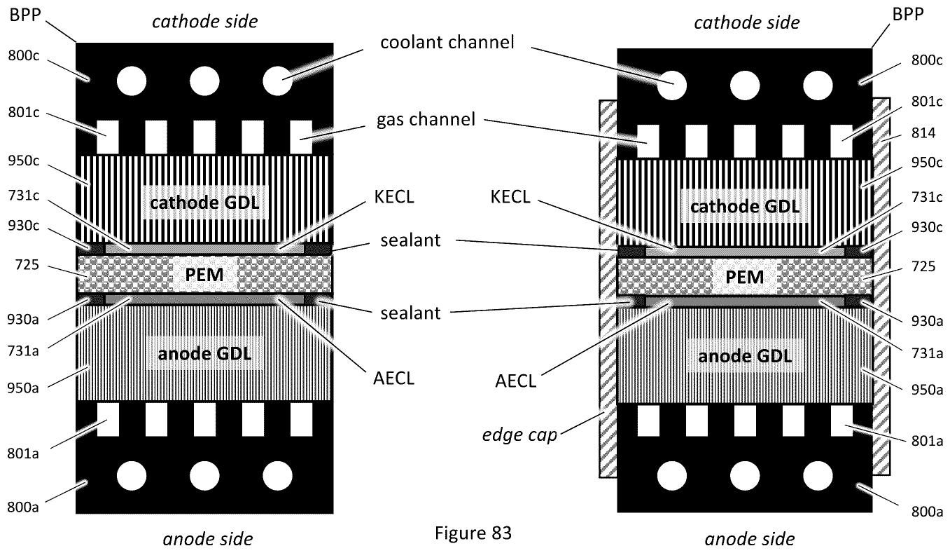

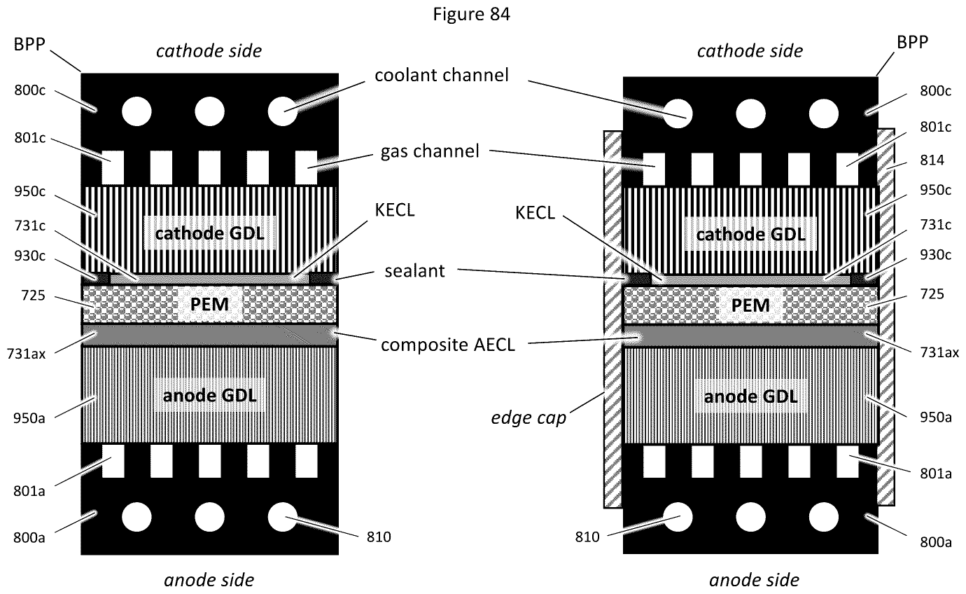

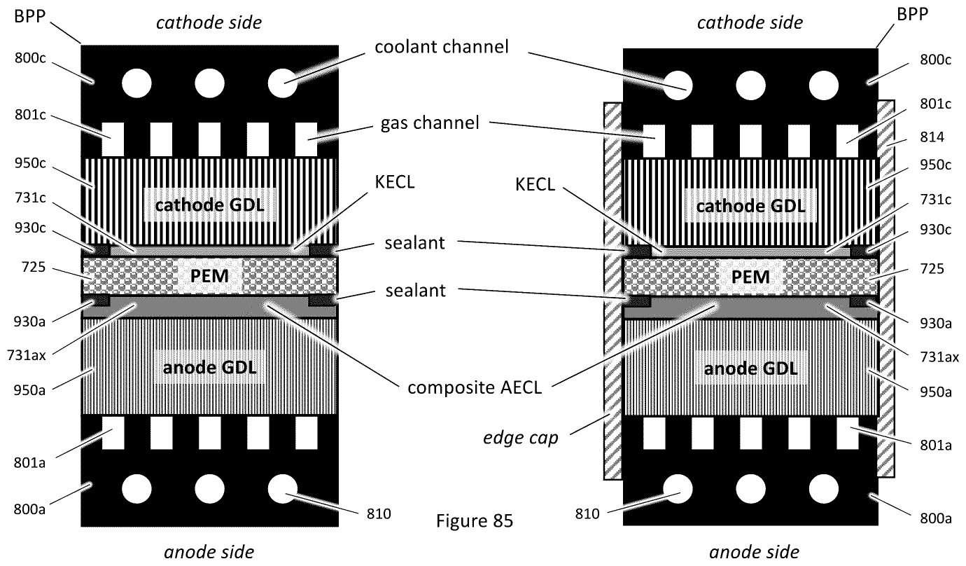

The same assembly method can be used to fabricate a MEA7 sandwich comprising a double sealed MEA5 core using sealant 930a and 930c as shown in FIG. 83; or a combination of a sealed catalyst layer on one electrode for example KECL 731c with sealant 930c on the cathode and a bilayer of composite catalyst layer 731ax on the anode shown in FIG. 84, or vice versa. In another embodied permutation the MEA7 may comprise a double-sealed structure with sealant 930a and 930c on both anode and cathode electrodes, and with one electrode comprising a bilayer or composite catalyst layer 731ax shown in FIG. 85 on the anode side, or 731ac on the cathode side (not shown), or both (not shown).

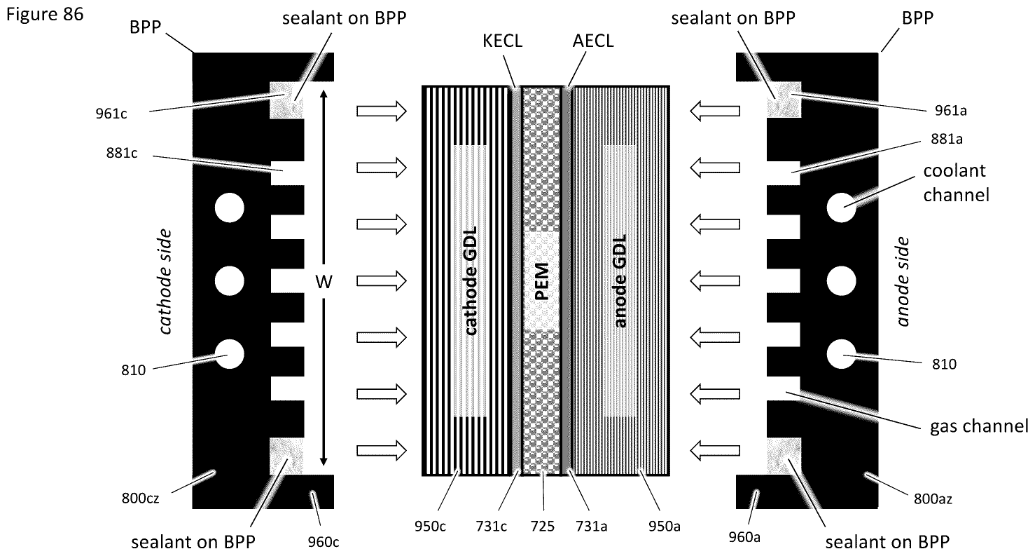

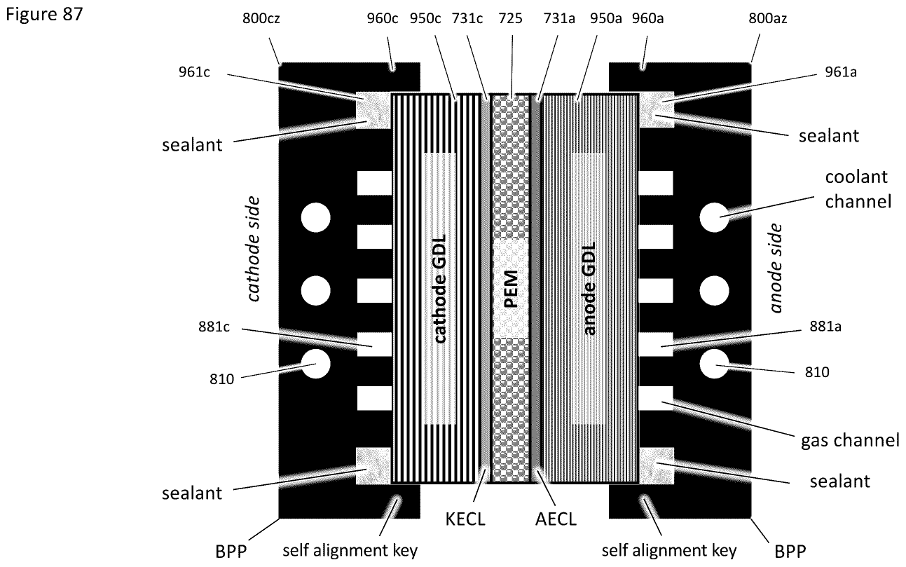

Self-Aligned MEA7 Assembly. A more advanced MEA7 embodiment of this invention is a self-aligned fuel cell assembly as shown in FIG. 86. A key feature of self-alignment is a well-shaped BPP layer where the outer edge is longer than the ribs defining the gas channels. Features of the self aligned anode and cathode BPPs 800az and 800cz include the self alignment keys 960z and 960c as well as edge chambers 961a and 961c which are wider than the gas flow channels 881a and 881c in order to hold dispensed sealant. The inner dimension W of the BPP is precisely the same dimension as the MEA5 assembly. As such, no alignment is needed to guarantee perfect positioning of the membrane assembly within the BPP. In this implementation the outer cavity is filled with sealant which after compression prevents gas leakage. The resulting structure is shown in FIG. 87.

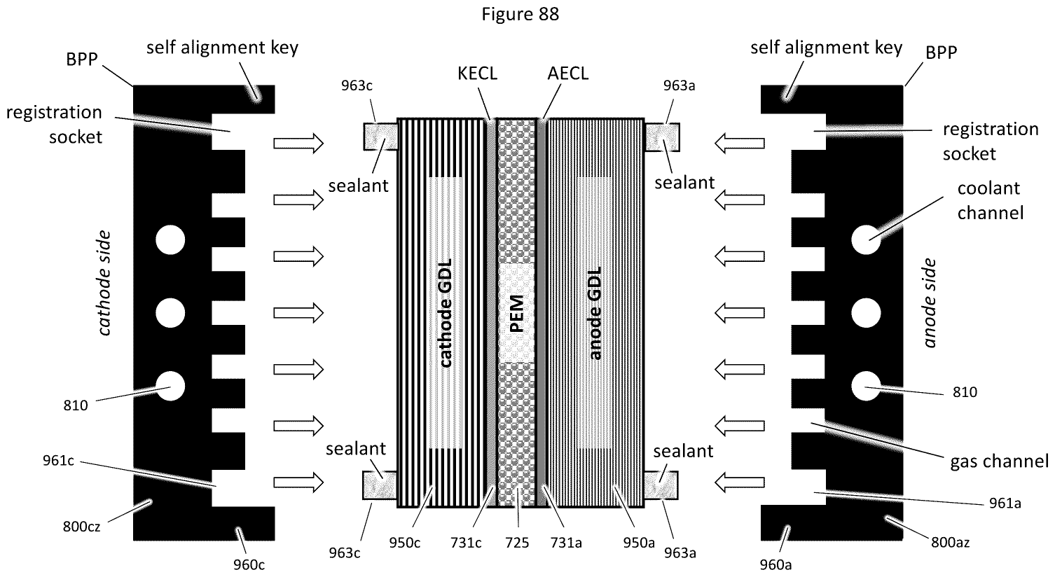

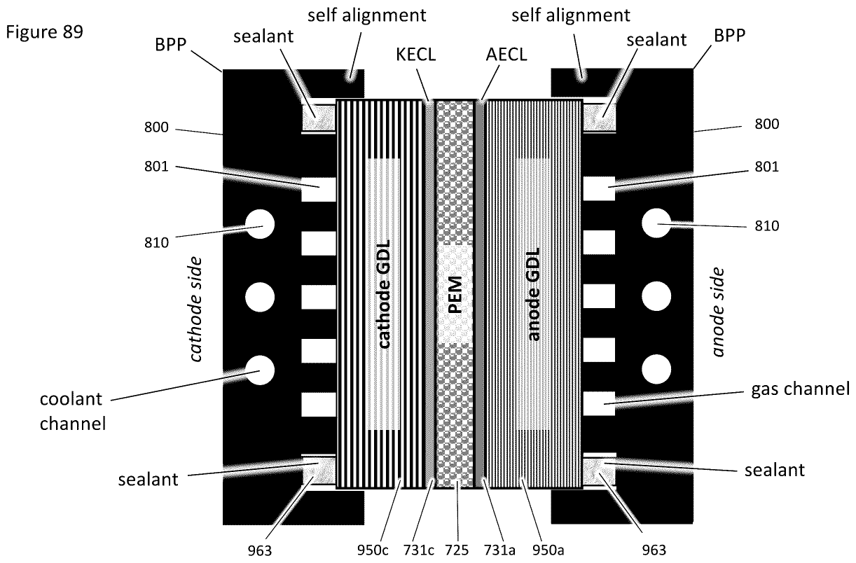

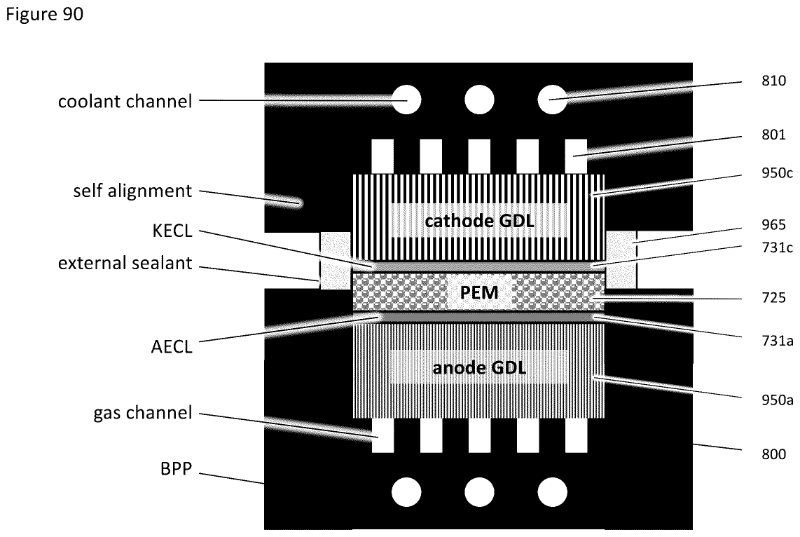

An alternate process flow shown in FIG. 88 includes sealant applied around the periphery of both the anode and cathode sides of the MEA5 assembly. In this case rather than dispensing sealant in the BPP plates 961a and 961c, sealant 963c and 963a is applied to the exterior surfaces of cathode and anode GDLs 950c and 950a. The protrusions 963a and 963c act like a key-socket registration with registration sockets 961a and 961c. Placing the assembly into the self-aligned BPP ensure the sealant aligns to the outer cavity in the BPP as shown in FIG. 89. In another embodiment of the invention FIG. 90 illustrates combining self-aligned BPP with an external sealant 965 to prevent gas leakage.

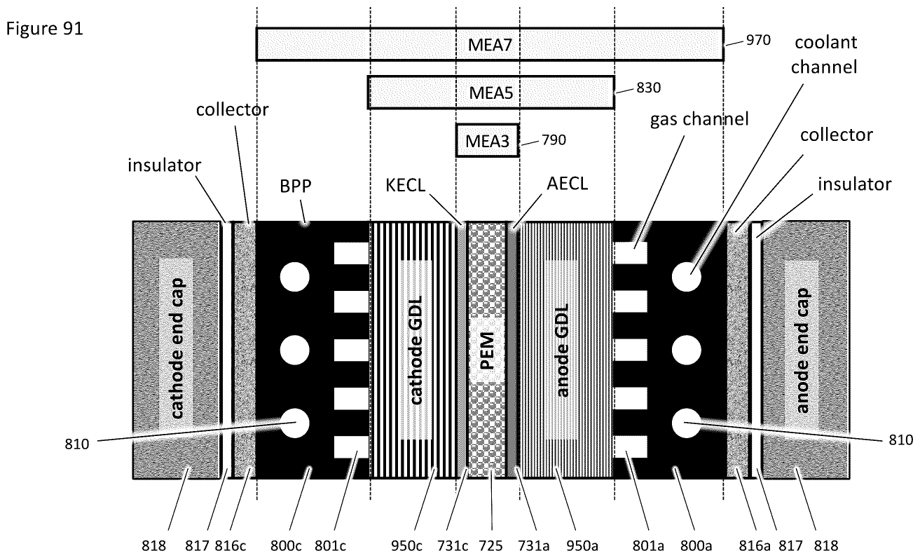

Stacking Fuel Cells. The assembly of FIG. 91 illustrates a completed fuel cell containing only a single PEM membrane. A single PEM fuel cell is referred to as a n=1 or a 1s circuit topology. The drawing defines the components MEA3 790, MEA5 830, and MEA7 970. In a single PEM assembly the bipolar plates 800c and 800a are dedicated for either the cathode or the anode. The anode BPP 800a only carries hydrogen in gas channel 801a and coolant 810, while the cathode BPP 800c only carries the oxygen-H₂O mix in gas channel 801c plus the coolant channel 810.

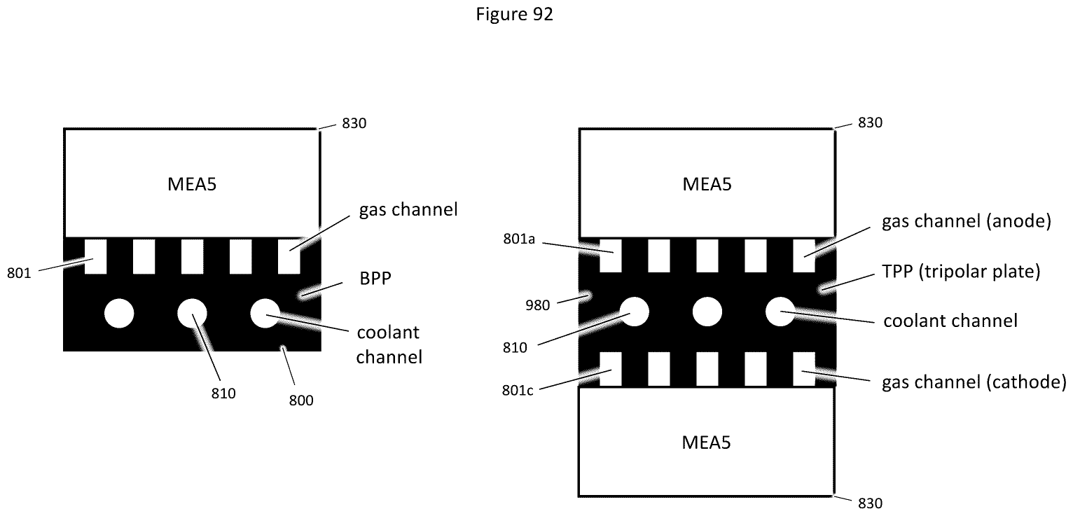

In general in a n=1 fuel cell design, the same BPP construction 800 can be used for both anode and cathode plates with gas channels 801 and coolant channels 810. Contrasted against a single membrane, a series stack of cells requires a two sided plate. As depicted in FIG. 92 plate 980 used in stacked fuel cells functions as the cathode of one cell carrying a the oxygen-H₂O mix in gas channels 801c, it functions as an anode of the series cell carrying hydrogen as a gas in channel 801a. It also carries coolant in channel 810. Accordingly to distinguish this three fluid plate over the previously defined BPP bipolar plates, we refer to this dual side structure as a tripolar plate or TPP also shown in same figure.

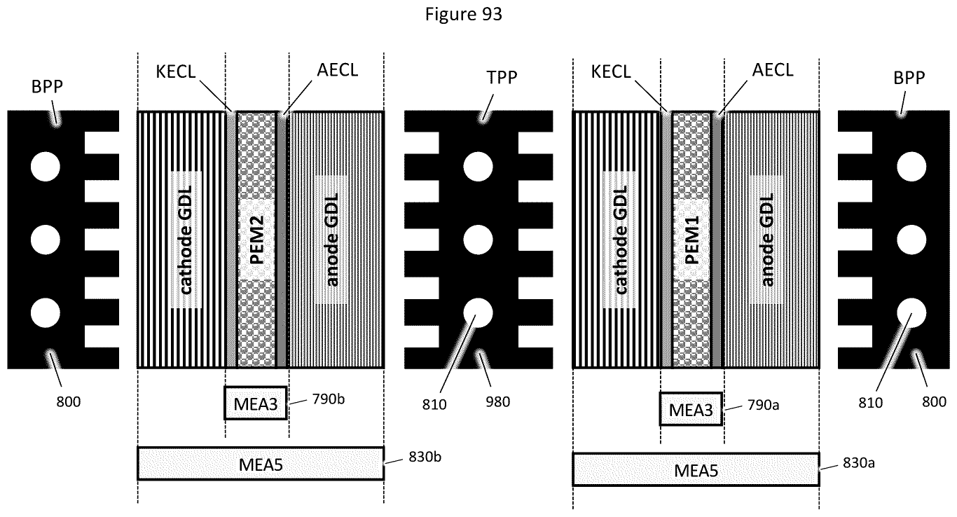

A shown in FIG. 93, a n=2 MEA7 assembly includes two BPPs 800, one TPP 980, and two MEA5 assemblies 830a and 830b. The corresponding completed assembly for n=2 is shown in FIG. including definitions of the various MEAs including MEA3 790a and 790b, MEA5 830a and 830b, and MEA7 970a and 970b. As shown the two MEA7 assemblies share TPP 980 which passes current from one cell to the next while deliver has and coolant.

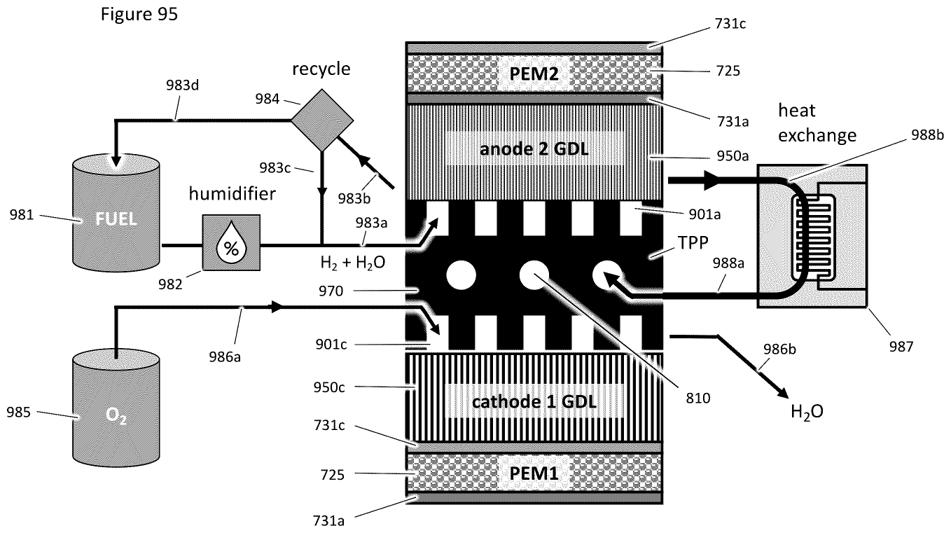

The gas flows in the tripolar plate 970 are described in FIG. 95. In anode side fuel supply 981 is optionally humidified 982 then delivered 983a into TPP channels 901a. The unused gas is collected 983b and returned to the fuel cell 983c or recycled and dehumidified 984 and returned to the fuel supply 981. The oxygen supply 985 is routed 986a into the TPP channels 901c. Unused gas and excess water vapor is passed to the exhaust port as effluent 986b. Coolant 986 is routed through cooling tubes 810 and back 988b to heat exchanger 987.

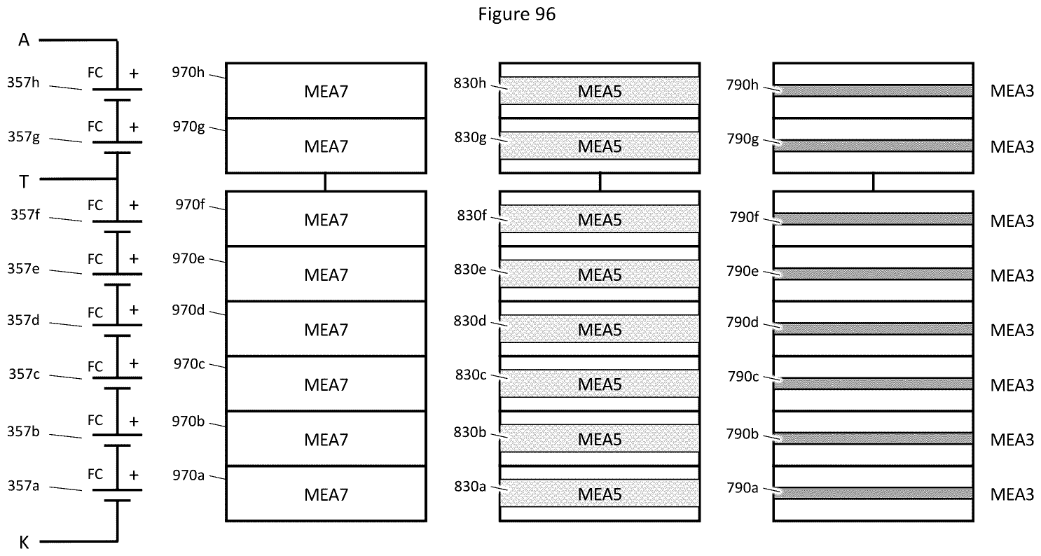

The stacking of eight cells arranged in two sets, one fuel cell where n=6 comprising cells 357a and 357f and a second where n=2 comprising cells 357g and 357h is shown schematically in FIG. 96. As such the electrical representations 357a through 357h are realized physically by corresponding MEA7 assemblies 970a through 970h which in turn comprise MEA5 assemblies 830a through 830h containing CCMs made of MEA3 membranes 790a through 790.

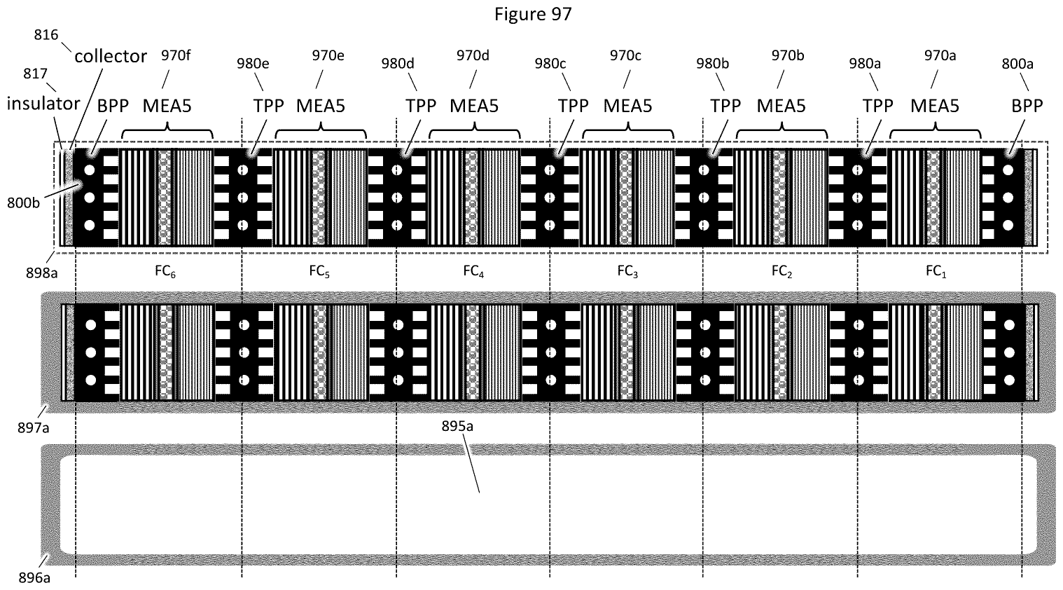

The six CCM stack shown in FIG. 97 includes five TPPs 980a through 980e, and 2 BPPs 800a and 800b the aggregate 989a of which combined with a single chamber 896a collector plates 816 and insulator 817 results in the complete assembly 897a.

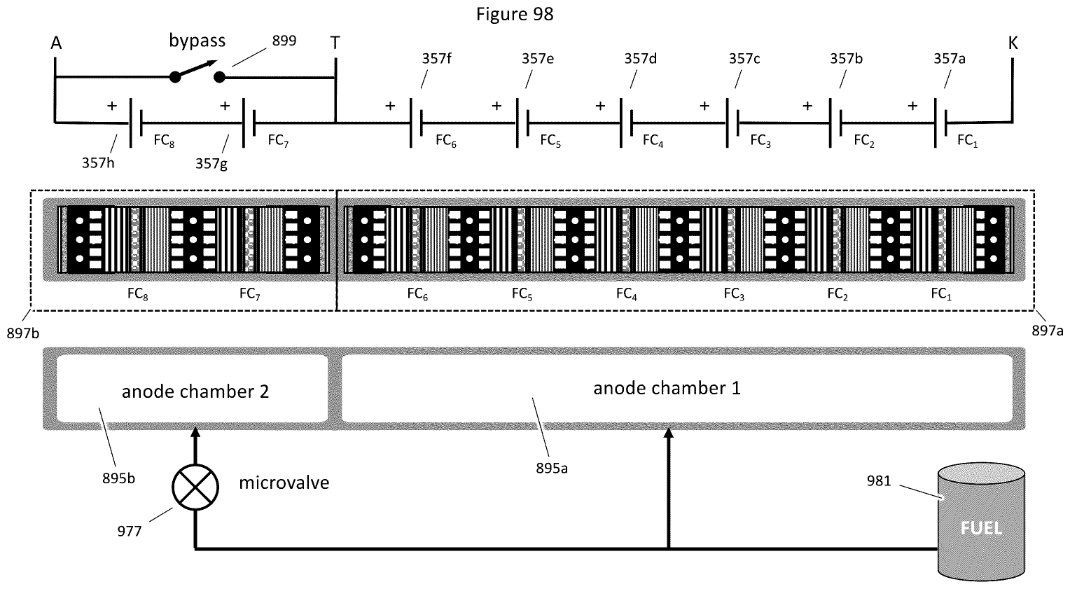

The complete stack of all eight cells is shown in FIG. 98 divided into two chambers 895a and 895b used to independently control the fuel supply to two cell arrays—array 897a comprising series stacked fuel cells 357a through 357f corresponding to FC₁ to FC₆; and array 897b containing fuel cell 357g and 357h for FC₇ and FCs. The six cell node chamber 895a has a direct connection to the hydrogen fuel 981 while the two cell anode chamber 895b includes an inventive bypass switch 899 and an associated gas cutoff valve 977.

Although the cross sections show every intervening conductive plate comprising a tripolar plate, in some cases the tripolar plates may be replaced with bipolar plates, i.e. conductive plates lacking the cooling channel. The tripolar and bipolar plates may inserted between the MEA5 assemblies in alternating fashion or at some fixed intervals, e.g. one tripolar plate for every four membranes with the remaining plates being bipolar in construction.

### Glossary of Terms

Anion—A negatively charge ion such as an OH⁻ radical able to traverse an AEM anion exchange membrane.

Anisotropic Etchback—A physio-chemical or mass-transfer process for removing material which etches a material preferentially in a direction of an electric field accelerating the etchant generally perpendicular to the surface being etched. In accordance with this invention polymeric sealant is etched back to form a seal ring at the CCM-to-GDL interface.

Anode (A)—The negative terminal of a fuel cell to which positively charged cations are attracted and where in a redox reaction reactants undergo reduction, i.e. gaining an electron.

Anode Chamber—The portion of a fuel cell where gas reducing agents such as oxygen and water vapor are present. The term “chamber” is metaphoric as the chamber is the space between atoms called pores present in the catalyst layer, the gas diffusion layer, and the gas channel in the BPP or TPP caring anode gasses.

Anode Electrode Catalyst Layer (AECL)—A layer of material present on the anode side of a ion exchange membrane for promoting chemical reactions generally an amalgamate or blending of a noble metal such as platinum with carbon and possible with metallic oxides such as TiO₂. The AECL promotes reduction of membrane transported ions in a fuel cell redox reaction. In accordance with this invention the AECL is formed by sputtering or co-sputtering catalyst materials to form a homogenous, heterogenous, or graded concentration to enhance molecular transport to the membrane.

Anion Exchange Membrane (AEM)—An ion exchange membrane able to selectively conduct negatively charge ions like hydroxyl (OH⁻) but preventing the flow of positive ions like protons (H⁺).

Asymmetric Catalyst Coated Membrane (ACCM)—Made in according with this invention, an asymmetric catalyst membrane is a MEA3 structure where the anode electrode catalyst layer (AECL) differs chemically or stoichiometrically from the cathode electrode catalyst layer (AECL), specifically to enhance the reaction rate of the ORR in the cathode, to reduce methanol fuel crossover from the anode, to reduce oxygen back streaming from cathode into the anode thereby suppressing H₂O₂ poisoning of the catalyst and ionomer groups, and to suppress the diffusion of atmospheric CO into the CCM poisoning the catalyst layers.

Asymmetric Catalyst Coated Membrane Polarity Tag—An asymmetric CM requires a polarity tag comprising a physical deformation, ink or laser mark or tag formed on one side of the membrane, its handle, or frame to ensure the CCM is inserted into the fuel cell assembly in the proper orientation.

Bipolar Plate (BPP)—A mechanically rigid electrically conductive plate designed to carry fuel such as hydrogen to and from the cathode of a fuel cell's MEA5 core or alternatively carry reducing agents such as oxygen gasses to and from the anode side of fuel cell's MEA5 core; and to optionally carry coolant to regulate the fuel cell's internal temperature. In accordance with this invention, the BPP includes a registration key for self-alignment and a reservoir for holding sealant between the BPP and the GDL at cell's periphery.

Bypass—An electrical switch generally comprising a power MOSFET transistor which diverts current around an unused fuel cell. Bypassed fuel cells may also have the fuel supply interrupted to improve conversion efficiency. In accordance with this invention, a bypass is used to dynamically change the number of fuel cells in a series stack in order to modulate or quasi regulate the fuel cell stack voltage nV_{FC}.

Tripolar Plate (TPP)—A mechanically rigid electrically conductive plate designed to carry fuel such as hydrogen to and from the cathode of one fuel cell's MEA5 core and concurrently carry reducing agents such as oxygen gasses to and from the anode side of a different fuel cell's MEA5 core; and to optionally carry coolant to regulate the fuel cell's internal temperature. In accordance with this invention, the TPP includes a registration key for self-alignment and a reservoir for holding sealant between the TPP and the GDL at cell's periphery.

Catalyst—An element generally comprising a noble metal (such as Pt, Au, or Ag) which promotes a chemical reaction thermodynamically but remains unchanged after the reaction is completed. Damage to a catalyst from a gas contaminant such as CO is referred to as catalyst poisoning. In accordance with this invention, the catalyst is deposited using sputter deposition after sputter etching the membrane surface to enhance electrochemical reactivity.

Catalyst Coated Membrane (CCM)—The three layer core of a fuel cell comprising an ion exchange membrane coated on both sides by a catalyst layer. The CCM is structurally synonymous with a MEA3 three layer membrane electrode assembly, but highlights the presence of the catalyst layer. In accordance with this invention, the composition of the catalyst layer on the cathode may have a stoichiometry able to enhance oxidation while the composition of the catalyst layer on the anode may have a different stoichiometry designed to enhance reduction. The coating may also include gettering metals or compounds used to capture CO and prevent it from diffusing into the cell and damaging catalyst layers.

Catalyst Layer (CL)—A layer of material present on the anode (AECL) and cathode (KECL) sides of a ion exchange membrane for promoting chemical reactions generally comprising an amalgamate or blending of a noble metal such as platinum with carbon and possible with metallic oxides.

Cathode (K)—The positive terminal of a fuel cell to which negatively charged anions and electrons are attracted and where in a redox reaction reactants undergo oxidation, i.e. losing an electron.

Cathode Electrode Catalyst Layer (KECL)—A layer of material present on the cathode side of a ion exchange membrane for promoting chemical reactions generally an amalgamate or blending of a noble metal such as platinum with carbon. The KECL promotes oxidation of fuel in a fuel cell redox reaction. In accordance with this invention the KECL is formed by sputtering or co-sputtering catalyst materials to form a homogenous, heterogenous, or graded concentration to improve ion transport.

Cation—A positively charged ion such as H⁺ (a proton) or K⁺ able to traverse an PEM cation exchange membrane.

Composite Catalyst Layer—Made in accordance with this invention, a composite catalyst layer comprises a catalyst bilayer, one formed on the membrane, the other formed on the GDL, subsequently joined and annealed. A composite catalyst layer reduces the contact resistance between the CCM and GDL.

Coolant Channel—A channel or conduit within a BPP or TPP for carrying forced air or liquid coolant to a heat exchanger.

Current (A)—A measure of the flow of charges equal to one coulomb per second.

Current Density (A/cm²)—Area normalized current flow defined as current divided by the cross sectional area of a conductor generally measured in mA/cm² or A/cm².

Direct Methanol Fuel Cell (DMFC)—In a direct methanol fuel cell methanol introduced into the anode of a PEM membrane fuel cell is catalyzed into ionized hydrogen which traverses the ionomeric membrane, recombining with oxygen in the cathode to form water. The methanol dissociation is however not carbon free and results in waste CO₂ gas. DMFC fuel cells suffer from fuel cross over where unreacted methanol leaks into the anode impeding catalytic activity from supporting oxygen reduction reactions (ORR) thereby reducing fuel cell current and efficiency.

Edge Cap—Made in accordance with this invention, an edge cap comprises a nonporous coating applied to the exterior surface of the fuel cell to prevent gaseous leakage out of the sides of the fuel cell.

Effluent—The byproduct of a fuel cell reaction, generallywater, along with unspent reactants.

Recycling of effluent or recovery of unused fuel may require removal of excess water through condensation of desiccation.

Electron (e⁻)—The stable smallest elemental charged particle carrying charge in an amount of 1.6×10⁻¹⁹ coulombs, generally obtained by oxidizing a reactant or ionizing atoms and molecules.

Endoskeleton—Made in accordance with this invention an endoskeleton comprises a grid of thin semirigid pillars transecting a fuel cell membrane to provide mechanical support and stability for improved handling during manufacturing. Endoskeletal support merge into wider exoskeletons circumscribing the border of a fuel cell membrane.

Etchback—A chemical or physio-chemical etch used to thin a deposited layer of material from its original as-deposited thickness. Etchback processes may be isotropic of anisotropic to control the resulting film topography. Made in accordance with the invention, an etchback process is used to thin deposited layers of sealant positioned between the CCM and GDL.

Exoskeleton—Made in accordance with this invention an exoskeleton comprises a grid of wide semirigid pillars circumscribing the border of a fuel cell membrane to provide mechanical support and stability for improved handling during manufacturing. A fuel cell exoskeleton may also provide support to thinner endoskeletons transecting the membrane. An exoskeleton width may be designed to accommodate fuel cell mechanical or laser singulation and may be adjusted in optical absorption to match better match the wavelength of a laser cutter.

Fuel—The energy source of a fuel cell such as hydrogen or glucose generally oxidized in the cathode of the fuel cell to release unbound conduction electrons as usable energy.

Fuel Cell (FC)—An electrochemical device able to convert fuel directly into electrical energy without combustion or moving parts by employing a coupled pair of oxidation and reduction (redox) reactions to maintain a steady-state equilibrium reaction while preserving charge neutrality.

Fuel Cell Area (mA_{FC})—The total cross sectional area of a fuel cell where A_{FC} is an arbitrarily defined area typically 1 cm² and m is a multiplicative area scaling factor.

Fuel Cell Resistance (R_{FC})—The resistance standardized unit cell of a single fuel cell of standard size where the total fuel cell resistance is (n/m) R_{FC} given that n is the total number of series connected fuel cells m is an multiplicative area scaling factor.

Fuel Cell Stack (nFC)—A stack of identical fuel cells connected in series cathode-to-anode-to cathode. The number of fuel cells is a stack is designed herein by the mathematical variable “n”.

Fuel Cell Voltage (V_{FC})—The voltage produced by a single fuel cell. The fuel cell voltage depends on its chemistry and on various environmental factor such as temperature and relative humidity.

Fuel Cell Stack Voltage (nV_{FC})—The total voltage of a stack of n series connected fuel cells. For example a stack of ten fuel cells (n=10) each producing 0.4V at a given relative humidity will exhibit a stack voltage of nV_{FC}=10(0.4V)=4V

Gas Channel—A opening in a BPP or TPP where gas flows generally comprising a comb like structure abutting the outer edge of a GDL gas diffusion layer.

Gas Diffusion Layer (GDL)—A porous material typically of carbon able to carry gas, conduct electric current and heat in a fuel cell.

Gas Microvalve—A small gas valve used to disable gas flow to unused or dormant fuel cells. In accordance with this invention, a gas microvalve is used to cut off gas supply to bypassed cells in dynamically reconfigurable fuel cell arrays.

Glucose—An simple sugar molecule C₆H₁₂O₆ used as a fuel source in a glucose fuel cell, generally as a liquid suspension.

Graded—A gradual change in composition, generally monotonically, i.e. either increasing or decreasing in one dimension. Made in accordance with this invention a catalyst layer may comprise a graded concentration of platinum or other metals and of carbon. Also made in accordance with this invention a gas diffusion layer may contain a gradation of pore size.

Handle—A rigid material such as a polymer or silicon wafer temporarily attached to a thin film like a ion exchange membrane in order to facilitate handling during manufacturing after which the handle is removed typically by dissolving an adhesive. In accordance with this invention a handle is used to provide mechanical support to the CCM during fabrication before the GDL is attached.

Heat Exchanger—A device used to transfer heat into or out of a heat exchange fluid to the surrounding ambient.

Heterogenous—Having a non-uniform composition or morphology varying spatially according to a pattern, a gradation, or by random variations. In accordance with this invention, the ion exchange membrane, catalyst layer, and gas diffusion layers may all be heterogenous in construction and compositional stoichiometry.

Homogenous—Having a uniform composition or morphology.

Hydrogen—The smallest atom in the periodic table, the protium isotope of hydrogen contains one proton (H⁺), one electron (e⁻) and no neutrons. Hydrogen stably bonds to itself in pairs forming the gas H² and easily ionizes in the present of a catalyst such as Pt.

Hydrophilic—Any molecule or surface that favors bonding to water such as PFSA or various side groups of compound organic molecules.

Hydrophobic—Any molecule or surface that resists bonding to water such as PTFE.

Hydroxide—A negatively charged radical comprising an ionized oxygen-hydrogen bond OH⁻.

Humidifier—Any device that increases the amount of water vapor in a gas or air.

Ion Exchange Membrane—A thin membrane able to selectively transport either cations (PEM) or anions (an AEM) and prevent conduction of the other polarity ionic species.

Ionomer—A polymer composed of repeat units of both electrically neutral repeating units and ionized units covalently bonded to the polymer backbone as pendant group moieties (credit Wikipedia).

Isotropic Etch—A chemical etch where the etch rate does not depend on direction. Iso etches produce rounded surfaces after etching. In accordance with this invention removal of excess sealant following a lift-off process may employ an isotropic etch.

Manifold—A gas chamber present in a BPP or TPP intended to uniformly distribute a gas or fluid along the length of a fuel cell, especially in high aspect ratio designs.

MEA3—A three-layer membrane electrode assembly

MEA5—A five-layer membrane electrode assembly

MEA7—A seven-layer membrane electrode assembly

Membrane Sag—A measure of the vertical displacement due to gravity of a membrane or thin film supported only by its edges. Ideally a well supported membrane should exhibit negligible sag. Made in accordance with this invention the combination of an endoskeleton and exoskeleton in the ion exchange membrane and CCM-GDL sealant transecting the fuel cell both reduce membrane sag.

Methanol—An alternative fuel to hydrogen, methanol together with water introduced into the anode of a proton exchange membrane fuel cell is catalyzed to form ionized hydrogen which is transported across the membrane the same as in a hydrogen fuel cell, and combining with oxygen in the cathode to create water while generating electric current. Dissociation of methanol, however, has the adverse effect of producing CO₂ in the anode.

Mold Cavity—A chamber used to contain a powder or fluid that polymerizes into single membrane under pressure, elevated temperature, or ultrasonic excitation.

Mold Chase—An insert placed into a mold cavity to precisely reduce the volume of the mold cavity to produce smaller objects of varying shapes from the same mold machine. In accordance with this invention, a mold chase is used to form the PTFE skeleton in a heterogenous membrane.

Over-mold—A mold performed in a mold chamber containing a previously molded component whereby the second mold material bonds to the former during polymerization to form a single object or film but of heterogenous construction. In accordance with this invention, over-molding is used to form the thing active membrane regions supported by the PTFE skeleton in the disclosed heterogenous fuel cell membrane.

Oxidation—A chemical reaction resulting in an atom or molecule losing one or more electrons. The oxidation of hydrogen molecule H₂ produces two hydrogen ions (H⁺) also known as protons and liberates two conduction electrons (2e⁻).

Oxygen Reduction Reaction (ORR)—In a hydrogen or direct methanol fuel cell, ionized hydrogen entering the anode react with oxygen gaining an electron (reduction) and forming water as an effluent. The ORR reaction rate is mediated by the catalyst layer on the anode side of the catalyst coated cembrane (CCM), which generally limits the overall conductivity and conversion efficiency of the fuel cell.

PFSA (perfluorosulfonic acid)—A polymer generated by free radical initiated copolymerization of a perfluorinated vinyl ether having unique conduction properties as a proton exchange membrane (PEM) either as a bulk material or as a coating onto a substrate or scaffold such as PTFE.

Pore Size—The size of openings between molecules in an amorphous matrix generally ranging from nanometers to microns in size. In accordance with this invention the pore size within the GDL is heterogenous, with smaller pores nearer the membrane and larger pores adjacent to the BPP and TPP planes.

Print Head—A device which sprays or drops a fixed quantity of ink onto a substrate or paper surface. In GDL the print head may deliver carbon ink of varying degrees of granularity while in catalyst deposition the ink may comprise a mix of platinum and carbon.

Plasma—An radio frequency induced ionization of a gas used to enable the gaseous ions to be accelerated by a DC electric field commonly used in plasma etchers, chemical vapor deposition, and in sputtering.

Platinum—A noble metal used as a chemical catalyst in fuel cells.

Proton—Another name for a monovalent ionized hydrogen atom H⁺.

Proton Exchange Membrane (PEM)—An ion exchange membrane typically comprising PFSA optionally covalently bonded onto a PTFE substrate able to transport positively charged ions (cations) but resisting conduction with negatively charged ions (anions) or electrons.

PTFE (polytetrafluoroethylene)—A synthetic fluoropolymer of tetrafluoroethylene characterized by its unique properties of being hydrophobic, non-wetting, high density and heat resistant. PTFE is used as a electrically neutral substrate in the formation of ion exchange membranes.

Raster (pattern)—A two dimensional pattern of movement where a beam or mechanically positioned print head scans back and forth across a fixed width while a material passing through the device or printer such as carbon paper slowly advances producing a quasi-uniform film thickness across the full width of the carbon paper.

Redox—a pair of coupled chemical reactions in a fuel cell, one stripping away electrons from a fuel source in the cathode (oxidation), the other recombining the charges in the anode (reduction) to produce a chemical byproduct generally comprising water.

Reduction—A chemical reaction resulting in an atom or molecule gaining one or more electrons. The reduction of hydrogen by oxygen produces water.

Relative Humidity (RH)—A measure of gaseous water vapor defined as the ratio of dew point temperature to the ambient temperature At 25° C. and RH=50%, water vapor comprises 9 g per kg of air.

Sealant—A nonporous material used to prevent gas leakage in a fuel cell. In accordance with this invention sealant may be applied as a ring or grid between the CCM and GDL and also on the outer edge of the interface between the GDL and TPP or BPP.

Selective Growth—A method to limit the deposition of a material to selected areas previously coated by a promoter or seed material.

Self Alignment—A manufacturing process where multiple process steps share a common point of reference eliminating the need for manual alignment processing and prevents objects from misaligning from one another. In accordance with this invention, the assembly of advanced fuel cells self-align to an exterior edge of the tripolar plates forming a shared registration key.

Sputtering—A non-chemical method deposition method using mass transfer of plasma induced argon ions to strike a target, dislodging material from the target to be deposited onto a substrate in the same stoichiometric ration as the target. In accordance with this invention, sputtering is used to first etch the surface of ion exchange membrane then to deposit a catalyst layer comprising an amalgamate of carbon, noble metal, metal oxides, and other materials.

Solvent—The liquid carrier in which a solute is dissolved controlling the viscosity of a deposited film, spray paint, or ink during deposition. Frequent or continuous stirring may be required to prevent the solute from precipitating out of solution and changing the composition of the deposited material.

Solute—A material to be deposited by a spray painting or printing carried in a suspension by a solvent in which the solute is able to partially or fully dissolve. In accordance with this invention, spray painting or printing of a carbon ink employs different size or length carbon fibers applied sequentially or concurrently in a blend by one or more print or spray heads to produce a gas diffusion layer of varying porosity.

Ultrasonic Molding—The application of ultrasonic activation of molding compounds, typically at 20 kHz to 25 kHz to improve bonding and uniformity in compression and injection molding. In accordance with this invention, ultrasonic molding is used in formation of an ion exchange membrane such as PFSA or a membrane substrate such as PTFE.

I claim:

1. A fuel cell assembly comprising one or more catalyst coated membranes, a plurality of gas diffusion layers, and a plurality of conductive plates wherein;
the catalyst coated membrane comprises an ion exchange membrane able to conduct ions;
where catalyst layers coating the membrane comprise metal atoms accelerating fuel cell reactions and enhancing film conductivity;
where the gas diffusion layers and conductive plates comprising carbon and metal supply gas to the membrane and conduct fuel cell generated electric current;
wherein the ion exchange membrane comprises an ionomeric polymer;
wherein the membrane contains an endoskeleton having greater mechanical strength than the ionomeric polymer.

2. The device of claim 1 where the endoskeleton comprises a carbon reinforced polymer.

3. The device of claim 1 where the ionomeric polymer is chemically bonded to the endoskeleton.

4. The device of claim 3 where the endoskeleton may be thicker, thinner, or substantially equal in thickness to the ionomeric polymer.

5. The device of claim 1 where the endoskeletal matrix is laterally circumscribed by a wider exoskeletal pillar.

6. The device of claim 5 where the exoskeletal pillar is substantially equal to or thicker than the endoskeleton.

7. The device of claim 5 where singulated membranes comprises exoskeletal pillars cut by lasers.

8. The device of claim 5 where the endoskeleton or exoskeleton is identified on one side of the membrane by a tag or laser mark.

9. The device of claim 1 where the interface between the catalyst layer includes a sputter etched surface with a in-situ deposited catalyst layer.

10. The device of claim 1 where the anode catalyst layer and the cathode catalyst layer comprise different stoichiometries or materials.

11. The device of claim 10 where the anode catalyst layer exclusively comprises platinum and where the cathode may include other metals.

12. The device of claim 1 where the gas diffusion layer comprises a heterogenous composition.

13. The device of claim 12 where the gas diffusion layer comprises a carbon substrate coated with discrete layers of carbon comprising different carbon fiber lengths.

14. The device of claim 12 where the gas diffusion layer comprises a carbon substrate coated with a continuously varying composition of carbon.

15. The device of claim 12 where the density of the gas diffusion layer varies monotonically with the highest density near the catalyst layer and the lowest density adjacent to the conductive bipolar or tripolar plate.

16. The device of claim 15 before the gas diffusion layer is attached to the catalyst coated membrane the membrane includes a catalyst layer formed atop the ionomer and the gas diffusion layer also includes a catalyst layer formed on the least porous portion of the gas diffusion layer.

17. The device of claim 1 where the interior of the conductive plate includes a sealant that compresses again the gas diffusion layer to prevent gas leakage.

18. The device of claim 17 where the conductive plate includes channels to transport hydrogen and oxygen in the fuel cell.

19. The device of claim 18 where the conductive plate also includes a separate channel for carrying water or coolant.

20. The device of claim 1 where the fuel is gaseous hydrogen and the conducting cation comprises ionized hydrogen.

21. The device of claim 1 where the fuel is methanol and the conducting cation comprises ionized hydrogen.
